(19) United States
(12) Patent Application Publication
(10) Pub. No.: US 2021/0165771 A1
(43) Pub. Date: Jun. 3, 2021

(54) COMPUTER-IMPLEMENTED METHODS FOR DYNAMIC ANALYTICS

(71) Applicant: VALUE XD LTD., Exeter (GB)

(72) Inventors: Armen Varant Papazian, Copplestone (GB); Aleksandr Eduard Grigoryan, Yerevan (AM)

(21) Appl. No.: 17/107,401

(22) Filed: Nov. 30, 2020

Related U.S. Application Data
(60) Provisional application No. 62/943,114, filed on Dec. 3, 2019.
(60) Provisional application No. 62/943,118, filed on Dec. 3, 2019.
(60) Provisional application No. 62/943,123, filed on Dec. 3, 2019.
(60) Provisional application No. 62/943,124, filed on Dec. 3, 2019.

(30) Foreign Application Priority Data
Nov. 28, 2019 (GB) 1917358.2
Nov. 28, 2019 (GB) 1917361.6
Nov. 28, 2019 (GB) 1917364.0
Nov. 28, 2019 (GB) 1917369.9

(51) Int. Cl. G06F 16/21; G06F 16/25

(52) U.S. Cl. CPC G06F 16/212; G06F 16/25

(57) ABSTRACT

A computer-implemented method comprises the steps of: providing a data set for use in a first analytical scenario or analytical use case; providing a user interface for applying a model function to the data set and for creating an analytical data representation such as a model, chart, table or map representative of the first analytical scenario or analytical use case, wherein data from the data set represents model function variables; modifying the data set for use in a second analytical scenario or analytical use case; wherein the model function is accessible to allow a user to reapply the model function, via the user interface, and thereafter generate a modified analytical representation representative of the second

### RELATED APPLICATIONS

The present application claims priority to Great Brittan applications GB1917358.2 filed 28 Nov. 2019, GB1917361.6 filed 28 Nov. 2019, GB1917364.0 filed 28 Nov. 2019, and GB1917369.9 filed on 28 Nov. 2019 and claims the benefit of U.S. Provisional Patent Application Nos. 62/943,114 filed Dec. 3, 2019, 62/943,118 filed Dec. 3, 2019, 62/943,123 filed Dec. 3, 2019 and 62/943,124 filed Dec. 3, 2019, the entire specifications of which are hereby incorporated by reference in their entirety for all purposes.

### TECHNICAL FIELD

Aspects of the present invention generally relate to computer-implemented methods for dynamic analytics. Further aspects of the present invention generally relate to computer-implemented methods for mathematical functions. Further aspects of the present invention generally relate to computer-implemented methods some of which concern control units.

### BACKGROUND

Analytical tools such as Microsoft® Excel used to create analytical models are widespread and well known. These analytical tools use spreadsheets comprising grids of cells arranged in numbered rows and letter-named columns to allow for data manipulations like arithmetic operations. Raw data may be imported into a spreadsheet where a user is able to process it according to a variety of expressions. For instance, cells in a spreadsheet can contain expressions in the form of items of data and/or functions that may be employed as equations on data. The expressions behind the cells may be used to build an analytical model using the imported data.

Prior art of this kind has a number of technical limitations. In particular, with traditional analytical tools such as Microsoft® Excel, sharing of inputs and outputs can only be done in file format (electronic documents). In order to save the equations related to a particular analytical model for a later date, the spreadsheet containing the expressions must first be saved as a file. This means that there is no direct user access to the model without opening a saved file. This limits the applicability of the model to the specific analysis of that file and the model and functions used in it cannot be readily applied to other use cases.

Furthermore, sharing analytical data or models in file format has the disadvantage that data files in which models are stored may become corrupted. Corruption may occur for example, while the data file containing the model is being ‘saved as’ to be applied to an alternative analytical use case, during network transmission or by the occurrence of many other types of events. The loss of equations and functions behind cells and the loss of any amount of data can be frustrating to a user particularly when the user has spent considerable time and effort to build the analytical model saved in the file.

Moreover, given that functions in such tools are saved inside cells, behind the data, they are not visible to the user unless the user clicks on a specific cell. Additionally, the accuracy and transparency of such tools is questionable given that functions are not in mathematical language and often represented through abbreviations which are not used in expert and scholarly publications and textbooks.

Accordingly, in the prior art, equations are provided as expressions including non-mathematical language, inside the cells, that is, ‘behind’ the data in the cells intended to be analyzed. For example, if a cell contains an expression that uses values contained in other cells to make a calculation, the original cell may output the result of the calculation in place of the equation itself.

Prior art of this kind has a number of technical limitations. In particular, with traditional analytical tools such as Microsoft® Excel, the expressions behind the cells cannot be modified or checked, as they are provided in coding language rather than mathematical language. This real lack of transparency and flexibility is prone to errors. Another disadvantage is that, in order to save the equations for a later date, the spreadsheet containing the expressions must be saved as a file. This means that there is no direct user access to the equations without opening a saved file. This limits the use of the equations to the specific analysis of that file and the expressions cannot be readily applied to other use cases.

From another perspective, Microsoft Excel® is the cumbersome prior art spreadsheet operating tool which this application seeks to radically depart from. The prior art requires direct access to the spreadsheet for data manipulation to create new visual representations. Spreadsheets of this kind are almost impossible to interact with on relatively small devices such as mobile phone screens. They require large power hungry screens for direct access to the data which can then often readily be corrupted by erroneous input. Aspects of the invention will seek to provide an entirely different approach to controlling the modification of the visual representation derived from datasets. In addition, aspects of the invention will seek to overcome the need for power hungry screens and provide an approach which can both handle complex adjustments whilst at the same time allow these to be executed from devices which would consume much less power due to the simplification of the methodologies deployed.

From another perspective, data visualization techniques enable users to assess and comprehend large quantities of information. Existing visualization tools can include charts or graphs that collect, summaries or transform data into meaningful graphical representations including shapes, colors and patterns.

Charts or graphs are typically created based on data imported into a spreadsheet using widespread analytical tools such as Microsoft® Excel. These analytical tools use spreadsheets comprising grids of cells arranged in numbered rows and letter-named columns to allow for data manipulations like arithmetic operations. Raw data may be imported into a spreadsheet where a user is able to process it according to a variety of expressions. For instance, cells in a spreadsheet can contain expressions in the form of items of data and/or functions that may be employed as equations on data. Accordingly, in the prior art, equations are provided as expressions including non-mathematical language, inside the cells, that is, ‘behind’ the data in the cells intended to be analyzed.

Data selected from a spreadsheet is first displayed in the form of a chart or graph in an Excel file, then copied into another program more suitable for presentation such as Microsoft® PowerPoint. The chart or graph is then saved in a PowerPoint file.

The prior art has a major disadvantage in that there is no direct link to the analytics (equations) from which the displayed graph derives. The chart or graph is presented as a static image which cannot be easily adjusted without going back to the raw data in the Excel file. This can be cumbersome and impractical to do during a presentation. Furthermore, the static image lacks transparency towards the analytics (equations) from which the displayed graph derives. Furthermore, the process of navigating through multiple platforms is also not only time consuming as it fails to deliver a real time adjustment function during live presentations but it requires additional processing power and energy consumption which is particularly damaging to the battery charge of portable processors which are often used for live presentations.

Further still, saving the models and their visual representations in various different file formats has the disadvantage that any of the various data files in which models or graphical representations are stored may become corrupted. Corruption may occur for example, while the data file is being saved, during network transmission or by the occurrence of many other types of events. The loss of any amount of data can be frustrating to a user particularly when the user has spent considerable time and effort to build and represent the analytical model saved in the files.

Aspects of the present invention provide an effective solution to address these technical problems, amongst others.

### SUMMARY OF THE INVENTION

According to a first independent aspect of the invention, there is provided a computer-implemented method comprising the steps of:

providing a data set for use in a first analytical scenario or analytical use case; providing a user interface for applying a model function to the data set and for creating an analytical data representation such as a model, chart, table or map representative of the first analytical scenario or analytical use case, wherein data from the data set represents model function variables;
modifying the data set for use in a second analytical scenario or analytical use case;
wherein the model function is accessible to allow a user to reapply the model function, via the user interface, and thereafter generate a modified analytical representation representative of the second analytical scenario or analytical use case.

Preferably, the method provides a user interface that provides a structured data set for use in an analytical scenario or analytical use case through import, upload, or direct input of data.

In preferred embodiments, the or each sheet is ascribed x and y axes, allowing the automation of structured data analysis.

In preferred embodiments, a user interface is provided for creating abstract analytical panels, including a model equation or function or functions, that can be applied to any data set in order to create a data analysis and representation panel such as a model, chart, table or map, using actual mathematical language with visible equations.

In further preferred embodiments, the method comprises the step of providing abstract panels as reusable universal analytical tools when created in abstraction and when created using data from the first analytical scenario or analytical use case, wherein data from the data sets represent model function variables.

Preferably, the method provides a user interface to aggregate multiple number of equations or functions in panels in abstract analytical dashboards that can be applied and reapplied to any number of analytical scenarios or analytical cases.

Preferably, the method may provide a user interface that allows the application of abstract panels and dashboards on analytical cases via a drag and link data validation interface, and thereafter generate a modified analytical representation representative of the n^{th} analytical scenario or analytical use case.

In a further optional embodiment, the method provides a user interface that allows the sharing of abstract panels and dashboards, and data sets, across users, thus allowing the sharing of applicable models and functions as cloud based tools.

In a further optional embodiment, the method provides a user interface that allows the creation of presentations from within an analytical scenario or case, with one click, or from multiple cases and scenarios.

In a further optional embodiment, applied dashboards include panels which are exported into a presentation module that allows for a continuous and dynamic link to underlying case data.

In a further optional embodiment, the method provides a user interface, the controller, that allows the front end manipulation, simulation, and projection of analytical outputs in applied panels and dashboards, before and during live presentations, allowing for multiple scenario creations and analysis.

This method advantageously enables through an integrated technology that covers all the elements and aspects of the analytical value chain, thus providing a self-sufficient loop within its own technology, the creation and instant sharing of live analytical inputs and outputs and, importantly, the models (model equations or functions) that produce them.

This provides an integrated, cloud based analytical platform with global access via the internet that allows for the creation of a model in San Francisco, and its instantaneous application in London, or Kathmandu, without any files or emails being sent between the creator of the model/panel/dashboard and the users who choose to apply it.

Advantageously therefore, with the present invention, the sharing of analytical functions and models no longer has to be done in file format, avoiding file corruption and modelling errors, thus providing for a more robust system.

The input data may be provided for example in a data sheet comprising a plurality of data cells. The user may input additional constants and/or variables for the second analytical use case or scenario and apply modifications in order to display a modified table and/or map and/or chart and optionally either reverting to a previous display or applying said modifications as a new scenario. This allows modifications to be carried out with versatility.

Preferably, the method further comprises providing a control unit operable to select at least one model function variable and/or constant, receive an input to modify a data value in the data set associated with the variable and/or constant and reapply the model function to the data set to provide a second analytical representation (such as a visual representation) of the applied model function.

Preferably, the method may provide the multiple application of panels and their functions, whether they be models, tables, charts, or maps, on a n^{th} analytical case, without needing the original data sheet that was used to create the equations and functions in the panels. This approach is particularly efficient allowing a user to feed new data into model functions that sit in panels through an interface which sits above the data without having to interact directly with it on the level of cells as in conventional spreadsheets.

This also allows a reduction of the screen size for manipulating data and visual outputs which allows complex modifications to be applied from devices with relatively small screens such as mobile phone or the like. This is particularly efficient from an energy usage point of view as advanced and complex interactions are now achievable with such devices thus saving on the charge used.

Optionally, through the data validation interface, new data (sheets) with set x and y axes, can be linked to abstract panels and dashboards, allowing for flexible, automatic, and easy matching of variables in the data and the parameters of the functions in model/chart/map/table panels of the selected dashboards. This provides a tool for rapid detection of existing required variables, rapid matching of potentially usable material without requiring a user to necessarily look at cells or rows of variables in the data sheet.

Preferably, the method further comprises providing a controller unit operable after panels have been created and applied to an analytical case, allowing front end adjustments to be applied to model functions, to selected model function variables and/or constants. The controller allows the user to access an input variable/constant in order to modify a data value in the data set associated with the variable and/or constant and reapply the model function to the data set to provide an alternative analytical representation (such as a visual representation) of the applied model function.

Preferably, the user interface enables the user to combine one or more of said panels in a dashboard. More preferably, the user interface allows the user to apply the dashboard to the n^{th} analytical scenario or analytical use case. This enables extra versatility.

In a further subsidiary aspect, said control or data validation unit is accessible by interaction with the user interface and said control unit provides the option of selecting an additional variable and associating said variable with a particular data set of a data sheet by clicking to link and/or unlink said additional variable.

Advantageously, in certain embodiments, the control unit incorporates a projector which operate as the simulation tool that allow manipulation of data through a few clicks providing front end access to underlying data variables after models/maps/charts/tables are created, where new outputs are saveable as new analytical use case or scenarios in the same project.

Whilst advantageously, the control unit incorporates a projector for scenario simulation, the projector may also be provided as a standalone module. In certain preferred embodiments, these two very useful tools make the analytical process more fun, more effective, and infinitely less tedious. With just a click of a button, the user can open the control unit or controller, which provides fine tuning tools for specific variables from the front end of the model. These variables, the ones that end up in the controller of a model may be chosen by the user.

Advantageously as outlined previously, the projector sits within the controller, and allows users to project the analytical representations (models, charts, tables, and maps) into the future, whilst providing them with the opportunity to factor in specific future events that affect different variables at different periods in the future. In preferred embodiments, all of the above aspects may be carried out with a few clicks, without ever having to revisit a data sheet.

In a dependent aspect, the user interface includes a toolbar display operative to display a plurality of visual components representing respective mathematical functions or equations, wherein one of said visual components is displayed in response to a selection of its respective mathematical function, wherein at least one of said mathematical functions is connected to an associated calculation engine of a calculation controller independent from the data set, the calculation engine operable to apply the at least one of said mathematical functions to the data set. The plurality of visual components are preferably suitable for combining into an aggregate mathematical function representing said model function.

Advantageously, this enables the use of mathematical functions or equations as visual mathematical engines written in mathematical language that sit in panels, not in cells, above the data, not behind. Preferably, the equations are cloud-based, readily deployable tools on any datasheet, thus increasing transparency, efficiency, and knowledge build up. This increases robustness and reliability of the system. Said method may be configured so that the visual mathematical engine, the mathematical engine and/or the mathematical controller are accessible by interaction with a floating panel which sits above said cells. Said mathematical engine is preferably accessible independently from any interaction with the data cells or spreadsheets.

Preferably, said controller is configured to be accessible during a presentation of said chart and/or table and to allow a user to input additional constants and/or variables to said controller and thereafter generate a modified display as an updated chart and/or updated map and/or as an updated table which takes into account said inputted additional constants and/or variables. This provides live, in presentation, advantageous functionality as presentations can be rapidly modified or enhanced in real time for example due to feedback from the audience. Furthermore, it provides an integrated solution which due to its enhanced efficiency also reduces the likely consumption of electrical charge by the processing unit which is driving the presentation.

It will be appreciated that the described methods may be performed on any suitable processing system, including hardware or firmware. In some cases, each step may be performed by a module in a system.

Additionally or alternatively, any of the described methods may be embodied as instructions on a non-transitory computer-readable medium such that, when the instructions are executed by a suitable module within the system (such as a processor), cause the module to perform a described method.

According to a further independent aspect of the invention, there is provided a computer-implemented method comprising the steps of:

providing a data set for insertion into a data sheet comprising a plurality of data cells;
providing a user interface such as a toolbar display operative to display a plurality of visual components representing respective mathematical functions or equations,
wherein one of said visual components is displayed in response to a selection of its respective mathematical function,
wherein at least one of said mathematical functions is connected to an associated calculation engine of a calculation controller independent from data inserted in the plurality of data cells, the calculation engine operable to apply the at least one of said mathematical functions to the data set.

In a dependent aspect, the plurality of visual components are suitable for combining into an aggregate mathematical function.

Advantageously, the method enables the use of mathematical functions or equations as visual mathematical engines written in mathematical language that sit in panels, not in cells, above the data, not behind. Preferably, the equations are cloud-based, readily deployable tools on any datasheet, thus increasing transparency, efficiency, and knowledge build up. This increases robustness and reliability of the system. Said method may be configured so that the visual mathematical engine, the mathematical engine and/or the mathematical controller are accessible by interaction with a floating panel which sits above said cells. Said mathematical engine is preferably accessible independently from any interaction with said cells or spreadsheets.

Preferably, the method comprises the steps of modifying said equations by direct interaction with them through said mathematical engine prior to selectively applying said modified equations to a data set in order to return a modified result. This is particularly advantageous as it avoids the prior art requirement of necessarily clicking cells to be able to review the equations associated with said cell. It also avoids having to even access a file containing the data to carry out the modification of the equation as the modification of said equation may be carried out externally and independently. The user being thereafter able to control how to apply its user edited formulas and to what extent to apply these over one or a plurality of data sets as appropriate. This provides a particularly efficient manner of returning results without having to go through the steps of selecting cells or data sheet files to start with. It may be particularly significant when editing spreadsheet on battery powered devices which would need to consume much more power in the prior art method. Now by contrast, embodiments may be configured to significantly reduce the number of windows opened by allowing direct and independent access to the mathematical engine for amendments and only thereafter applying said modifications appropriately. This will also therefore provide significant savings in power consumption in addition to the very significant other advantages mentioned previously with regard to efficiency of user interaction.

In a further subsidiary aspect, the plurality of visual components of said user interface comprise one or more user definable variables and/or one or more user definable constants which are selectable to formulate one or more mathematical functions; said functions being stored independently from any data sheet or data cell.

In a further subsidiary aspect, said mathematical functions are accessible independently from any interaction with any data sheet or data cell; and are separately assignable to any data set, data cell, or data sheet by user interaction with a user interface.

In a further subsidiary aspect, said user interface provides the option of associating a variable with a particular data set of a data sheet.

In a further subsidiary aspect, said user interface may be configured to provide the option of selecting a variable and associating said variable with a particular data set of a data sheet by dragging and dropping. Dragging and dropping may include the actions of selection by the user either directly or indirectly (via a cursor for example) and the subsequent selection by the user either directly or indirectly of a particular data set of a data sheet, whereby the variable is then associated with a particular data set of a data sheet.

In a further subsidiary aspect, said user interface may be configured to provide a number of editable template equations and may represent said equations as buttons which either display in an editing panel following a user selection of said button or provide information with regard to said template equations in response to a user solely hovering over said button. The term hovering includes for example the positioning of a user's selection means (for example a finger, a cursor etc.) in a position typically over said button without any action of selection (such as the application of pressure on a touch sensitive screen) of said button taking place.

In a further subsidiary aspect, said information pertaining to said template equation may selectively be user inputted.

In a further subsidiary aspect, said user interface may be configured to provide the option of inputting user defined variables and constants.

In a further subsidiary aspect, said user interface may be configured to provide the option of inputting user defined buttons or user defined sub-formulas.

It will be appreciated that the described methods may be performed on any suitable processing system, including hardware or firmware. In some cases, each step may be performed by a module in a system.

Additionally or alternatively, any of the described methods may be embodied as instructions on a non-transitory computer-readable medium such that, when the instructions are executed by a suitable module within the system (such as a processor), cause the module to perform a described method.

According to a further independent aspect of the invention, there is provided a computer-implemented method comprising the steps of:

providing a data set for insertion into a data sheet comprising a plurality of data cells;
applying a model function to the data set, wherein data from the data set represents model function variables;
providing a first visual representation of the applied model function, and providing a control unit operable to select at least one model variable and/or constant, receive an input to modify a data value in the data set associated with the variable and/or constant and reapply the model function to the data set to provide a second visual representation of the applied model function.

Preferably, the method provides a second visual representation without a user taking the step of accessing the data sheet. This approach is particularly efficient allowing a user to mix the data by engaging with an interface which may sit above the data without having to interact directly with it as in conventional spreadsheets. This also allows a reduction of the screen size for manipulating data and visual products which allows complex modifications to be applied from devices with relatively small screens such as mobile phone or the like. This is particularly efficient from an energy usage point of view as advanced and complex interactions are now achievable with such devices thus saving on the charge used.

Preferably, said data set has a time line and said at least one model variable and/or constant is provided as a panel with a matching time line and at least one matching variable and/or constant. This provides a tool for rapid detection of matching potentially usable material without requiring a user to directly access the spreadsheet.

In a further subsidiary aspect, said at least one variable comprises a time period and the method comprises the steps of selecting one or more additional time periods and forecasting the data relating to said selected additional time periods dependent on previously entered data and/or one or more additional variables and/or constants. This allows the controller to project the visual representation into future time periods without necessarily requiring a user to directly access the spreadsheet. This may be particularly advantageous when employing the control unit during live presentation of the visual representations.

Optionally, said forecasting step for one or more of said additional time periods derives data for said additional time periods based on a rate associated with a previous time period. This provides an intuitive and responsive projection without requiring complex calculations.

In a further subsidiary aspect, said forecasting step for one or more of said additional time periods derives data for said additional time periods based on a rate associated with the most recent time period.

Preferably, said forecasting step for one or more of said additional time periods derives data for said additional time periods based on an average rate determined from a plurality of previous time periods. This provides advantageous efficient projections of the visual representation.

Preferably, said data set has a plurality of time periods and the method further comprises the steps of selecting additional time periods and inputting user defined values relating to said additional time periods.

In a further subsidiary aspect for further enhancing the advantages outlined with respect to previous aspects, the method comprises the steps of allowing modification of a data value after the creation of one or more visual representations and optionally either reverting to a first visual representation of the applied model function or saving said second visual representation as a new scenario.

In a further subsidiary aspect for further enhancing the advantages outlined with respect to previous aspects, the method comprises the steps of providing a user interface which simultaneously presents a first visual representation of the applied model function and a button accessible in said user interface for accessing said control unit. This allows access to the control unit directly from said visual representation in order to avoid any direct user interaction with the spreadsheet.

In a further subsidiary aspect, said control unit is accessible by interaction with a user interface and said control unit provides the option of associating a variable and a constant with a particular data set of a data sheet.

In a further subsidiary aspect, said control unit is accessible by interaction with a user interface and said control unit provides the option of selecting an additional variable and associating said variable with a particular data set of a data sheet by clicking to link and/or unlink said additional variable.

Preferably, the method further comprises the step of providing a panel relating to one or more additional variables and/or constants.

Preferably, the method further comprises the steps of presenting a list of one or more panels relating to one or more additional variables; said one or more panels having at least one selectable matching property and/or at least one selectable matching constant.

Advantageously, in certain embodiments, the control unit incorporates a projector which operate as the simulation tools that allow manipulation of data through a few clicks providing front end access to underlying data variables after model s/maps/charts/tables are created, where new outputs are saveable as new scenarios in the same project.

Whilst advantageously, the control unit incorporates a projector for scenario simulation, the projector may also be provided as a standalone module. In certain preferred embodiments, these two very useful tools make the analytical process more fun, more effective, and infinitely less tedious. With just a click of a button, the user can open the control unit or controller, which provides fine tuning tools for specific variables from the front end of the model. These variables, the ones that end up in the controller of a model may be chosen by the user.

Advantageously as outlined previously, the projector sits within the controller, and allows users to project their models, charts, tables, and maps into the future, whilst providing them with the opportunity to factor in specific future events that affect different variables at different periods in the future. In preferred embodiments, all of the above aspect may be carried out with a few clicks, without ever having to revisit a data sheet.

In a further broad independent aspect, the invention provides a computer-implemented method for operating a computer application for displaying data as a chart and/or as a map and/or as a table, comprising the steps of:

providing a data set for insertion into a data sheet comprising a plurality of data cells;
displaying said data as a chart and/or as a map and/or as a table; and providing a user interface and a controller which is accessible through said user interface:
wherein said controller is configured to be accessible during a presentation of said chart and/or table and to allow a user to input additional constants and/or variables to said controller and thereafter generate a modified display as an updated chart and/or updated map and/or as an updated table which takes into account said inputted additional constants and/or variables.

This provides live in presentation advantageous functionality as presentations can be rapidly modified or enhanced in real time for example due to feedback from the audience. Furthermore, it provides an integrated solution which due to its enhanced efficiency also reduces the likely consumption of electrical charge by the processing unit which is driving the presentation.

Preferably, the controller comprises a calculation engine which provides at least one mathematical function; wherein said calculation engine is operable to apply during said presentation the at least one of said mathematical functions to said data set. This provides not only data manipulation during the presentation but the option of modifying the underlying equation which may therefore more rapidly provide accurate and adaptable results.

Preferably, the calculation engine is accessible during the presentation and the at least one mathematical function is editable thereby. This provide enhanced speed of modification of a presentation.

In a further subsidiary aspect, the method comprises the step of displaying alongside said chart and/or said map and/or said table one or more labels corresponding to particular variables: said displayed labels being selectable: whereby once selected said particular variables are removed from said displayed chart, and/or map and/or table. This allows the contents of a presentation to be optionally reduced in real time without having to interact with the spreadsheet.

Optionally, the method comprises the steps of selecting one or more additional periods and forecasting the data relating to said selected additional periods dependent on previously entered data and/or one or more additional variable. This provides an advantageous forecasting tool which may be implemented during a live presentation.

Preferably, the method comprises the steps of selecting additional periods and inputting user defined values relating to said additional periods. This allows a user to implement potential simple requests from an audience or according to particular interests of a user.

In a further subsidiary aspect, the method further comprises the steps of applying modifications in order to display a modified table and/or map and/or chart and optionally either reverting to a previous display or applying said modifications as a new scenario. This allows modifications to be carried out with extra versatility.

In a further subsidiary aspect, the method comprises the steps of providing a user interface operative to display a plurality of visual components representing respective mathematical functions, wherein one of said visual components is displayed in response to a selection of its respective mathematical function, wherein at least one of said mathematical functions is connected to said calculation engine of said controller independent from data inserted in the plurality of data cells, the calculation engine being operable, during said presentation, to apply the at least one of said mathematical functions to the data set. This configuration allows the equations to be efficiently adjusted during live presentations.

In a further subsidiary aspect, the plurality of visual components are suitable for combining into an aggregate mathematical function.

Preferably, said mathematical functions are written in mathematical language and are accessible in panels or tool bars at the same time as said presentation. This is particularly advantageous because it allows real time adjustments to take place.

Preferably in order to further improve the efficiency of the method, said mathematical functions are cloud-based and accessible during said presentation.

Preferably in order to further improve the efficiency of the method, said mathematical engine and/or said mathematical controller operate in response to interaction with a floating panel which is presented at the same time as said presentation.

Preferably in order to further improve the efficiency of the method, said mathematical engine and/or said mathematical controller are accessible by interaction with said controller during said presentation.

Preferably in order to further improve the efficiency of the method, the method comprises the steps of modifying said mathematical functions by direct interaction with them through said mathematical engine and/or mathematical controller prior to selectively applying said modified mathematical functions to a data set in order to return a modified presentation.

Preferably, said plurality of visual components of said user interface comprise one or more user definable variables and/or one or more user definable constants which are selectable to formulate one or more mathematical functions; said functions being stored independently from any data sheet or data cell and are accessible by interaction with said controller during said presentation.

In a further subsidiary aspect, said user interface provides the option of associating a variable with a particular data set of a data sheet.

In a further subsidiary aspect, said user interface is configured to provide the option of selecting a variable and associating said variable with a particular data set of a data sheet by dragging and dropping.

In practical embodiments, business, executive or investment presentations become more informed thanks to this method that enables access to the data behind the slides in a dynamic way. Advantageously, it is possible to adjust the output chart in a slide during the live presentation, without opening any other file or software, or going back to the data sheet.

The method allows to do this by opening the controller of the model in the slide, and simulating the relevant changes.

In a further independent aspect, the invention provides a computer-implemented method comprising the steps of:
providing a data set for use in a first analytical scenario or analytical use case;
providing a user interface for applying a model function to the data set and for creating an analytical data representation such as a model, chart, table or map representative of the first analytical scenario or analytical use case, wherein data from the data set represents model function variables;
modifying the data set for use in a second analytical scenario or analytical use case;
providing a user interface for accessing a plurality of model functions in a library of model functions; said model functions being downloadable;
wherein the method provides a step of segregating downloadable or non-user generated model functions from user created model functions.

In a subsidiary aspect, the method comprises the step of providing downloadable dashboards and segregating downloadable dashboards from user created dashboards.

In a subsidiary aspect, the method comprises the step of providing non-user generated content to a user specific area of a server and separating user generated content in another user specific area of a server.

In a further independent aspect, the computer-implemented method comprises the steps of:
providing a data sheet comprising a plurality of data cells;
providing a user interface operative to display a window for the selection of a plurality of visual components representing a plurality of options for defining a principal axis time line;
wherein said window sits above or alongside said data sheet.

In a further subsidiary aspect, the principal axis time line is the X-axis time line.

In a further subsidiary aspect, the plurality of options are selected from the group comprising: a first date, a second date, a number of periods, an indication of the length of each period, the direction of the axis, the type of day, and/or a count type.

In a further subsidiary aspect, one or more of said contents are selectively shareable within a group.

In a further subsidiary aspect, one or each one of the following content is selectively shareable: cases, datasets, presentations, dashboards and any elements of these.

In a further subsidiary aspect, the method comprises the step of providing a plurality of disparate user definable group.

In a further subsidiary aspect, the method comprises the step of providing company, department and team level groups.

It will be appreciated that the described methods may be performed on any suitable processing system, including hardware or firmware. In some cases, each step may be performed by a module in a system.

Additionally or alternatively, any of the described methods may be embodied as instructions on a non-transitory computer-readable medium such that, when the instructions are executed by a suitable module within the system (such as a processor), cause the module to perform a described method.

### BRIEF DESCRIPTION OF THE DRAWINGS

Aspects of the present invention will now be described, by way of example only, with reference to the accompanying figures, in which:

FIG. 1 shows a block diagram schematically illustrating functional elements according to an example of the invention; in particular it shows key modules, structure, and functional elements. A cloud-based analytics platform that covers all the elements of the analytical value chain through an innovative self-sufficient and integrated technology that radically departs from conventional thinking by transforming the flow and architecture of the analytical process.

FIG. 2 shows an exemplary overall system flow as a cloud based integrated technology that covers all the elements and steps of the analytical value chain thus providing a self sufficient loop within its own technology allowing global sharing of live analytical inputs and outputs, and the models that produce them.

FIG. 3 shows a data flow and storage module, allowing users to input, upload or import data.

FIG. 4 shows an abstract analytical panel creation interface module; in certain embodiments, the creation of analytical equations of all types, whether used in models, maps, tables, and/or charts, may be provided through abstract panels that may be cloud based tools and deployed at anytime on any case or scenario or data sheet.

FIG. 5 shows an abstract analytical dashboard creation interface module; in certain embodiments, the creation of abstract analytical dashboards of all types, uses models, maps, tables and/or charts, and may occur through the aggregation of abstract panels in dashboards.

FIG. 6 illustrates the application of abstract analytical dashboards to cases scenarios and/or sheets; In certain embodiments, this application creates dashboards using all types of panels, including models, maps, tables, and/or charts. In certain embodiments, applying a dashboard to a Case/Scenario starts by selecting the abstract Dashboard in the Dashboard workstation. This can be done at the beginning when creating a case, or later on during analysis. After linking the panels or the dashboard to specific sheets in the scenario or case, the Data Validation interface module allows the user to link the data in sheets/scenarios/cases, to the required parameters in the panels through drag and link.

FIG. 7 illustrates using the controller and projector on applied panels and dashboards. In certain embodiments, once an abstract dashboard has been applied to a case or scenario, and results have been generated in an applied dashboard, users can fine tune their analysis through the Controller tool which is situated at the bottom right of all panels that have been assigned controller variables or constants. This happens during the creation of all panels (Models, Charts, Tables, and Maps), and the user selects which variables are to be included in the Controller/Projector tool. The controller and projector tool allow the user to simulate and project the panels, as a front end access to back end variables and constants that works like a DJ's Mixer.

FIG. 8 illustrates creating a dynamic presentation (e.g. with a single click) and simulating data during live presentation. In certain embodiments, users can create a presentation using all the outputs created for a specific case or scenario by clicking on ‘Create Presentation’ button, which takes the user to the internal presentation module with all the panels already placed in slides. All panels remain dynamic and actively linked to data, can be edited and adjusted in size to allow a visually impressive presentation, while the content of the panel is adjusted to these changes automatically. Panels can also be placed in a presentation through different cases and different scenarios through a ‘Build a Presentation’ button that allows users to select panels from different cases and scenarios with ease, so that the presentation is not just reliant on one case or scenario. During Live presentations, user has access to the Controller and Projector of the panel that is on the slide, such that live presentations can now include live manipulation of data in front of the audience, this is facilitated by a direct link to the data, and a dynamic link between the slides, the panels on them, their controllers, and the underlying data.

FIG. 9 is another block diagram schematically showing functional elements of the invention. In certain embodiments, a dynamic cloud based analytics platform is provided that covers the entire analytical value chain, making the sharing of applicable models and collection of models possible.

FIGS. 10 to 35 show aspects of a user interface illustrating user interaction with the system that describe the entire system flow described in FIGS. 1-9.

FIG. 10 shows a user desktop interface. In certain embodiments, the user desktop interface contains all the analytical work and tools developed by the user over time.

FIG. 11 shows the creation of an analytical case, uploading files and description.

FIG. 12 shows the dashboard workstation, where users select the Dashboards to be applied to the case being created.

FIG. 13 shows an embodiment of descriptive data points that can be added to any and each case, which allow users to screen cases based on specific inputs and outputs.

FIG. 14 shows an embodiment of a VXD (registered trade mark) spreadsheet tool, scenario/case data, selected dashboards, and sheet axes.

FIG. 15A shows an embodiment of third party data import interface access point.

FIG. 15B shows an embodiment of an IMF (International Monetary Fund) Data Import Interface.

FIG. 15C shows an embodiment of a Bloomberg (registered trade mark) Data License Data Import Interface—Identifying and Selecting Securities through their FIGI Codes

FIG. 15D shows an embodiment of a Bloomberg License Data Import Interface-Identifying and Selecting Data Types and Fields.

FIG. 15E shows an embodiment of Bloomberg Data License Data Important Interface-Identifying Time Window and Periodicity of Data and Sending Request.

FIG. 16A shows an embodiment of applying dashboards to a scenario or case—Linking Dashboards and Panels to Specific Data Sheets.

FIG. 16B shows an embodiment of data validation modules linking sheet data variables and constants to required panel/dashboard parameters.

FIG. 17 shows an embodiment of applied dashboard results.

FIG. 18A shows an embodiment using the controller on applied panels and dashboards.

FIG. 18B shows an embodiment of linking panels in dashboard through the controller.

FIG. 18C shows an embodiment of projecting data through the Projector in the Controller.

FIG. 19 shows an embodiment of creating a new dashboard by selecting from existing panels, models, charts, tables and maps.

FIG. 20 shows an embodiment of creating a dashboard using a model, a chart, a table and a map.

FIG. 21 shows an embodiment of saving a newly created dashboard.

FIG. 22 shows an embodiment of expanding a panel (model, chat, map or table).

FIG. 23A shows an embodiment of creating an abstract analytical panel-model.

FIG. 23B shows an embodiment of creating a model using an existing data sheet.

FIG. 23C shows an embodiment of selecting variables and constants from underlying data sheet selected.

FIG. 23D shows an embodiment of assigning symbols to variables and constants including Greek Letters.

FIG. 23E shows an embodiment of the formula or equation editor for writing a main formula and a sub formula of the model.

FIG. 23F shows an embodiment of the model catalogue where all models are saved.

FIG. 24A shows an embodiment of creating an abstract analytical panel—chart.

FIG. 24B shows an embodiment of creating the Chart using an existing data sheet, selecting variables and constants to display.

FIG. 24C shows an embodiment of a chart catalogue where a plurality of charts are saved.

FIG. 25A shows an embodiment of creating an abstract analytical panel—table.

FIG. 25B shows an embodiment of linking a table to an existing data sheet and selecting variables and constants, arranging their order.

FIG. 25C shows an embodiment of a table catalogue where all tables are saved.

FIG. 26A shows an embodiment of creating an abstract analytical panel-map.

FIG. 26B shows an embodiment of linking a map to an existing data sheet, selecting variables and constants, choosing variables to display and legend.

FIG. 26C shows an embodiment of a map catalogue where all maps are saved.

FIG. 27A shows an embodiment of an applied dashboard where the user can go back to scenario data or create a presentation.

FIG. 27B shows an embodiment of creating a presentation for the presentation module.

FIG. 27C shows an embodiment of editing and formatting slides and text, and panels.

FIG. 27D shows an embodiment of inserting media, images, shapes, editing colours, sizes and alignments.

FIG. 27E shows an embodiment of arranging multiple panels on slides.

FIG. 28A shows an embodiment of presenting a finalised presentation.

FIG. 28B shows an embodiment of dynamic slides during a presentation.

FIG. 28C shows an embodiment of using the controller during live presentations.

FIG. 28D shows an embodiment of manipulating data or timeline during live presentation.

FIG. 28E shows an embodiment of seeing results live on slide during a presentation.

FIG. 29A shows an embodiment of linking multiple panels to a controller during live presentation.

FIG. 30 shows an embodiment of the creation of sharing constructs for particular groups.

FIG. 31 shows an embodiment of an x-axis creator.

FIG. 32 shows an embodiment of the selection of downloadable dashboards.

FIG. 33 shows an embodiment of the selection of the download option.

FIG. 34 shows an embodiment of a preview prior to download of a dashboard.

FIG. 35 shows an embodiment of the desktop d configuration.

### DETAILED DESCRIPTION

### System Architecture/General Data Flow

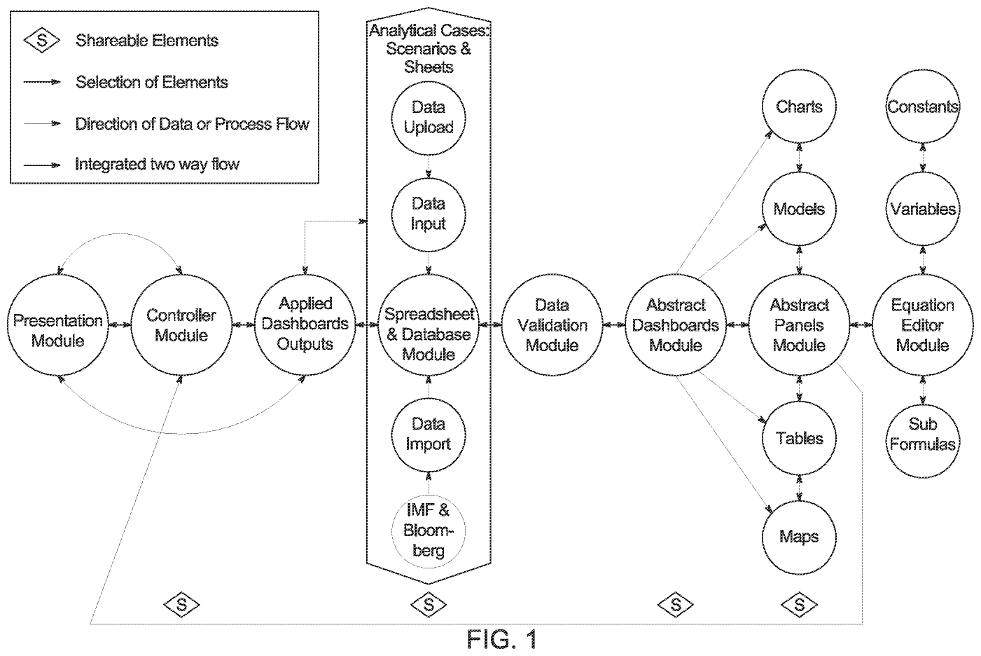

With reference to FIG. 1, a computer implemented system comprises a platform connected to a frontend (e.g. user interface), as well as internal and external databases. The system has a processor configured to carry out calculations, including, amongst others: calculating a formula, parsing a formula, carrying out a calculation, and returning a result. In the interest of clarity, it should be mentioned that some of the figures, FIG. 1 included, are somewhat hybrid in that some of the shown entities in the figures represent more functional aspects of the system, whereas others are more representative of physical articles. It would be understood, however, that the scope of the invention is in no way compromised or obscured and indeed it is of benefit to understanding the invention that the figures are set out as they are.

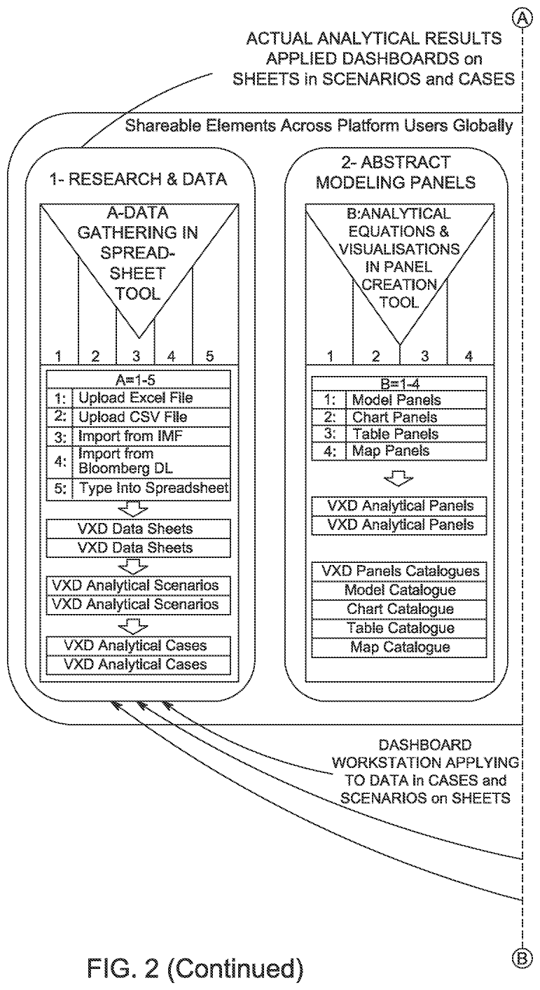

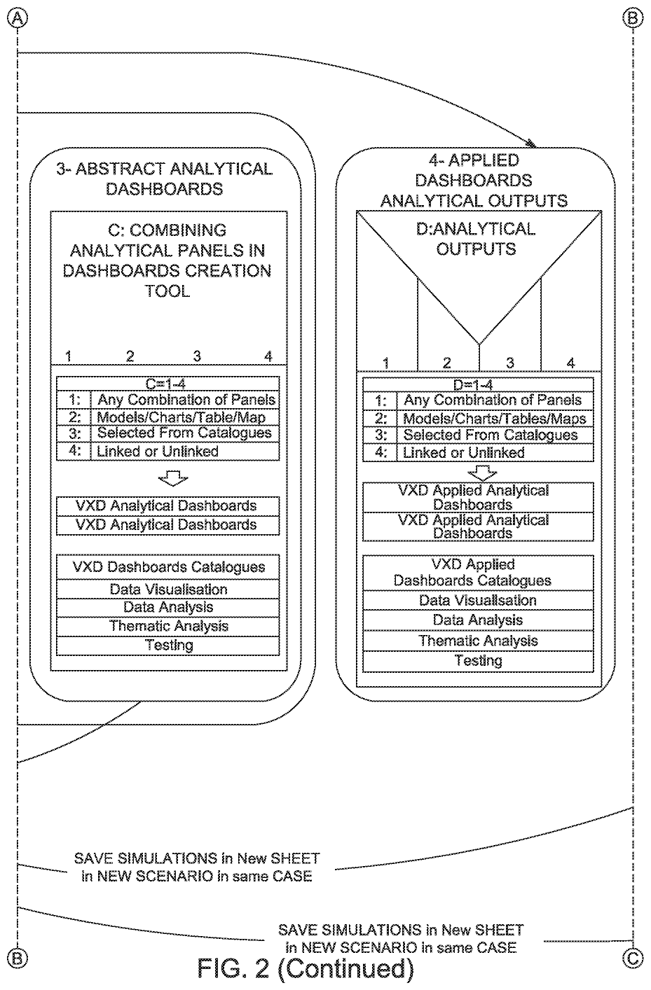

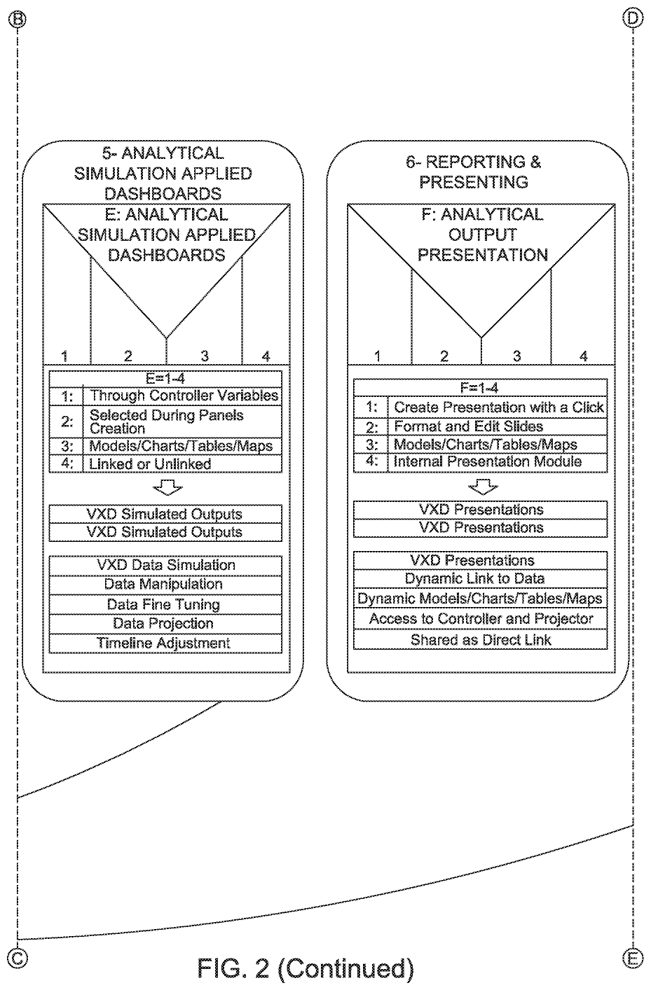

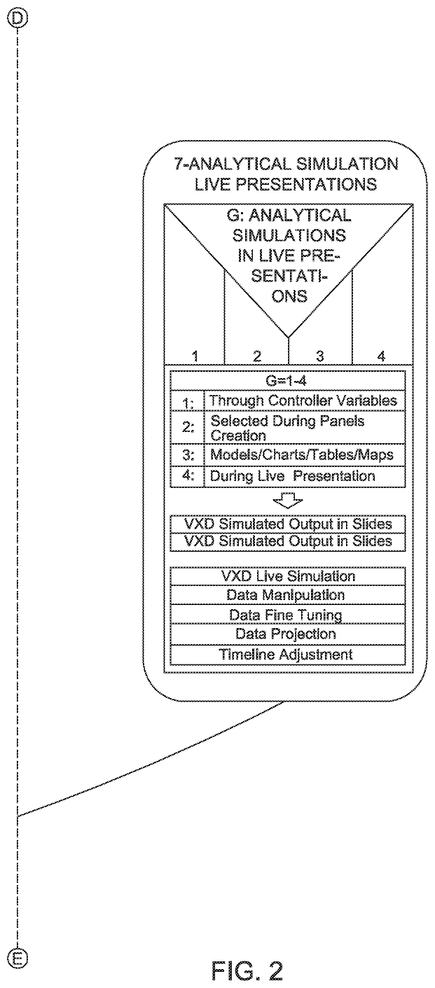

FIG. 2 shows an overall system flow as a cloud based integrated technology that covers all the elements and steps of the analytical value chain thus providing a self-sufficient loop within its own technology allowing global sharing of live analytical inputs and outputs, and the models that produce them. In this example, the platform includes the following modules:
1. Research and data
2. Abstract modelling panels
3. Abstract analytical dashboards
4. Analytical outputs applied dashboards
5. Analytical simulation applied dashboards
6. Reporting and presenting
7. Analytical simulation live presentations.

Modules 1, 2 and 3 represent shareable elements across platform users globally. The dashboard workstation (1-3) applies to data in cases and scenarios on sheets for example. The user may save simulations in a new sheet in a new scenario in the same case for example. A user specific content area may be provided in a server. Similarly, simulations may be saved in a new sheet in a new scenario in the same case. The modules and their interaction are described in more detail below.

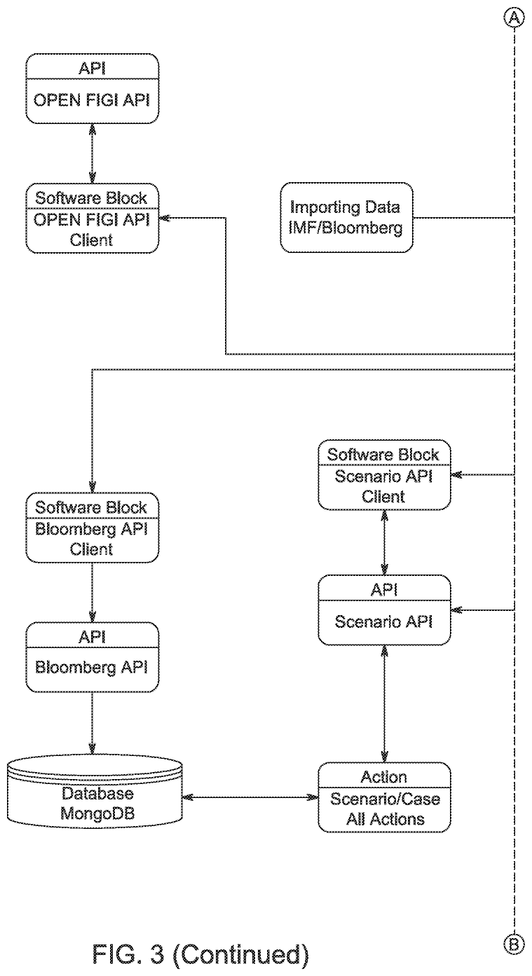

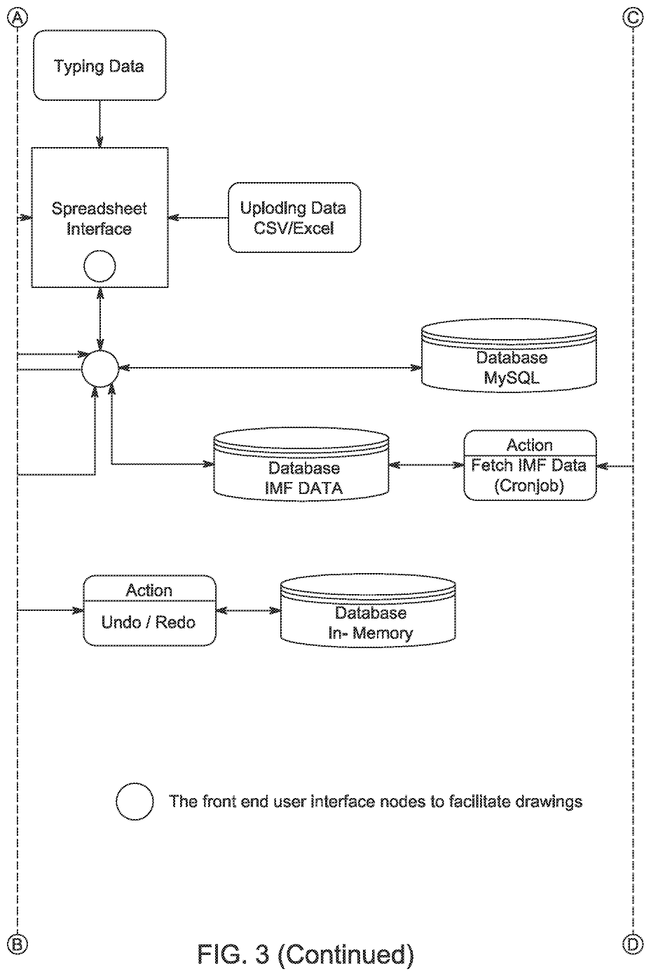

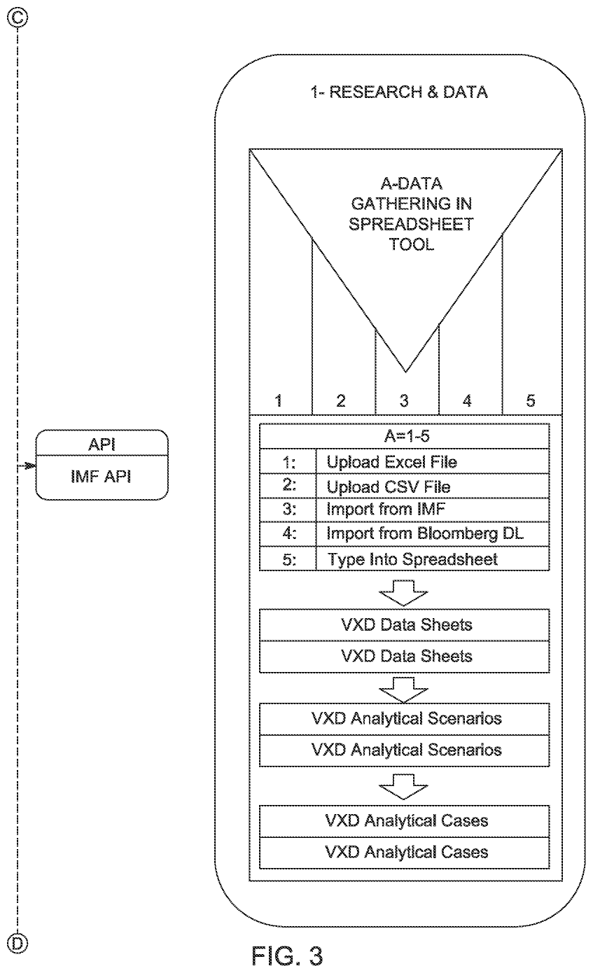

FIG. 3 shows the first module representing a data flow and storage module which allows users to input, upload or import data, for example by interaction with a spreadsheet interface. A data gathering in spreadsheet tool allows a user to upload data for example from files or external databases for the creation of data sheets, analytical scenarios and/or analytical cases. The terms upload and download are to be interpreted in certain embodiments as an assignment of data to a particular area of a server. This doesn't necessarily imply a transfer between multiple storage facilities as a user specific storage facility may be a reserved area for a user account on the same server as for other user and/or operatives.

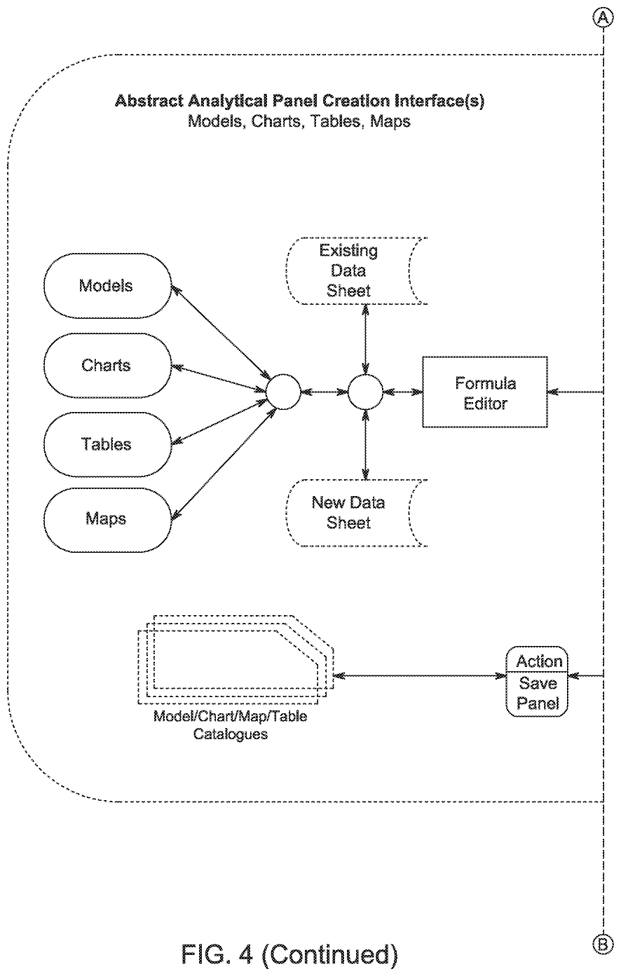

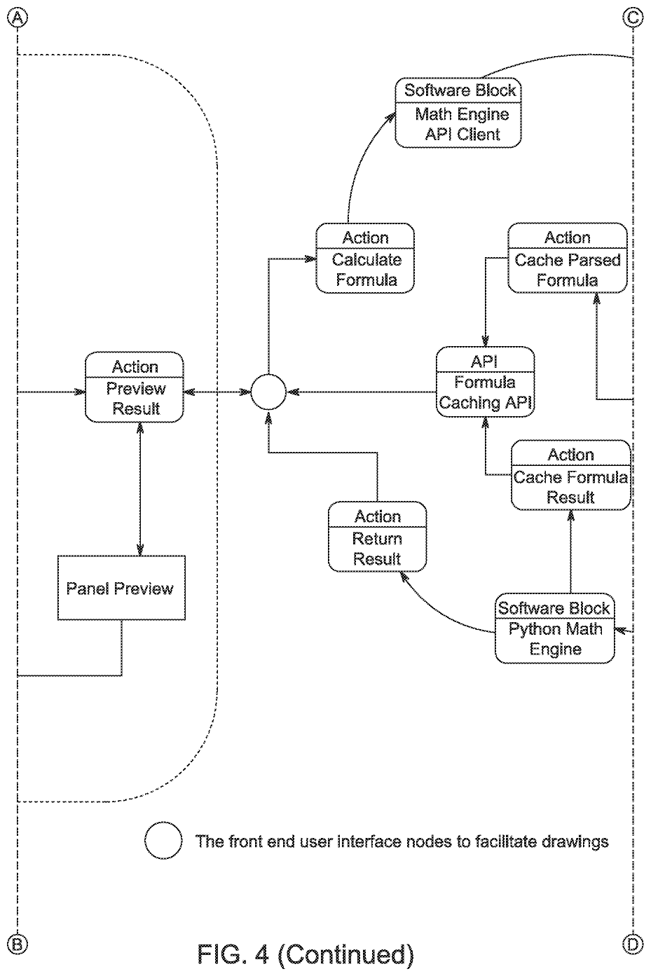

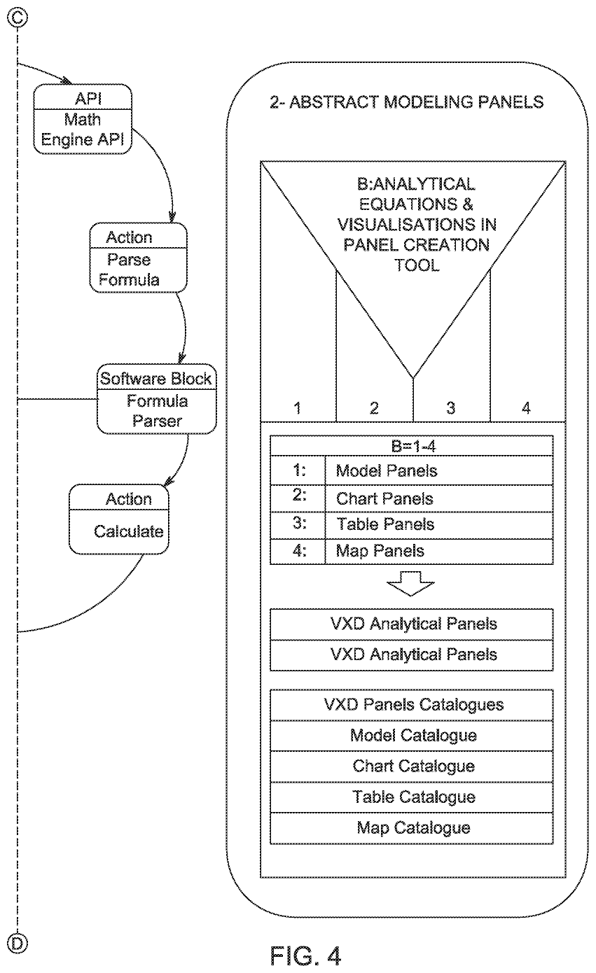

FIG. 4 shows an abstract analytical panel creation interface module. This allows the creation of analytical equations of all types, whether used in models, maps, tables and/or charts, to occur through abstract panels that are cloud based tools and can be deployed at any time, on any case, scenario or data sheet. The module includes one or more abstract analytical panel creation interfaces, allowing for the creation of analytical equations and visualisations in a panel creation tool. Preferably, the user interface includes an equation editor to allow for equation formation, which will be described in more detail below.

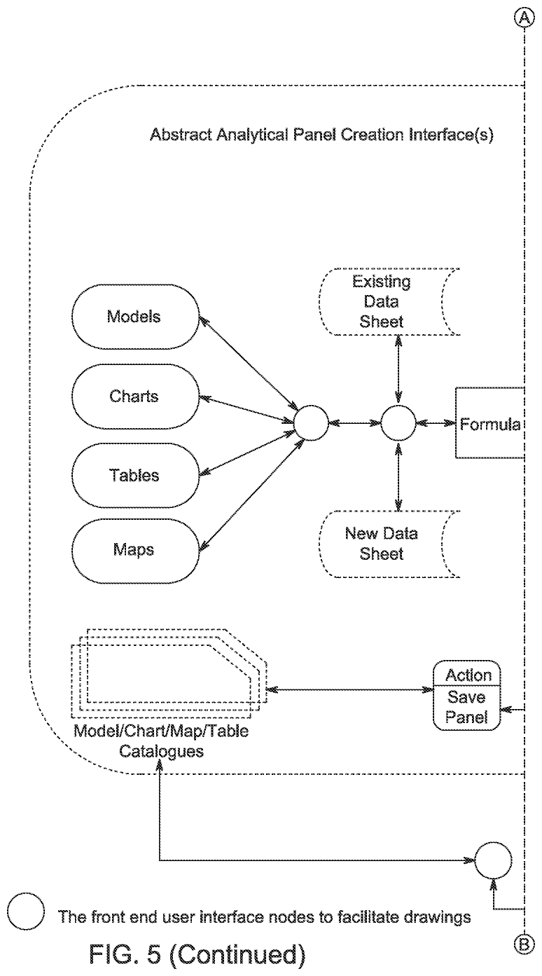

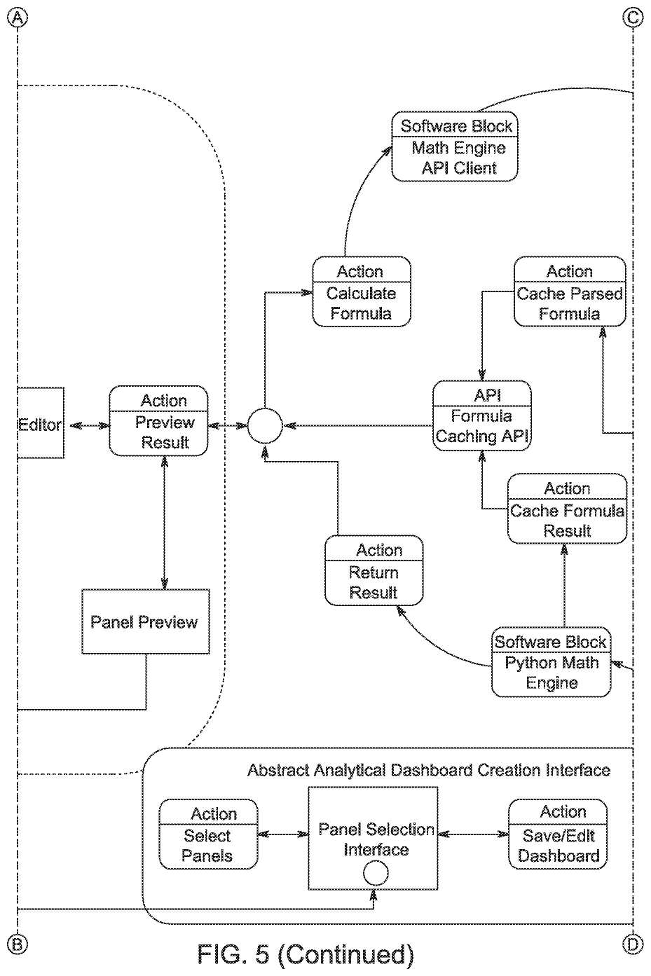

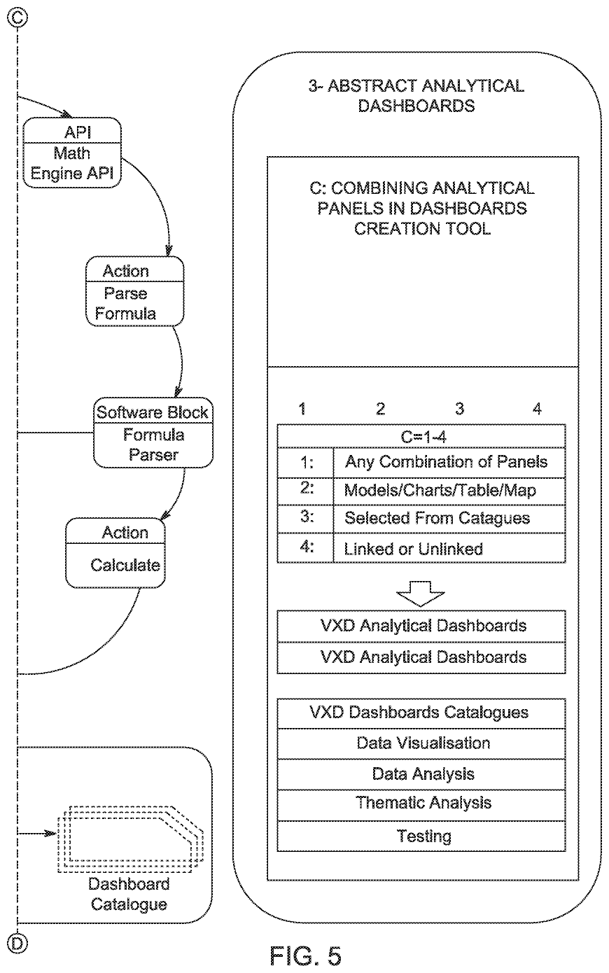

FIG. 5 shows an abstract analytical dashboard creation interface module. This allows the creation of analytical dashboards of all types, whether used in models, tables and/or charts, to occur through the aggregation of abstract panels in dashboards. The module includes an abstract analytical dashboard creation interface, allowing for analytical panels to be combined in a dashboard creation tool.

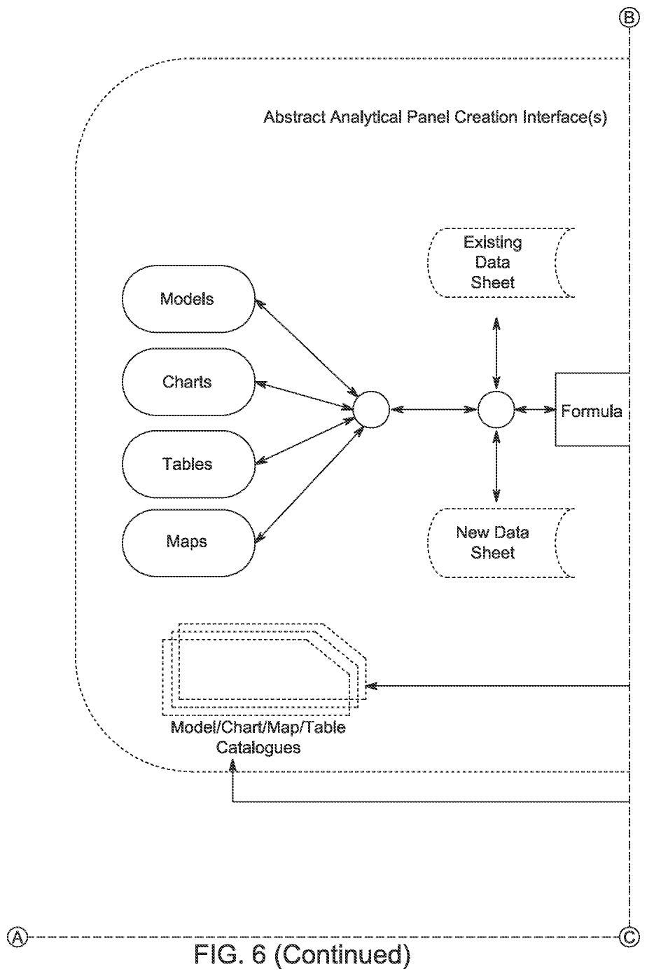

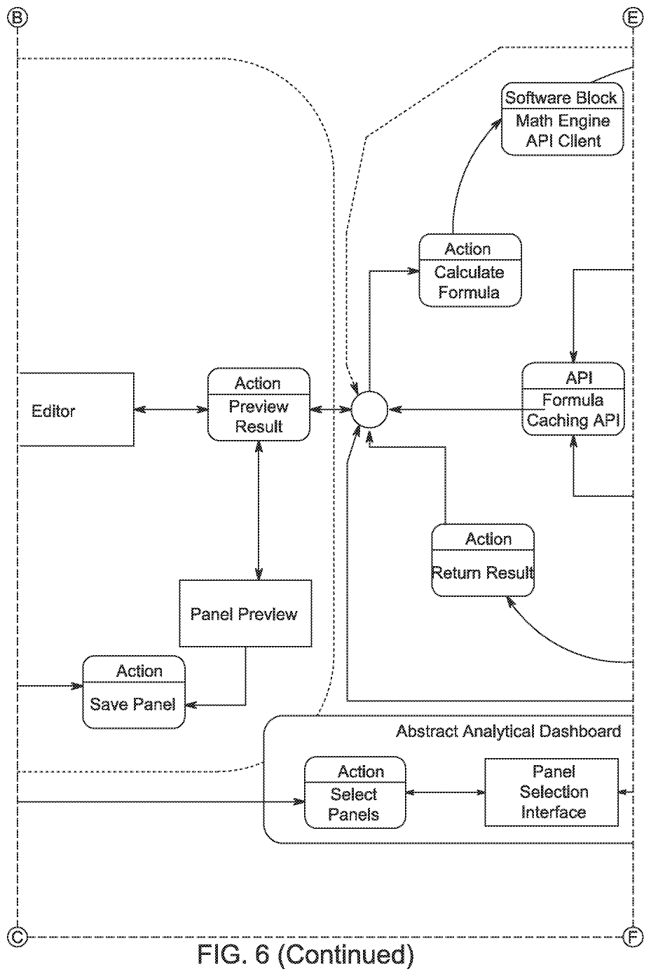

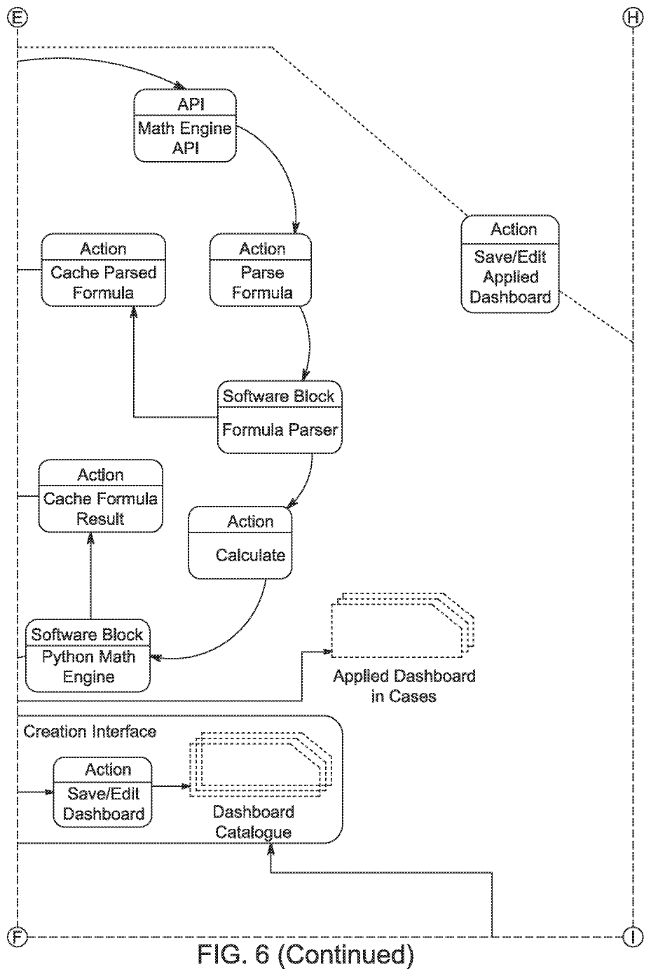

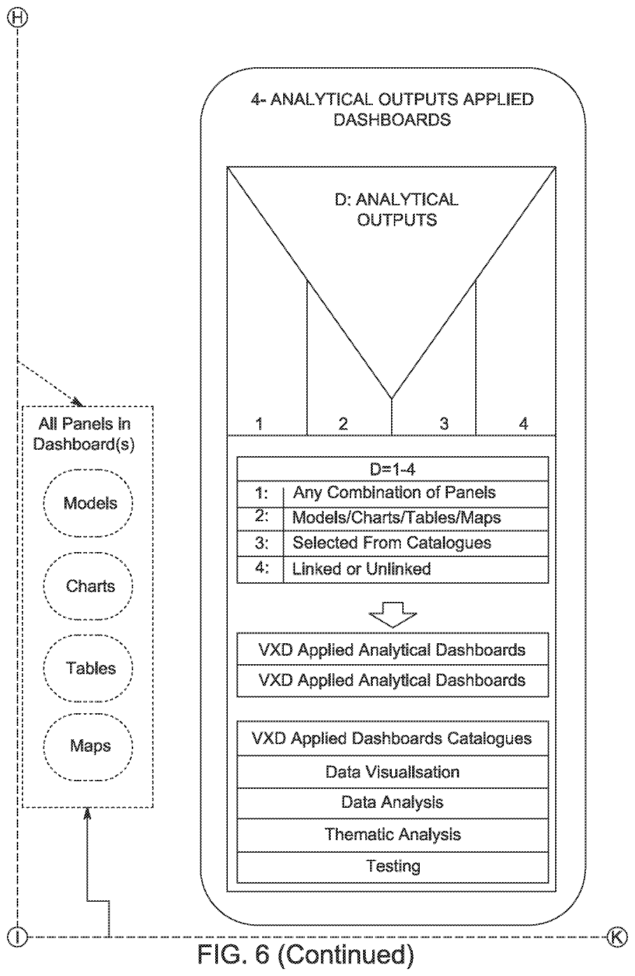

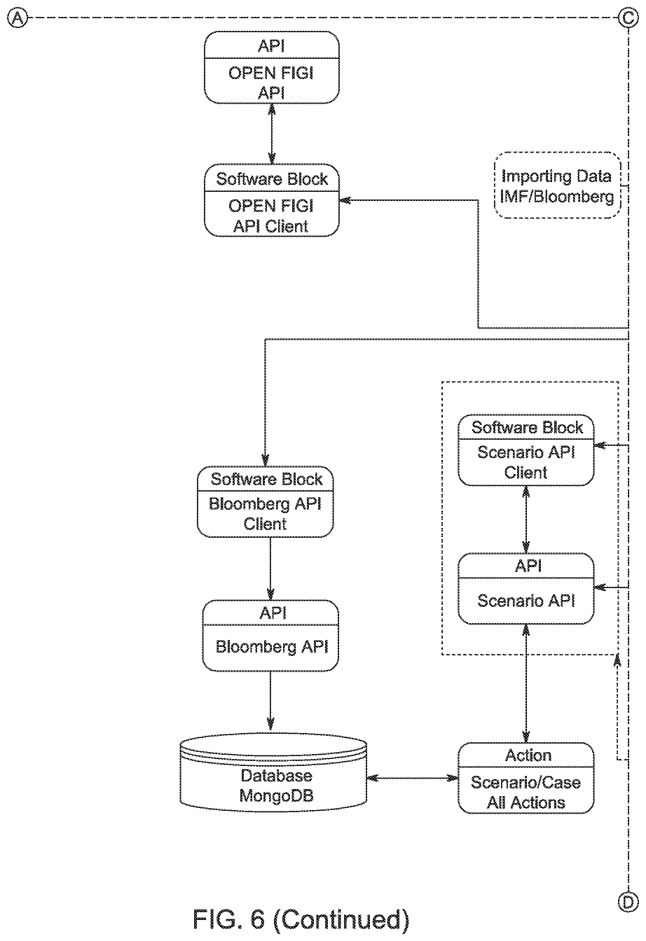

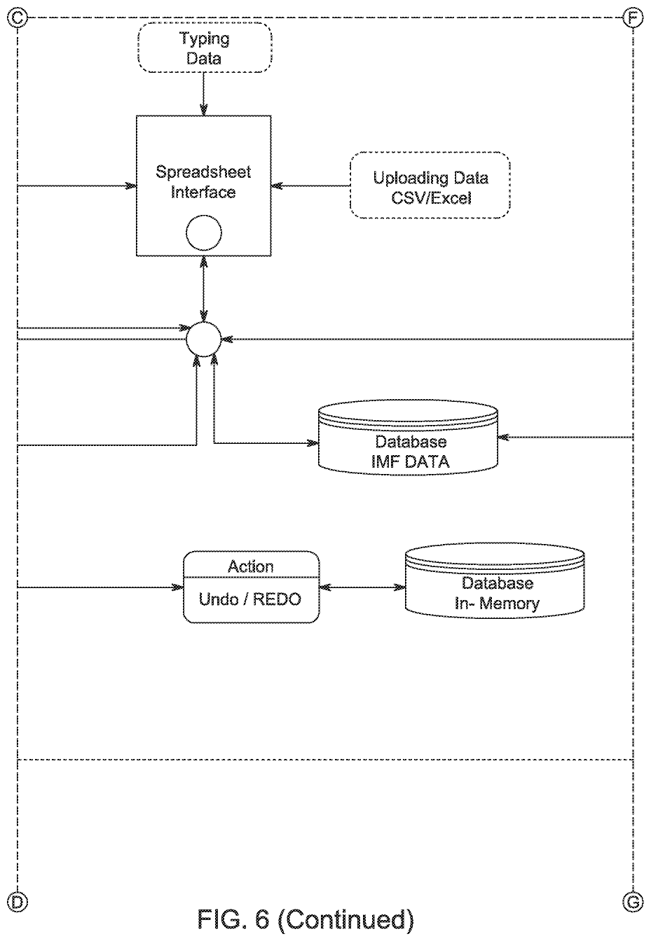

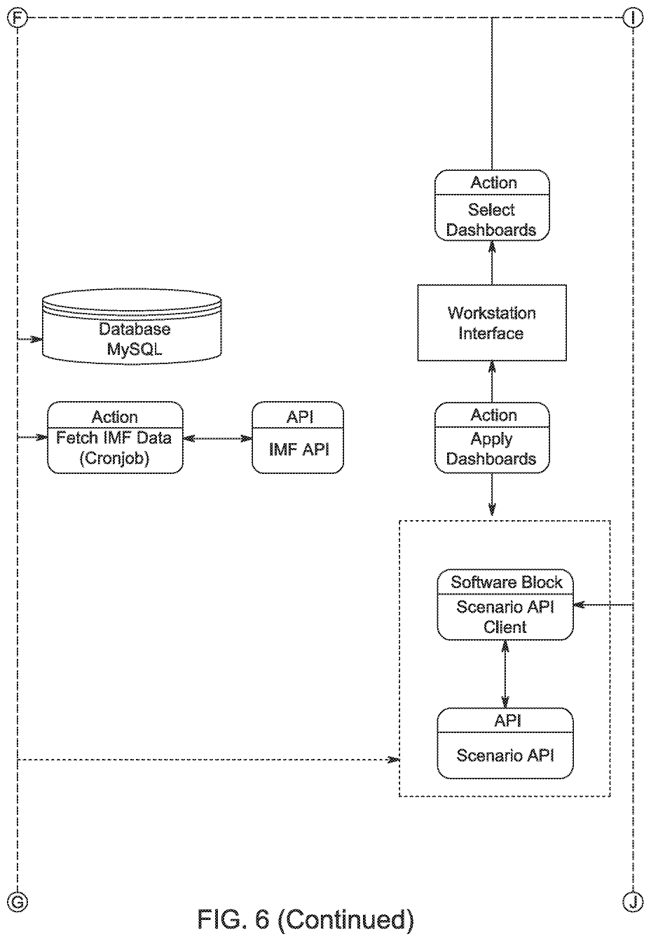

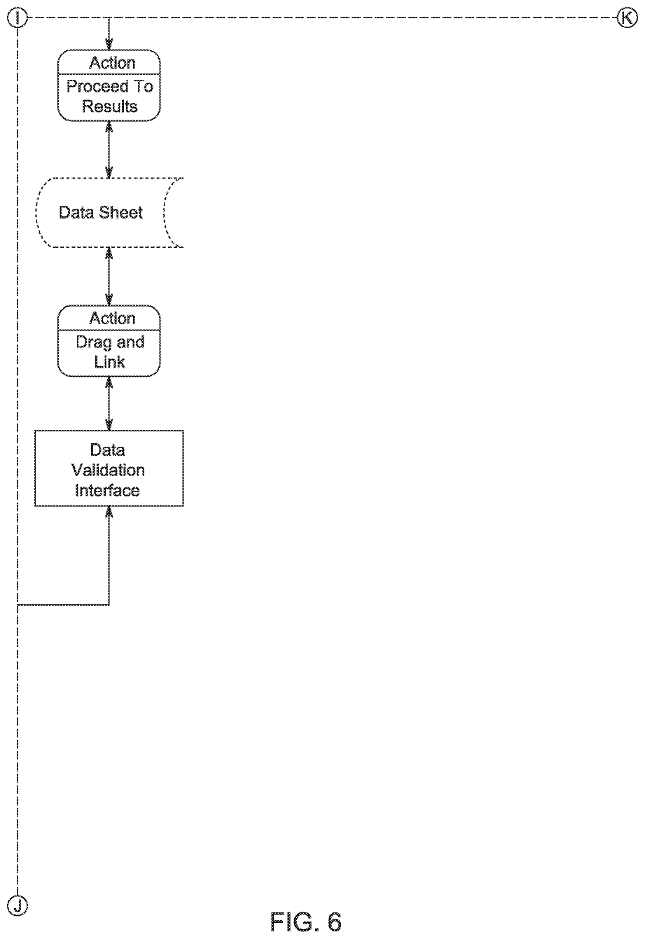

FIG. 6 illustrates the application of abstract analytical dashboards to cases scenarios and/or sheets. The application of abstract analytical dashboards creates applied dashboards using all types of panels, including for example models, maps, tables and/or charts. Applying a dashboard to a case or scenario may start by selecting the abstract Dashboard in a Dashboard Station element of the user interface. This may be done at beginning of the user interaction, when creating a case, or later on during analysis. Applying a dashboard to a case or scenario initiates the Data Validation interface module that allows the user to link the data in sheets, scenarios or cases, to the required parameters in the panels, whether they are models, charts, tables or maps for example.

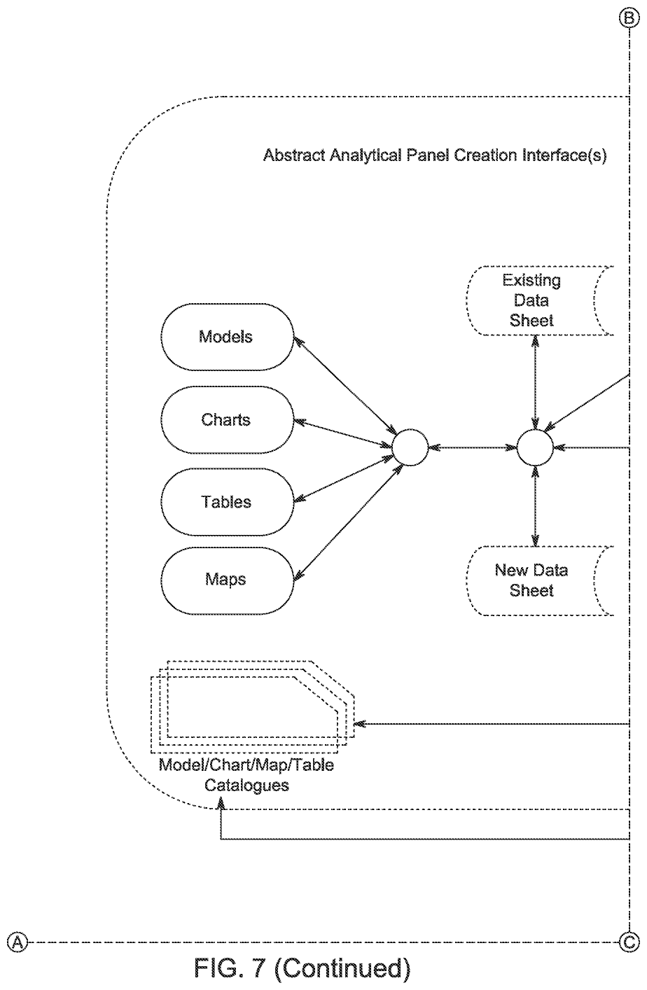

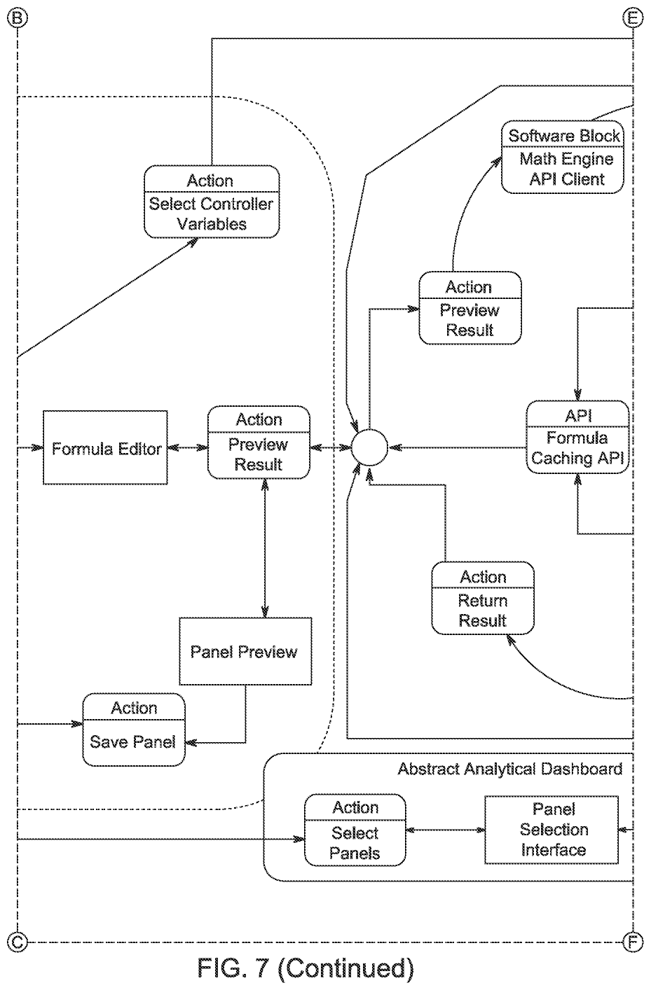

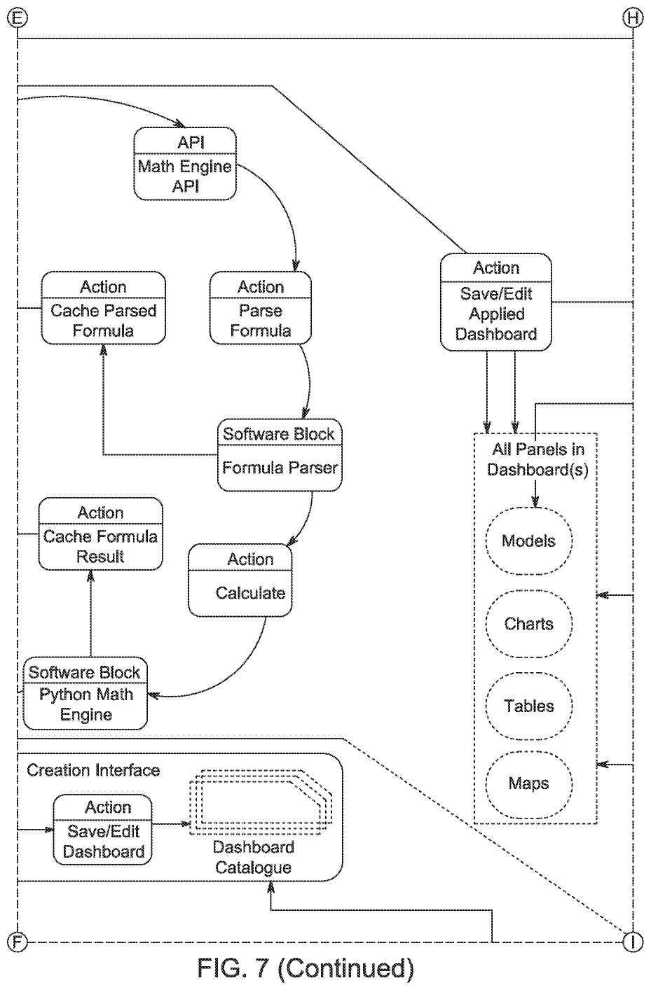

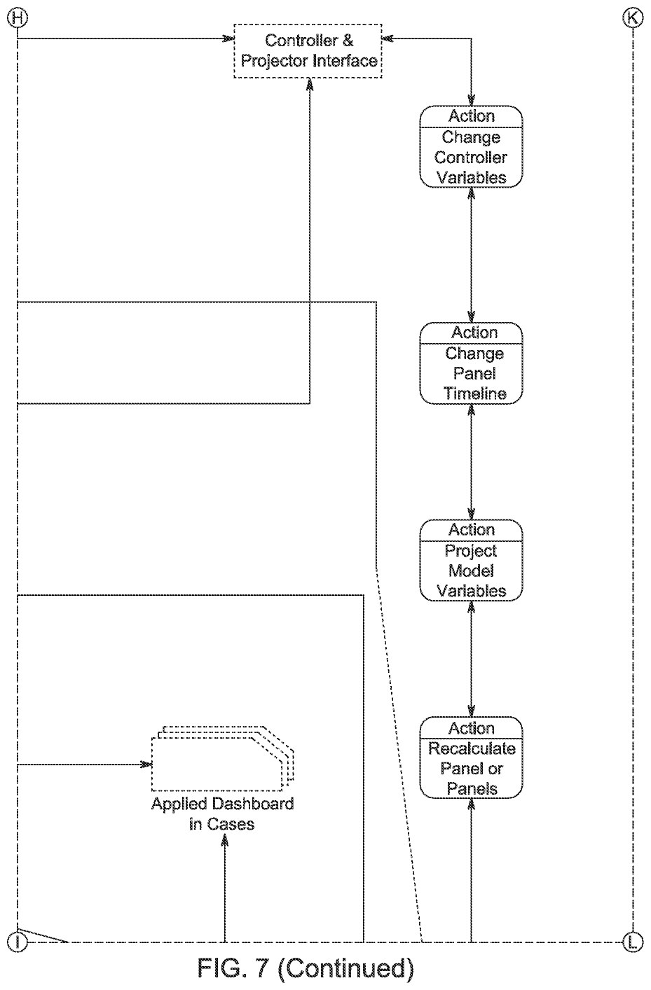

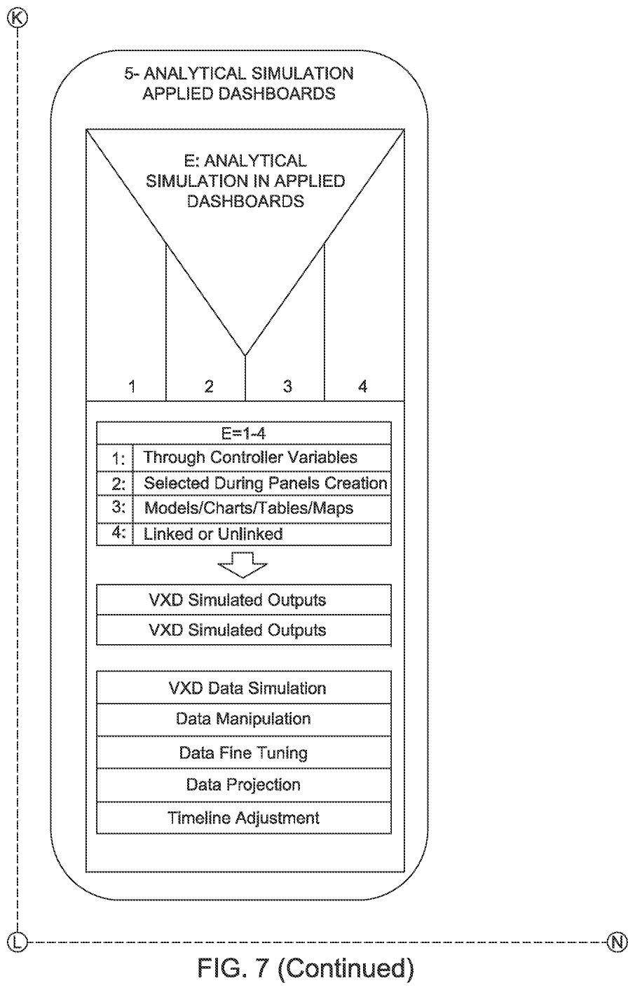

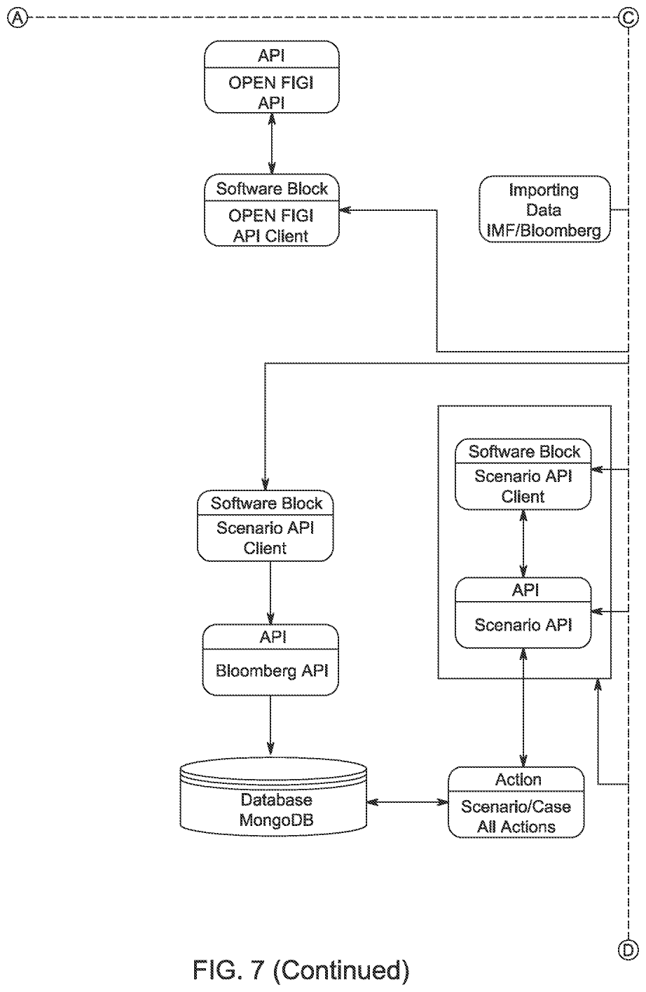

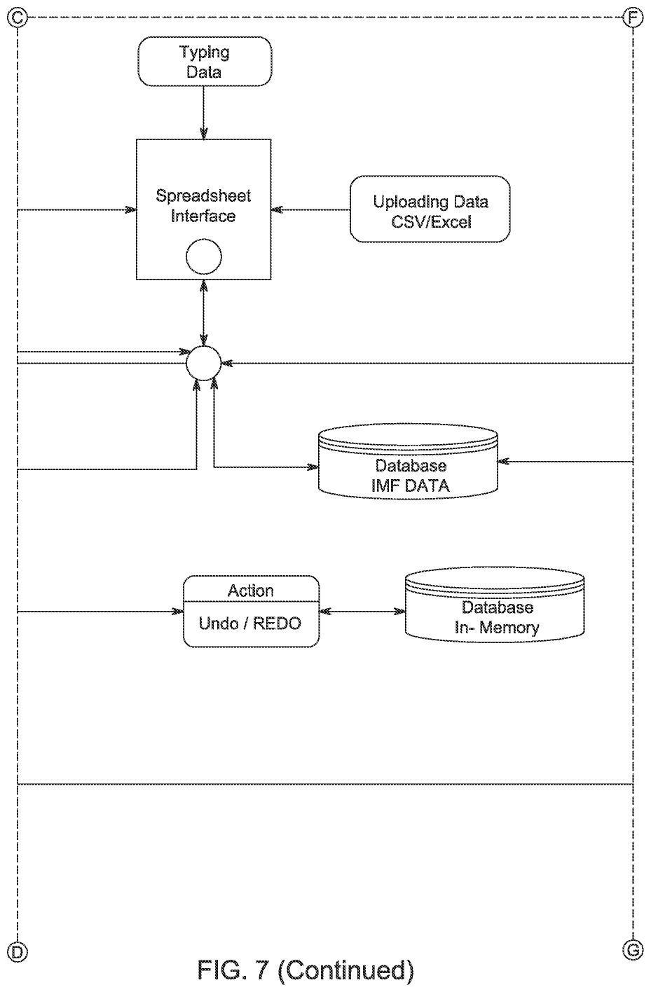

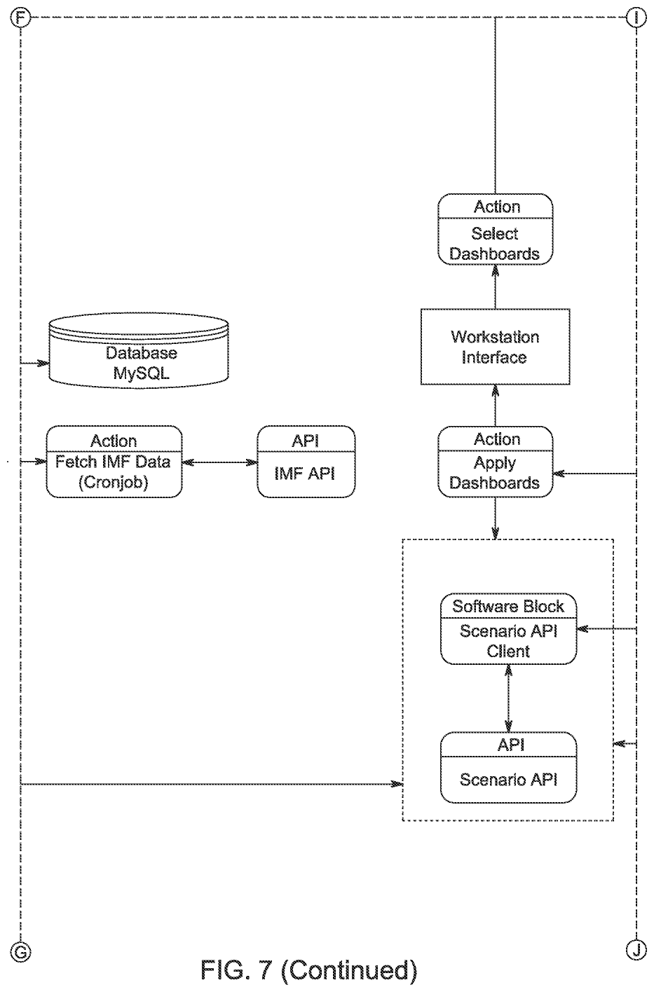

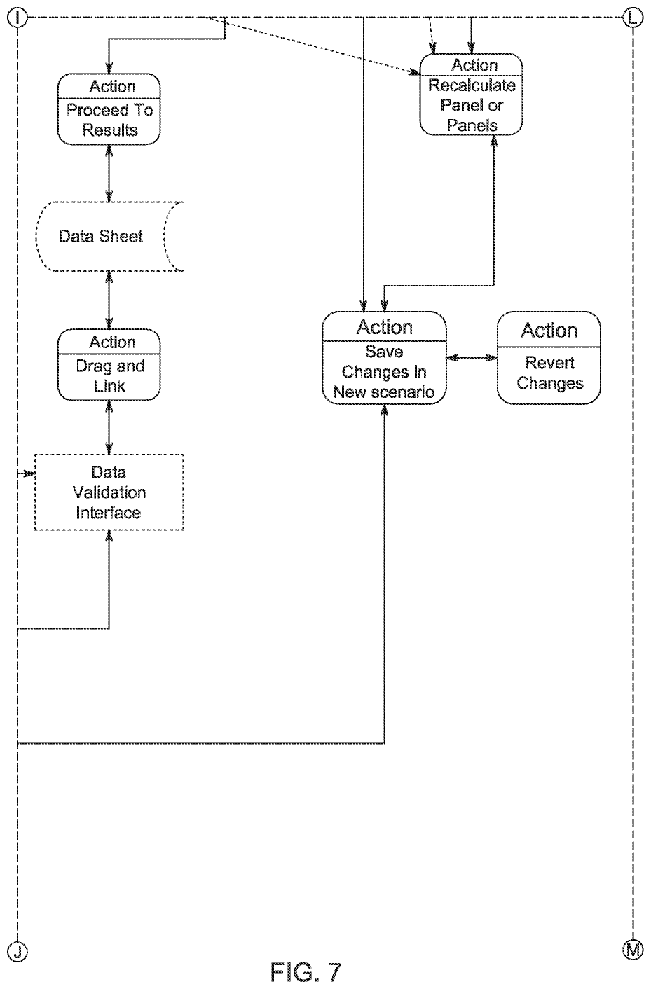

FIG. 7 illustrates using the controller and projector on the applied dashboards. In the Panel Creation tools and interfaces, users select the variables and constants they would like to include in the Controller. Advantageously, the Controller allows users front end access to the variables used in a model, after the model (or chart, table, map) has been created. Once an abstract dashboard has been applied to a case or scenario, and results have been generated in an applied dashboard, users have access to the controller of the panel, allowing them to manipulate or fine tune specific variables and also to project variables into the future. This may be done for example by selecting (e.g. clicking) on a controller icon included preferably in each panel.

The controller preferably includes a projector for projecting data over selected periods of time. A controller and projector interface allows the user to change or fine tune variables, and to project variables into the future, while forecasting specific changes to specific variables, and defining growth rates for others for example. If users are happy with the simulated panels or projected data, they can save them as a new scenario in the same project, along with growth rates and outputs. Advantageously, users may also link multiple panels to each other and allow for a synchronised analysis across panels, assuming that panels have the same timeline and at least one common variable or constant.

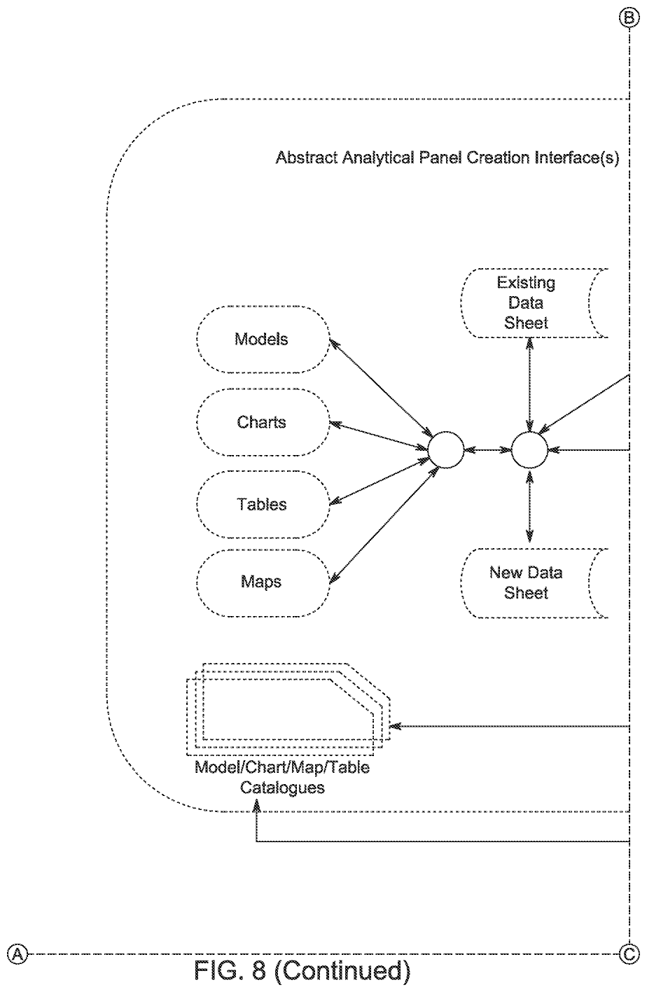

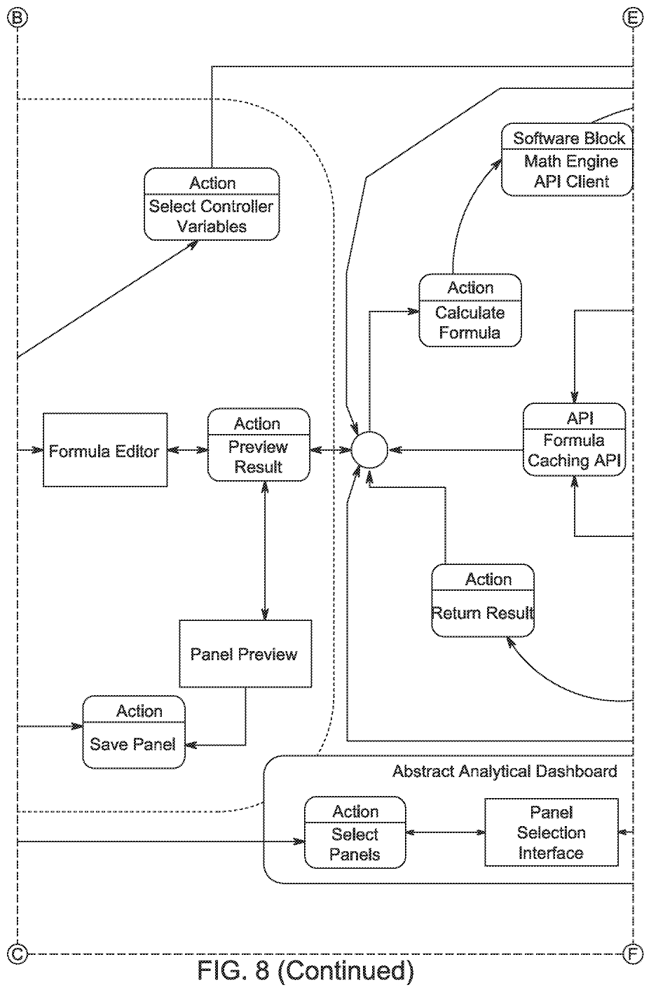

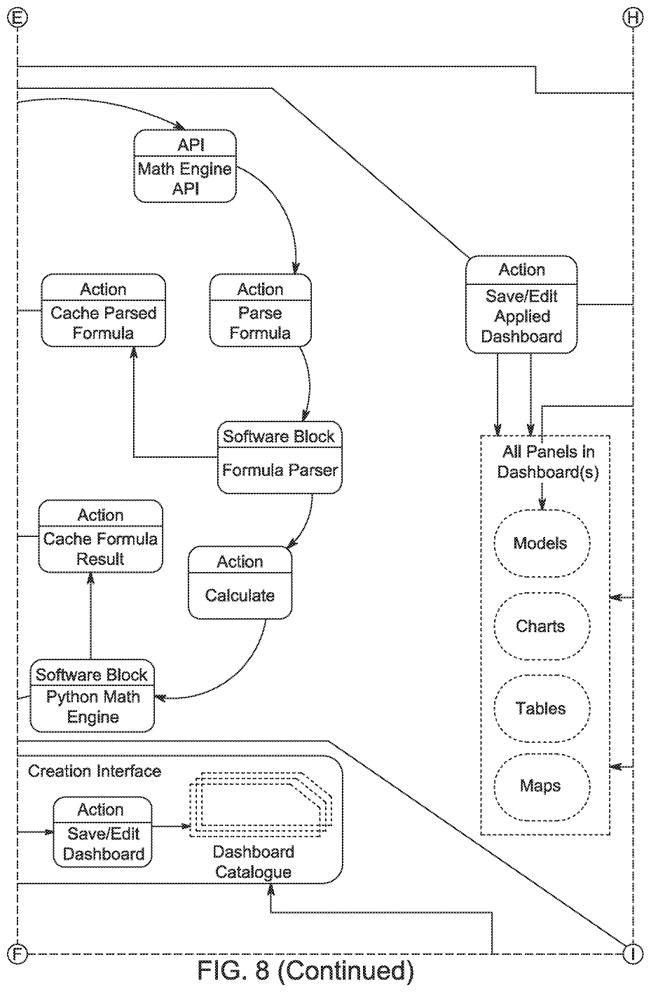

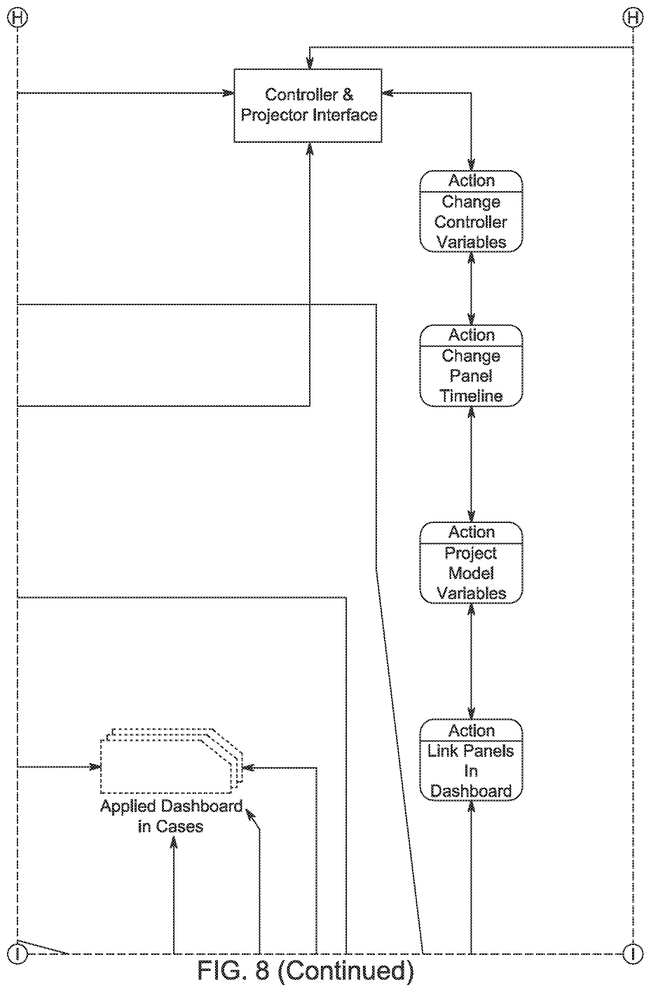

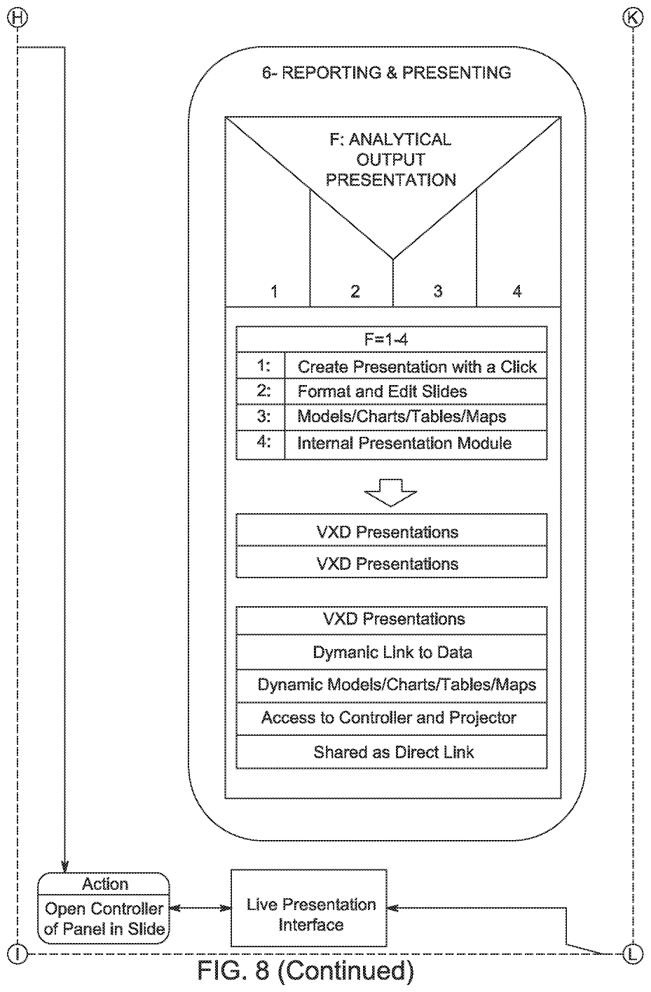

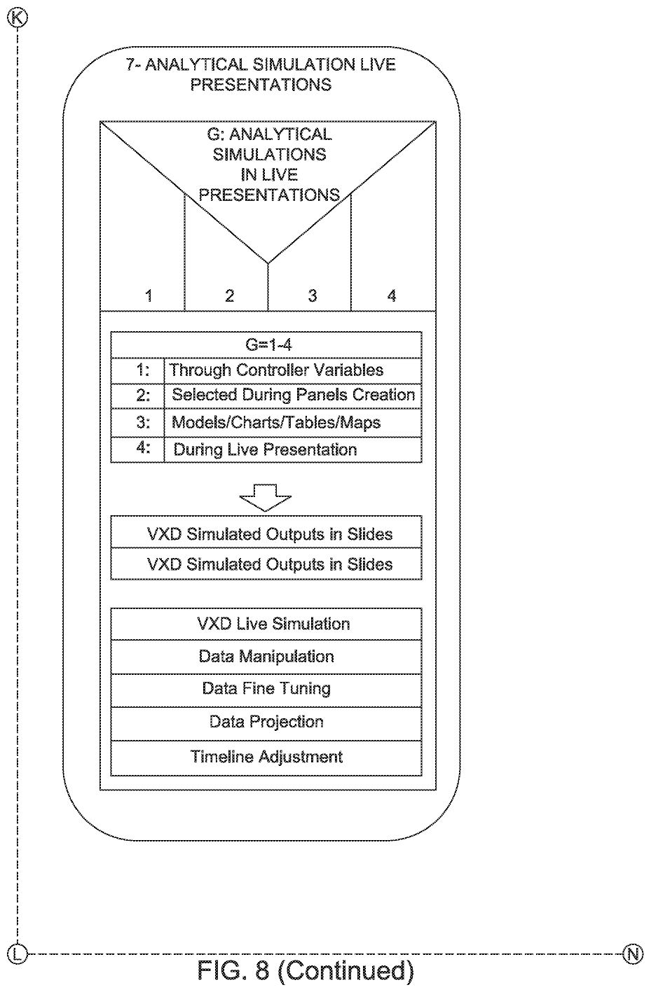

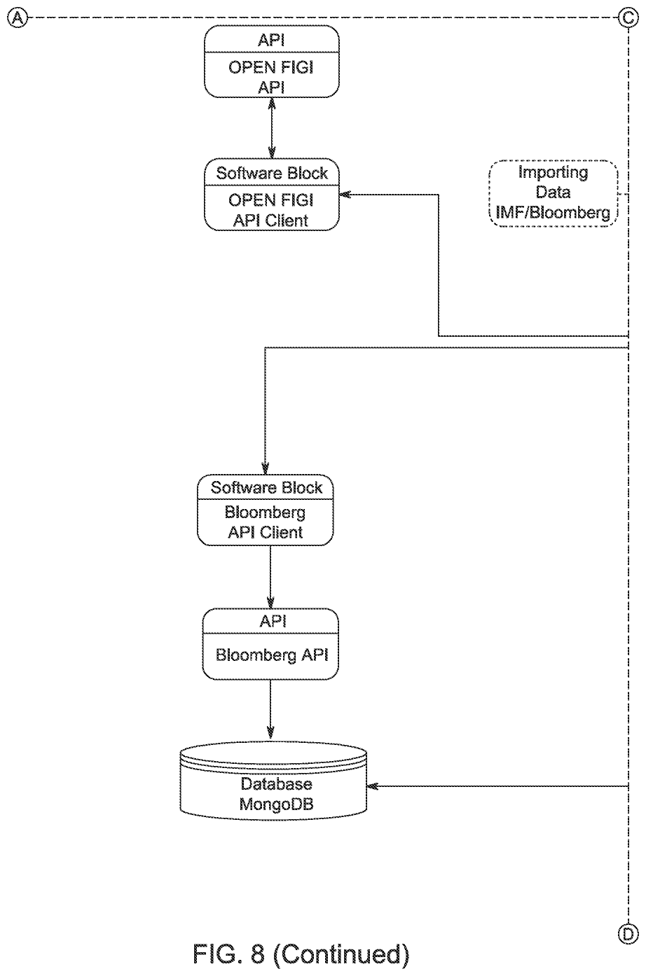

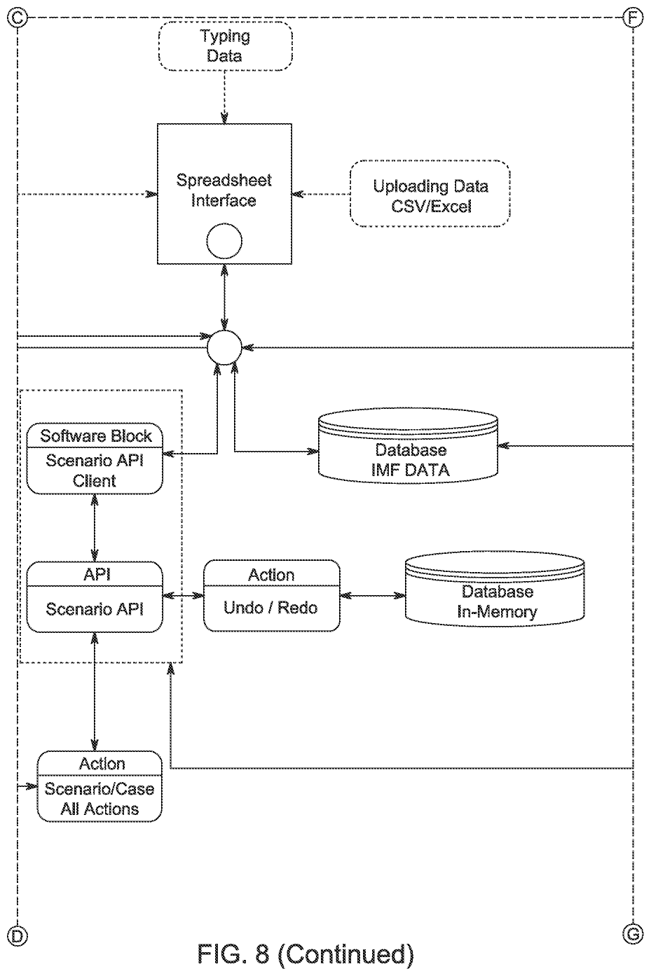

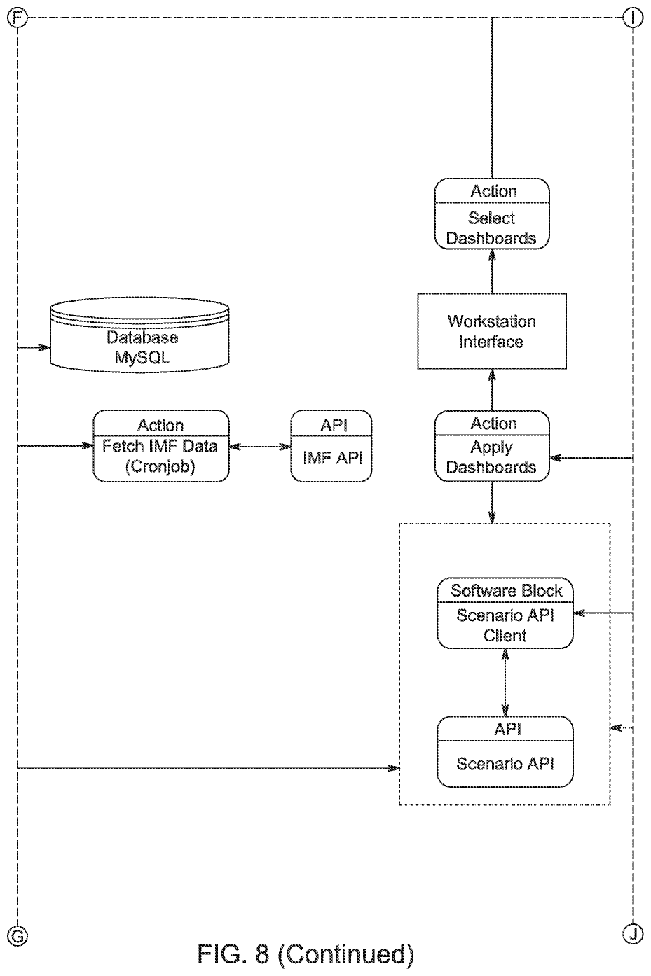

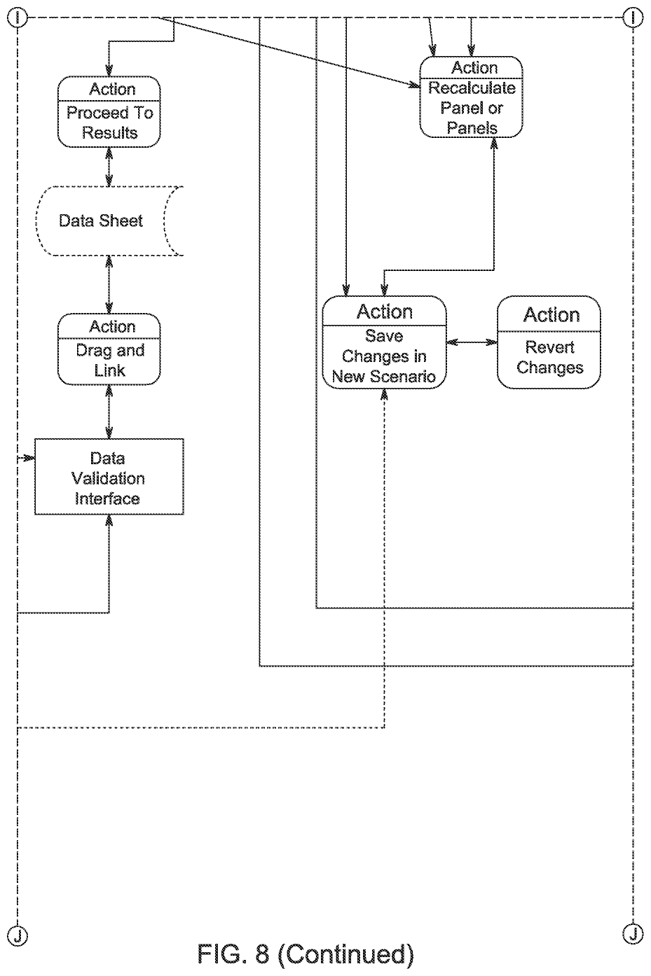

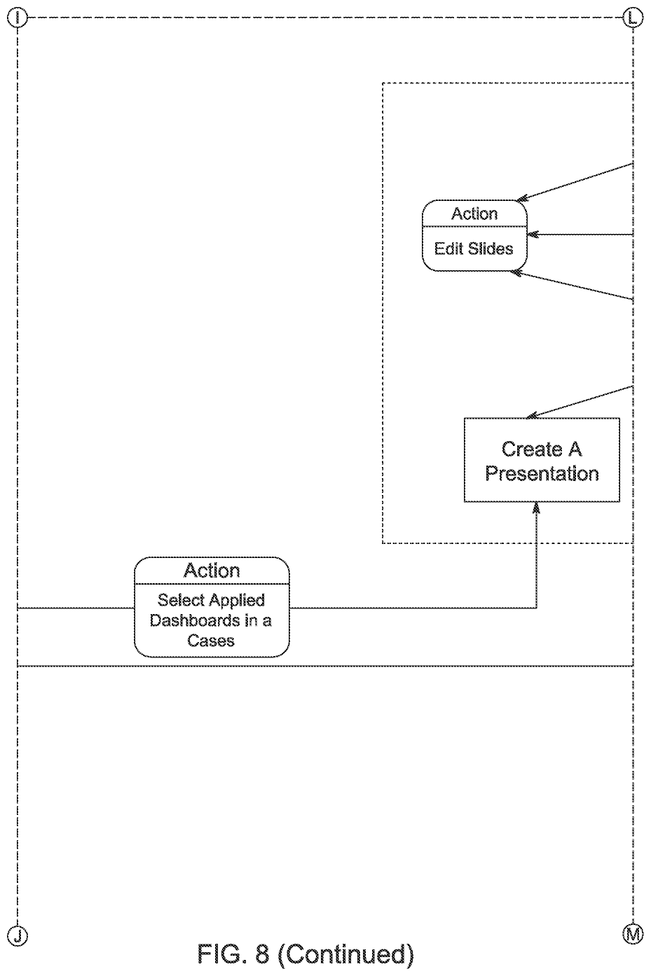

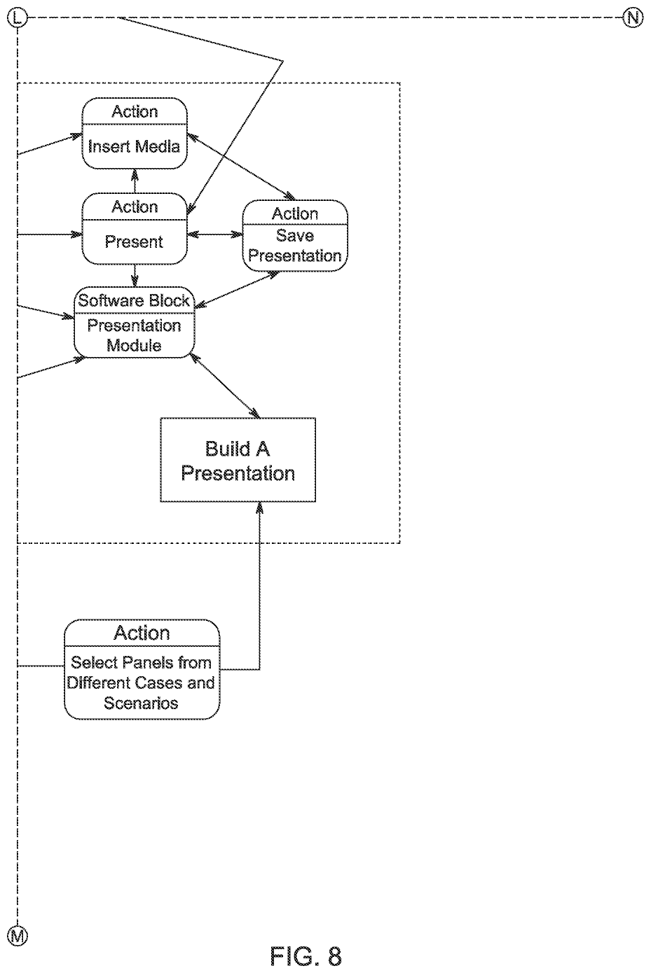

FIG. 8 illustrates creating a dynamic presentation (e.g. with a single click) and simulating data during live presentation. Once an abstract dashboard has been applied to a case or scenario, and results have been generated in an applied dashboard, users can create a presentation using the outputs created for a specific case or scenario. For example a user may select by clicking on a Create Presentation button in the user interface, which takes the user to an internal presentation module with panels already placed in presentation slides. Advantageously, all panels remain dynamic and actively linked to data. The panels may be edited and adjusted in size for example, while the content of the panel is adjusted to these changes automatically.

Panels may be also placed in a presentation through different cases and different scenarios. In an example, a ‘Build a presentation’ button in the user interface allows users to select panels from different cases and scenarios with ease, so that the presentation is not just reliant on one case or scenario.

For example, once the user clicks on the ‘Present’ button, the presentation module is closed and a live (i.e. in real time) presentation interface is launched. During live presentations users have access to the controller and projector of the panel that is in the presentation slide. Advantageously, live presentations therefore enable live manipulation of data for example in front of an audience being presented to. This is facilitated by a direct link to the data, and a dynamic link between the slides, the panels within the slides, their controller and the underlying data.

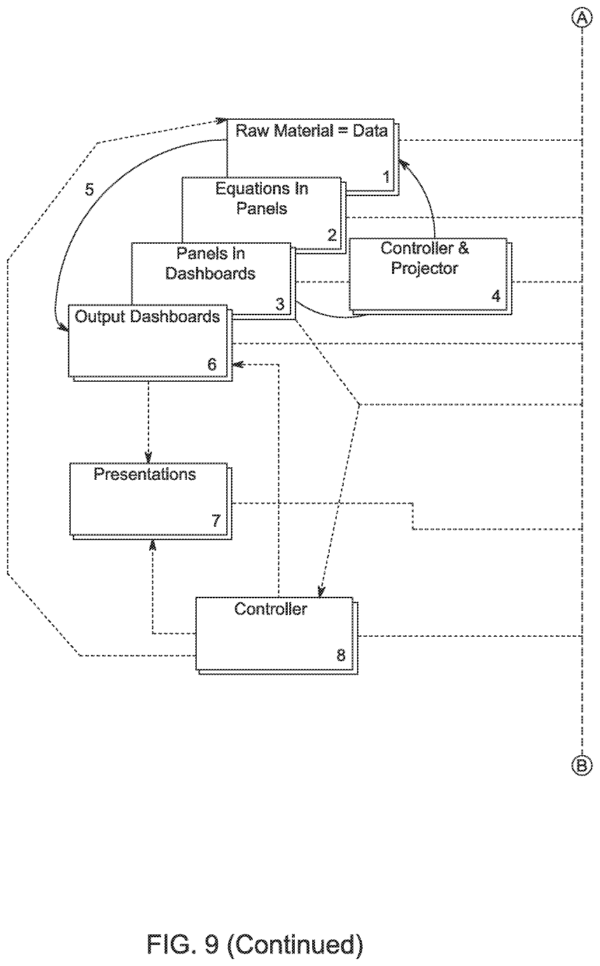

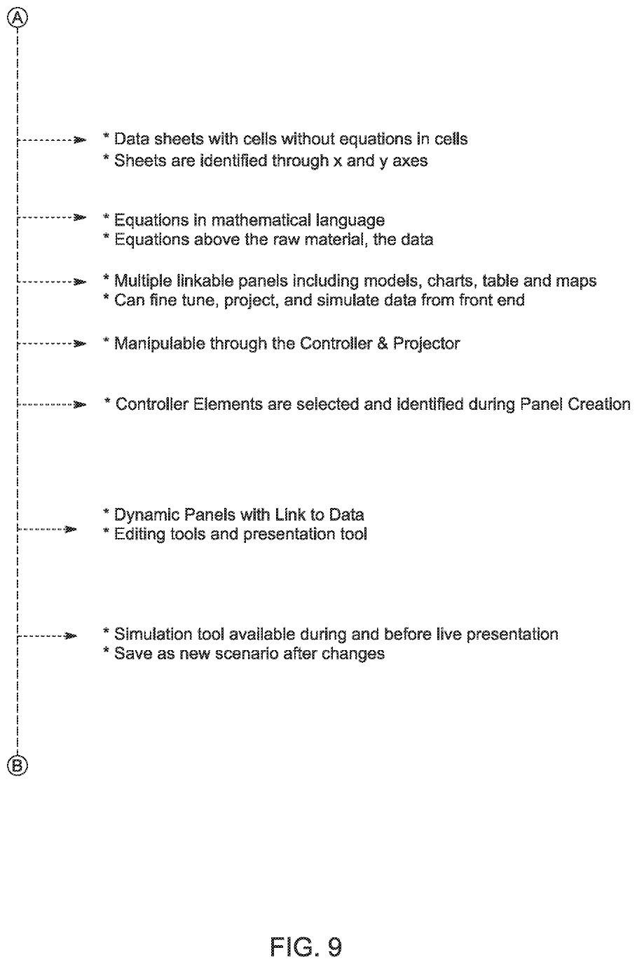

FIG. 9 is another block diagram summarising functional elements of the invention. Data may be uploaded, imported from external databases or input by users. Data may be analysed by creating models, charts, tables or maps, and combined in dashboards. Data may be simulated in new scenarios using the controller and projector. The analysed data may be presented in presentations, reports and live simulations. The analysed data may be shared in the form or presentations or reports, models, tables, charts or maps. A user has the option to download add-on modules or dashboards, presentation or reports, models, tables, charts or maps.

Interaction with the User Interface

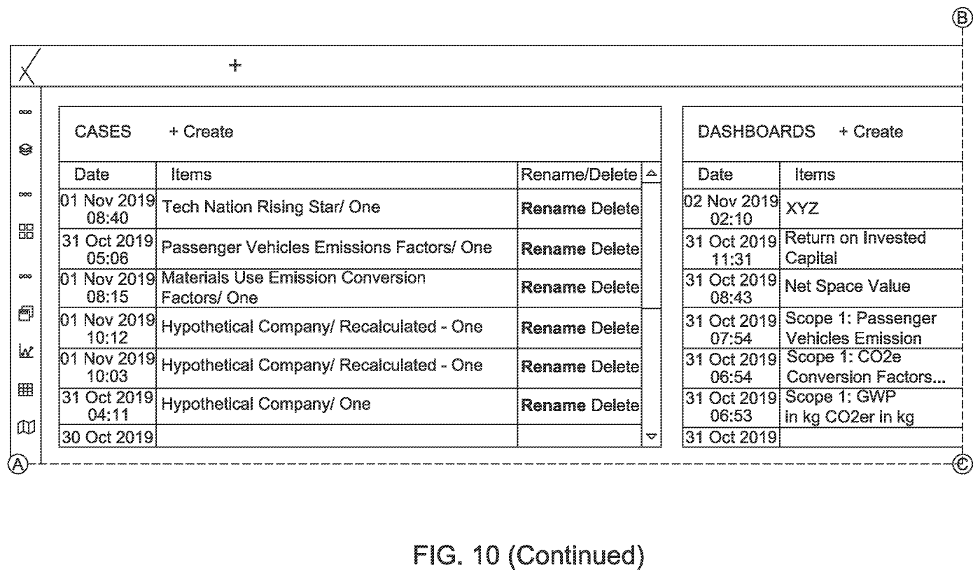

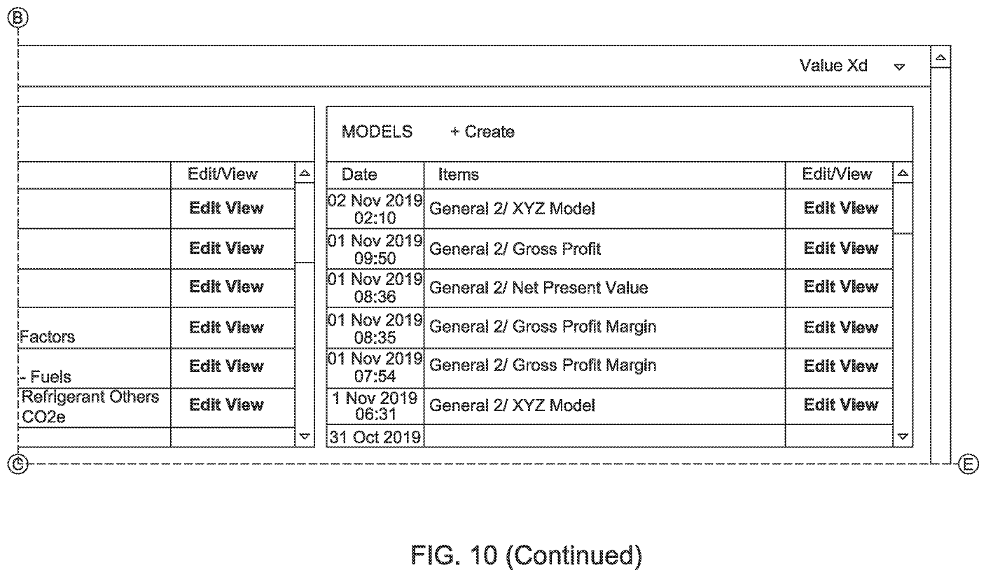

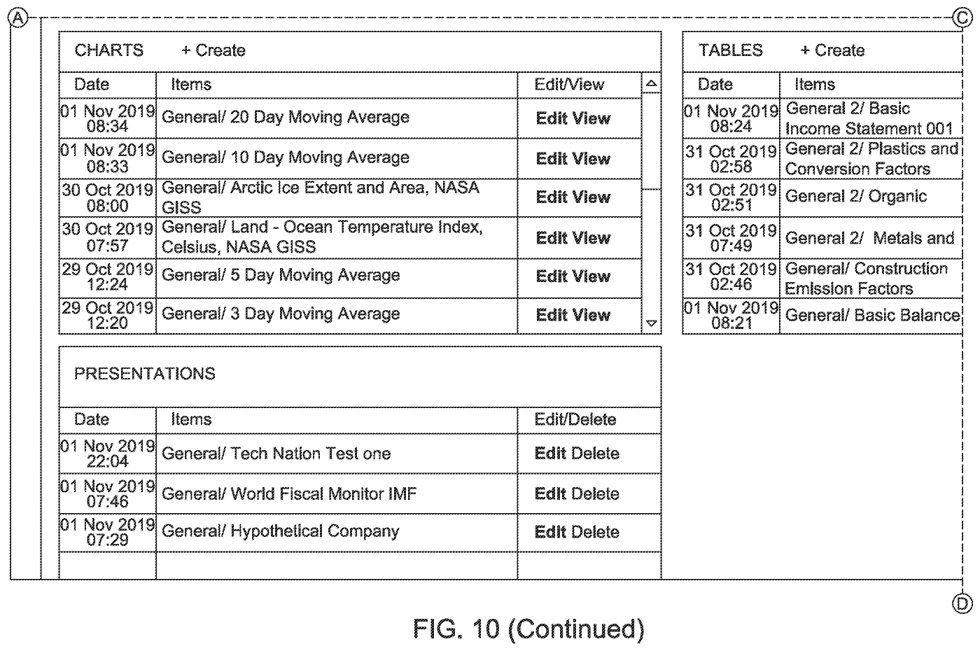

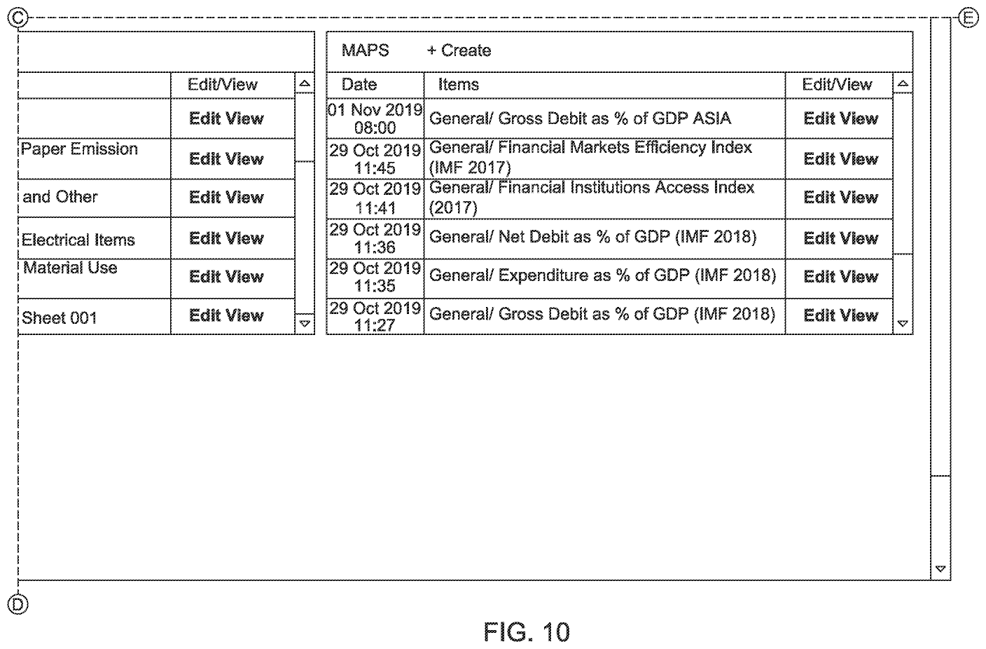

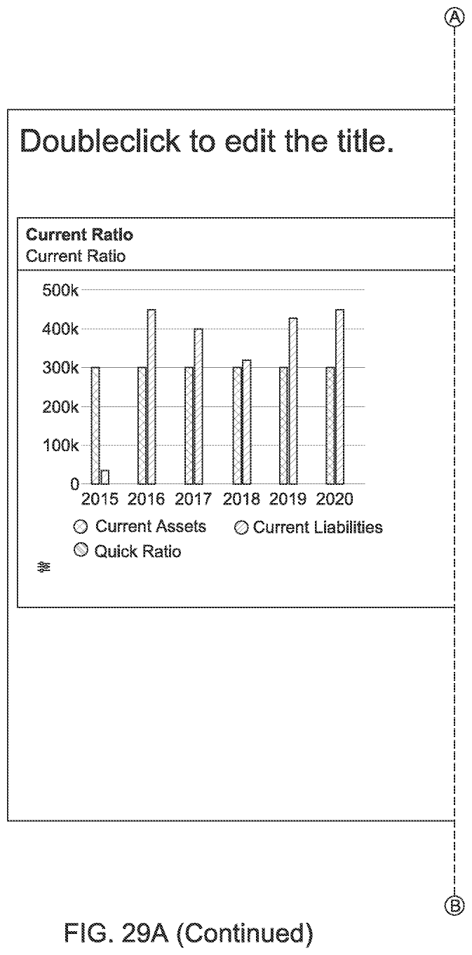

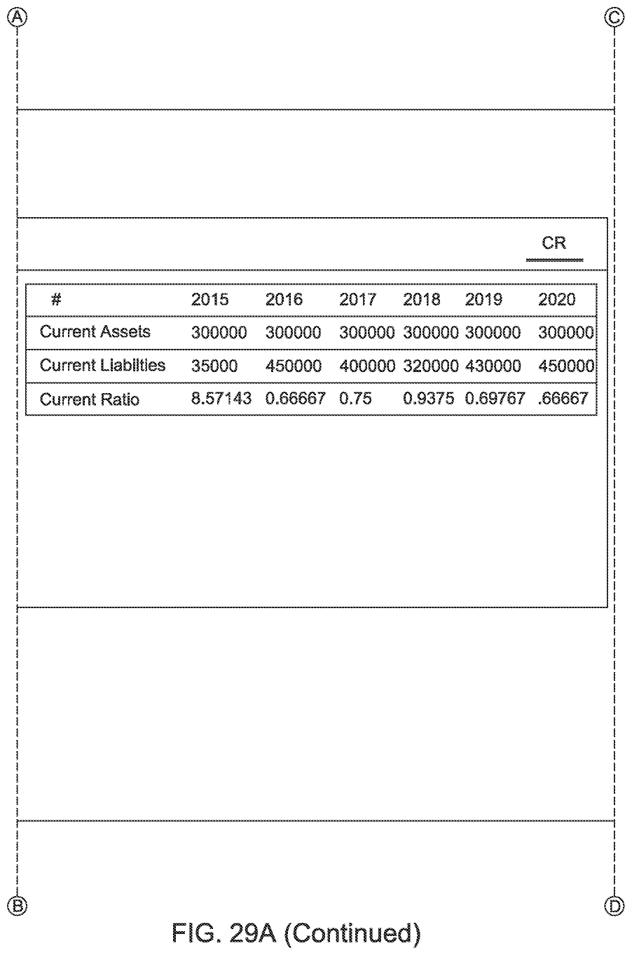

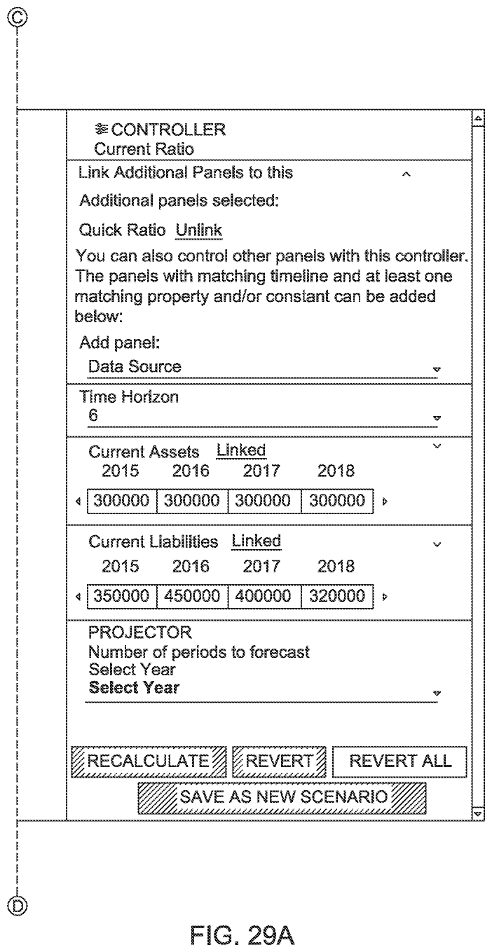

The functionality of the various functional elements of the platform will now be further described in the context of user interaction with the system, with reference to FIGS. 10 to 36.

In an example, after a user logs into the system, the user is directed to a user interface including the user's Home/Main screen that contains the analytical environment created and populated by the user over time. The user interface provides an overview and access to the users analytical cases and tools. With reference to FIG. 10, in the present example there are 9 main folders:

1) Cases (projects)—This folder contains all the analytical cases created by the user.
2) Dashboards—This folder contains all the Dashboards created by the user.
3) Models—This folder contains all the Models created by the user.
4) Charts This folder contains all the Charts created by the user.
5) Tables—This folder contains all the Tables created by the user.
6) Maps—This folder contains all the Maps created by the user.
7) Presentations—This folder contains all the Presentations created by the user.
8) Reports—This folder contains all the Presentations created by the user.
9) Add-Ons—This folder contains any add-ons created by the user.

### Cases

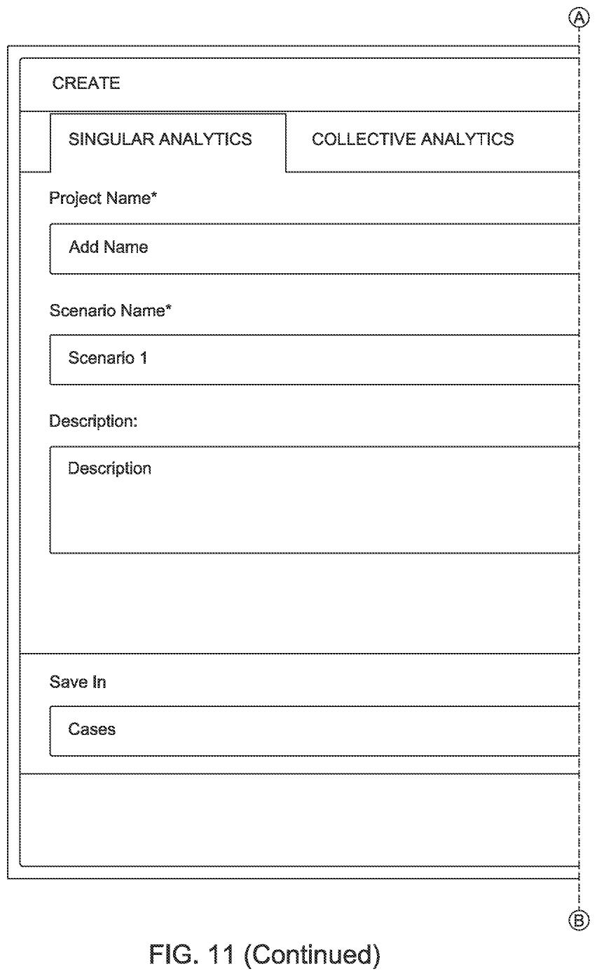

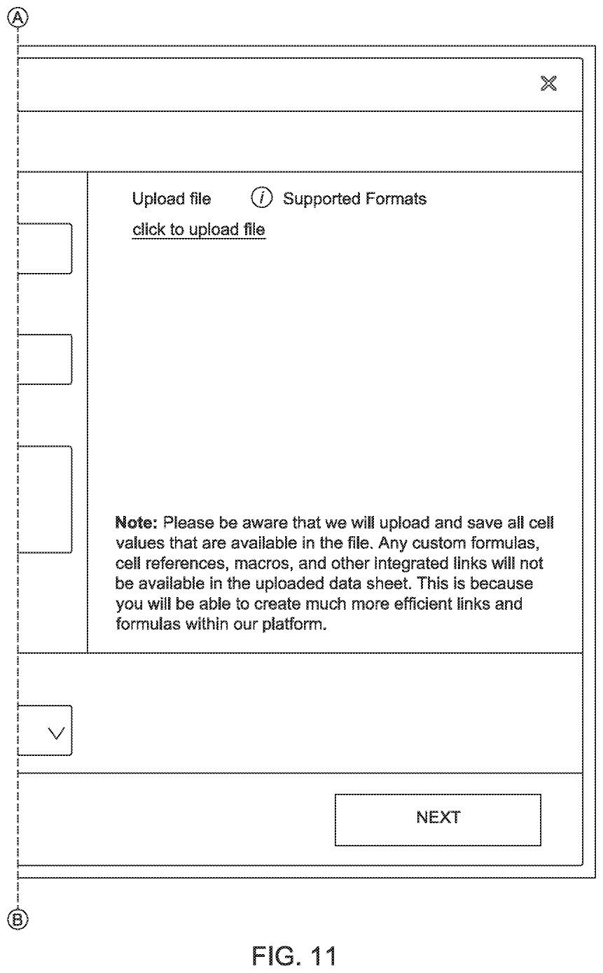

When a new case/project is being created, the user may input all necessary details about the case, and upload all relevant data files (FIG. 11). Data files may be in any suitable format including xls, xlsx, or csv file formats for example. It is possible to create two types of analytical cases including singular and collective cases. Collective analytics advantageously allow users to analyse and treat singular cases as a group.

For example, the user may input details for a singular case including: project name scenario name, project description, location for saving the project. The user may also upload data files for the project including one or more spreadsheets for example. This upload may simply be a transfer of data from one database to another location. It may also include a link to the data source.

After filling in the necessary information, the user may optionally define a workstation for the case/project, by selecting the relevant analytical dashboards that will be available for the created cases. Advantageously, the user is not required to save the created case as files anymore, as the analytical tools are available to the user as universal models that can be applied to any project. In the preferred embodiments, the analytical tools are stored in cloud storage ready to be applied to any new data sheet that matches the data requirements and axes of the models in the dashboards.

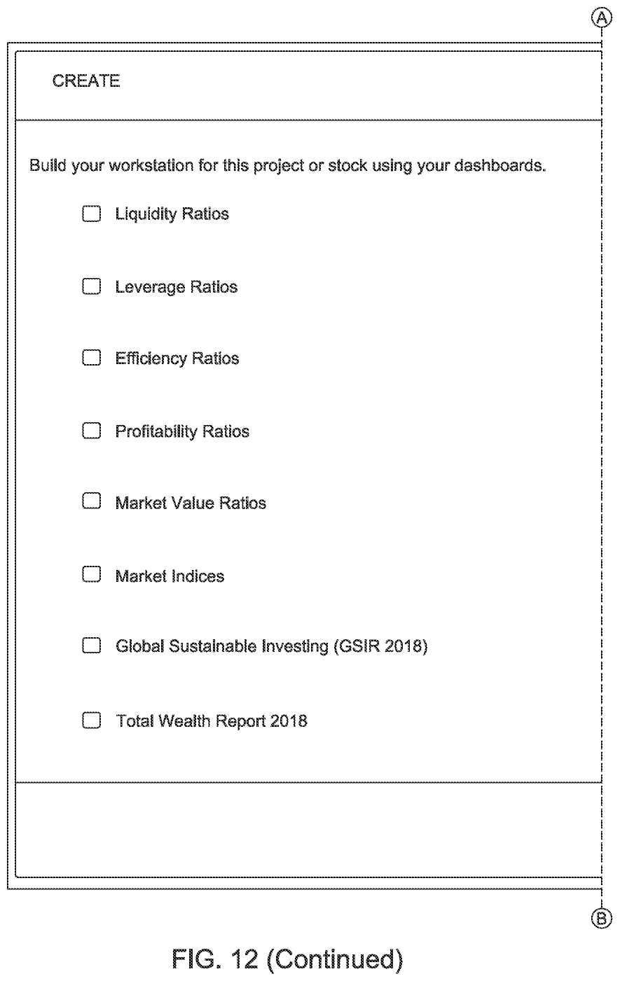

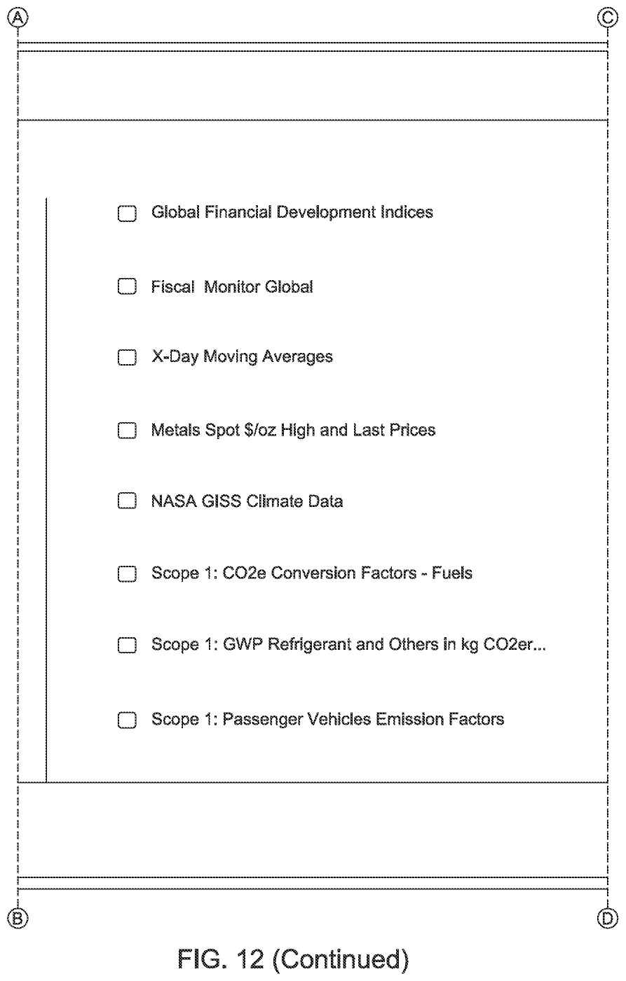

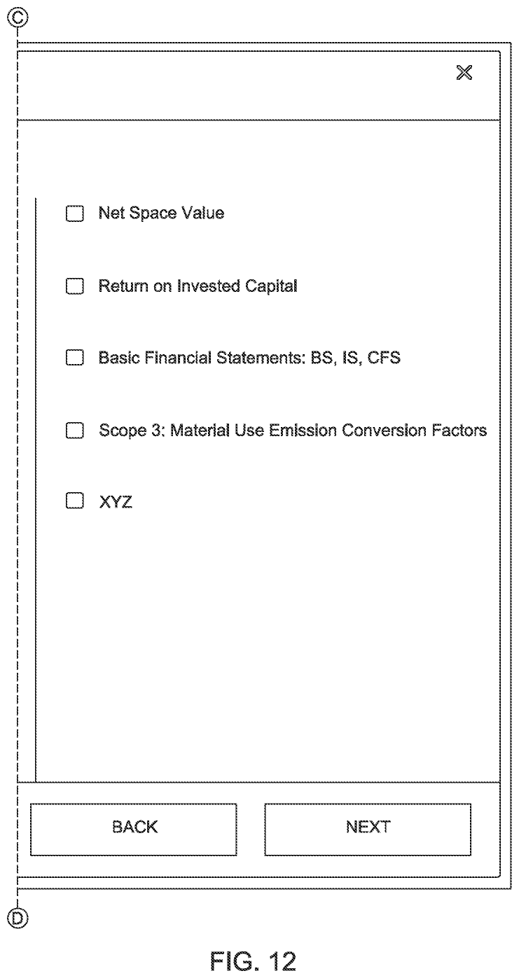

With reference to FIG. 12, a workstation building window allows users to select one or many dashboards to be applied or used in the new project/case.

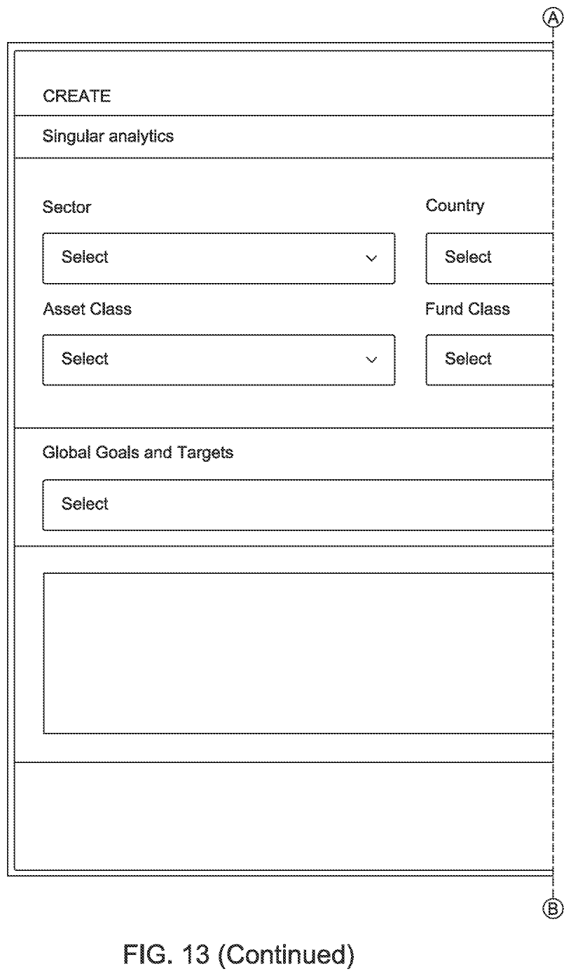

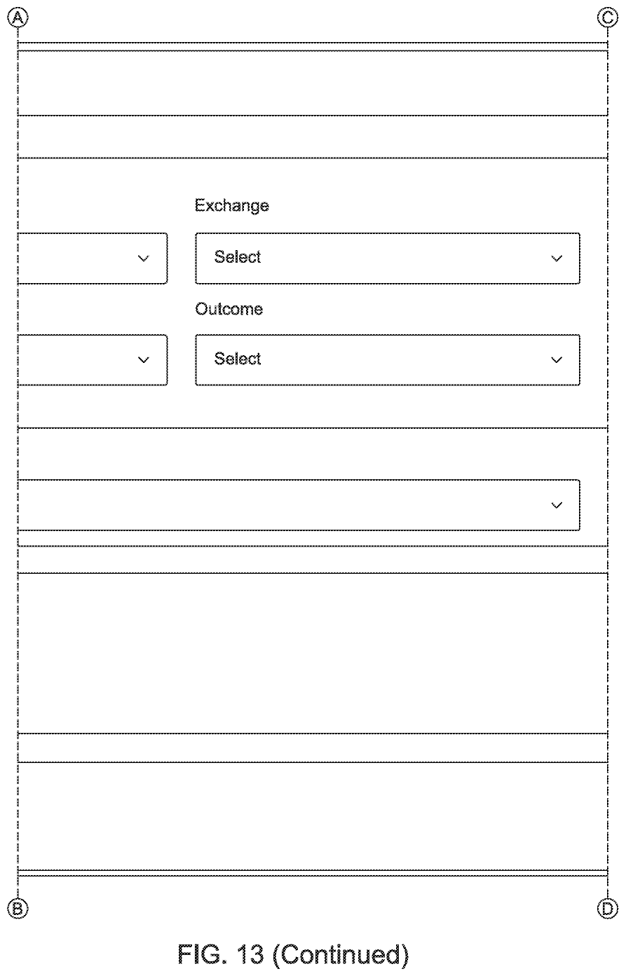

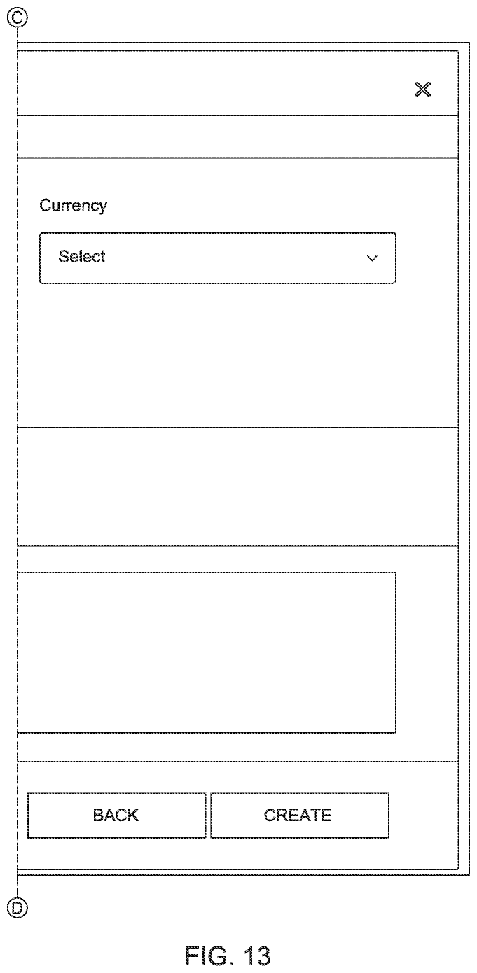

Advantageously, the content of the workstation can be changed and expanded at any time once the case has been created. Users may then be given the option to provide additional descriptive data about the new case they are creating—whilst optional, this can allow the user to smart scan their cases at a later stage, FIG. 13.

In this example, users can select a number of parameters preferably from drop-down menus in the user interface. For example, the user selects the sectoral focus of their project or case, such as “aerospace and defence”, “alternative energy”, “automobiles and parts”, “banks”, “beverages”, “chemicals” etc. Next, users can identify the country relevant to the case and select the relevant exchange from a list of equity, derivatives and commodities markets; currency relevant to the new case, relevant asset class of the case (e.g. when the case is an investment fund), fund class, and relevant target outcome.

Advantageously, the user can select one or more of the 17 UN Global Goals and 169 Targets as shown for example in FIG. 13. When a goal is selected, it will appear automatically underneath the select tab.

Users can click the X to remove a goal at any time. After selecting the relevant descriptive parameters and Global Goals, the user can click on the Create tab to create the new case. Alternatively, the user can skip the selection and click on Create tab to create the new case.

### Spreadsheet Editor and Case Scenario Data

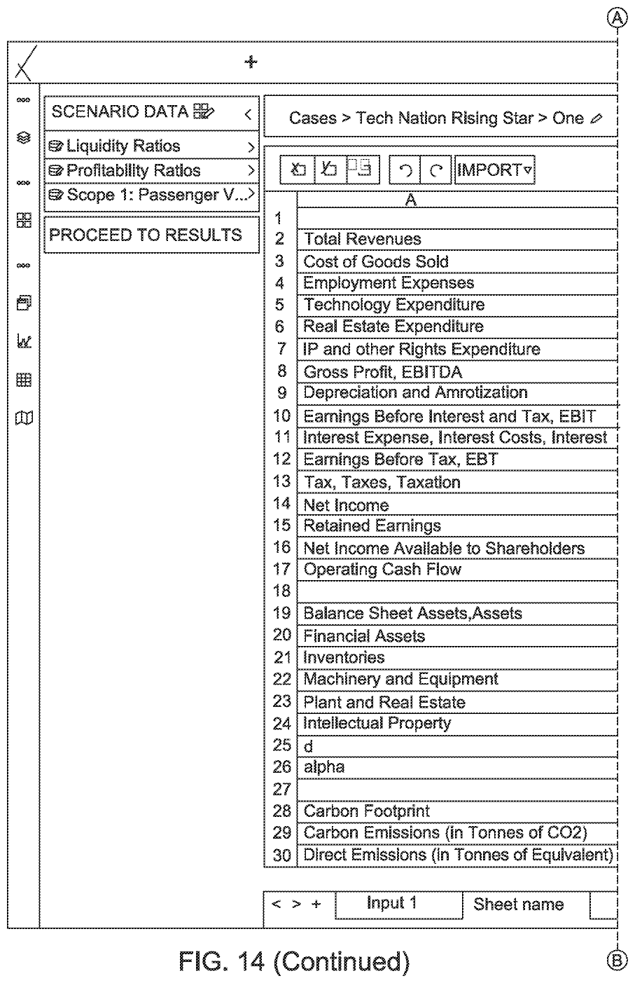

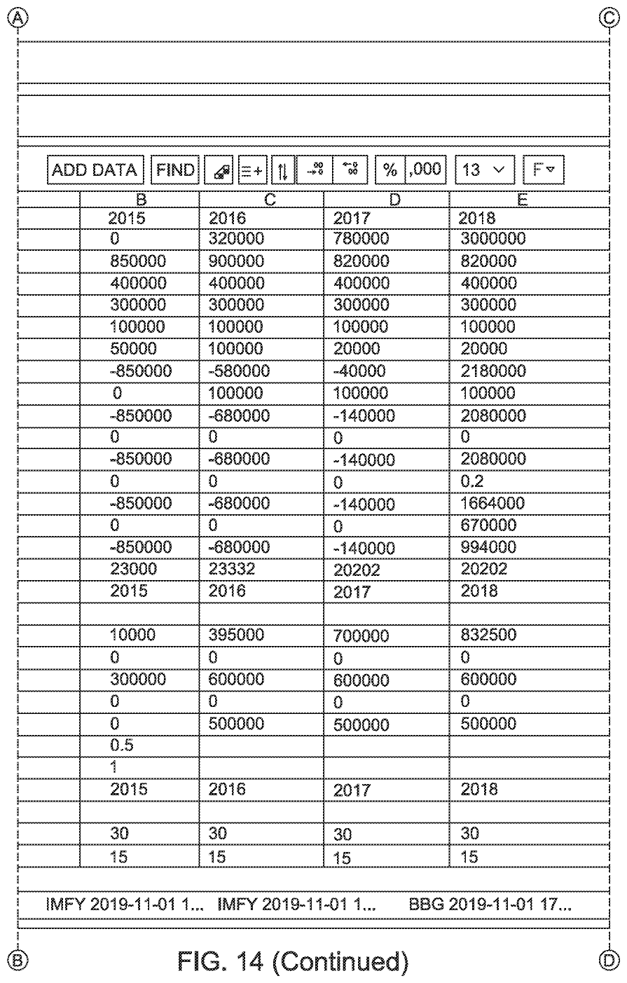

After creating the case, users are be directed to the scenario data sheet inside the spreadsheet editor, as shown in FIG. 14. The data in the uploaded files may be imported into new sheets in the editor following the same sheet structure used in the files. Advantageously, the system imports only the values and basic formatting of the user's data sheets without equations and macros.

For example, selected dashboards with their associated panels may be located on a dedicated section of the user's interface (on the left in FIG. 12). In this example, the panels list of each dashboard may be expanded by clicking the right arrow located next to each one.

With reference to FIG. 14, users can also modify their workstation for the new case by changing the selection of their dashboards by clicking on the button next to Scenario Data. Removing a dashboard from a workstation may remove all the related results that have been created by the scenario. After selecting all the dashboards needed users can click Save tab to continue or Cancel to go back. The changes will show in the dashboards section. User can edit scenario information such as the scenario name.

Once data has been uploaded, imported, or input into the case, users can start the analytical process. Whilst it will be appreciated that all suitable types of formatting and editing tools may be available to users, the first most important task is to define the axes of the sheet and the constants. Data sheets are unusable by the system if they have no defined X and Y axes. This is at the foundation of an automated panel system. Constants are optional but should be identified for future use if relevant. Furthermore, if time is one of the axes of the user's data, it should preferably always be set on the X axis.

For example, in order to define the X axis, users may select the relevant row on the sheet and press a button on the user interface. When the axis has been properly selected, the bottom outline of the cells and the button will preferably turn a different colour (e.g. green) automatically. Likewise, in order to define the Y axis, users may select the relevant column on the sheet and press another button. The left outline of the cells and the button will preferably automatically turn another colour (e.g. blue). In order to define constants, users may select the relevant cells on the sheet and press another button. The left outline of the cells and the button will preferably automatically turn another colour (e.g. purple). It will be appreciated that at any point any such actions may be undone-redone in the user interface, for example with a click of an undo/redo button.

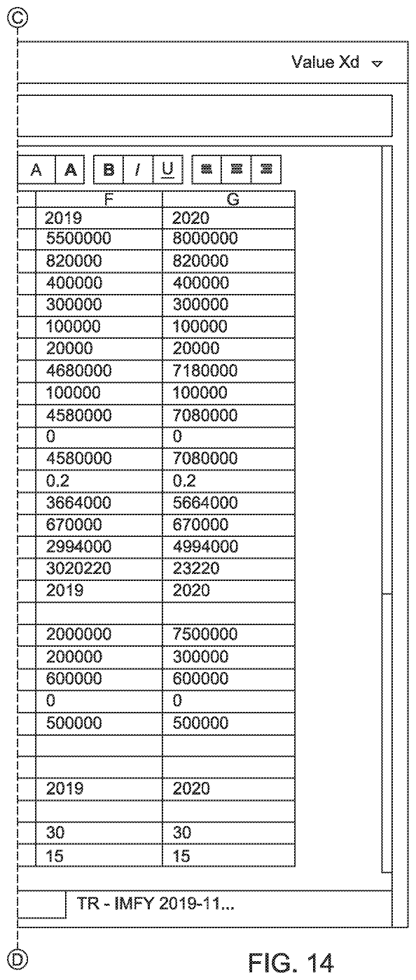

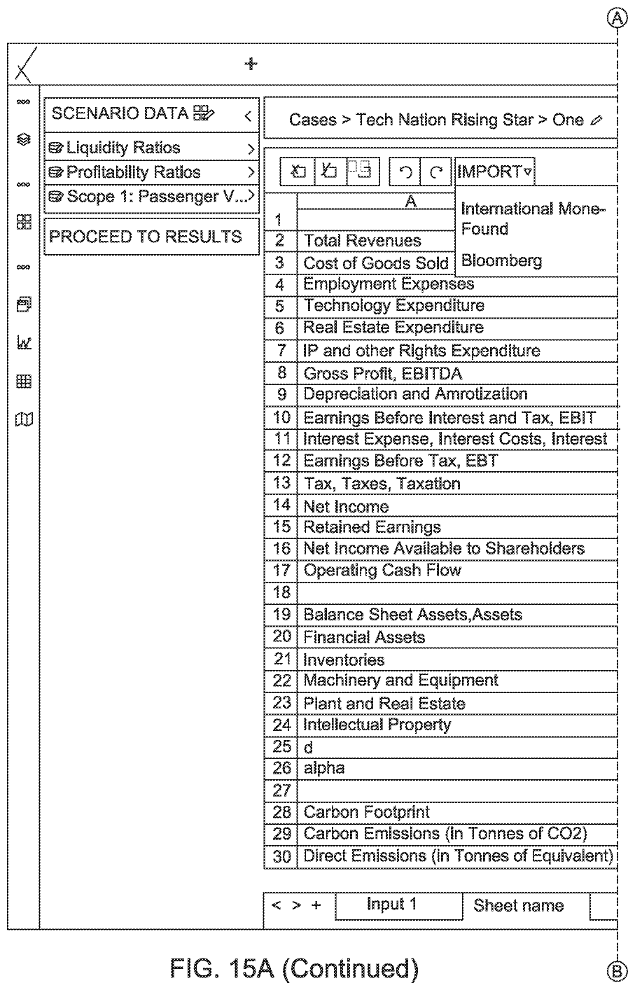

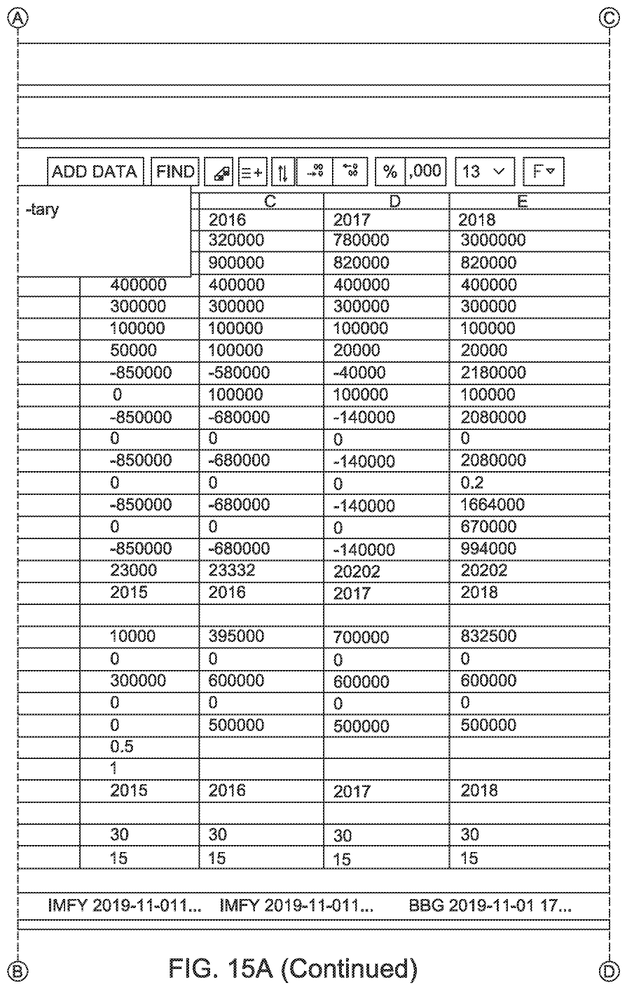

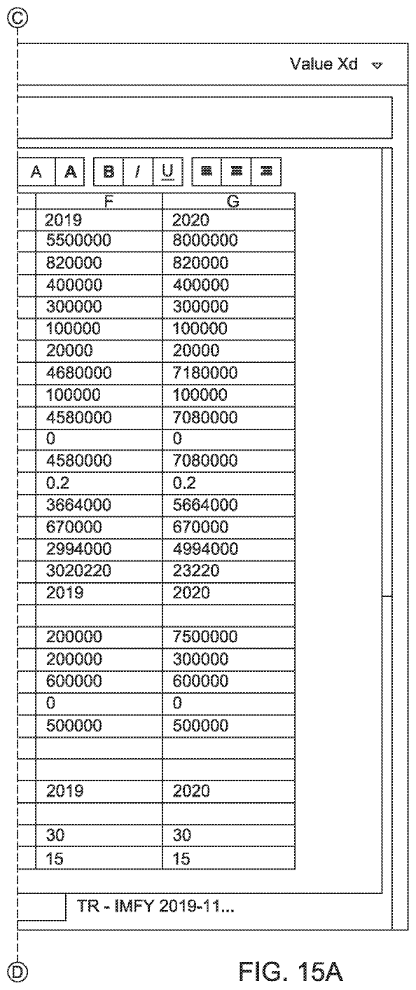

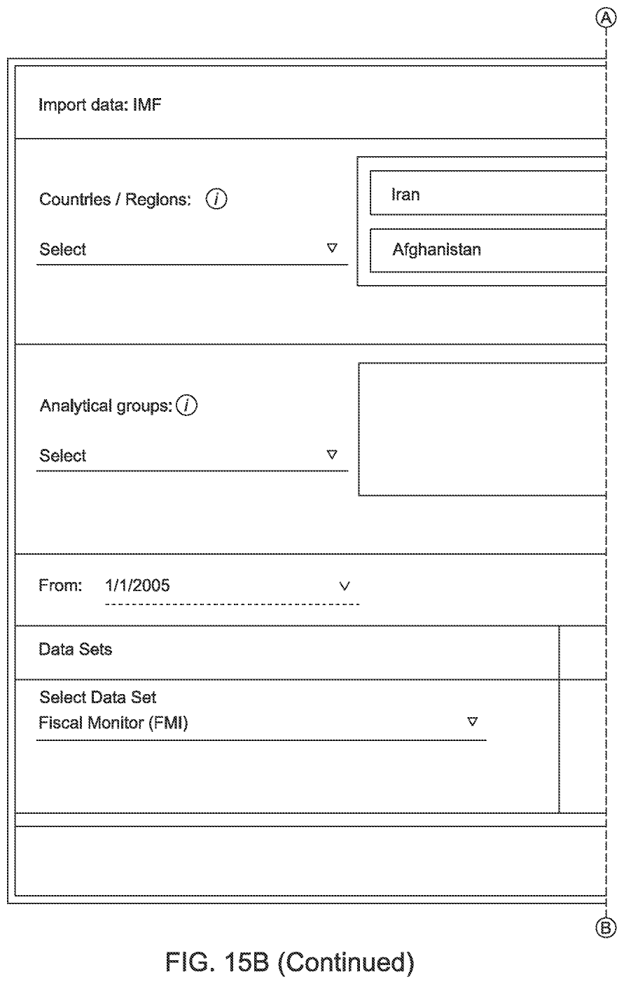

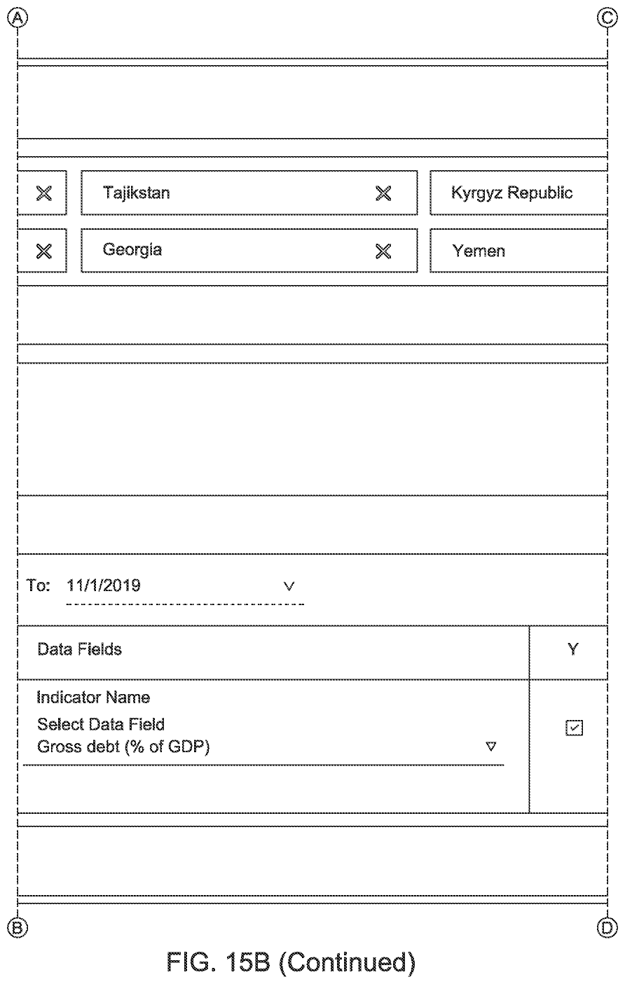

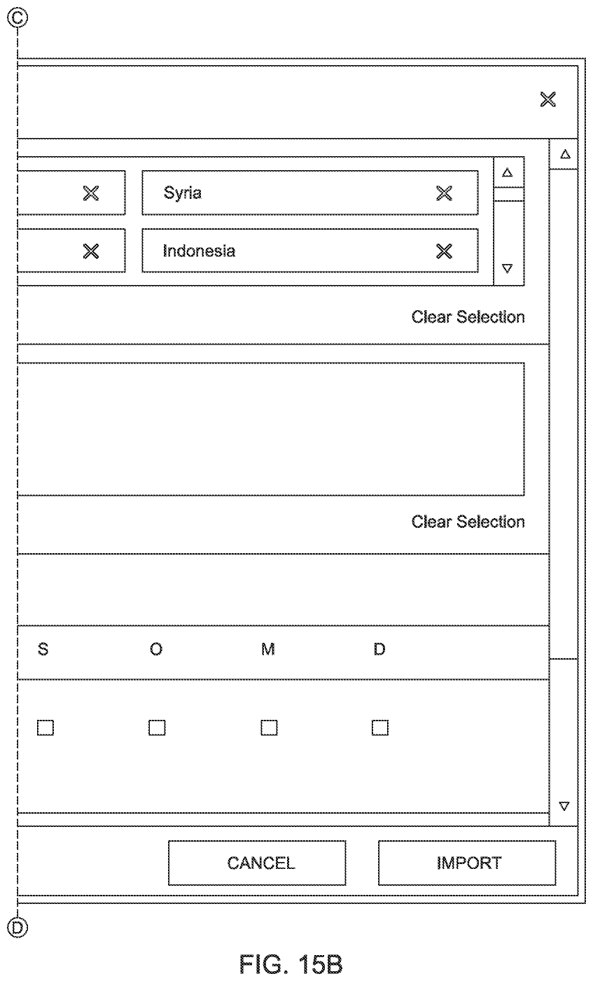

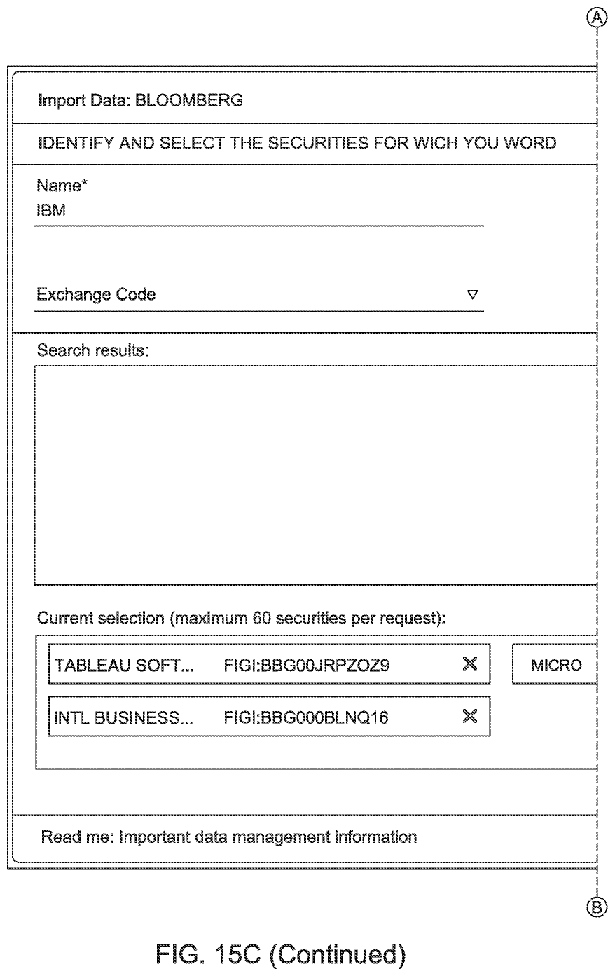

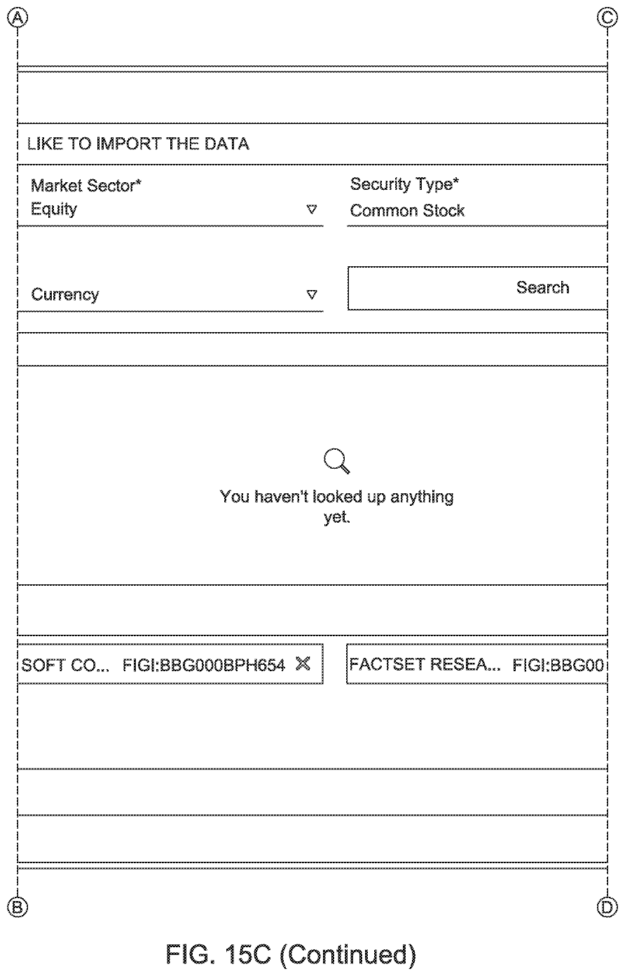

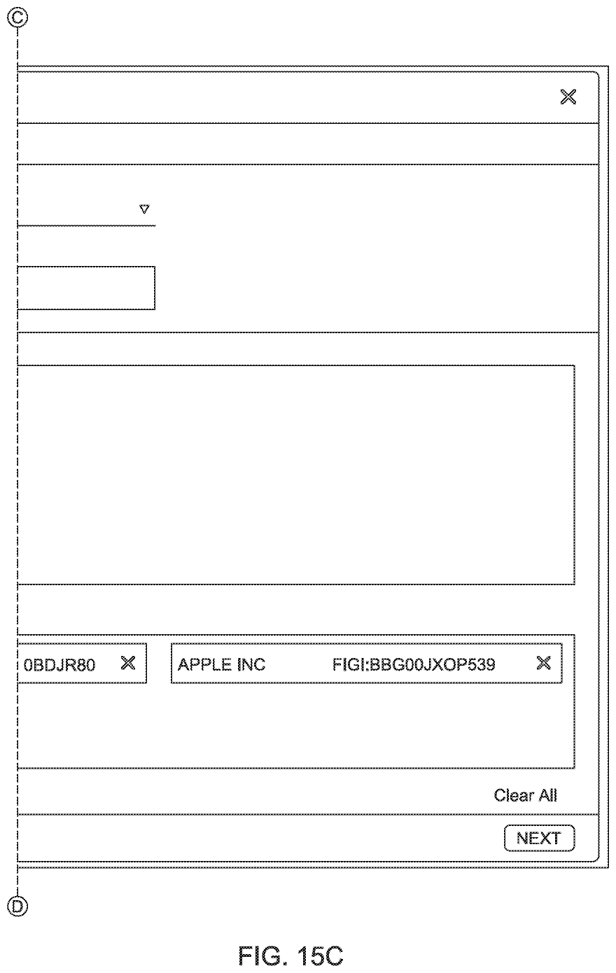

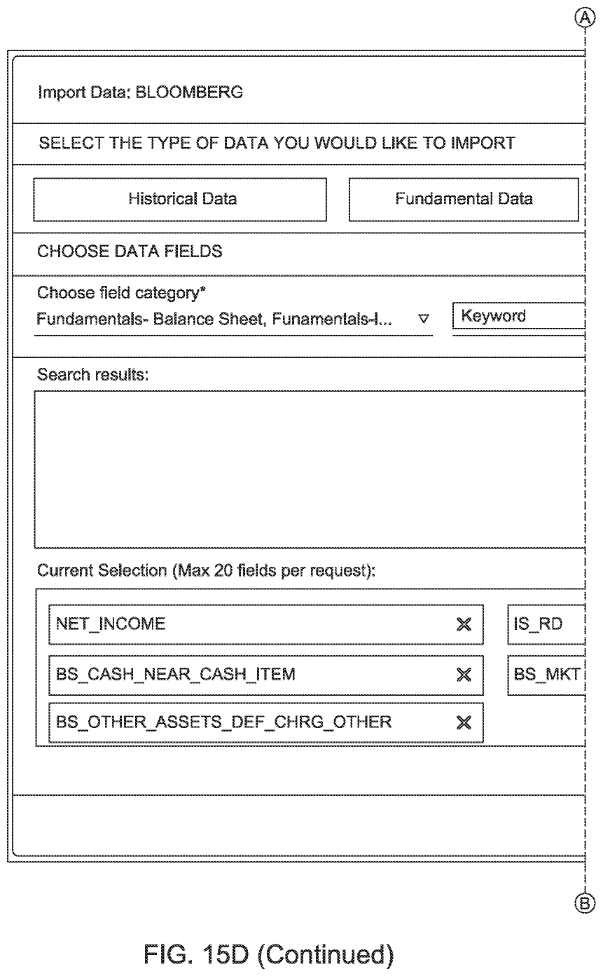

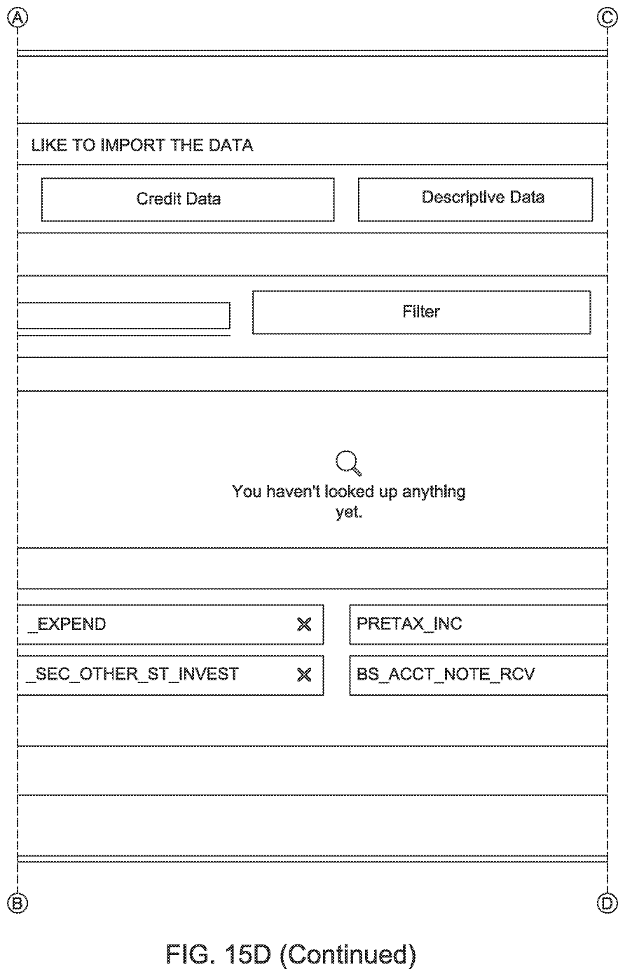

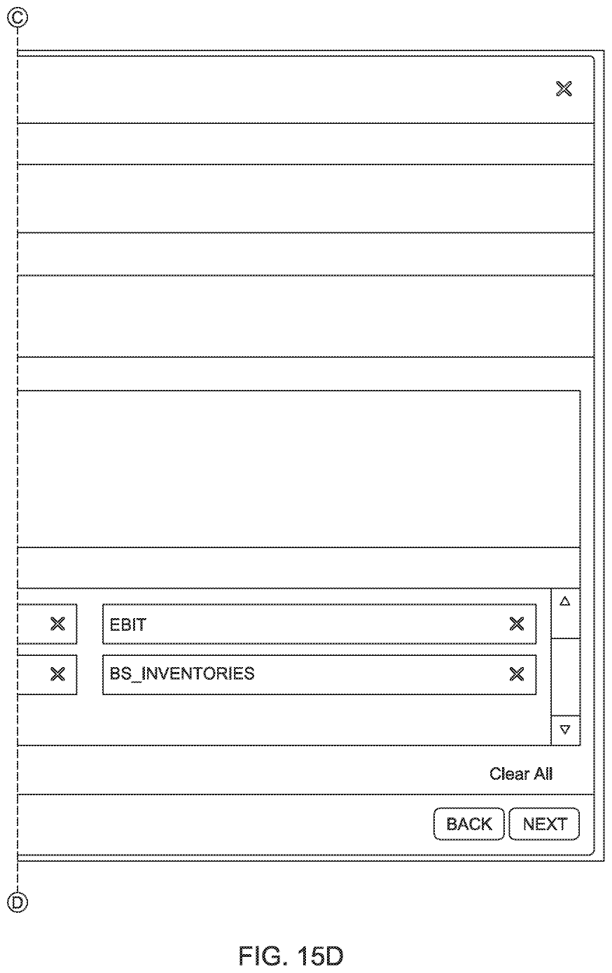

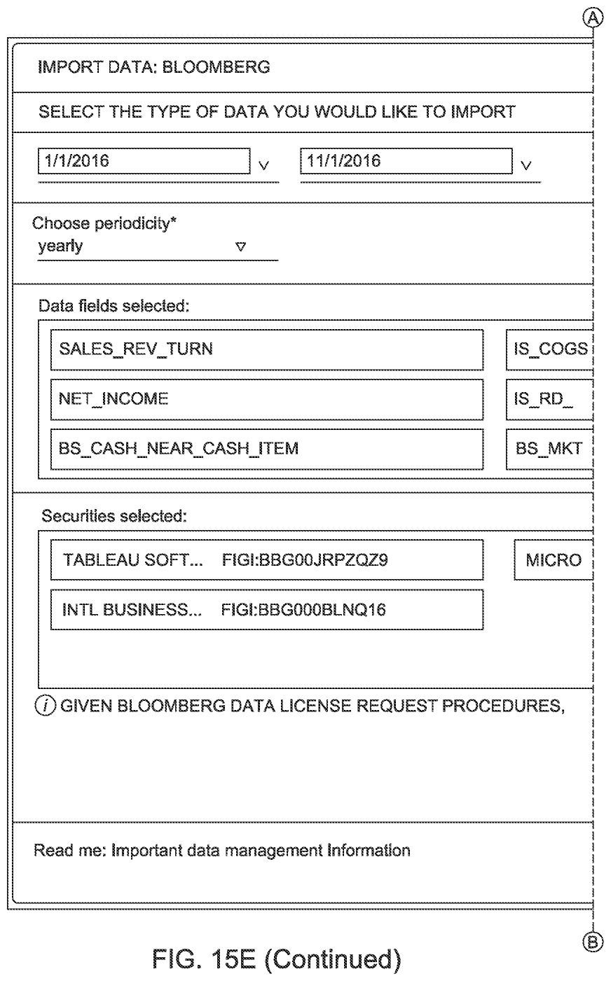

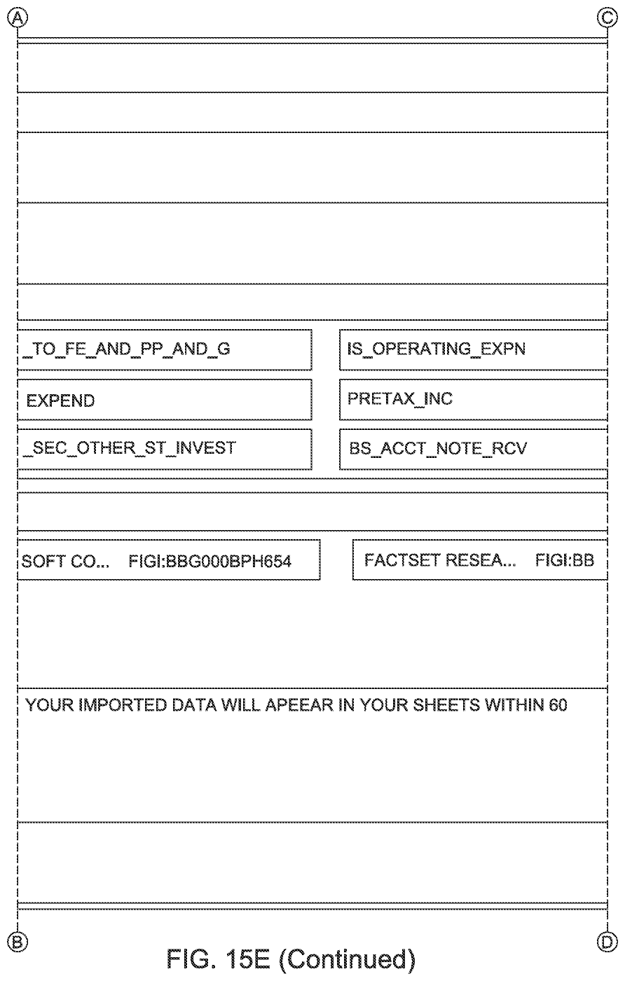

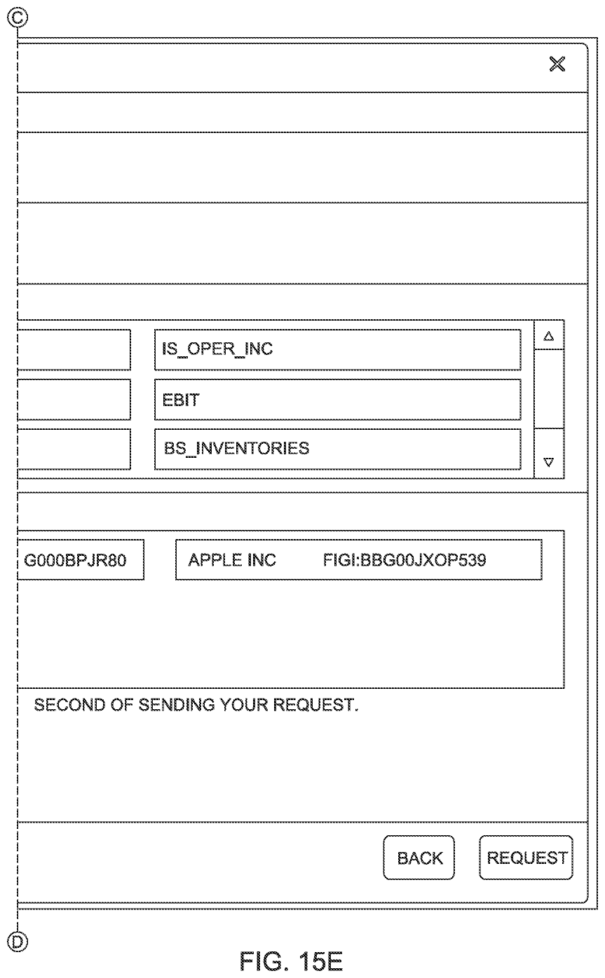

For example, users can click select a third party (external) data import interface (FIG. 15A). The interface is preferably with data sources from a macro and micro perspective such as the International Monetary fund, IMF and Bloomberg™ Data License. The external data may be directly accessed via the data sources open API, and is preferably mirrored and regularly updated in the present system.

For example, in FIG. 15B, the IMF Data Import Interface, users can choose to import data for one country or a group of countries, or all countries. Preferably, a selection menu allows users to select regions with one click, making it easier to find and select the user's target countries. Preferably, the region categorisation may be based on the United Nations (UN) M49 Standard. When a specific region is selected, the countries included in that region may be shown in the user interface next to it, and a user can remove any one from the selection at any time.

For example, users can also select one or many of the available analytical groups and/or regions for aggregated data search and import. These may be IMF provided series for example, not necessarily calculated by the present system. Similarly to countries selection, the selected Analytical groups may be shown in the user interface next to it, and may be removed at any time.

Furthermore, users can select an interval of dates to specify from-to. Users can also select available external Data sets and the relevant Data fields. The system then imports all data available for the time period and the type of data selected, for example as long as there is one Data field. Preferably, for each selected dataset/field, the type of data available is indicated in a selection box in the user interface.

Data may be provided in monthly, quarterly, and yearly format for example. If any of the boxes are unavailable, this indicates that the chosen field/data is only available in the options provided. The system imports all the data available in datasets as per the time period specified by the user, for the field(s), and country(ies).

Preferably, users can add (and subsequently remove at any time) one or many queries as desired. For example, when a user selects an option to “add query” in the user interface, another row is added with the same options, to select the Data Set with the related Data Field and data periodicity.

After selecting all desired options, the system imports the data automatically into a new sheet, added for example at the end of the existing sheets. The type of data may be identified—for example letter Y indicates yearly data.

It will be appreciated that selections may be made according to the type of imported data. In an example, for data sources from a micro perspective, users may use the Bloomberg® Data License import tool described in FIGS. 15C, 15D, and 15E.

The Bloomberg interface has three main steps, where the user may select the securities desired, by identifying their FIGI Codes, provided via a search API interface FIG. 15C. Users may then select the type of data they would like to import, such as Fundamental Data, Historical Data, Credit Data, or Descriptive Date, and then may filter data fields, by selecting types or categories from the drop down menu in FIG. 15D. They then identify the time window and periodicity of the data they would like to request from Bloomberg, FIG. 15E, and then proceed to importing the data.

Preferably, at any point, users may import additional data to an existing case, for example by uploading data from a spreadsheet file. Preferably, the user interface indicates the supported file formats available.

At any point, users may use a Find/Search function (e.g. button) to find for example a letter, word, sentence or number in a spreadsheet. The system then displays the results related to the search in the sheet, and the user may navigate through the search results for example by clicking up/down arrows.

A transpose sheet tool may be used to allow users to transpose their data sheets from Columns to Rows and from Rows to Columns. This is an important tool for map creation, and can be very helpful when adjusting axes from horizontal to vertical. Automatically a new transposed sheet will be created at the end of the user's sheets, and named e.g. Transposed/—“Sheet name”. In this example, time must always be set on the X axis. This tool is also very useful for adjusting existing data tables with time on the vertical axis.

It will be appreciated that other spreadsheet manipulation functions are available to the user to edit the spreadsheets. These may include, for example adding rows/columns to the spreadsheet, data sorting, increasing or decrease the place of the decimal of a numbered cell, activating a percentage tool % and/or thousands separator, 000 on any numbered cell, changing the font size/type in a specific cell, changing the cell or text colour, aligning text in the cells. Furthermore, users may navigate through spreadsheets using known user interface functions.

Spreadsheets may be removed by the users at any time. As a sheet to be deleted may be connected to Models or Charts to create visualisations, those Models or Charts will no longer appear in results and presentations. Accordingly, the system preferably issues a warning to this effect before final confirmation of the user to delete the spreadsheet.

After selecting the X and Y axes, and any constants, the dashboards may be activated and linked them to the validated sheets. For example, users may be prompted to choose the main sheet to be used as Data Source for the selected dashboard. If all the Axes are set on all the sheets in the case, then all sheets may be listed e.g. in a chosen Data Source Tab.

An entire dashboard or selection of panels may be activated in a dashboard. If the Axes are not set on any of the sheets in the case, the system may issue a notice message to the user to set the properties and timeline in at least one of the user's sheets before proceeding (e.g. ‘validated sheets not found’). When a user clicks on a dashboard that is not activated by any data source, the user may receive a notice message to select a data source for at least one of the panels of the dashboard to proceed (e.g. ‘no data source selected’).

### Drag and Link

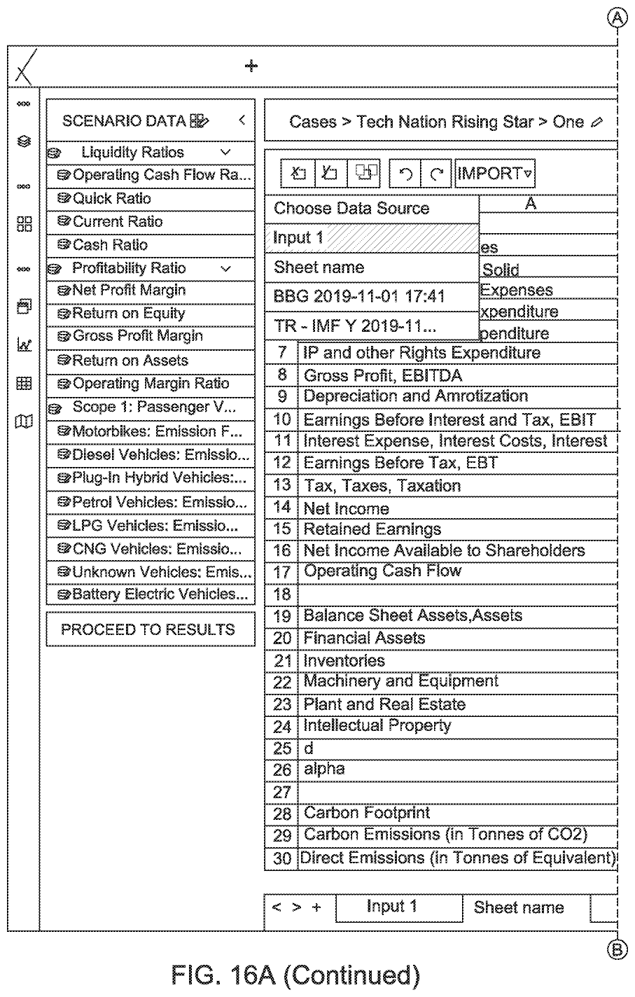

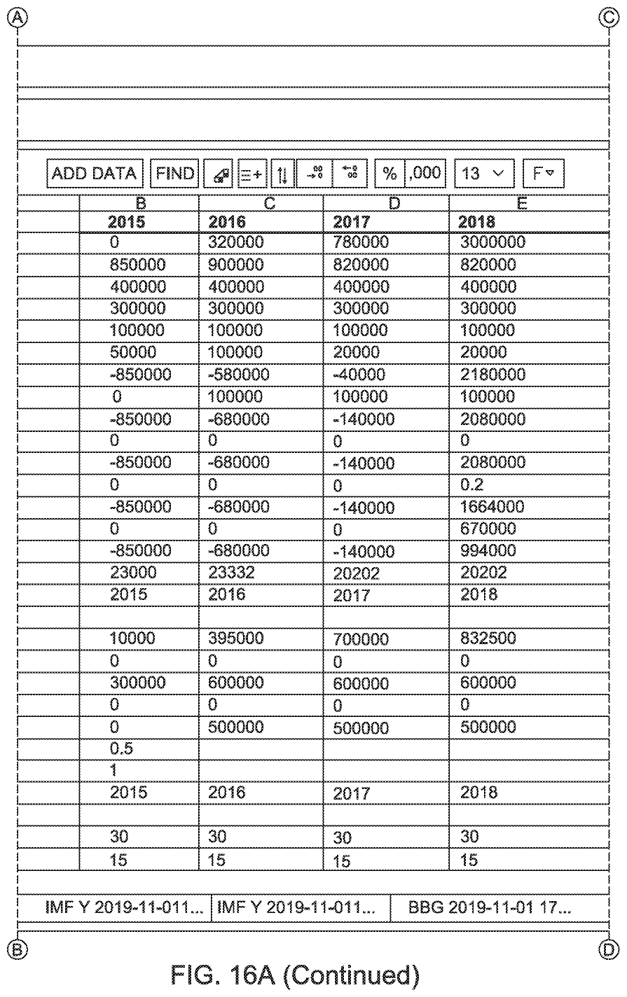

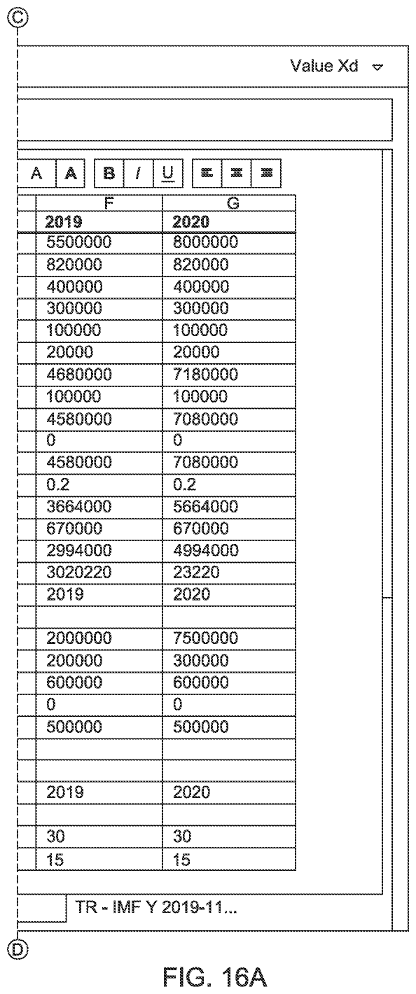

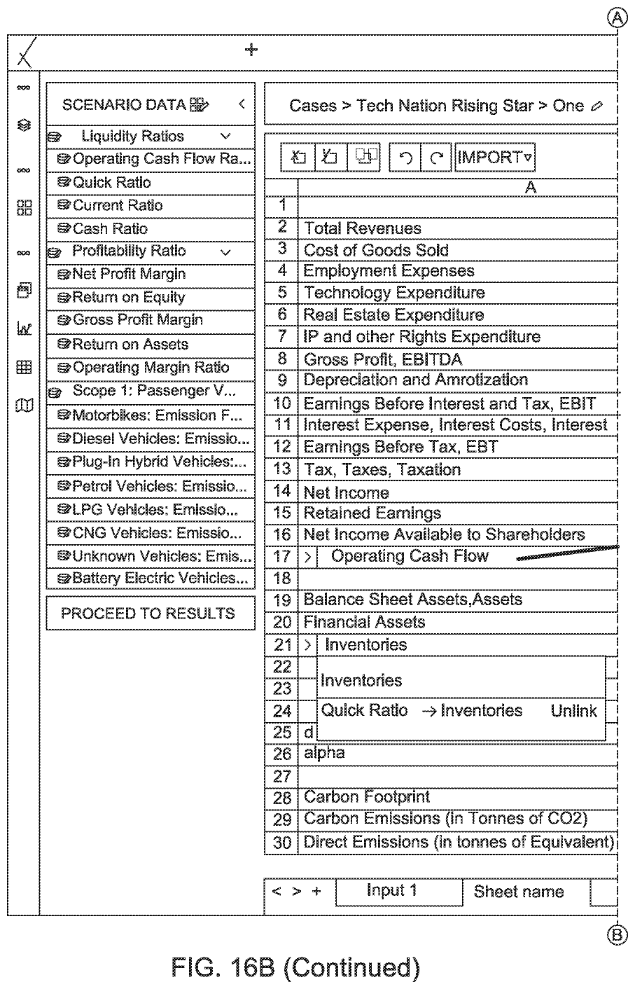

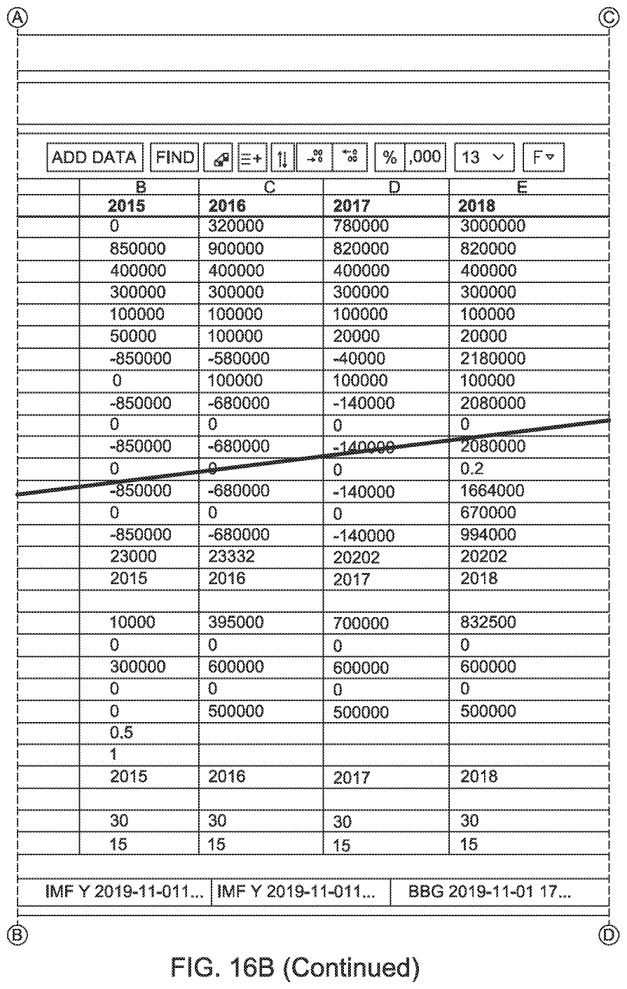

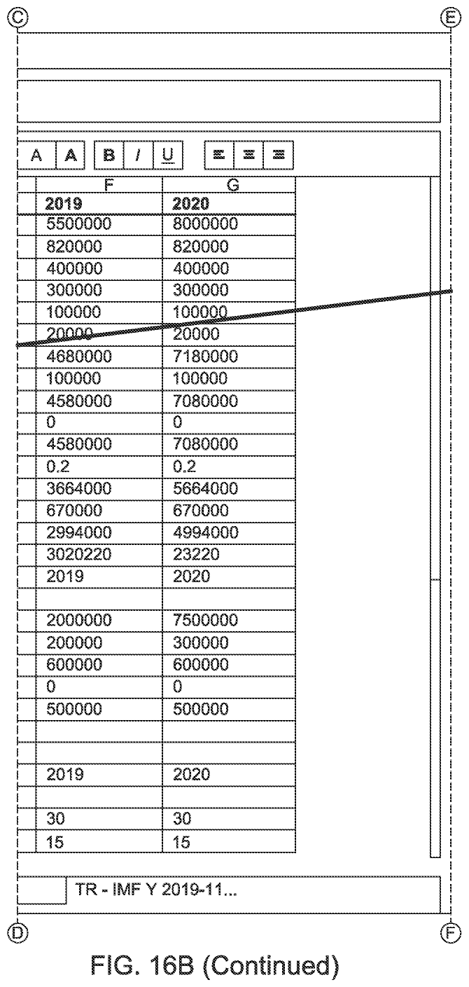

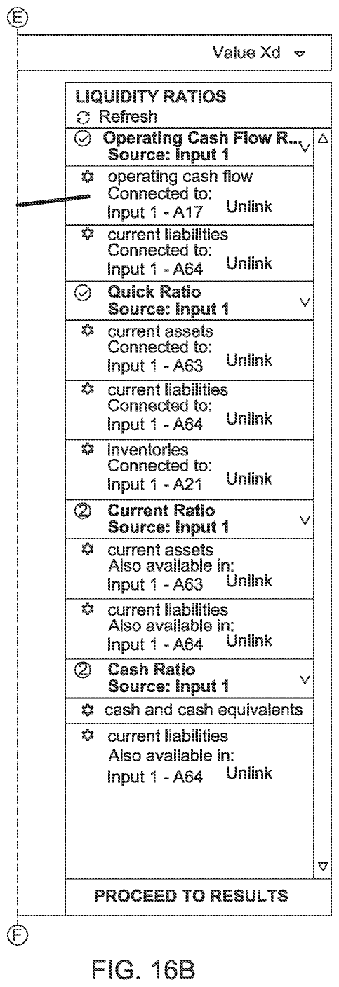

Next, data validation may be carried out by a ‘drag and link’ function. Users begin by linking selected dashboards and/or panels on the left side of FIG. 16A to specific sheets. This is done by selecting the database symbol next to each panel and/or dashboard. Linking can be done on both levels, panel and dashboard, in order to facilitate the integration of multiple models with multiple axes in one dashboard.

When users click on an linked or activated dashboard, a window appears on the right side of the user interface, as shown in FIG. 16B. This is the data validation module checking the availability of the required variables to run the dashboard and or panels in the dashboard. The window may contain the properties of the selected panel/dashboard named on top in a particular colour. All the activated panels of the selected dashboard will be listed. In the example shown in FIG. 16B, the top panels have a check and blue background indicating that all parameters of the models have been linked. The bottom two panels have the number 2 in red background which indicates the number of non-linked variables and constants of the panel that need to be linked to the variables of the data source sheet. Preferably, the user may refresh this list at any time.

Property variables (cog symbol) can be linked only to the main data source sheet that the panel or dashboard is linked to on the left side of FIG. 16A. The constant variable (Pi symbol) can be linked to any sheet that has its constants set. The main data sheet name that the panel it is linked to is written under the panel's name.

To link data in the sheets to properties and constants of panels in dashboards, the user may use the Drag and Link function as shown in FIG. 16B. For example, when a mouse cursor is moved over any of the cells that are set as Axis Y, that are marked with a coloured edge, or constant's set cells that are marked with a different outline, a 9 dots square will appear on the top right of the cell.

When the mouse cursor is moved over the square, the cursor will turn into a different symbol, e.g. a small hand. When the user clicks and holds the hand on top of the 9 dot square, a line (e.g. of a given colour) will appear that the user can drag freely to link the row/cell in the sheet to the properties and constants required by the models on the right side, as shown in FIG. 16B.

The user may drag the line with the mouse over to the corresponding property variable of the panels. The property variables of the panels may change the background colour when the line is dragged over—this advantageously identifies which variables are the right one to drag to. An activated cell can be linked to one or many variables in a panel. After dragging and releasing the mouse over a property or constant variable, the link will be activated and the variable colour turns to a different colour (FIG. 16B).

The variable may be connected for example to the Data source main sheet name—Cell location (column/row). The user may select an Unlink function from the user interface to remove the link. The user interface is preferably updated to indicates how many variables in a panel are still unlinked.

For example, when a cell is connected, a right arrow appears in the user interface that indicates that the cell is connected to a variable. In this example, the property cell will turn to blue and constant's cells will turn purple. The user may click on the right arrow in a connected cell to see more details about the specific model link.

A specific cell can be connected to one or many variables of a panel. When all the variables in a panel are linked and successfully connected, an indicator (e.g. check symbol) will preferably appear next to the panel's name. The user may expand the panel's variables list.

The user may also add new variable data by typing directly onto the sheets when variables are missing or are not in the data sheets. This allows flexibility in the data validation process, as it always allows the user to input new variables onto the sheets and then drag and link them to model parameters required.

### Results

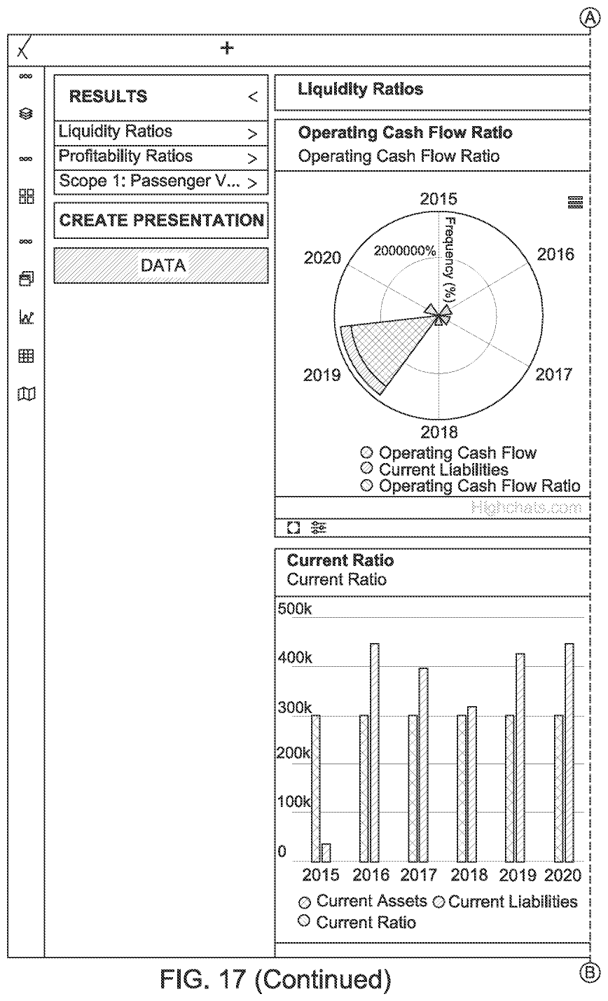

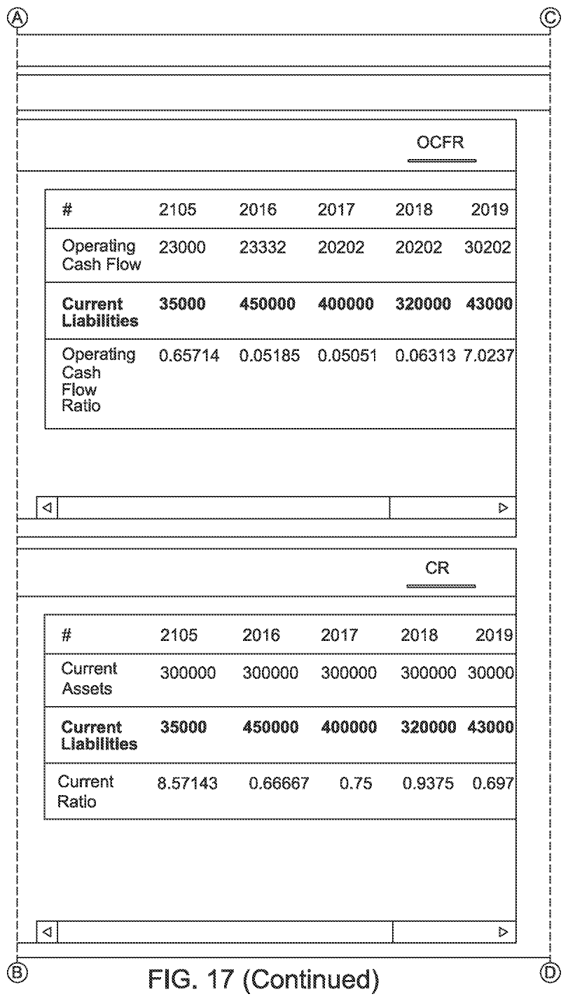

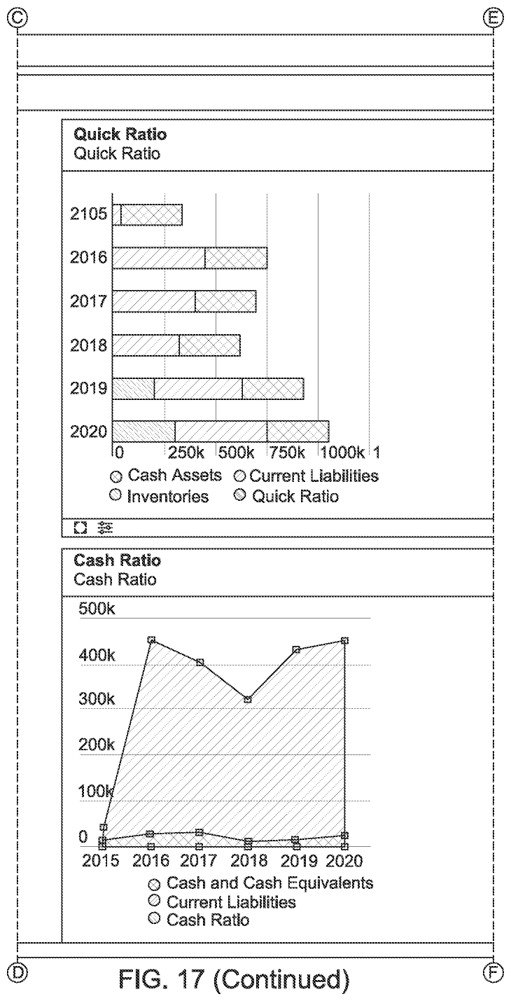

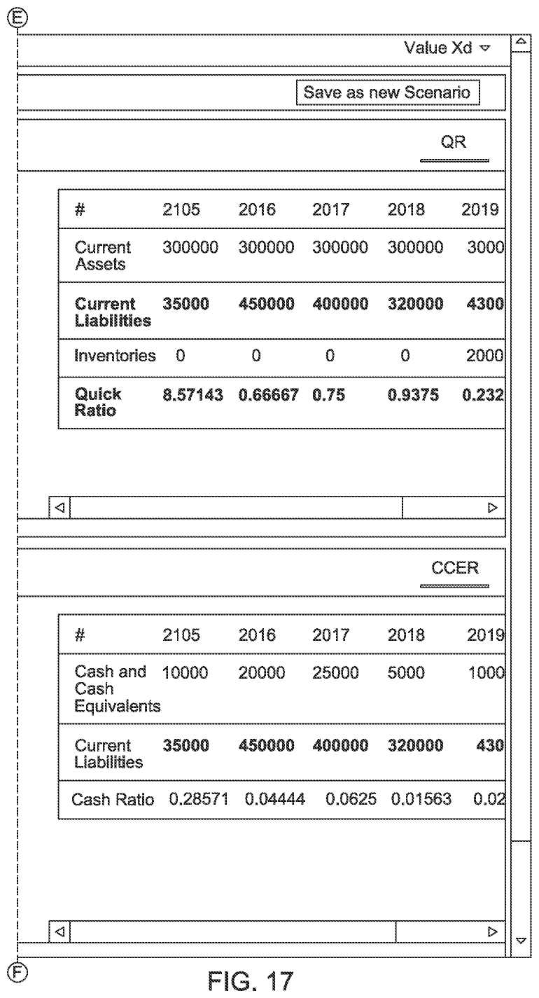

After selecting a PROCEED TO RESULTS button, users are directed to the results page of their analytics project/case, an example of which is shown in FIG. 17. The results page will preferably show all the panels of a successfully connected dashboard with its variables calculated and displayed as per user defined charts and tables, maps and models.

All the dashboards used or available in the case and scenario will be preferably displayed in a sidebar. This is the workstation defined by the user upon creating the case, or amended later on through the workstation edit button on the spreadsheet editor page. The user may optionally select a button to create presentation based on the results, which directs the user to a presentation page.

Preferably, a toolbar displays the name of the dashboard that can be saved as new scenario data in a new sheet. The user is then directed to the new scenario data page saved as recalculated with scenario name.

The linked and calculated dashboard's panels may be displayed with the users chosen visualization and the calculated properties and constants of the data. The user may navigate easily through the table and expand/zoom-in or out/rotate the visualised representation of the data for example. For example, if a panel is not linked to any variable, no visualization will be displayed. Instead, users may see a message informing that some of the parameters needed for the panel are missing or duplicated.

A user may select an Edit function to go to scenario data page to link the user's panel's missing parameters. When a dashboard is selected that is not activated by or linked to any data source sheet, the panels of this dashboard will be empty.

### Controller

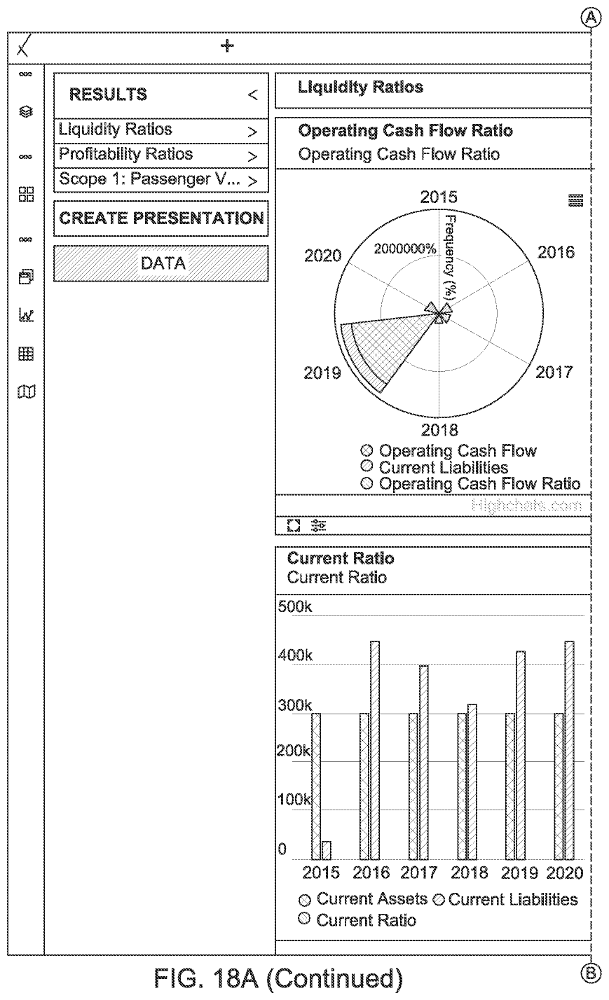

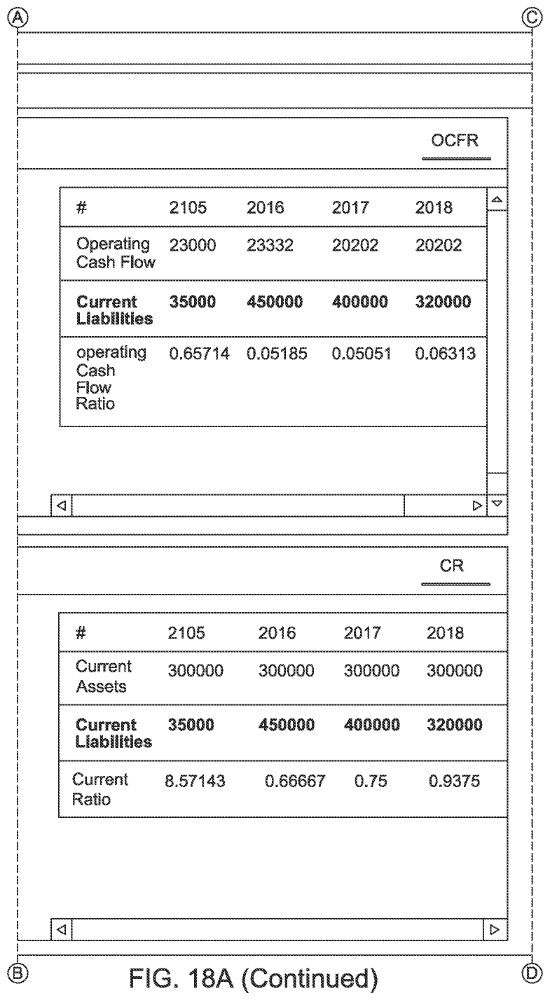

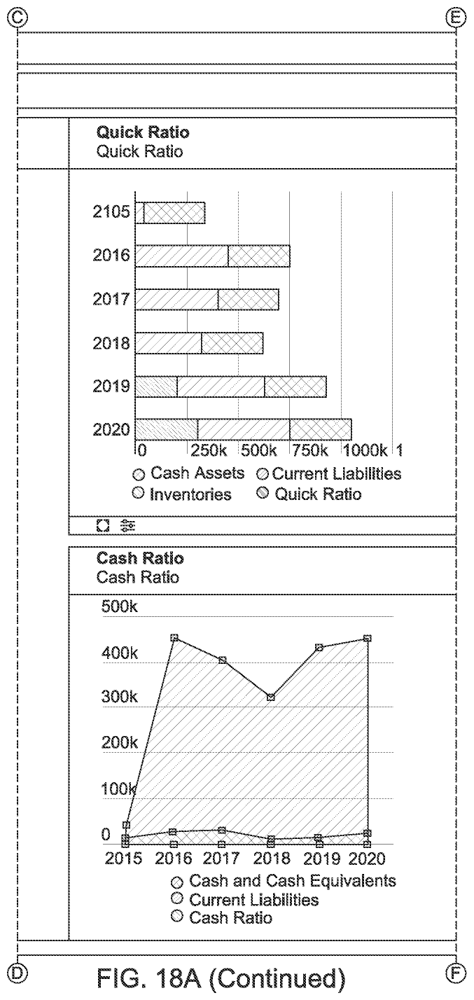

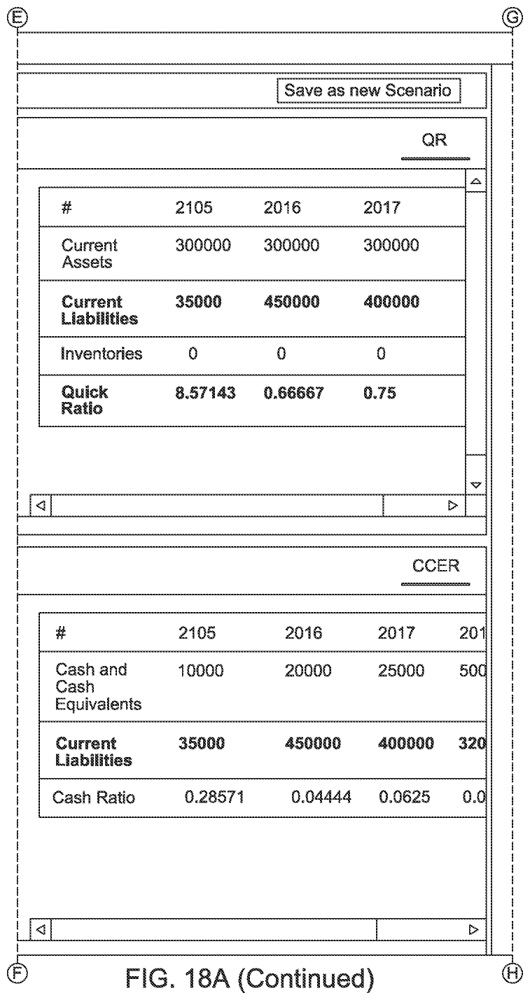

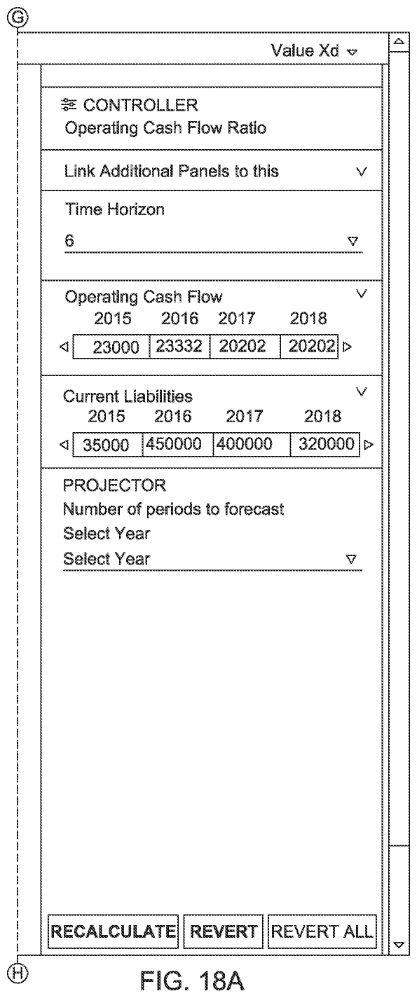

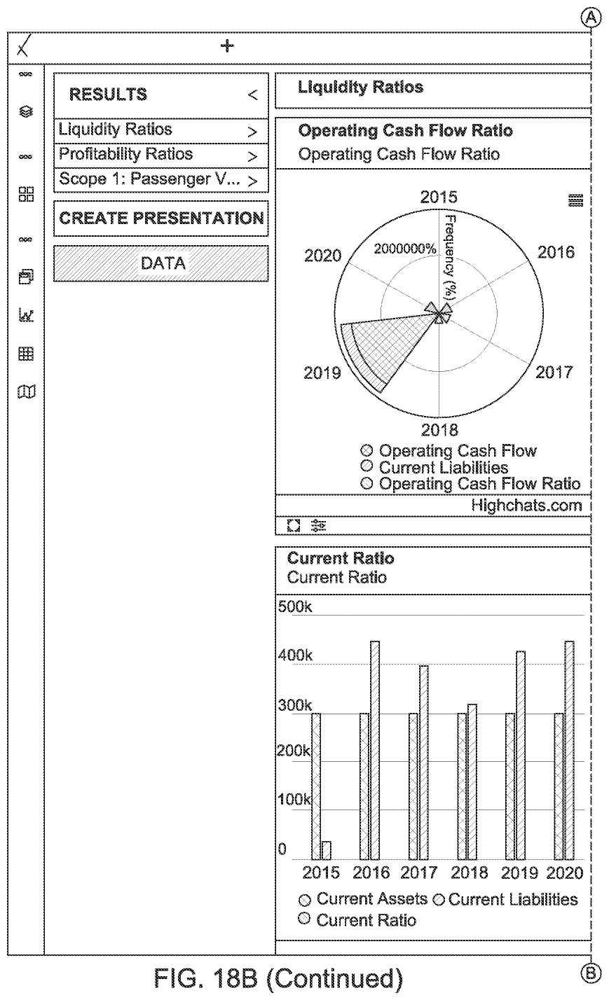

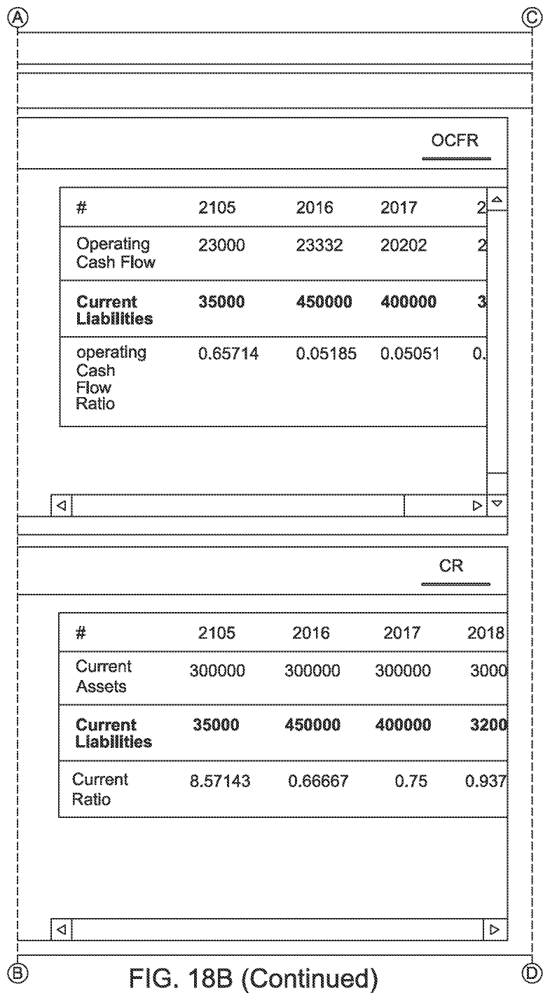

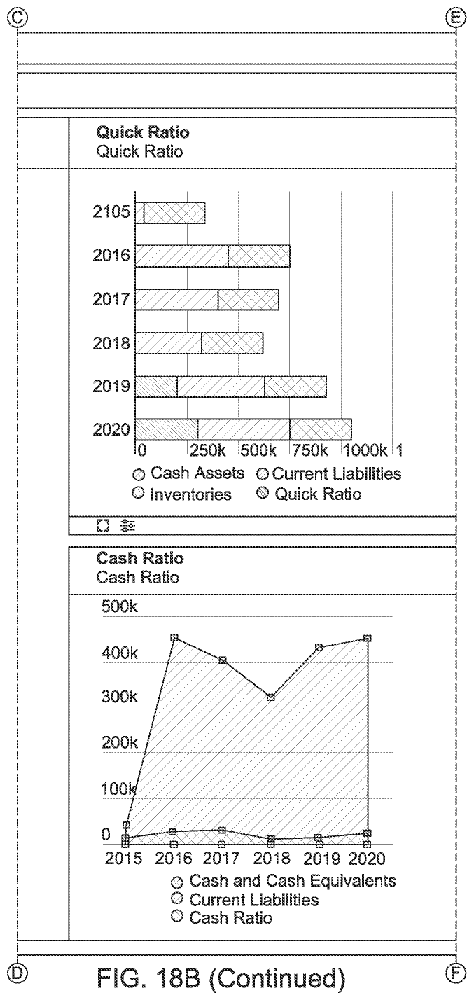

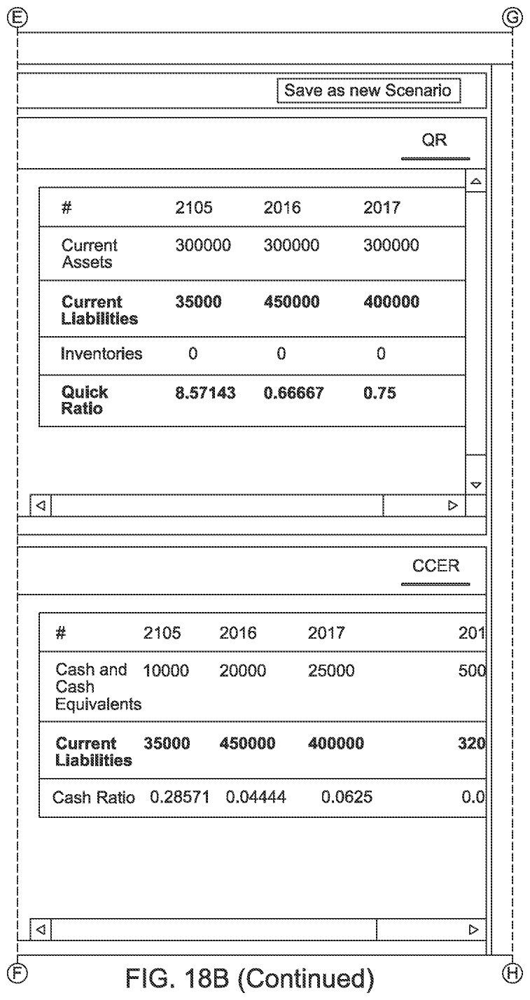

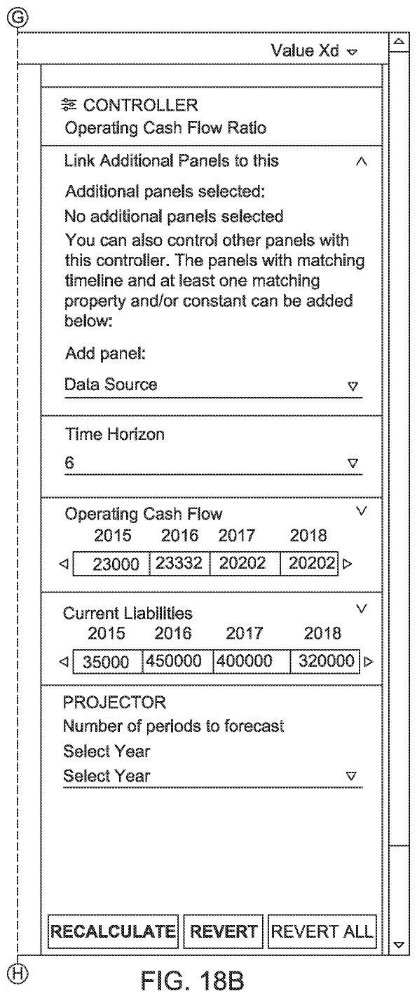

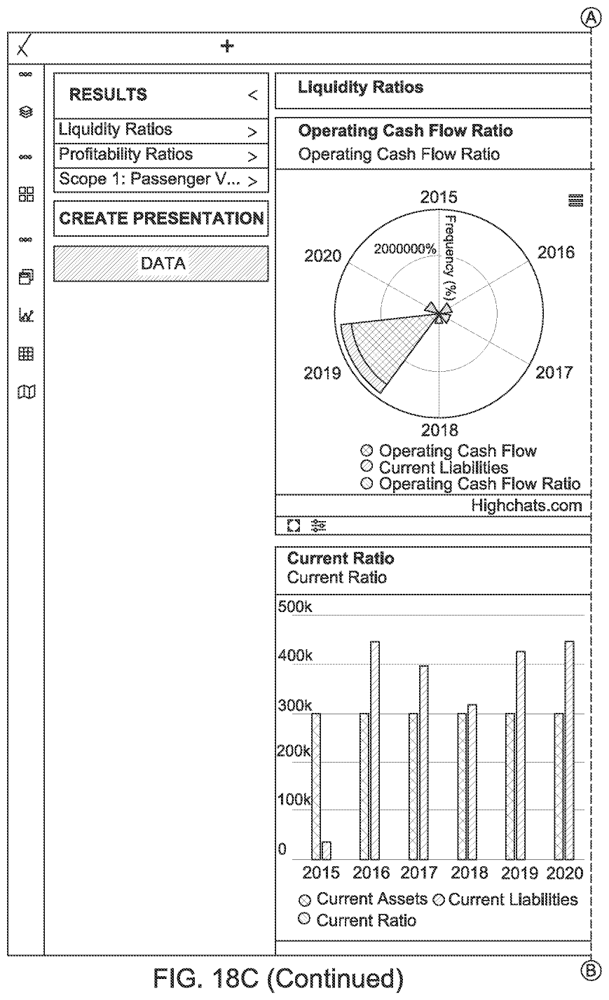

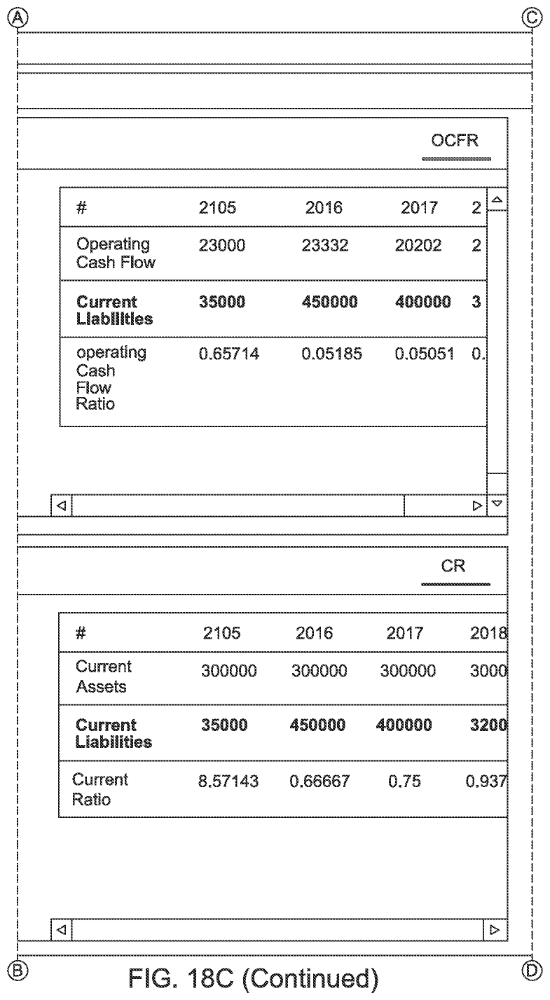

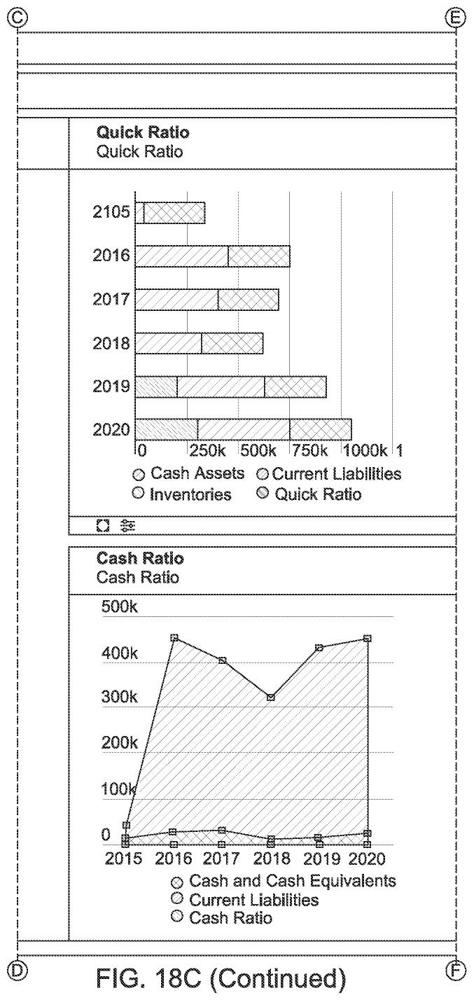

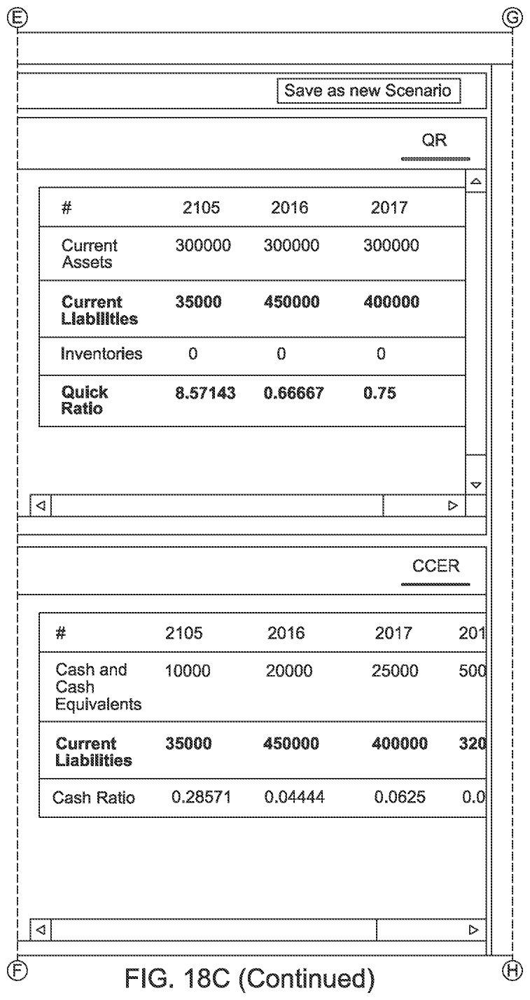

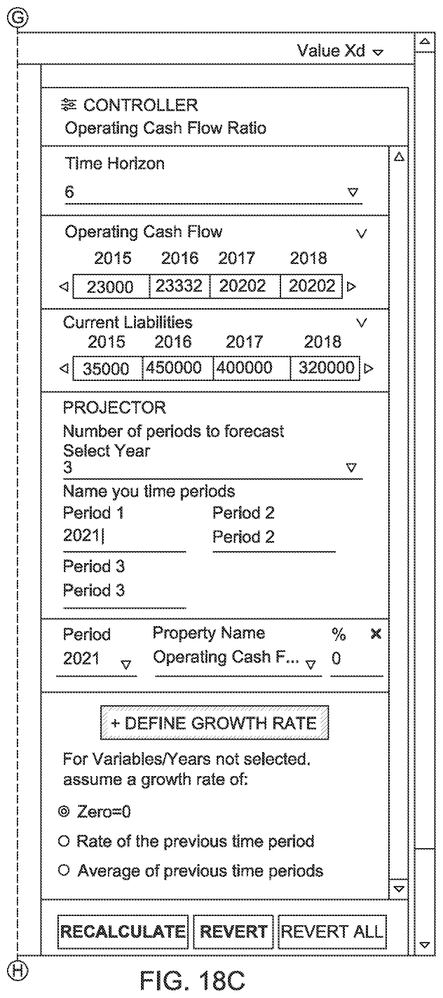

From the results page, a user may select an option to the Controller page as shown in FIG. 18A by clicking on the second button at the bottom left of a panel. The Controller button looks like a mixer, as it provides front end access to the panel parameters, selected during panel creation.

In this example, the name of the panel (“Operating Cash Flow”) can be noticed on top of the sidebar. In the Controller page, there is an option to Link option to link additional panels. This provides the opportunity to link other panels, thus making the controller the front end interface allowing users to fine tune, simulate, and manipulate results according to their strategic and tactical needs. For example, when a user clicks on the drop down menu of the select panel, only the panels with matching timeline and at least one matching property and/or constant will be available to select from. A user may add one or more panels as desired. The selected panels are then preferably listed in the user interface under additional panels selected. A user may unlink the panels to remove them.

The Controller window preferably includes a Time horizon section. This section allows the user to input how many time periods they would like to control. The number in the time horizon tab is dependent on the time periods in the selected axis.

With reference to FIG. 18B a user may control and simulate the user's properties and constants, along with the time horizon. When a panel is linked to the controller of another panel, all the common properties and/or constants may be shown as ‘linked’ next to the panel name. For example, the user can click on the Linked word to display the list of panels that this property or constant is connected to.

### Controller-Projector

The projector is an important component of the Controller that may be used to project existing panels into the future. Advantageously, this allows for factoring in specific events related to specific variables or elements of the panel. As shown in the example of FIG. 18C, when a user selects the number of periods, period boxes automatically pop up depending on the number of periods selected. In this example, three periods were selected to forecast. Names of the periods can be changed as desired, for example by double-click inside any text field to rename or change the value. In this case period one has been renamed 2021.

The projector also allows the users to factor in specific events related to specific variables or elements of the panel, at specific periods in the future. For example, the user can define the percentage growth rate of a variable in a specific period in the future. Users can define as many specific events or growth rates as needed.

As for the Variables/Years not selected, users can define for example what growth rate formula will be implemented when projecting them into the future:
Zero=0
Rate of the previous time period
Average of previous time periods

Advantageously, at any point in time, and after making changes in the settings of the controller, a user can select an option to RECALCULATE/REVERT/REVERT ALL:
Recalculate: To calculate the panels given the changes in the controller settings—results are shown instantly in the panels.
Revert: To revert the last change
Revert All: To revert all the changes made up to that point.

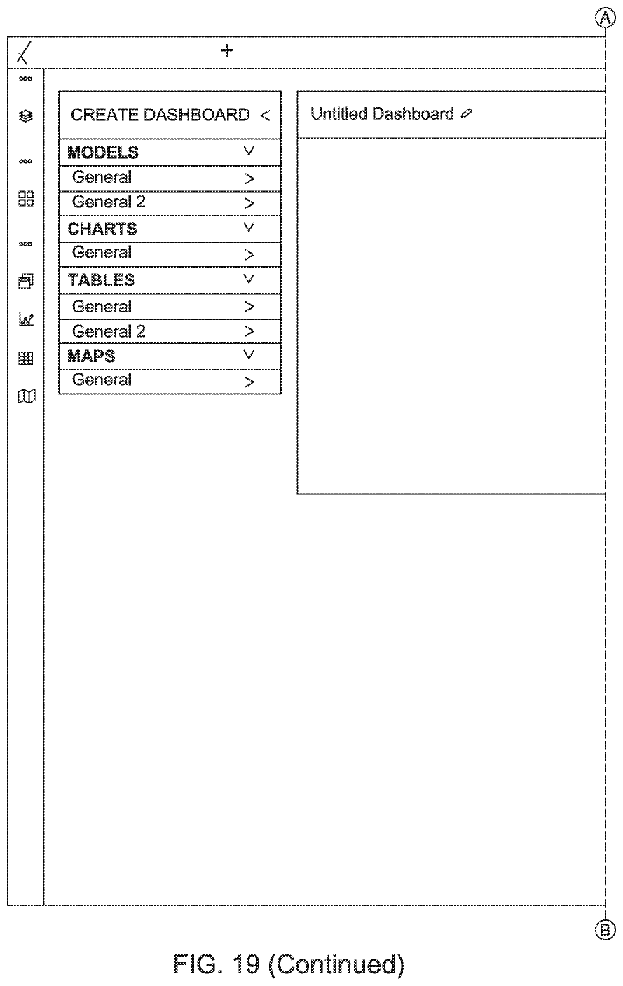

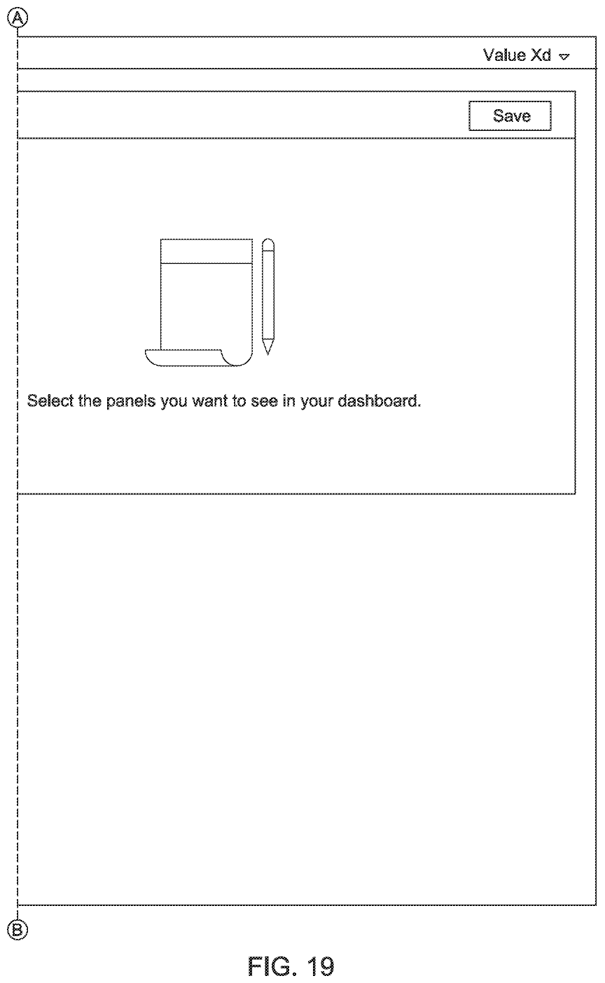

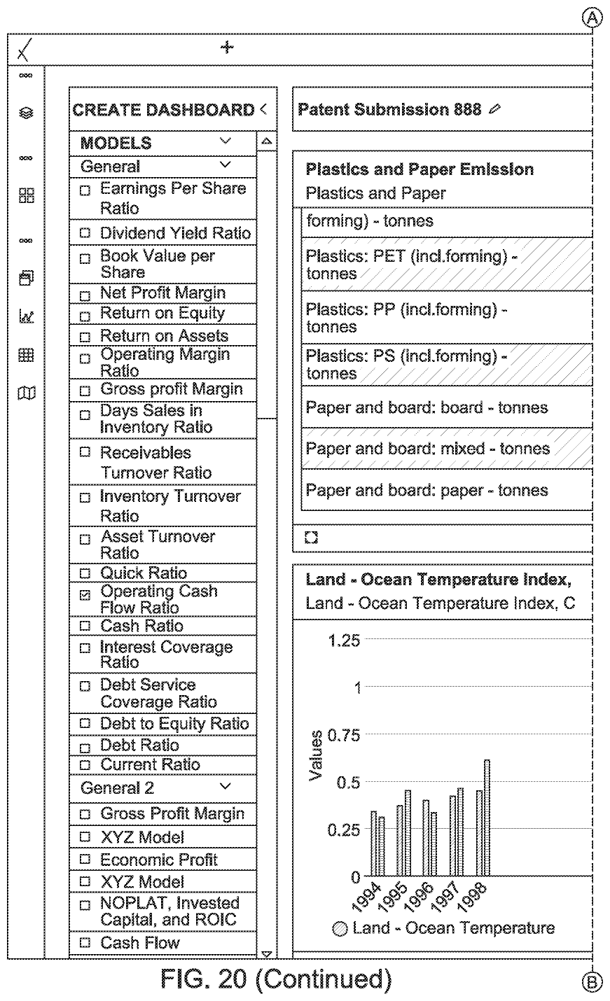

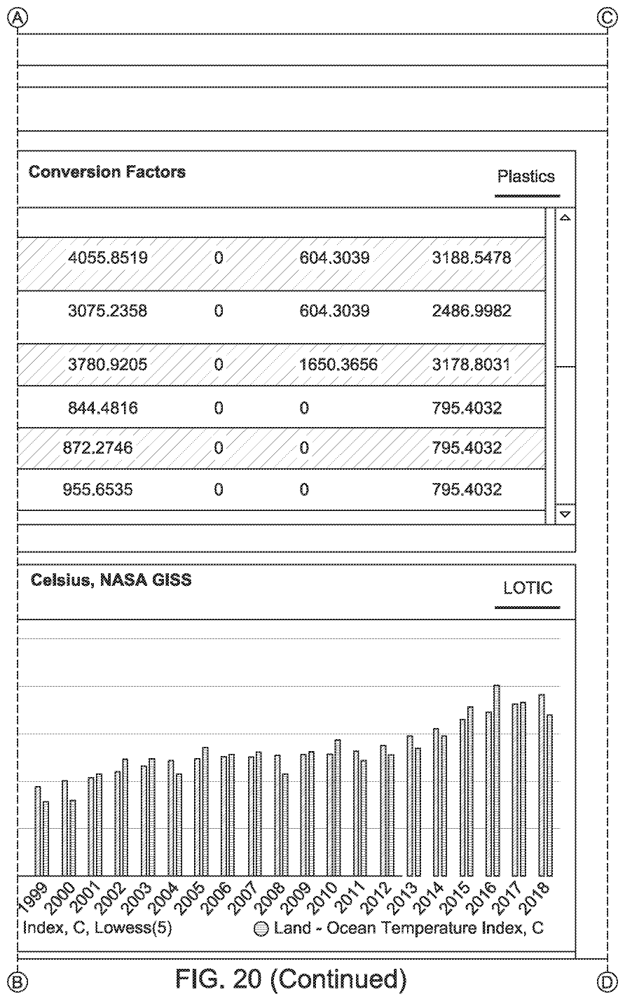

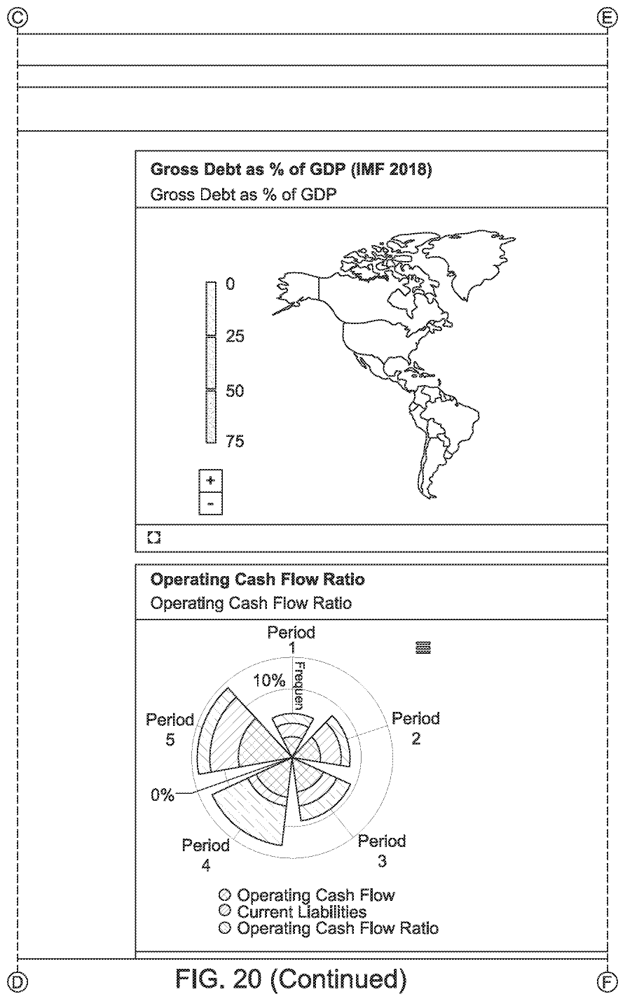

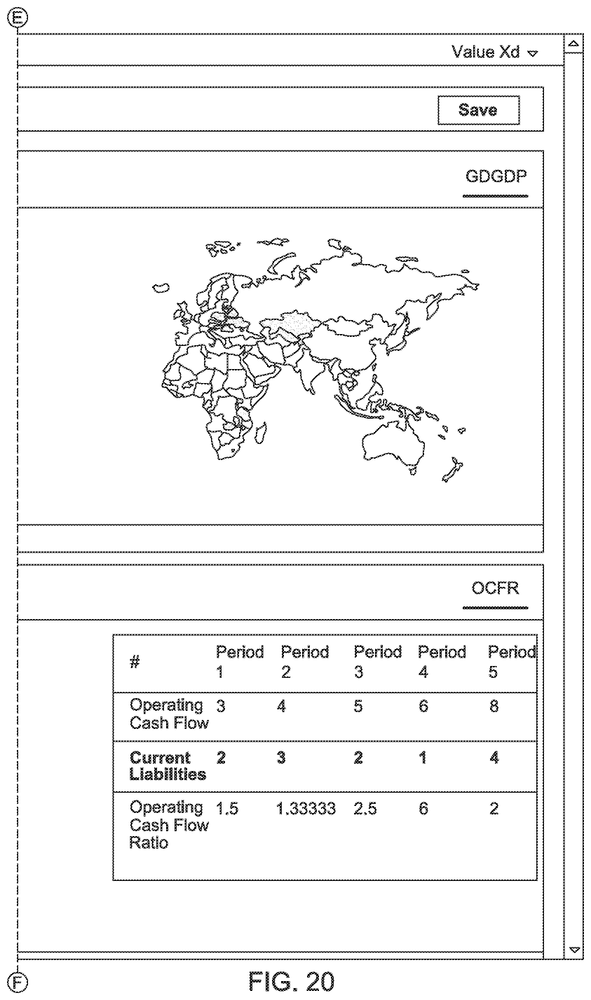

Dashboards A user can select to create dashboards. Upon this selection, the user interface directs the user to a new Dashboard page (FIG. 19) where the user can select a name and save the new dashboard. The dashboard may be populated with Models, Charts, Tables, and Maps that have already been created for example by simply ticking their corresponding box. A user may reorder the Models, Charts, Tables, and Maps for example drag and drop. Each subcategory may be expanded/hidden to list the panels available inside it. As shown in the example of FIG. 20 when a user selects a panel, the panel opens on the right side. A user may mix and match panels as needed. In the example of FIG. 20, four panels were selected, one from each category: Models, Charts, Maps and Tables.

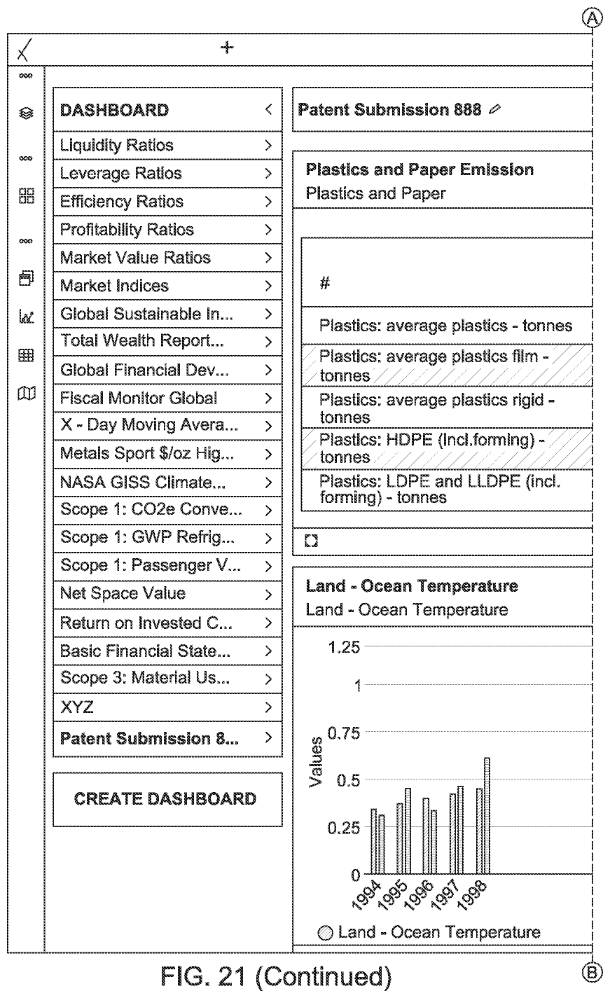

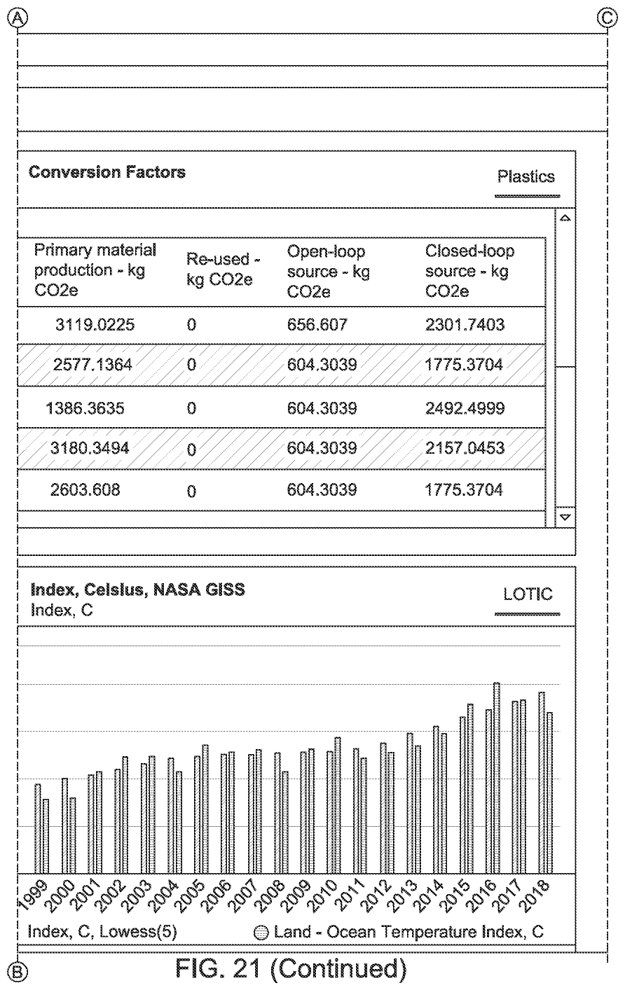

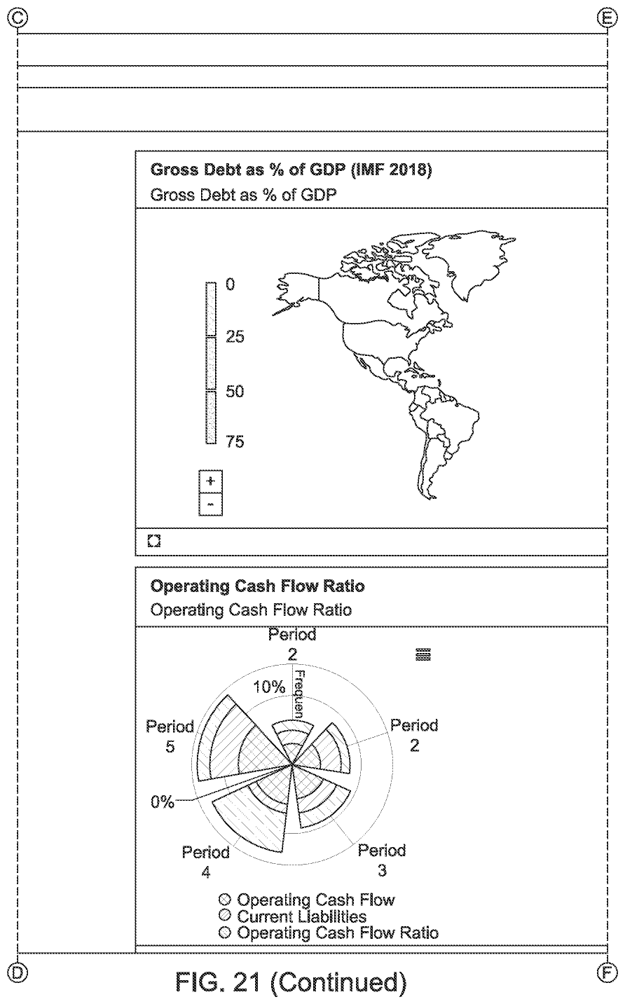

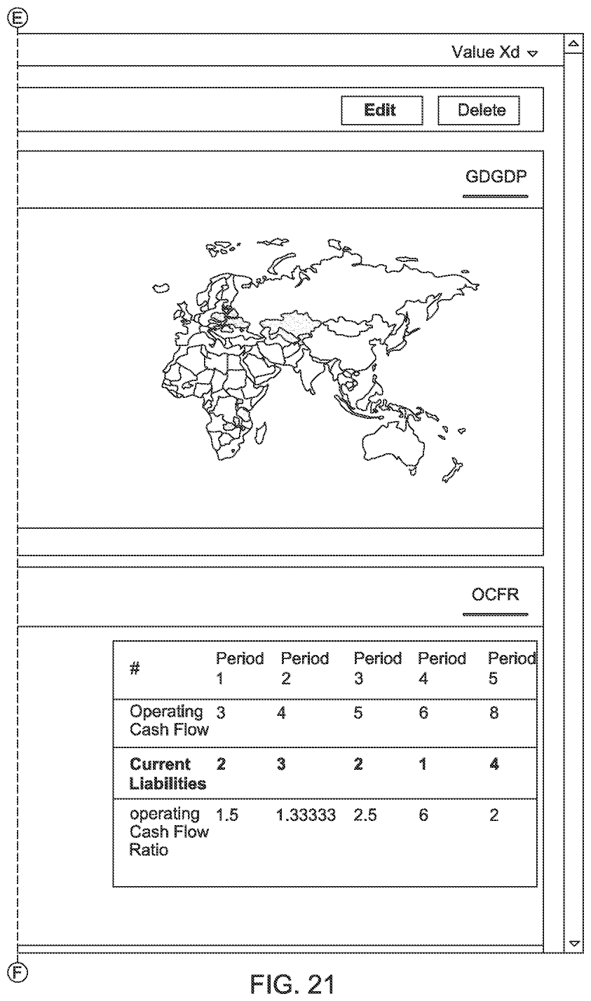

After selecting and checking the panels, the user may select to save the new dashboard. The user interface directs to the Dashboards' Catalogue page (FIG. 21) where the user can see the new dashboard listed at the end of the list. When a user selects to delete a dashboard, preferably, a message is issued by the user interface to note that everything contained in the dashboard will be deleted. If the panels inside the dashboard are used on any of the user's scenarios or presentations, they will be deleted from there as well. It will list the panels that this dashboard contains. When users select to edit a dashboard, they will be directed to an Edit page that has all the selected panels to remove or re-select other panels.

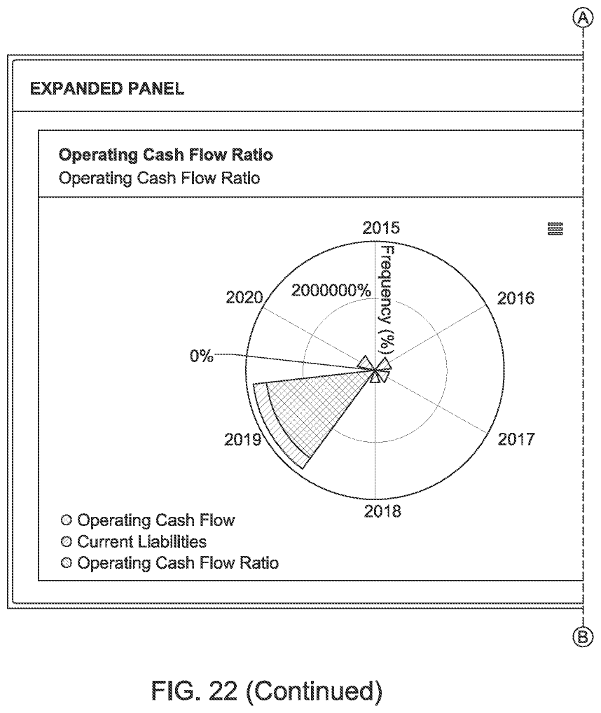

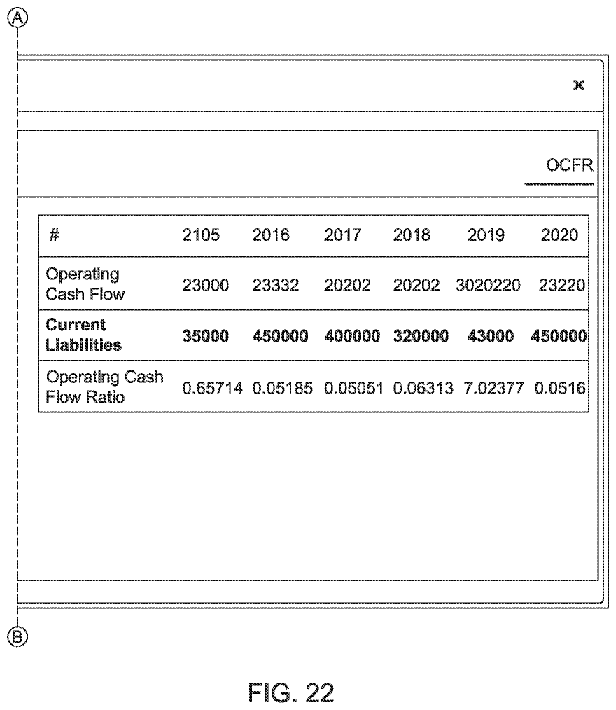

FIG. 22 shows an example of an expanded panel, by clicking bottom left small window icon, showing the dynamic modelling of the values related to the variables inside the table. This is also made possible in all panels even in not-expanded mode. The modelling representation is preferably interactive, for example by hovering over the mouse pointer or hiding variables. For example, when the mouse is hovered over a data point a description tab may pop up that indicates the value and name of the variable that the mouse is on. The outline colour of the pop up description may be according to the variable's colour. One or many variables in a chart may be turned off by selecting (e.g. clicking) on the variable names located under it. A user may notice when a variable is turned off, as its values will disappear from the chart, and axes will adjust accordingly. The name may turn off to a shaded colour for example. Similarly, each chart panel, map panel and table panel may be expanded and interacted with.

### Abstract Panels: Models

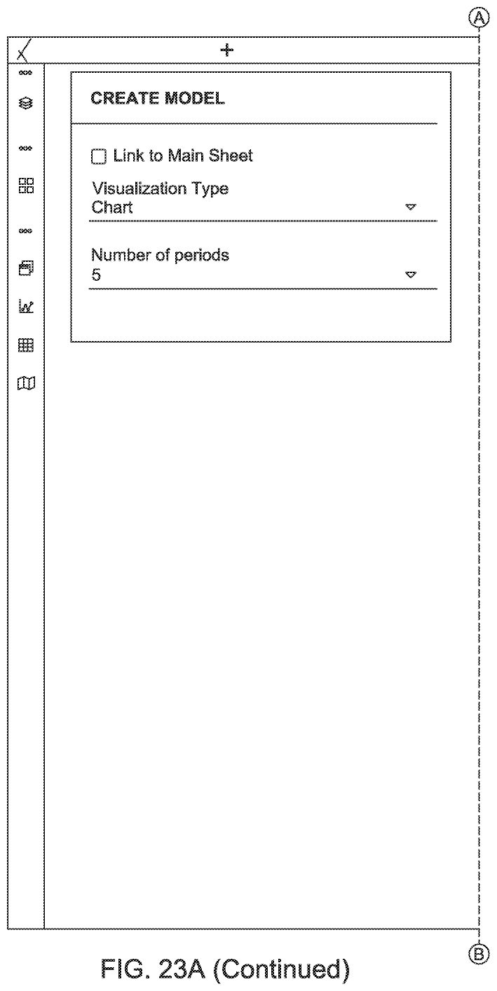

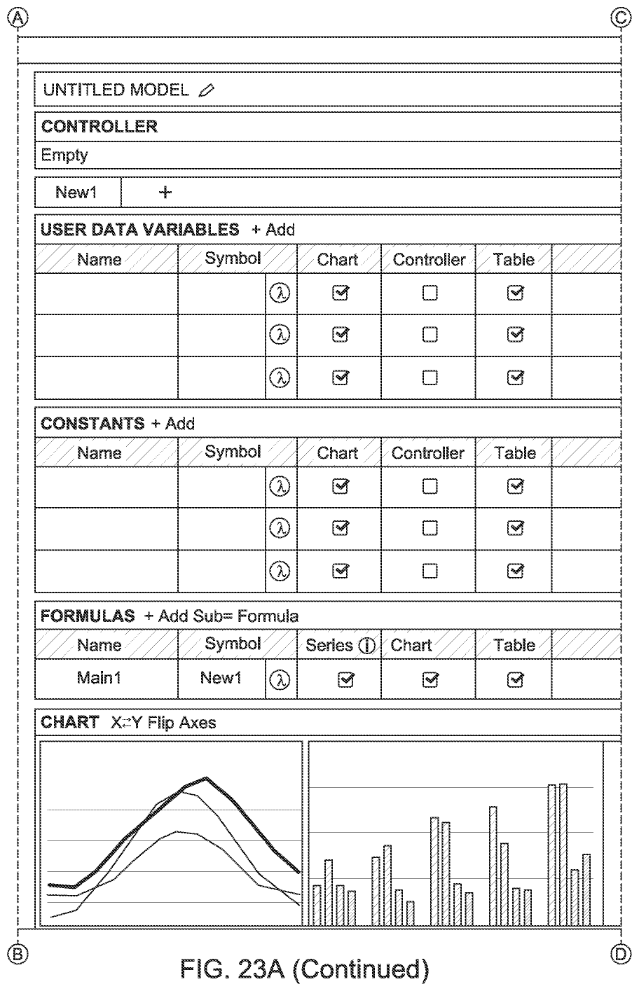

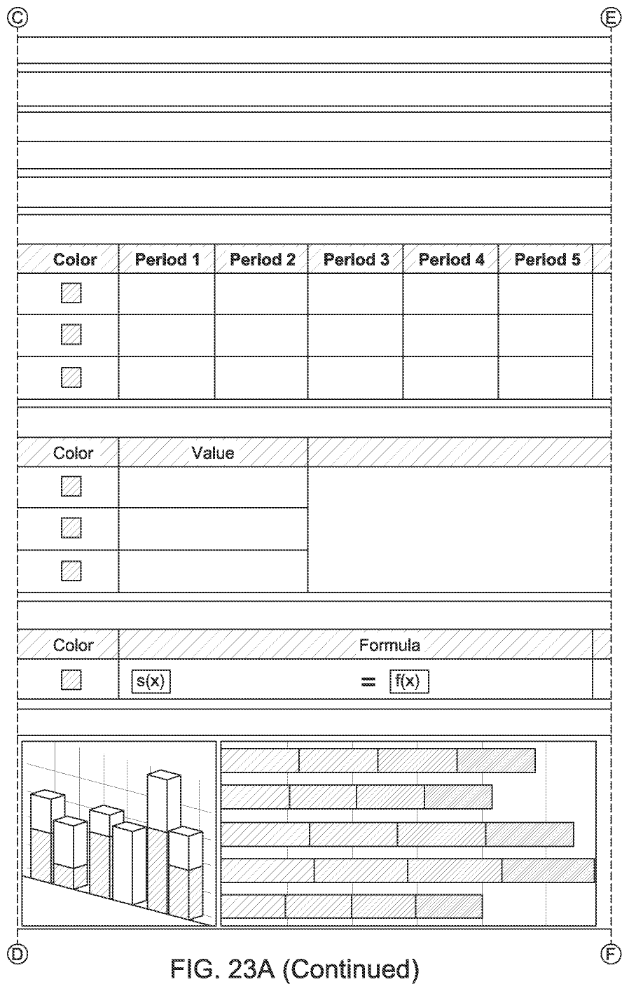

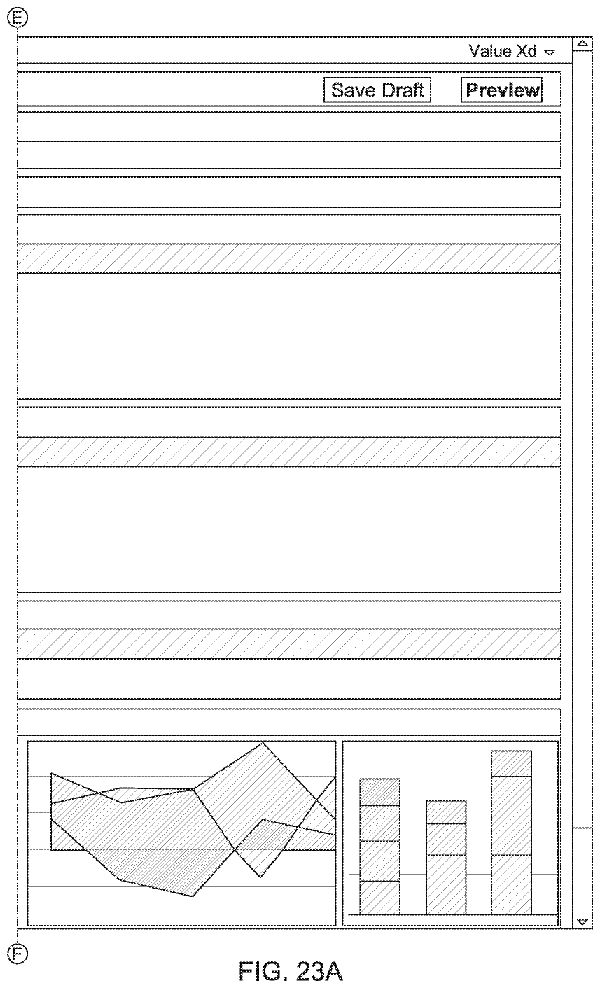

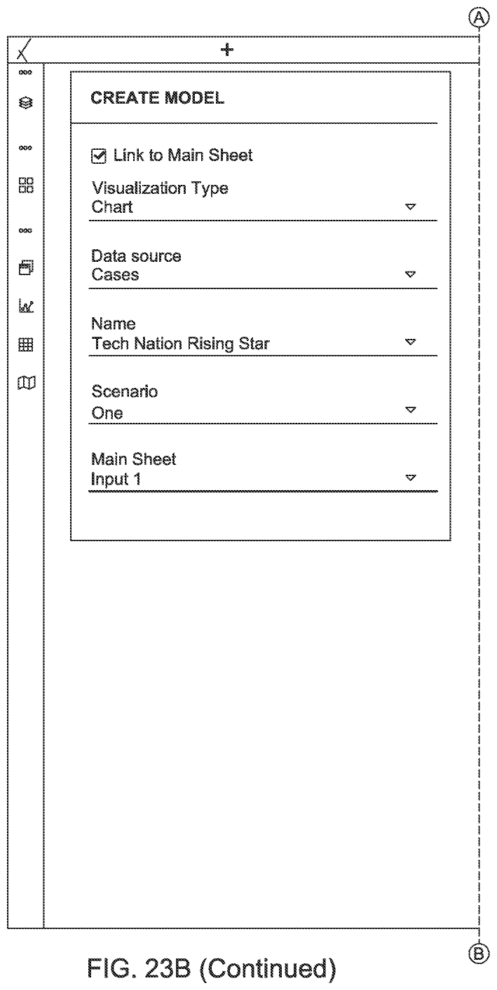

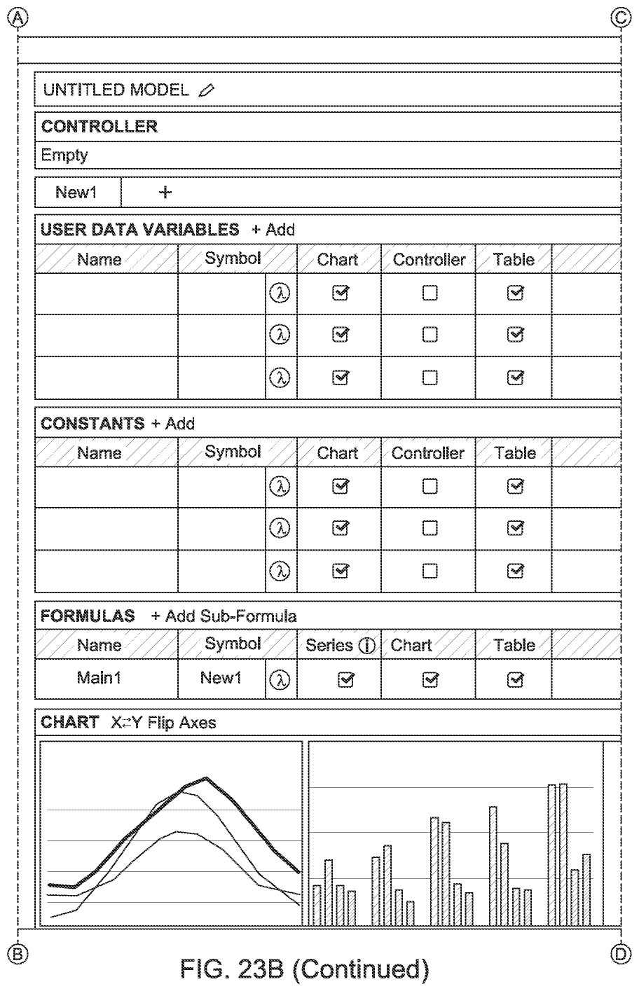

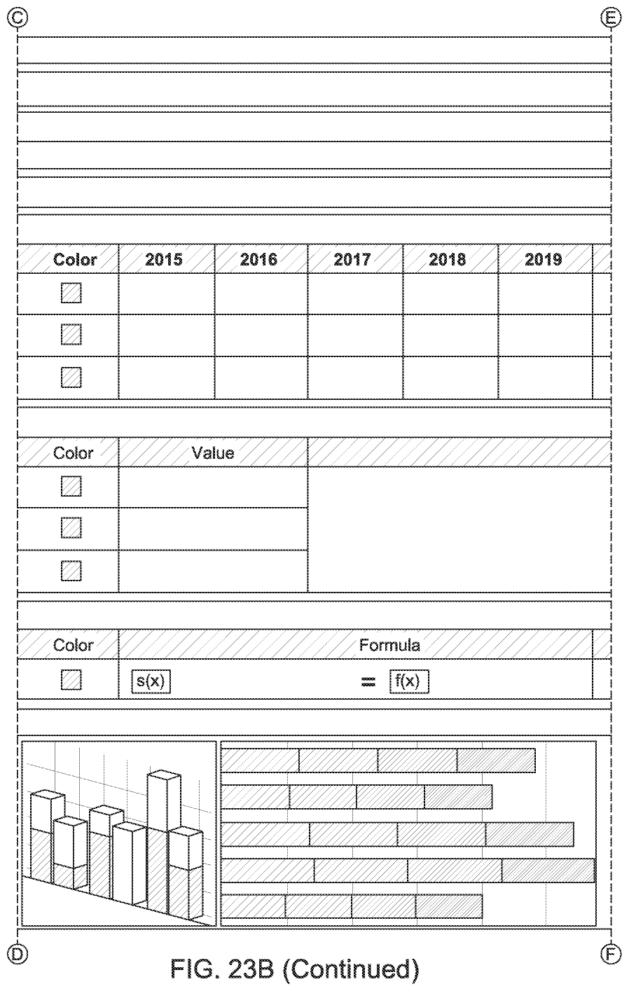

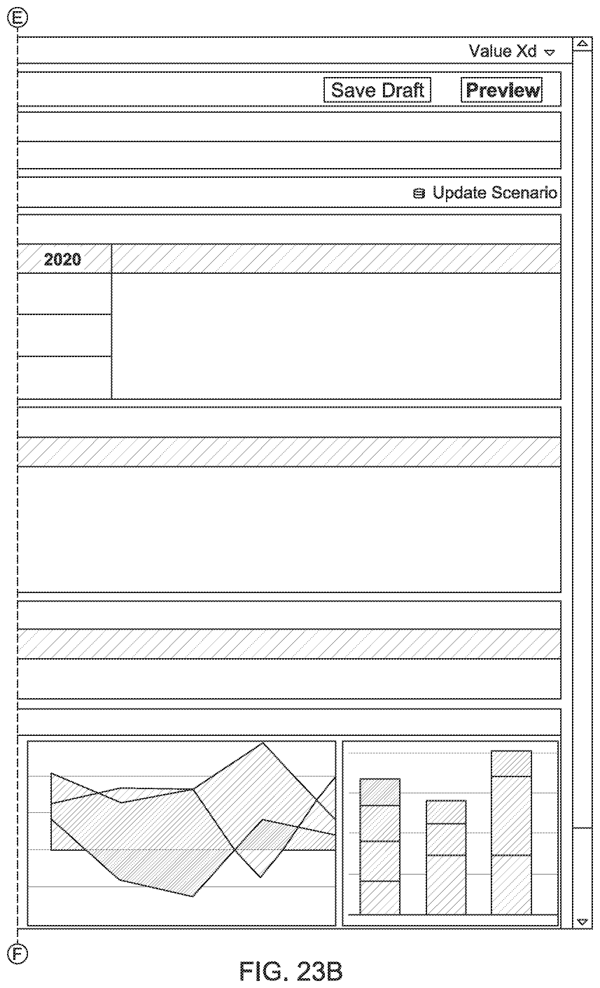

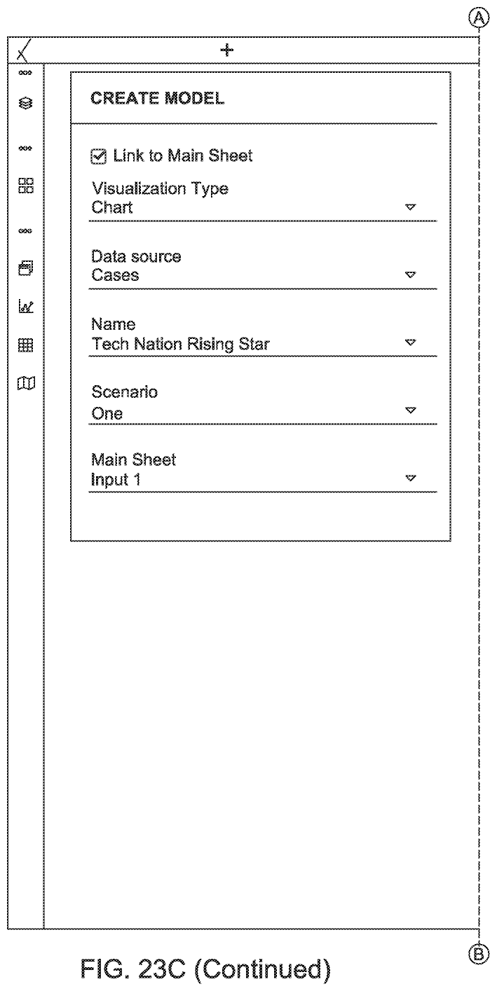

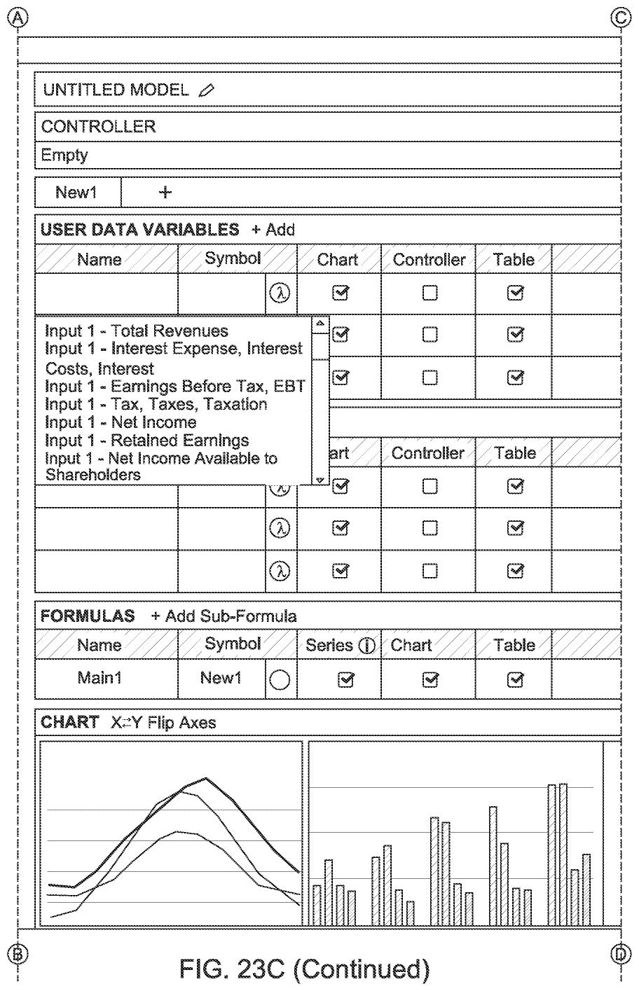

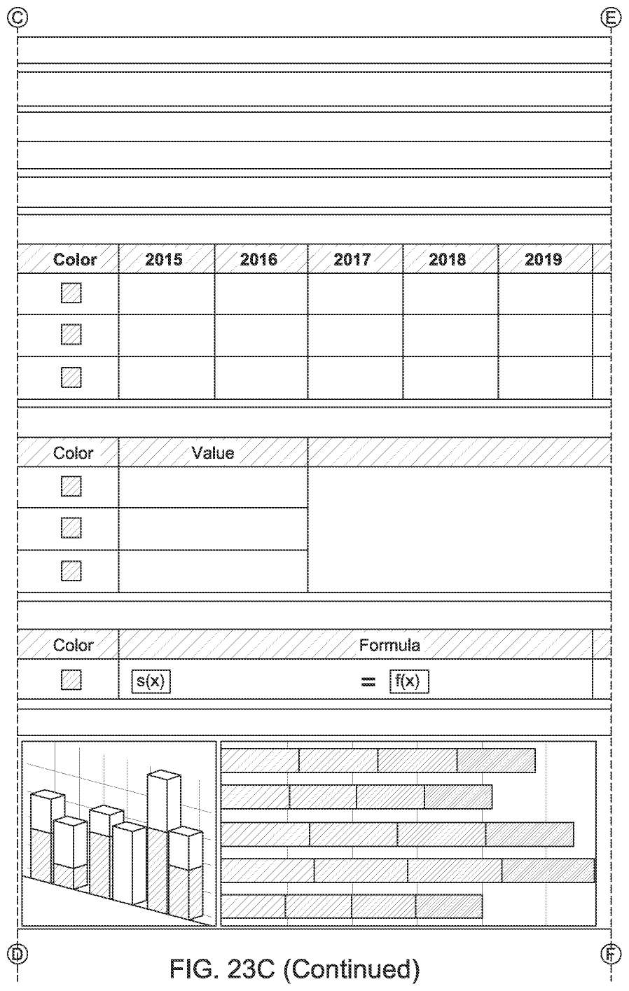

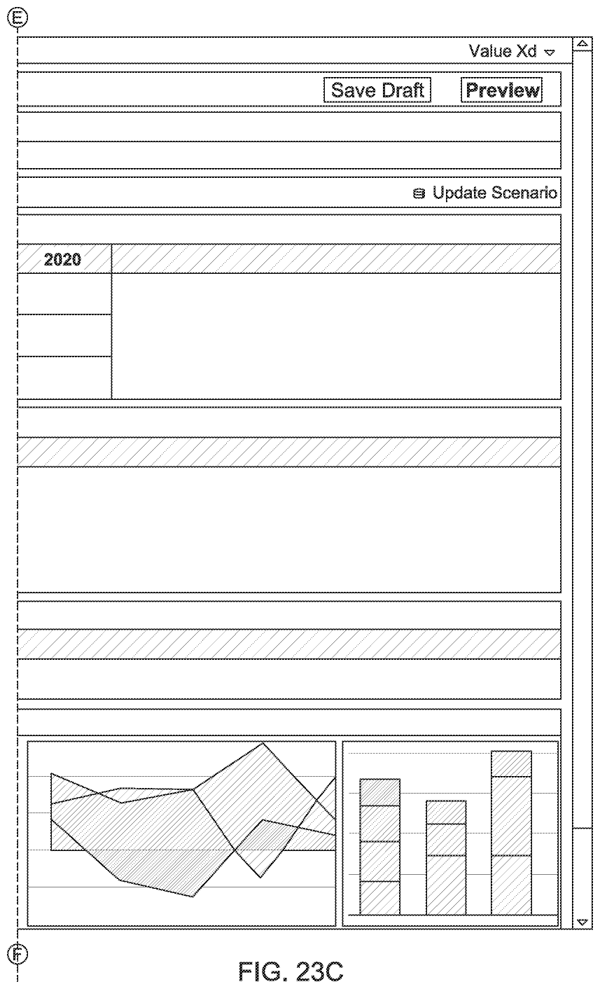

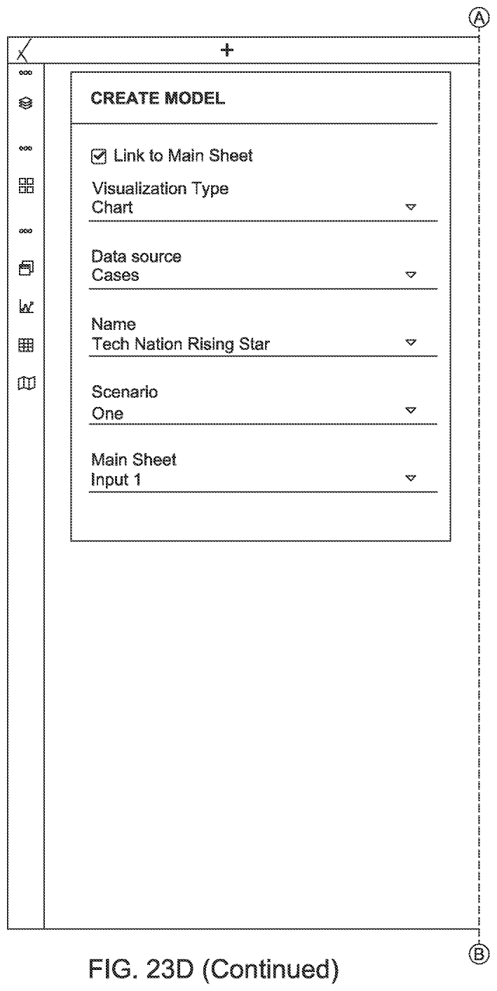

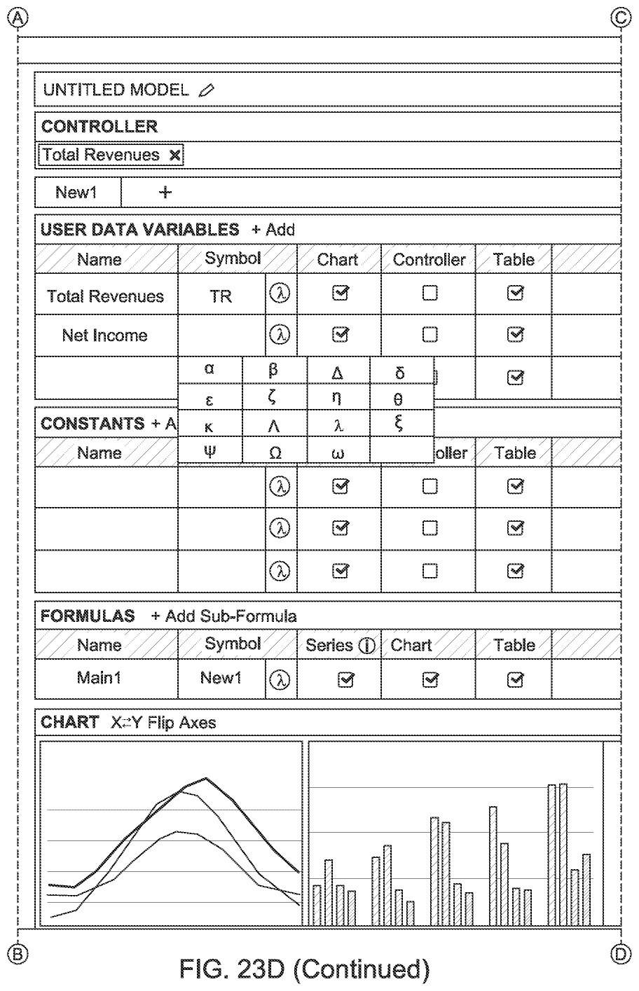

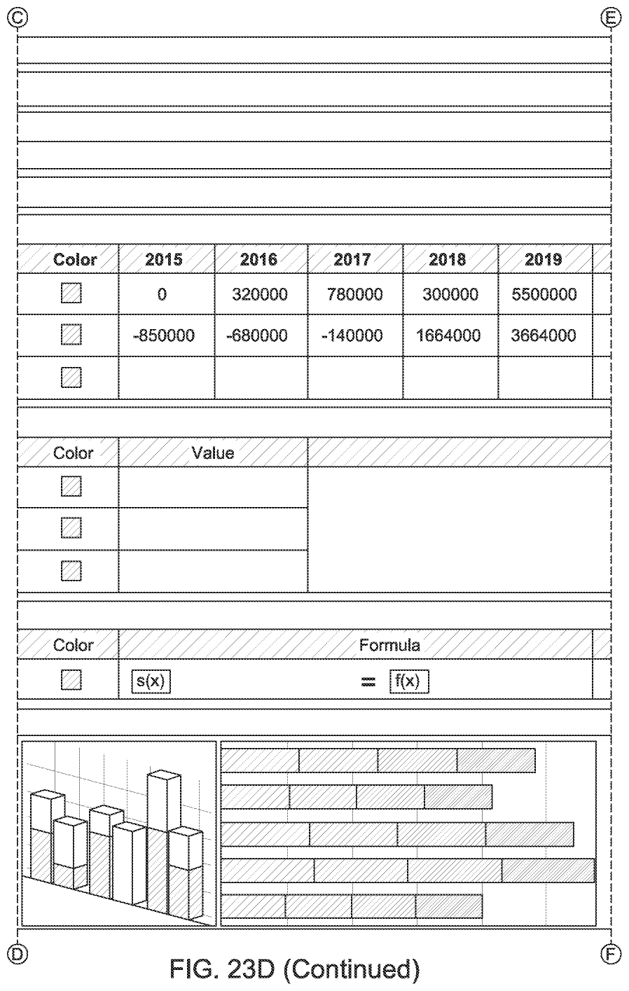

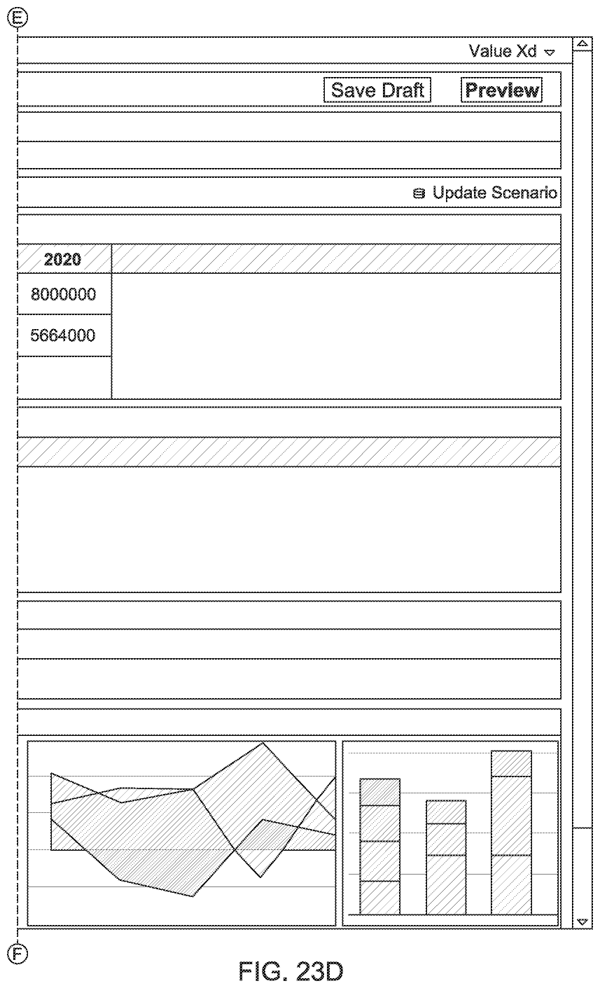

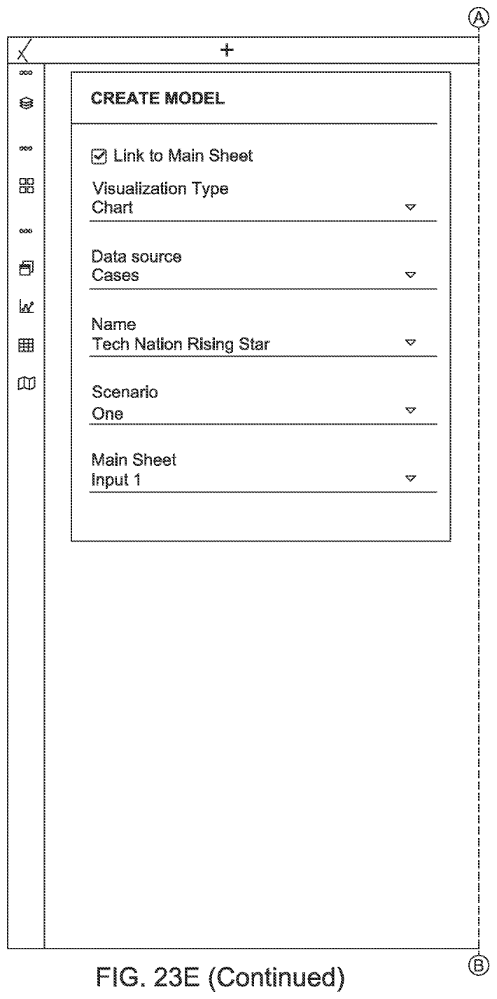

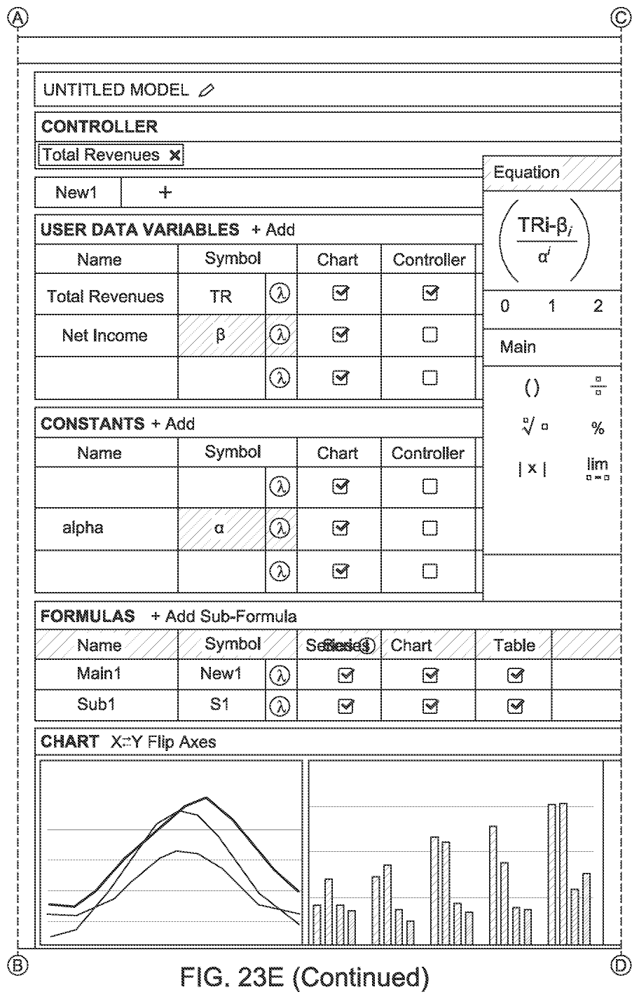

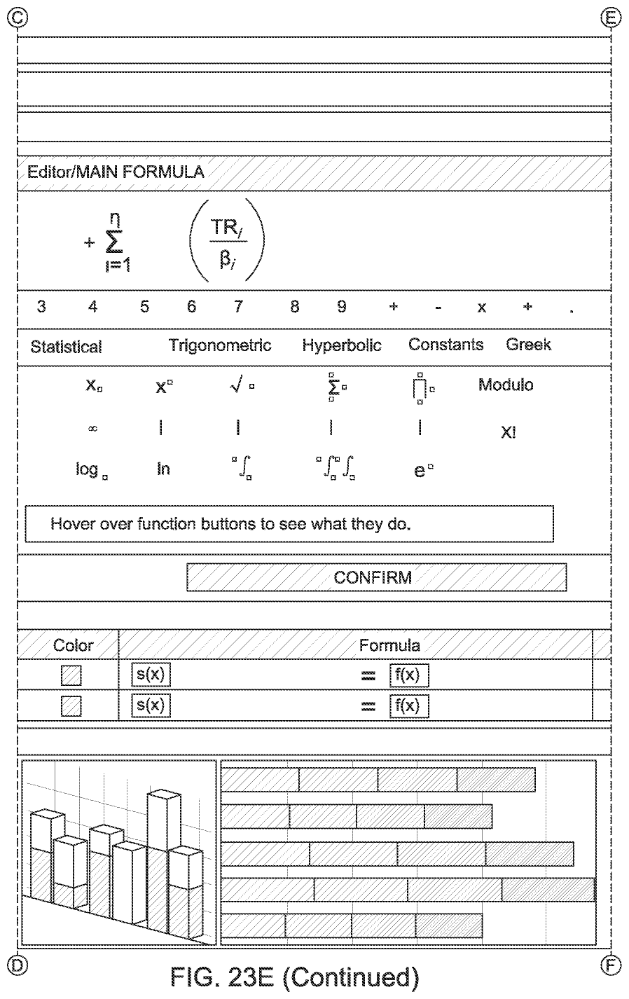

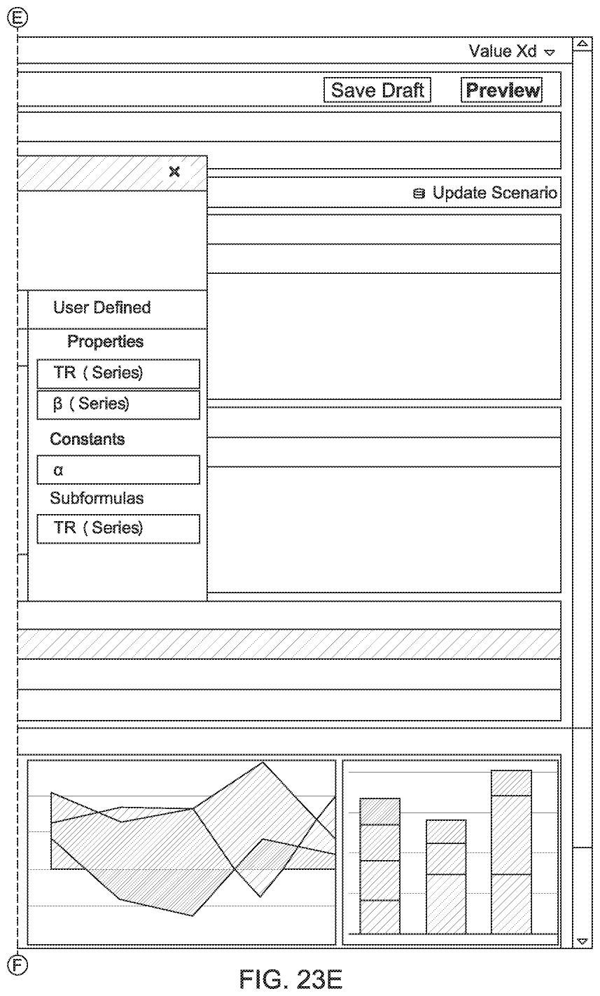

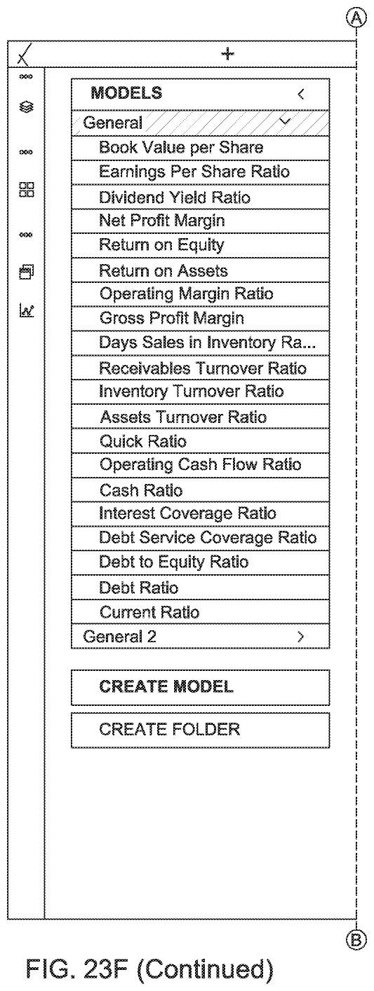

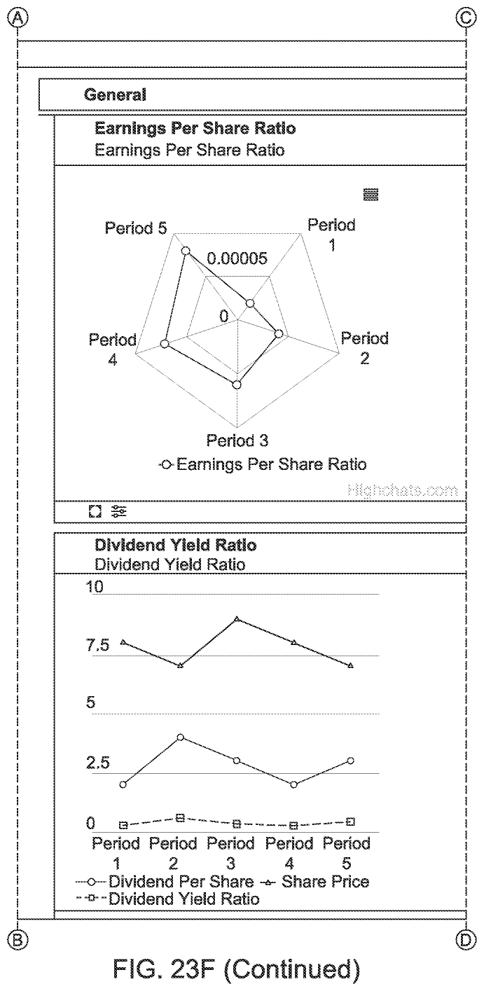

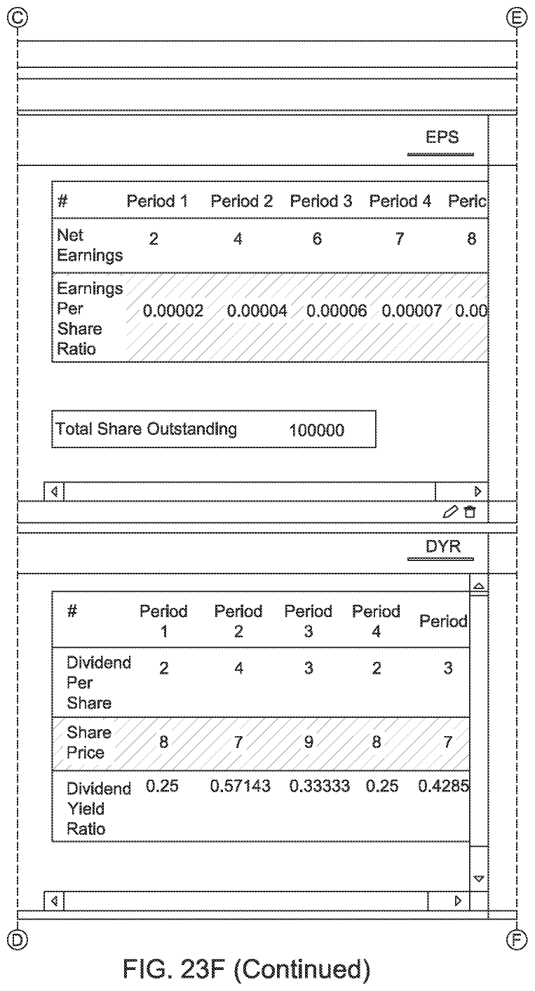

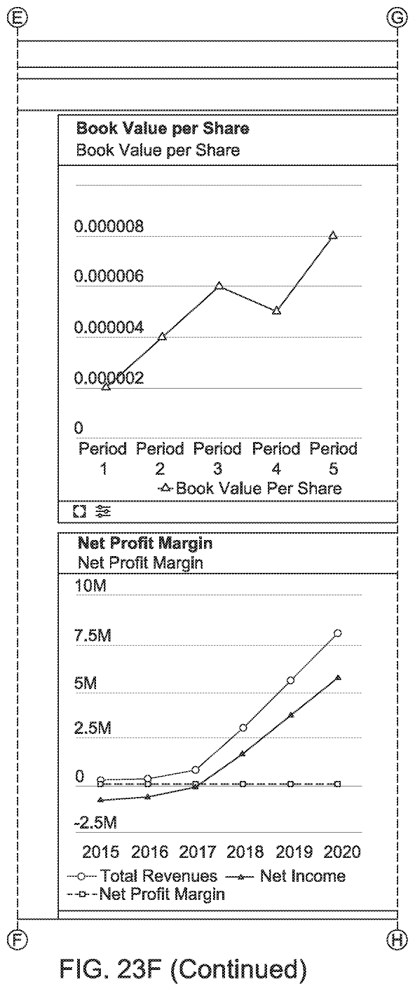

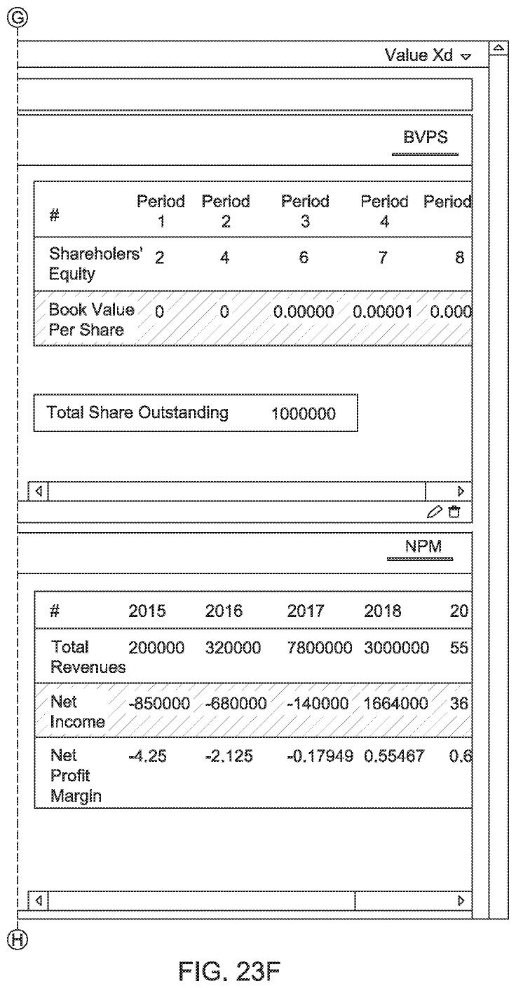

A user can select to create models. Upon this selection, the user interface directs the user to a new Model page (FIG. 23A). Linking the model with the main sheet for example is optional. For example, a user can define the periods or axis elements of the user's model, and input the variable directly into the form. Preferably a user may select from a number of visualisation types such as charts or diamonds.

A user may select the number of periods to use for the model. If a user selects the Link to Main Sheet option, the Number of periods section will disappear and instead a user is prompted to identify the Data Source to be used. The user may select data source type from a CASES folder for example, a project name from the SCENARIO section, and a main sheet from a MAIN SHEET section (FIG. 23B). Once the main data sheet is selected, the axes of the model will be defined. All the constants in the scenario, as well as all the variables in the main sheet will now be available for use within the model. If there are any other sheets in the scenario with matching axes, the variables on those sheets will also be available and accessible in the creation box. The variables are accessed by double clicking on the empty variable rows, as in FIG. 23C.

Once selected, variables are brought into the panel/model creation page, and the user may assign specific symbols, including Greek symbols to the variables selected for the model. The user can also edit the data on the spot, and make changes to the underlying data scenario by clicking update new scenario button (FIG. 23D)

The controller checkbox may be used to assign specific variables and or constants to the Controller, described above, to access variables from the front end, allowing for later fine tuning and further simulations of possible outcomes.

### Formula/Equation Editor

With reference to FIG. 23E, a tool is preferably provided to define for example a Main formula of the new model. Sub-formulas may be added/deleted as desired. The model/panel creation interface allows the user to enter inputs such as formula name, select symbols, series, charts, tables, colours etc, and to create new equations in the formula section.

In an example, a user may can create their own equations in the formula section that has two main parts:

f(X) is the equation editor where formulas and sub-formulas may be input and created;
s(X) is the symbol editor, where a symbol may be input for the main formula or sub-formulas.

The symbol editor works just like the equation editor, but it is purely to design the descriptive formula symbol when necessary.

A user may click on the f(X) button in the box to expand the Equation editor that contains a variety of functions to help create their own formulas. (FIG. 23E). The User Defined variables, constants, and sub-formulas appear in the f(X) equation editor, and not in the symbol editor, which is a descriptive tool to help you define a specific right side to the equation.

A user can choose from various categories of functions that will help create own formulas. In an example, there are six categories of functions: main (e.g. modulo, nth square root of the expression, %, etc), statistical functions (e.g. sample variance, sigma squared, sample standard deviation etc.), trigonometric functions, hyperbolic functions, constants functions, Greek letters, and user defined functions. In this example, on the right section inside the f(X) equation editor window, there is a user defined section where the Properties, Constants and Sub formulas defined by the user will be listed. It will be appreciated that they can be one or many. This section may be automatically filled by the symbols ascribed to the user's variables and constants and sub-formulas. They are automatically brought into the editor to use and include in the formulas.

A user can click on the top of the equation editor window and drag it freely around the create model's page. After a user finishes writing/creating the formula(s) or sub-formula(s), they can click on the confirm button at the bottom of the equation editor window. The formulas and/or sub-formulas will be placed inside the corresponding boxes, and they may be clicked at any time to edit/re-write.

In a chart section, a user may select the style of chart visualisations, and edit the visualisations for example by flipping axes. Visualisation styles include for example, line charts, column charts, column 3D, bar charts, area charts, bar style, horizontal column charts, surface visualisations, pie charts, diamond style etc. Preferably models may be pre-viewed and saved in selected folders.

For example, when a model is created for the first time, it is created as a universal abstract tool in a models' catalogue. Therefore, a user would still need to apply it to a case or cases. Even if, for example, a user used a sheet in Case A to create a model, they would still have to include the model in a dashboard, and then apply the dashboard to Case A in order to get the desired full results and charts. This is the step two of the analytical value chain, where the user is creating Abstract analytical panels, which can be models, charts, maps or tables.

Advantageously, all the charts, models and maps are dynamic and interactive inside the panels or presentations. A user may click on a model name inside the sidebar of the user interface and drag to change the location inside its folder as well as move it to another folder. For example, a grey copy of the name will show where it will be located when the users release the mouse click.

After a model is moved, the panels may be re-organized according to the change you made inside the folder. A user may also click on any panel and drag it anywhere before or after to change the location. For example, a grey copy of the panel will appear and the rest of the panel will re-organize accordingly. The models' name list in the sidebar will be updated accordingly.

All the models available in a folder are preferably listed in the user interface (FIG. 23F): for example, a user can scroll down to check, expand, check the variable's controller, delete or edit a specific model.

### Abstract Panels: Charts

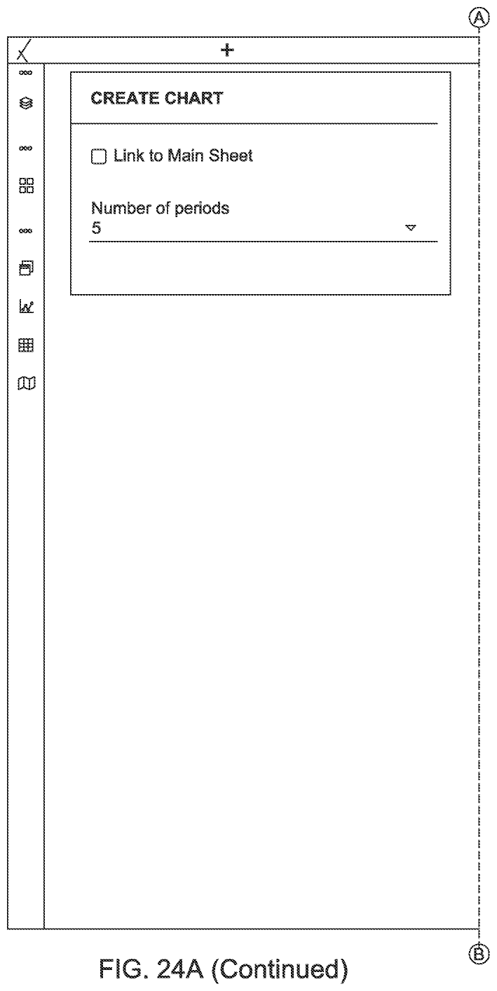

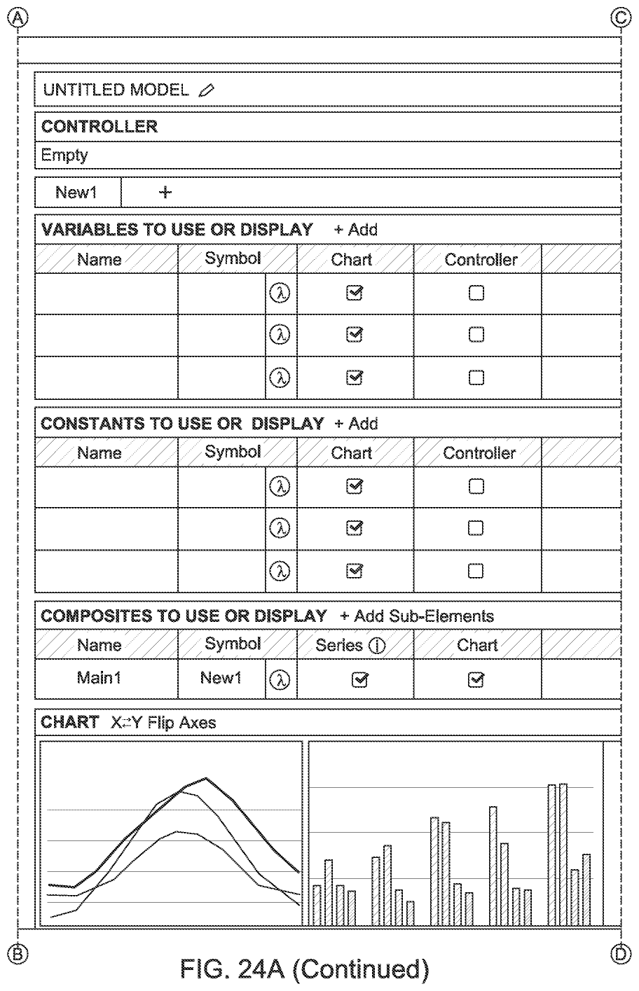

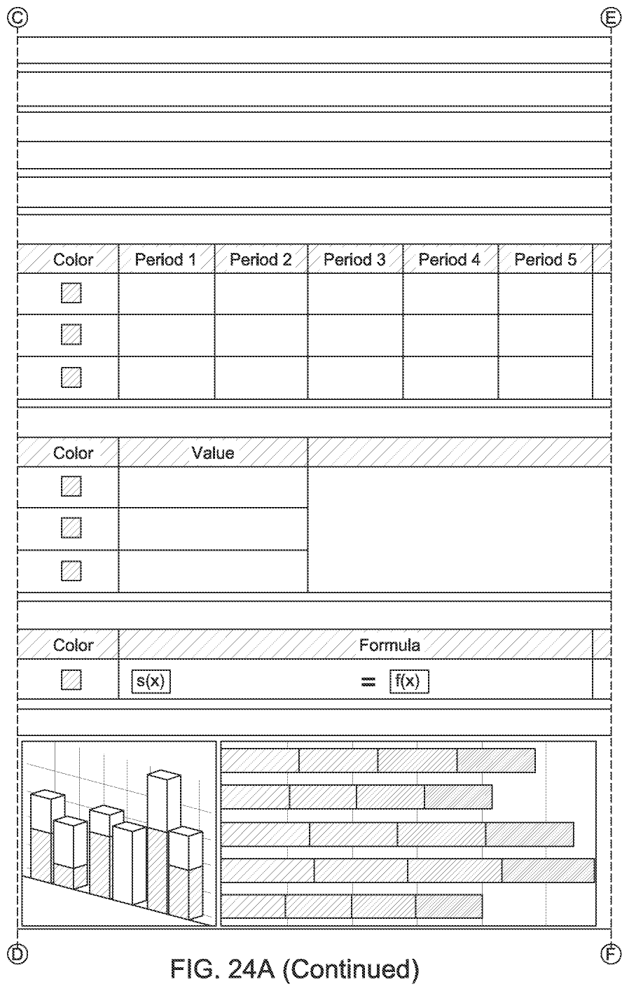

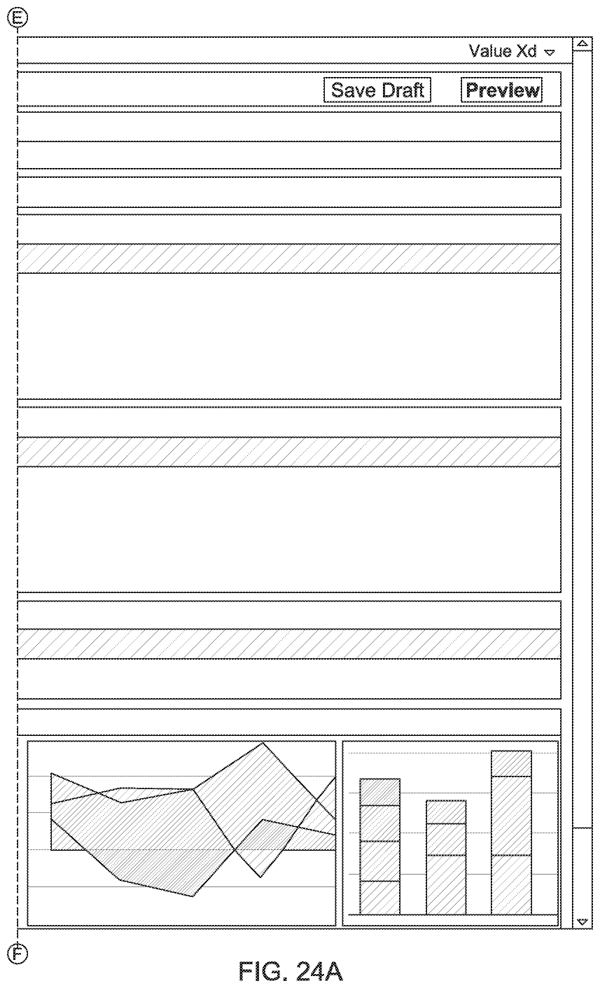

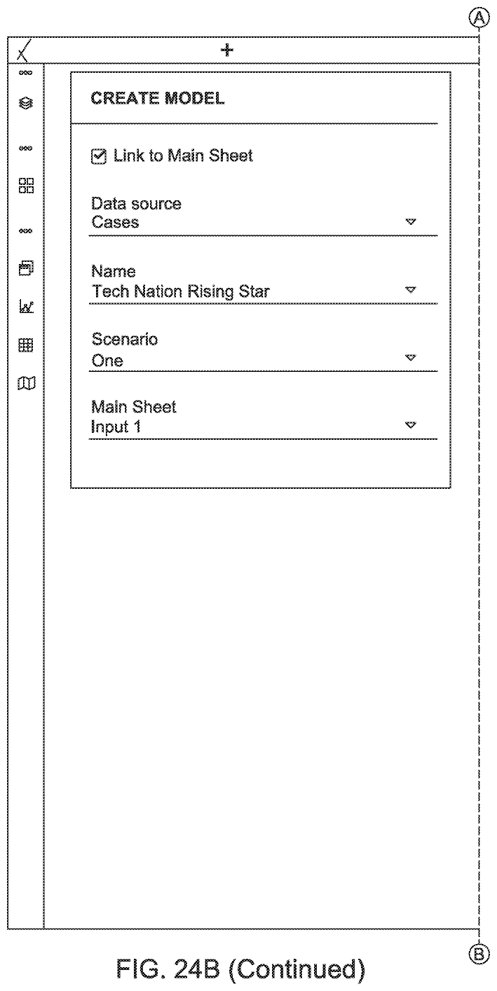

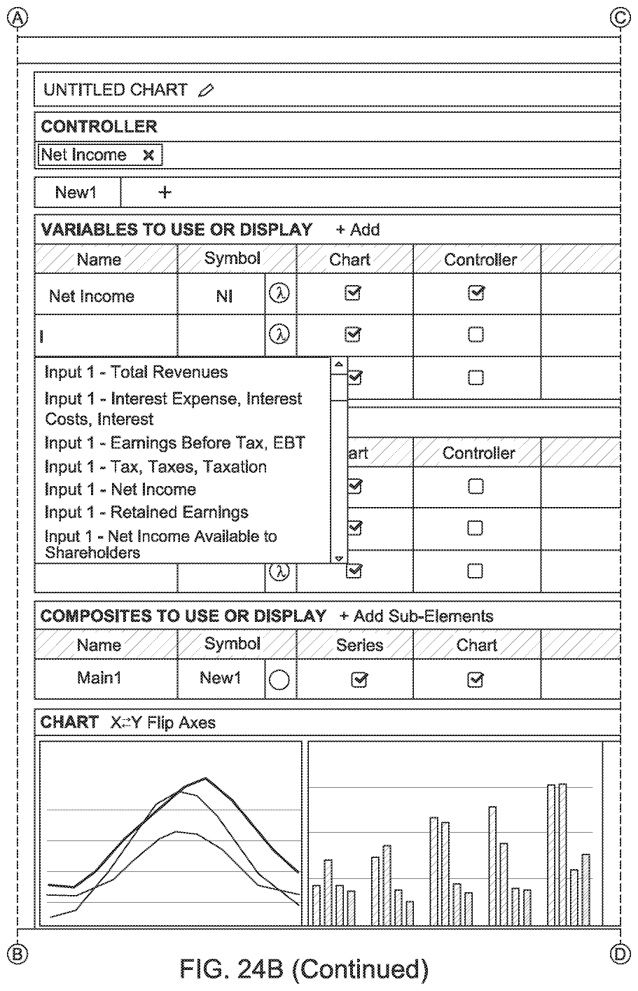

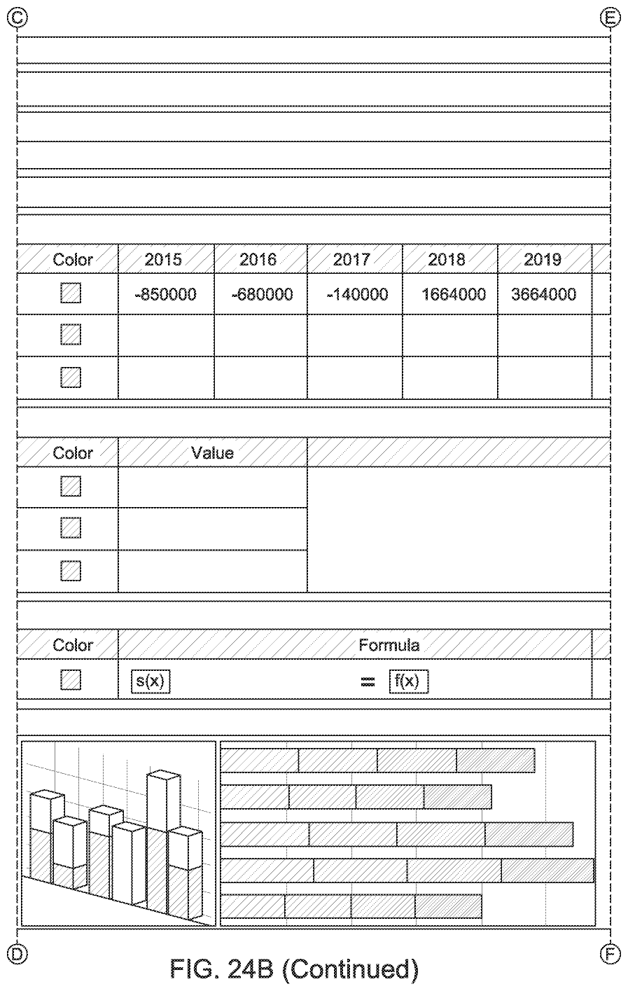

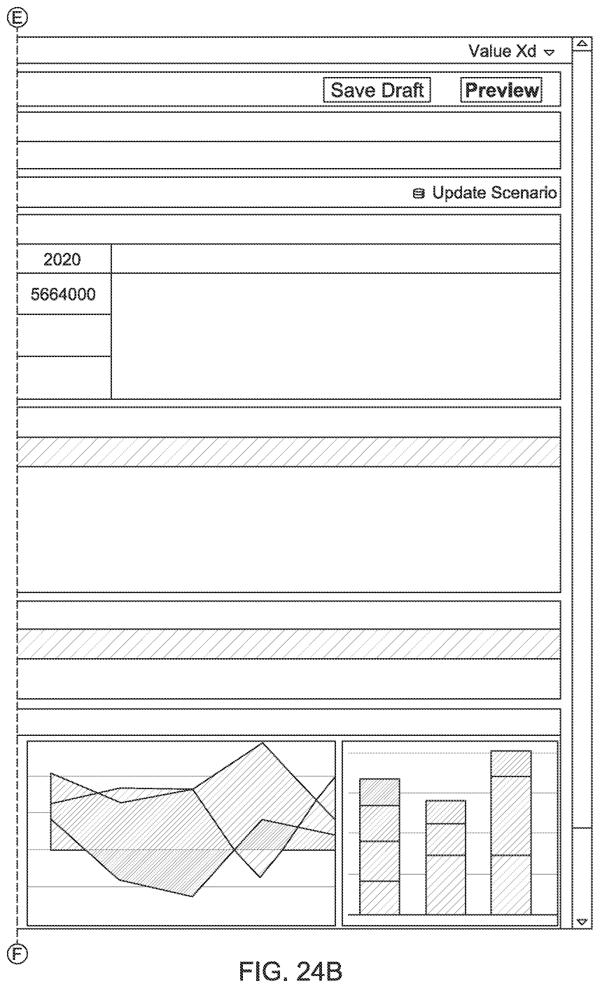

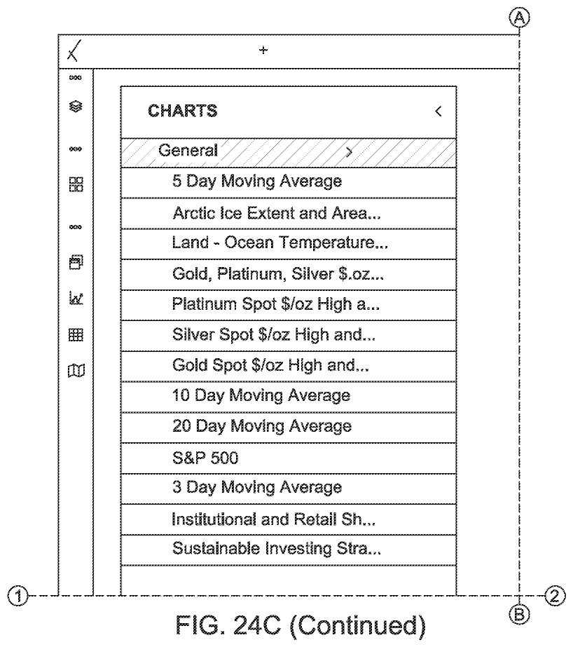

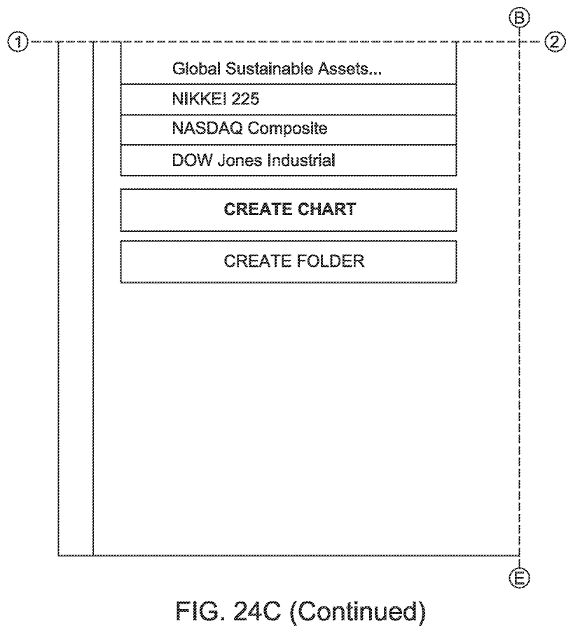

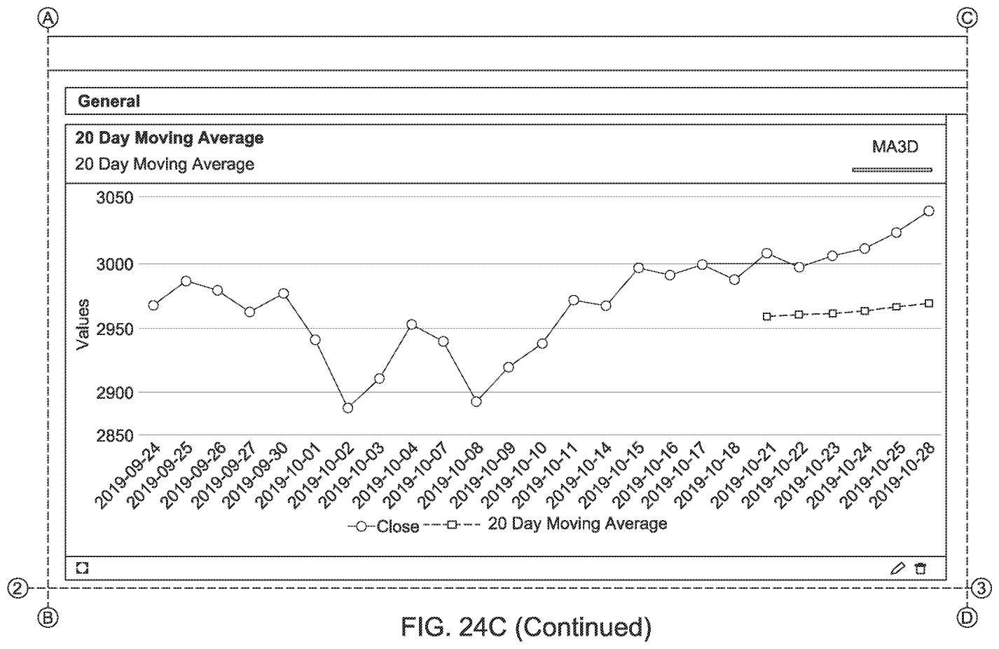

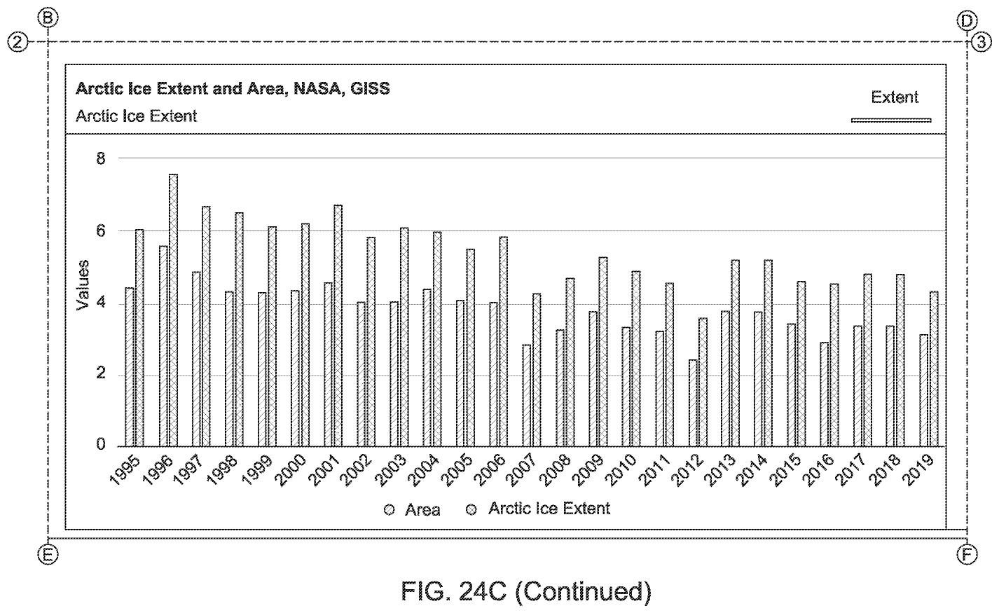

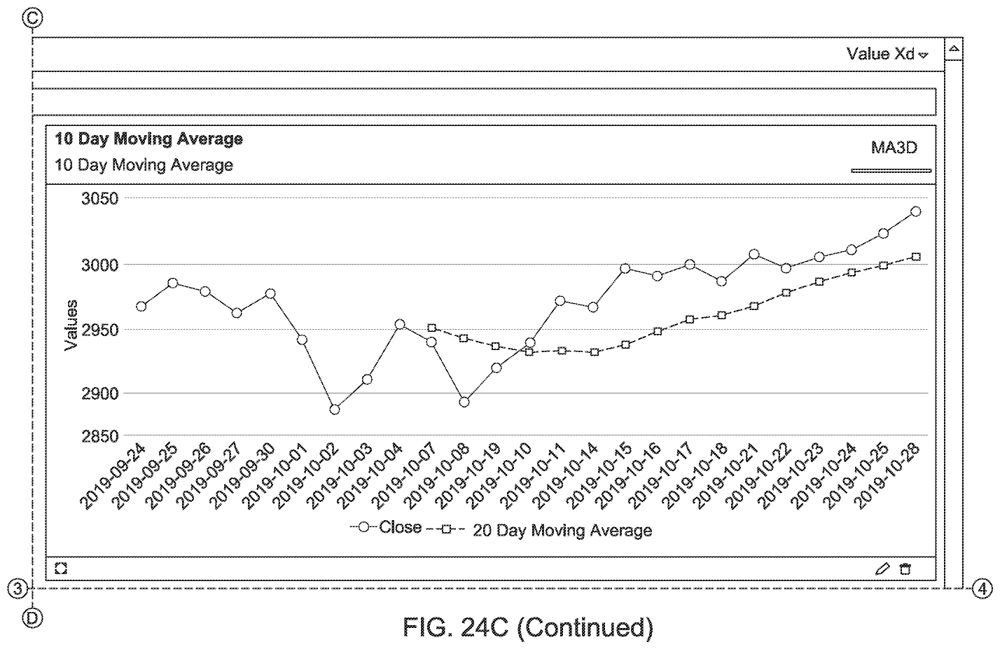

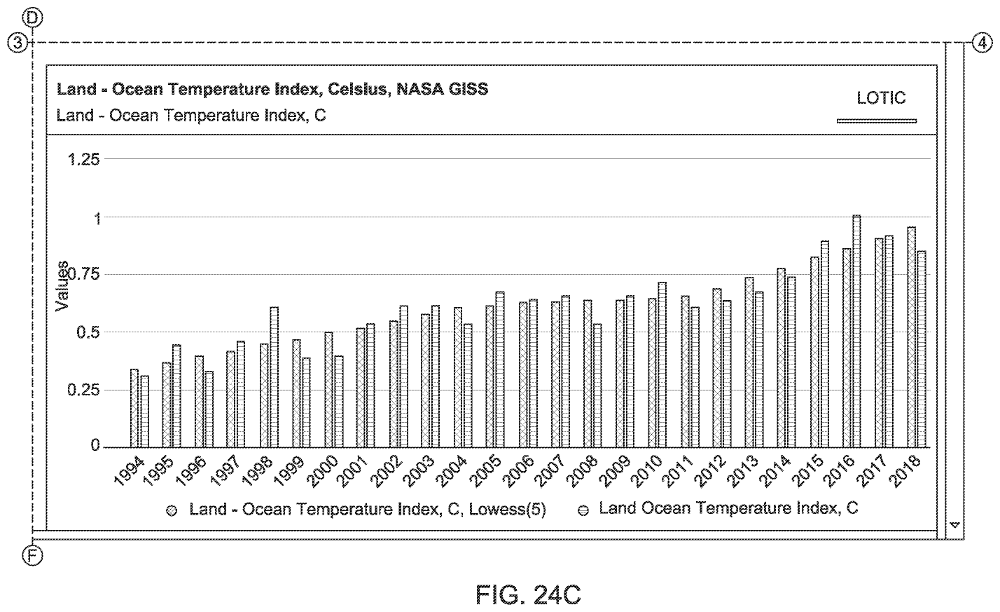

A user can select to create charts. Upon this selection, the user interface directs the user to a new Chart page (FIG. 24A). Linking the chart with the main sheet for example is optional. For example, a user can define the periods to use for the chart. Similar inputs to those described for creating a model as above are available.

The controller may be used as described above to access/edit variables from the front end to use or display and/or constants to use or display in the new chart.

Preferably, if the chart has been linked to a main sheet (FIG. 24B) when users double-click inside a name cell, they will see a list of variables you can select from. This list of variables is made up of all the variables on the main sheet, as well as those on other sheets in the same case/scenario that have, or include, the same axis. If the chart is not linked to a main sheet, then users may be able to double-click and input the name of the property or variable to display directly into the name box. Preferably users may insert a desired symbol (e.g. Greek letter) for each of the chart variables. For example, a 5 letter symbol may be attached to variables and constants. Users may preferably select colours for the variables. Similarly, the user may edit constant's attributes including name, symbol, colour, value etc.

The number of periods may be selected by users. If the chart is linked to a sheet, then the axis elements of the selected sheet may show instead. It is possible to update a scenario when it is linked to a main sheet. Whenever any value is changed, the main sheet may be updated. Preferably, a warning message is displayed indicating that updating the scenario data might affect the output of other models, charts, maps etc that are using this scenario as their data source. Moreover, if a value cell is left blank in the model, they may be treated as zeroes when overwriting the properties and constants of the scenario.

Users may also a Main Composite of the new Chart. This is to make it easy for the user to show a variable in the chart that is not yet available as a variable or constants, and needs calculation. This works just like the models' section, and attributes of the composite including name, symbol etc may be edited in the user interface. For the composites, user may create their own equations using the formula/equation editor as described above.

In a chart section, a user may select the style of chart visualisations, and edit the visualisations for example by flipping axes. Visualisation styles include for example, line charts, column charts, column 3D, bar charts, area charts, bar style, horizontal column charts, surface visualisations, pie charts, diamond style etc. Preferably models may be pre-viewed and saved in selected folders.

The controller may be also be used as described above to access/edit variables from the front end to use or display and/or constants to use or display in the new chart.

Similarly to models, all the charts available in a folder are preferably listed in the user interface (FIG. 24C); for example, a user can scroll down to check, expand, check the variable's controller, delete or edit a specific chart.

### Abstract Panels: Tables

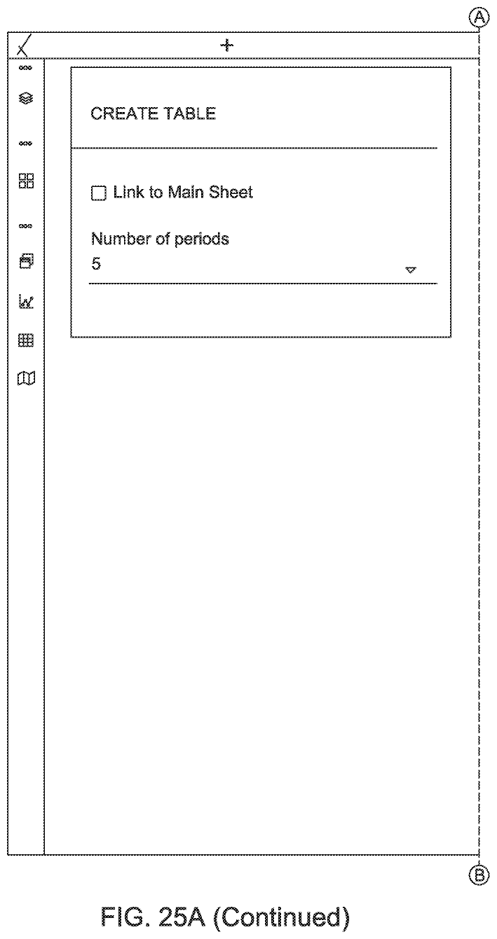

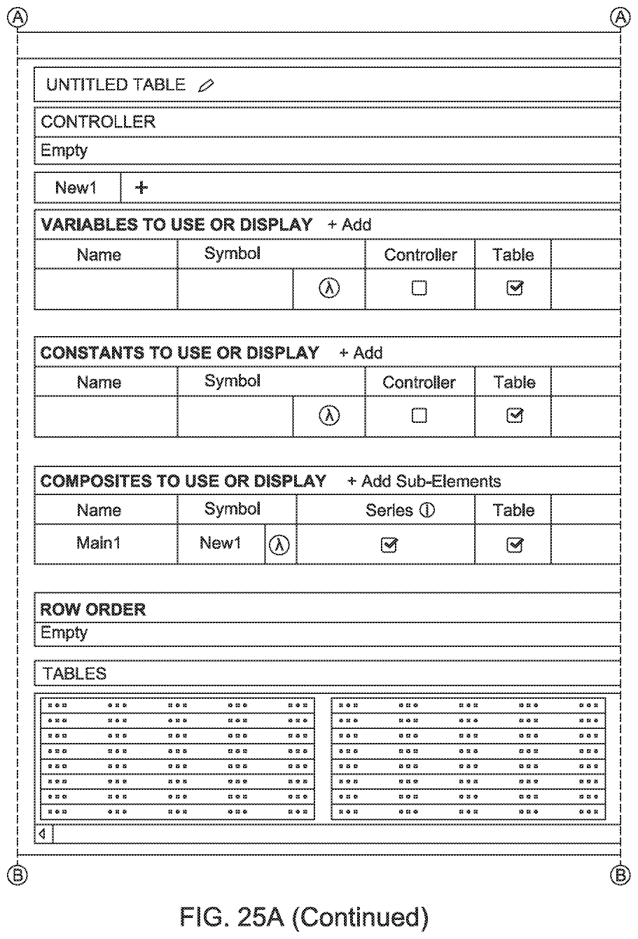

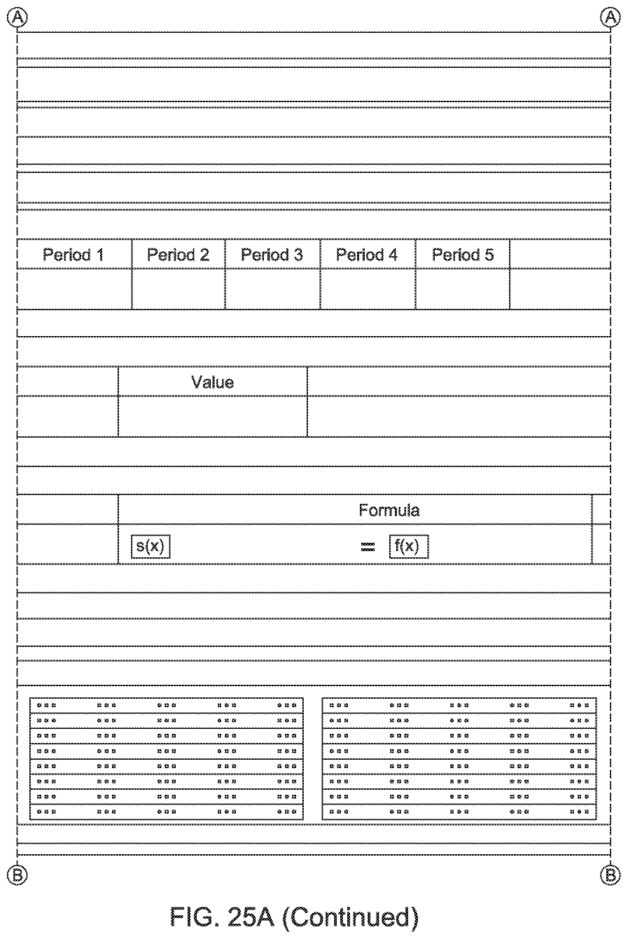

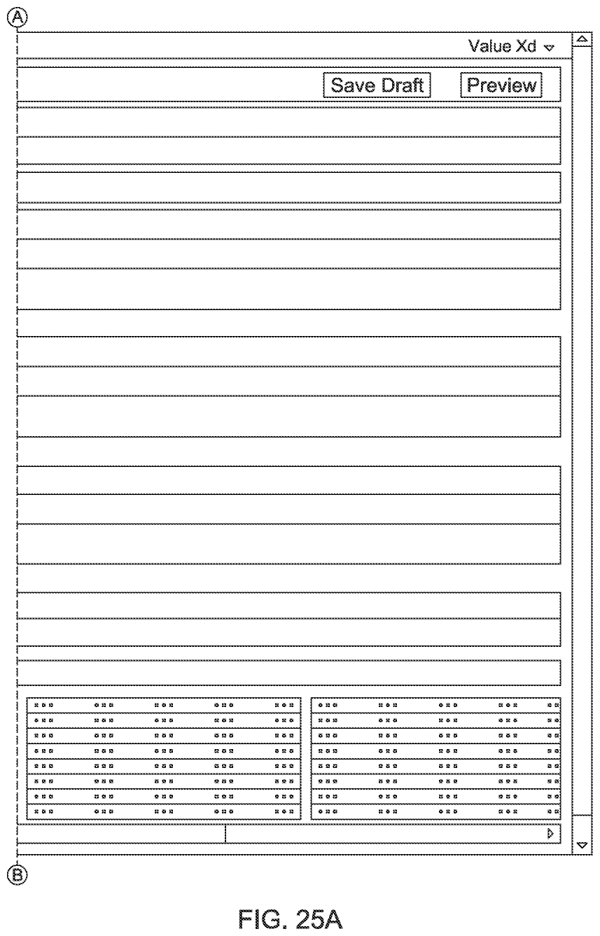

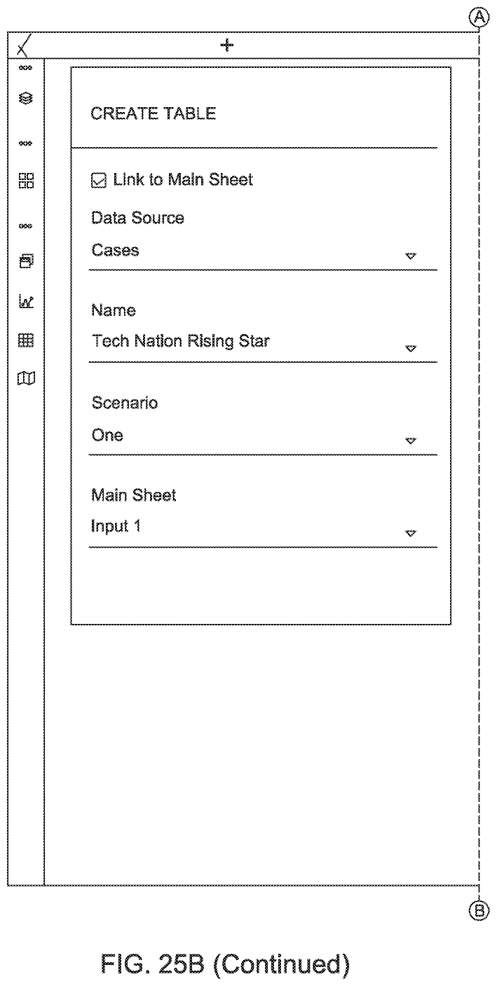

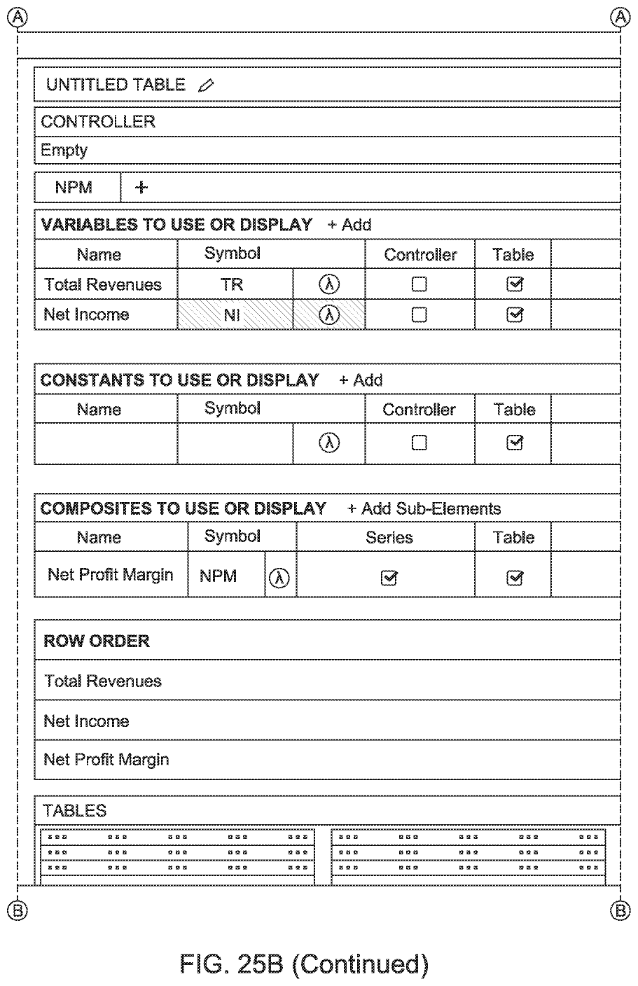

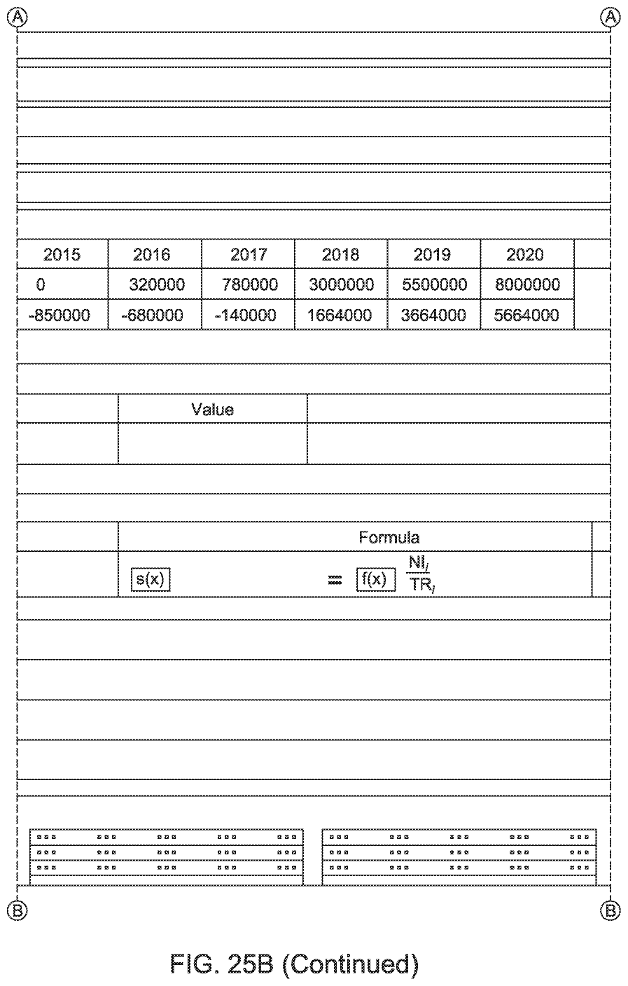

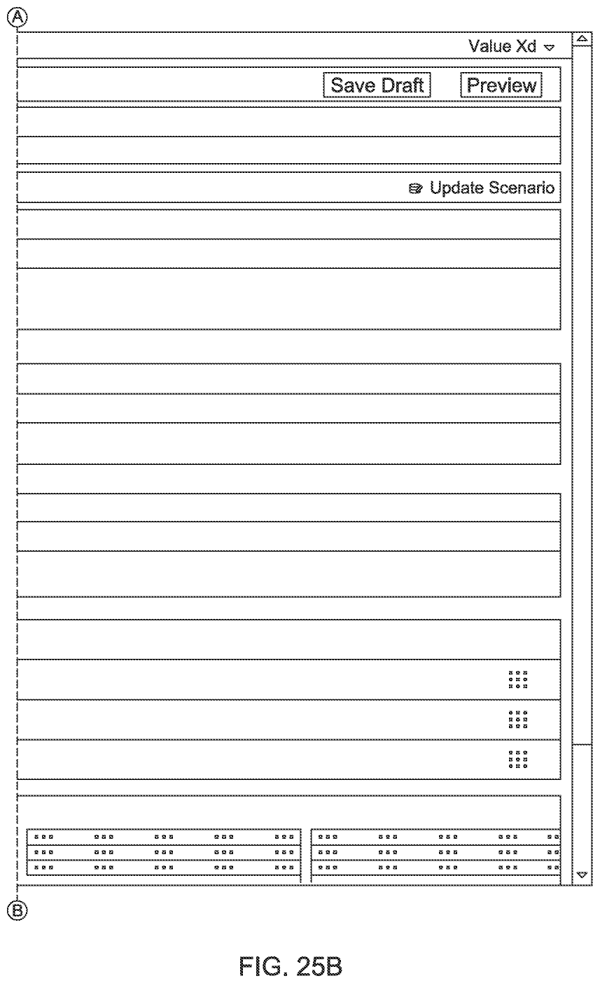

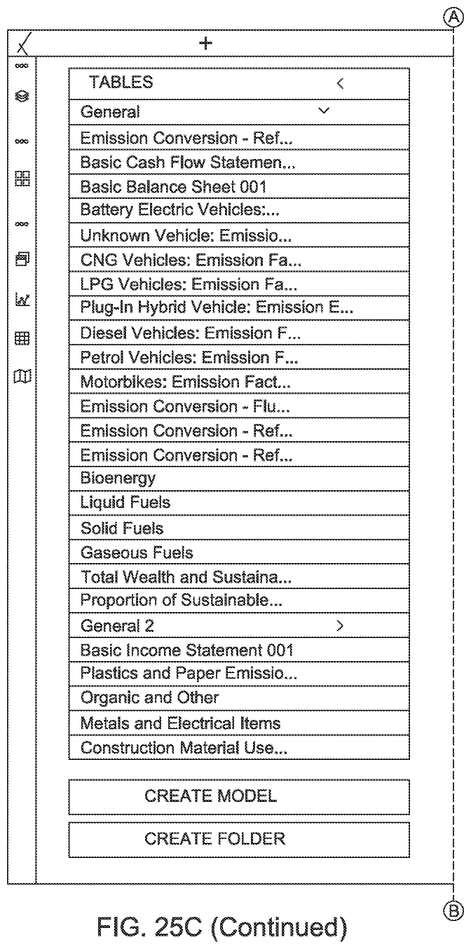

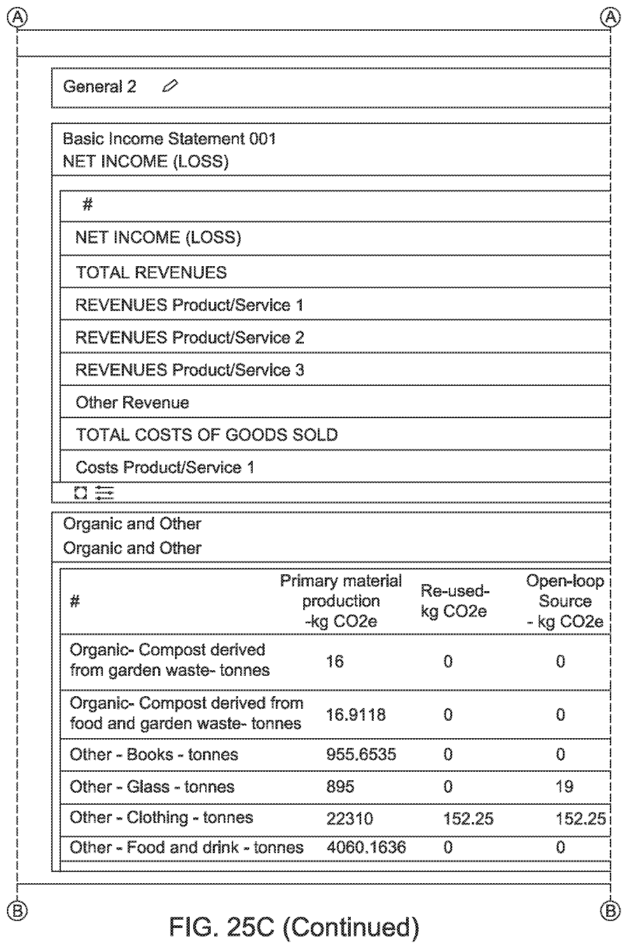

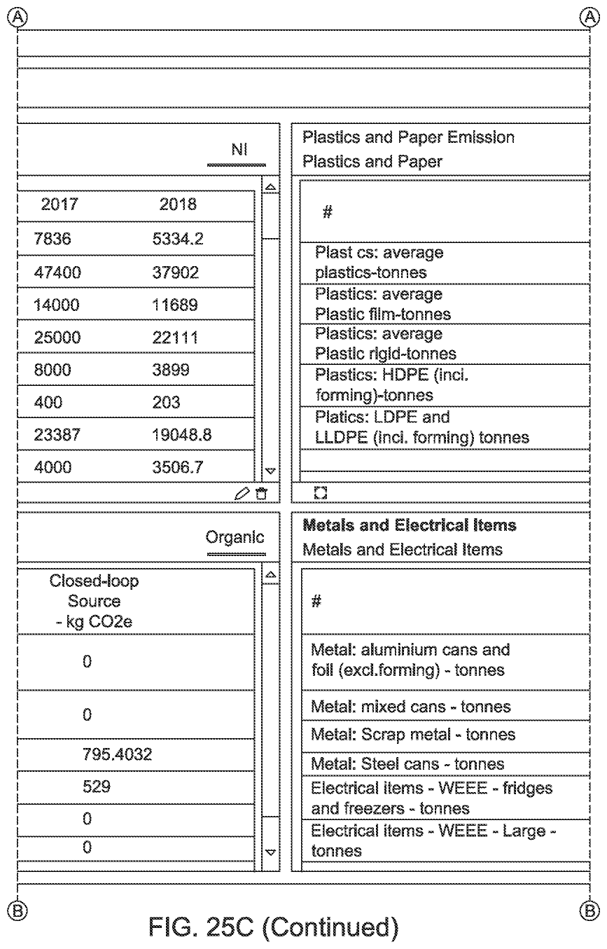

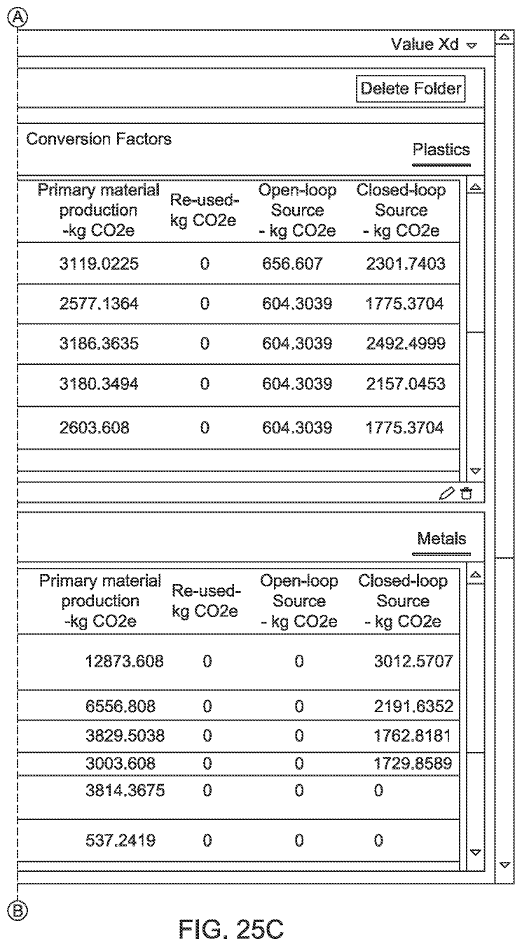

A user can select to create tables. Upon this selection, the user interface directs the user to a new Table page (FIG. 25A). Linking the table with the main sheet for example is optional. For example, a user can define the periods to use for the table. Similar inputs to those described for creating a model or chart as above are available. The controller may be used as described above to access/edit variables. As described in the Charts section above, users may also use a Main Composite this time for the new table. For the composites, user may create their own equations using the formula/equation editor as described in the sections above.

With reference to FIG. 25B, in a row order section all the variables, constants and sub-formulas checked to be included in the table are listed. The user can rearrange the rows for example by clicking on one row and dragging it up or down to change location, to create the ideal analytical design and flow for the table.

With reference to FIG. 25B, In the table section a user can select from the templates available in different colours. Tables may be previewed and saved in a tables' catalogue for example.

Similarly to models and charts, all the tables available in a folder are preferably listed in the user interface in a table catalogue (FIG. 25C); for example, a user can scroll down to check, expand, check the variable's controller, delete or edit a specific table.

### Abstract Panels: Maps

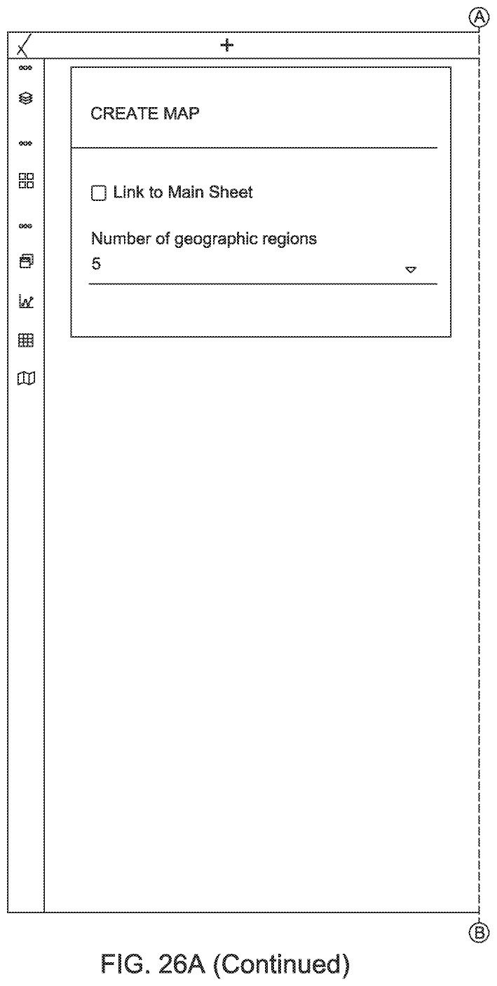

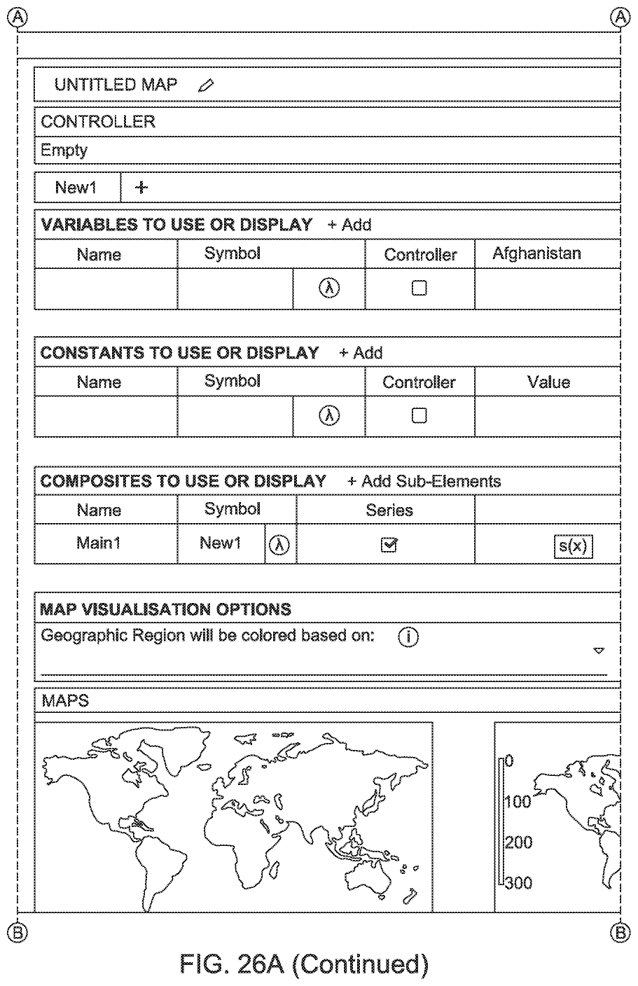

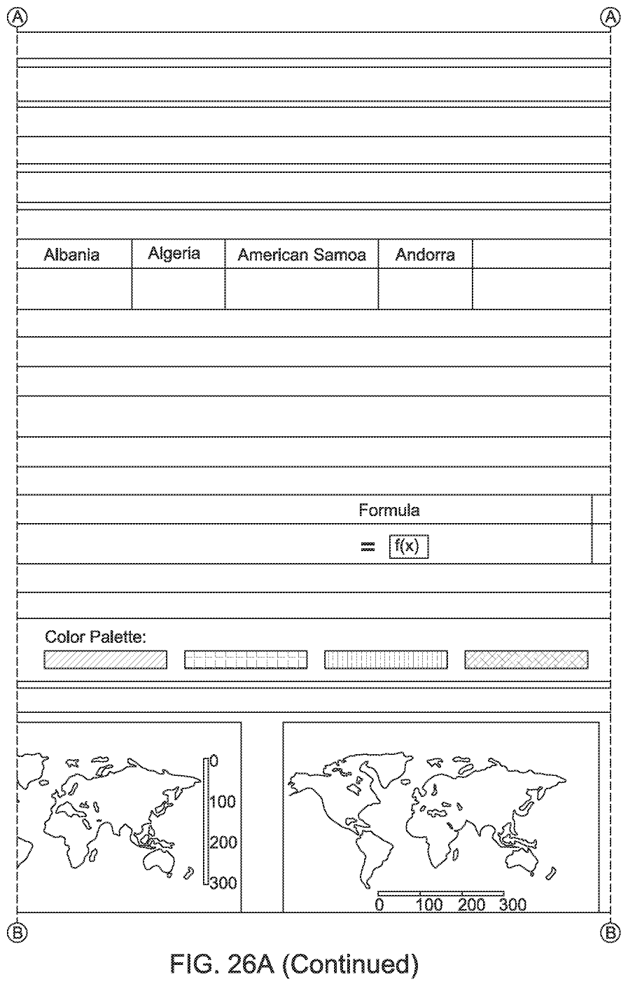

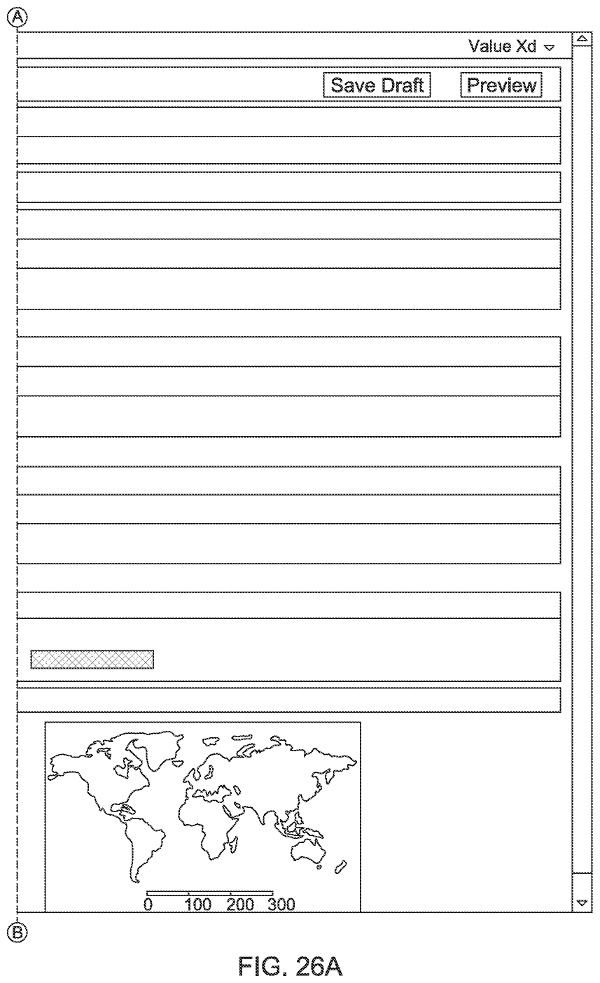

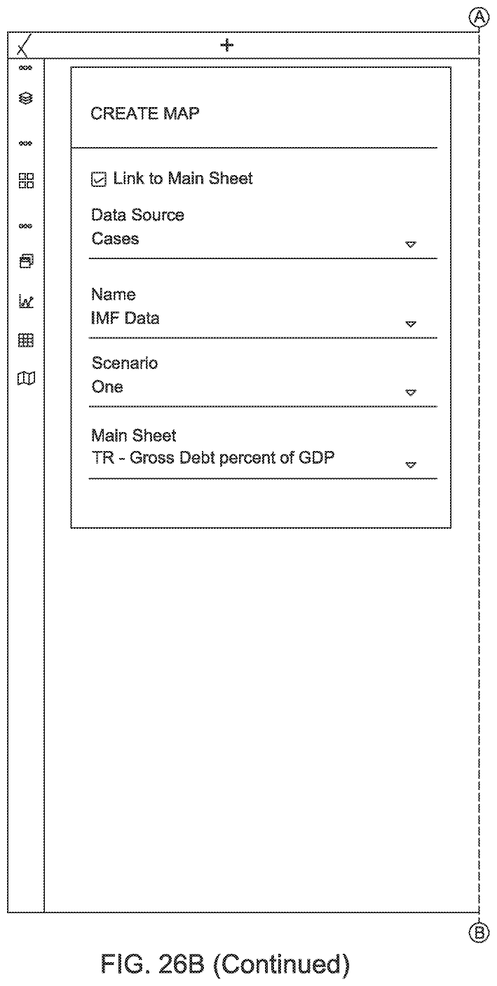

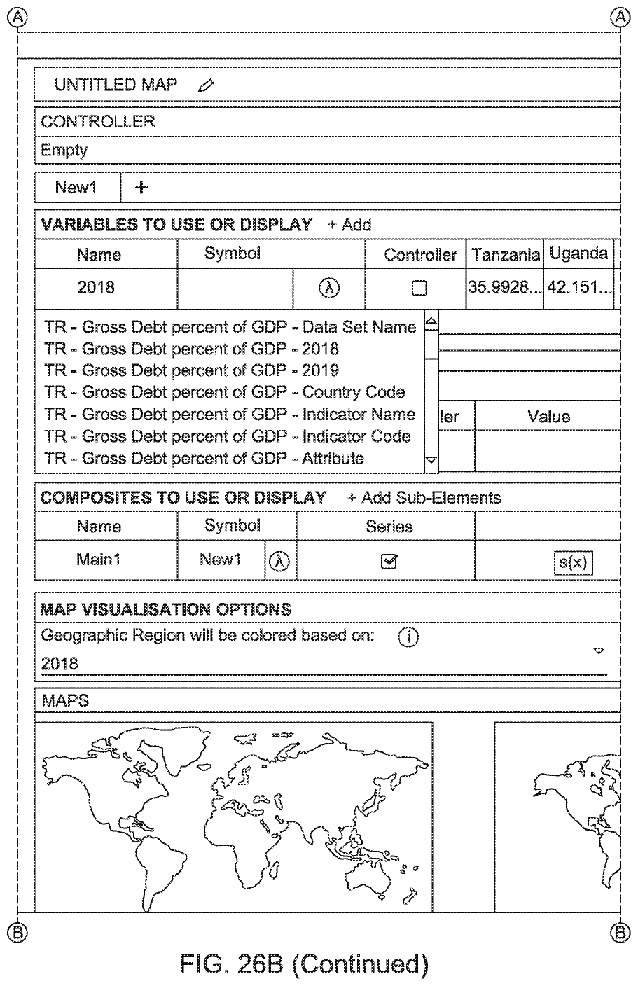

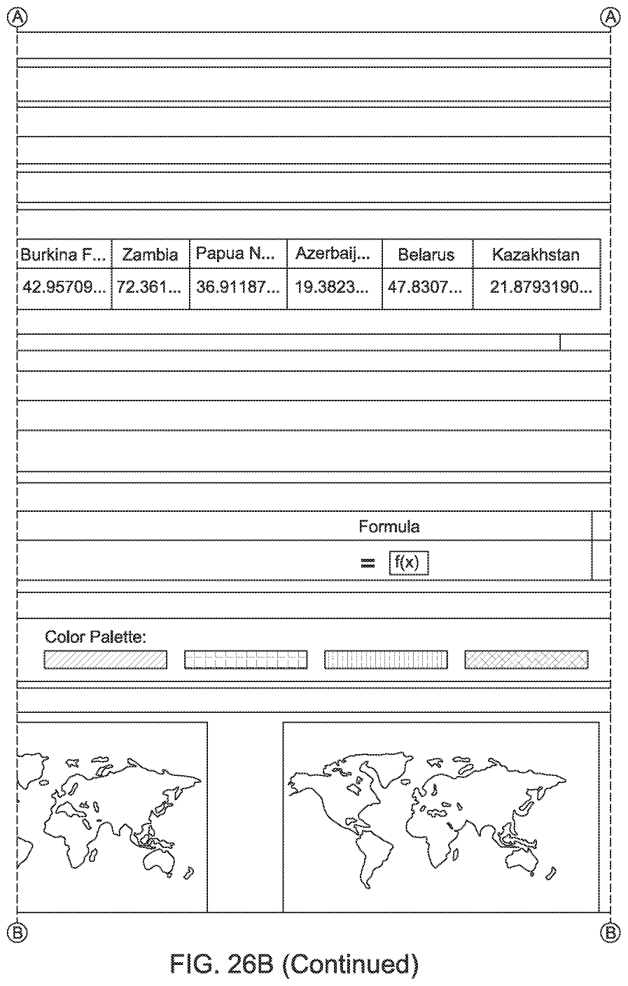

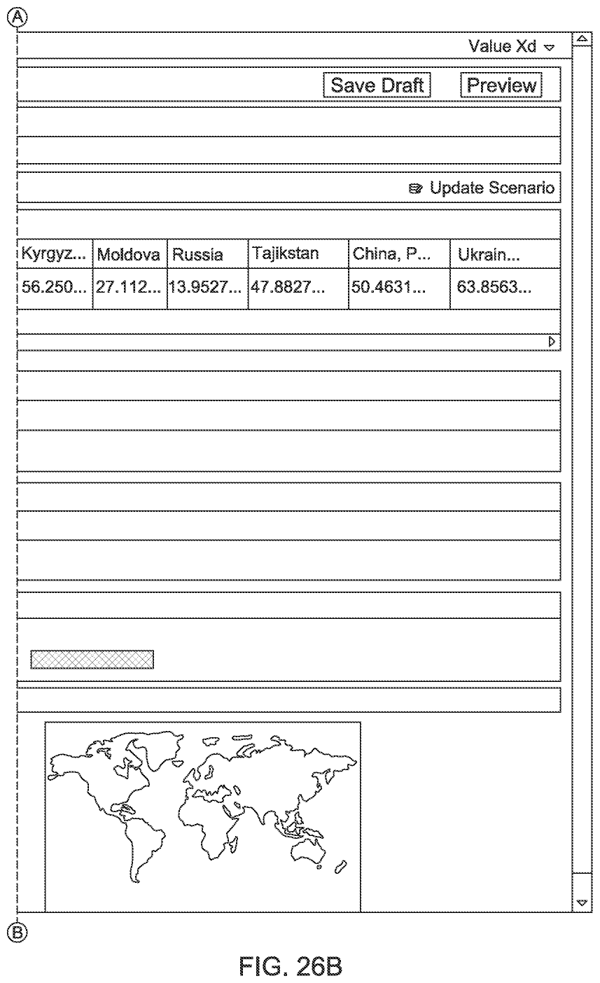

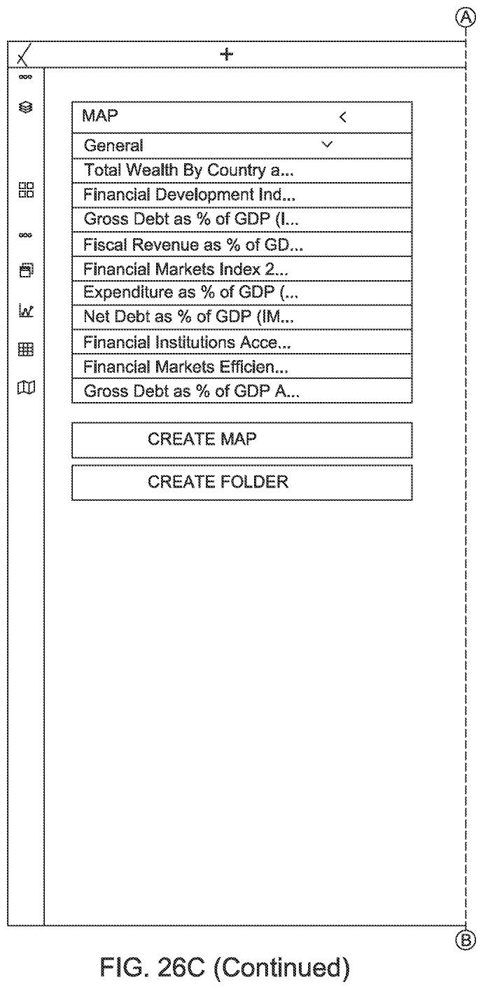

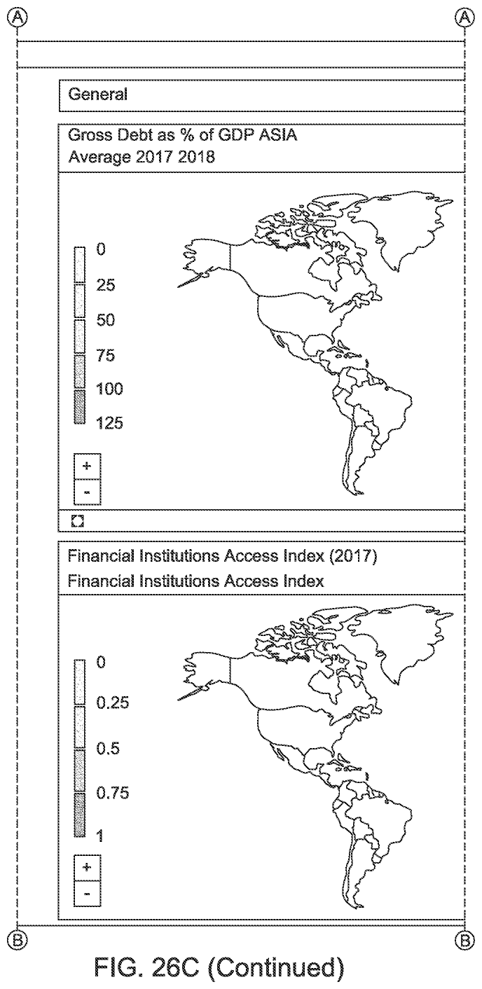

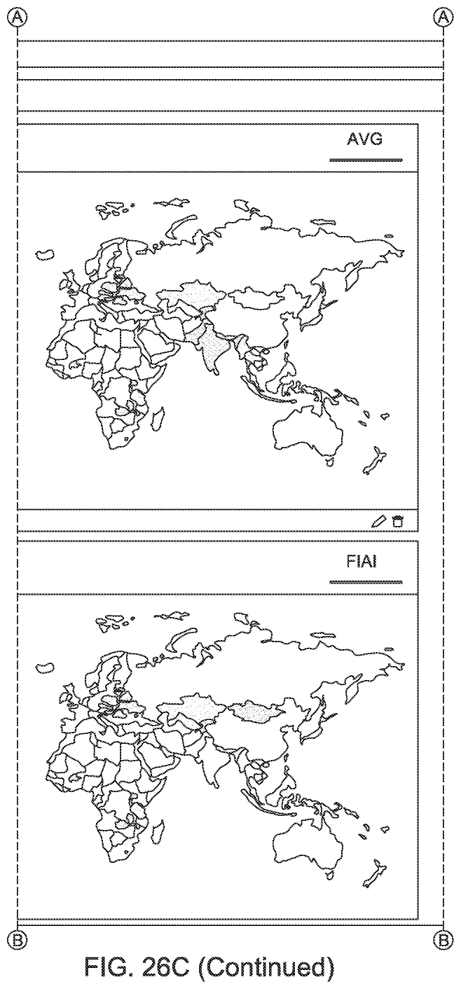

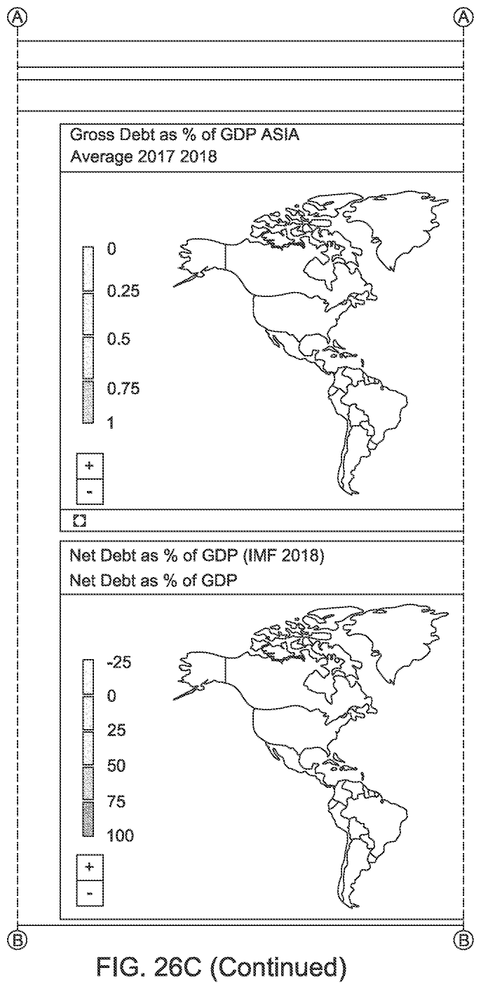

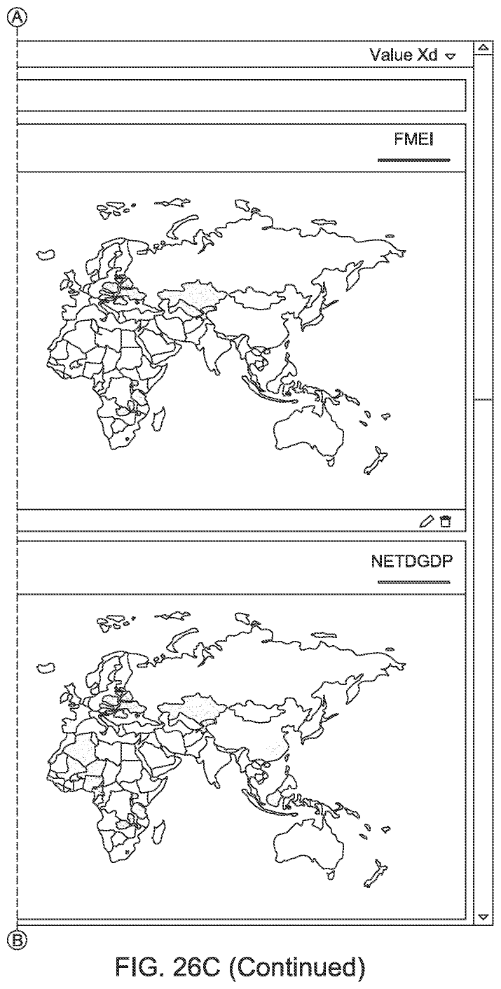

A user can select to create maps. Upon this selection, the user interface directs the user to a new Map page (FIG. 26A). Linking the map with the main sheet for example is optional (FIG. 26B). Users may select the number of Geographic Regions to use in the map. Further, similar inputs to those described for creating a model, chart or table as above are available. Similarly, users may also select to include a variable in a controller.

By default, the regions section may be dependent on the number of geographic regions selected. When linked to a main sheet, the Variables and their values will be displayed in this section. As described in the sections above, users may also use a Main Composite this time for the new map. For the composites, user may create their own equations using the formula/equation editor as described in the sections above.

It will be appreciated that users may select from different types of map visualisation. Similarly to models, charts, and tables, maps in a folder are preferably listed in the user interface (FIG. 26C); for example, a user can scroll down to check, expand, check the variable's controller, delete or edit a specific map. Preferably, map visualisation is interactive, and a user may zoom in/out, select a specific country, moved etc.

### Presentation

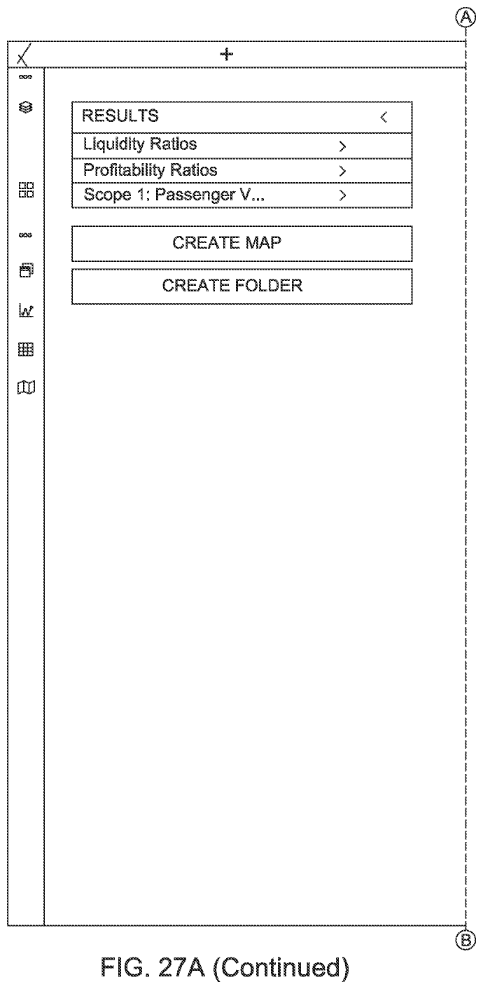

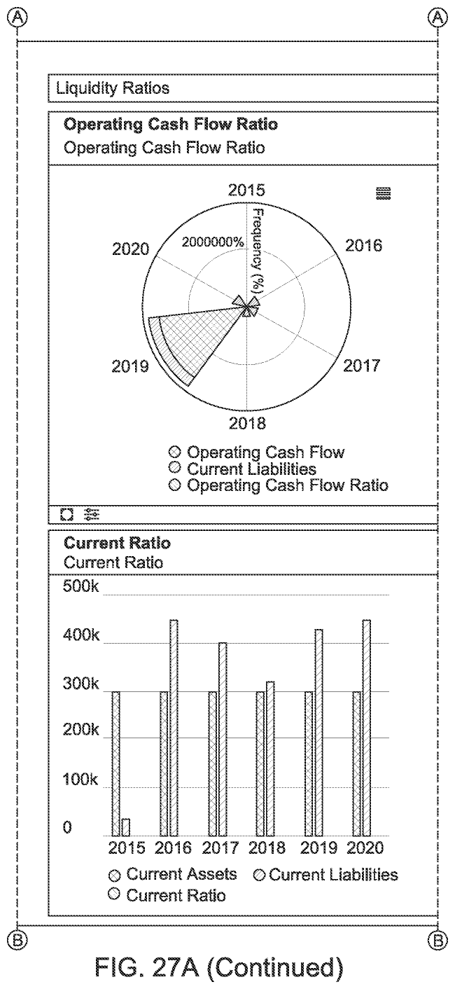

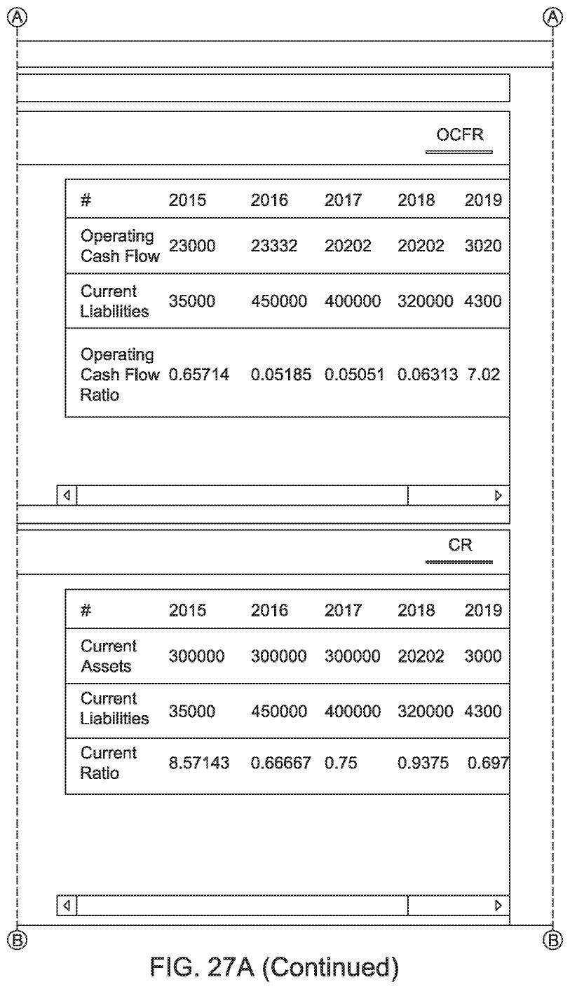

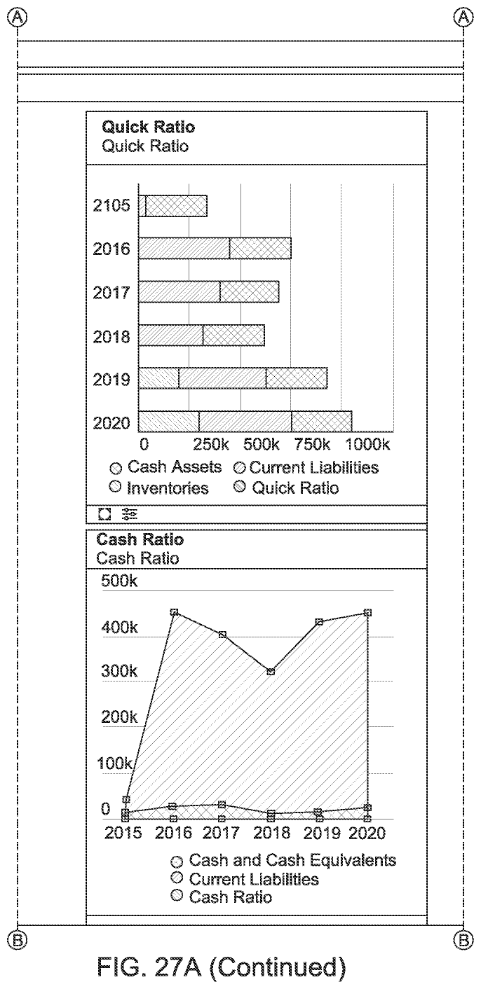

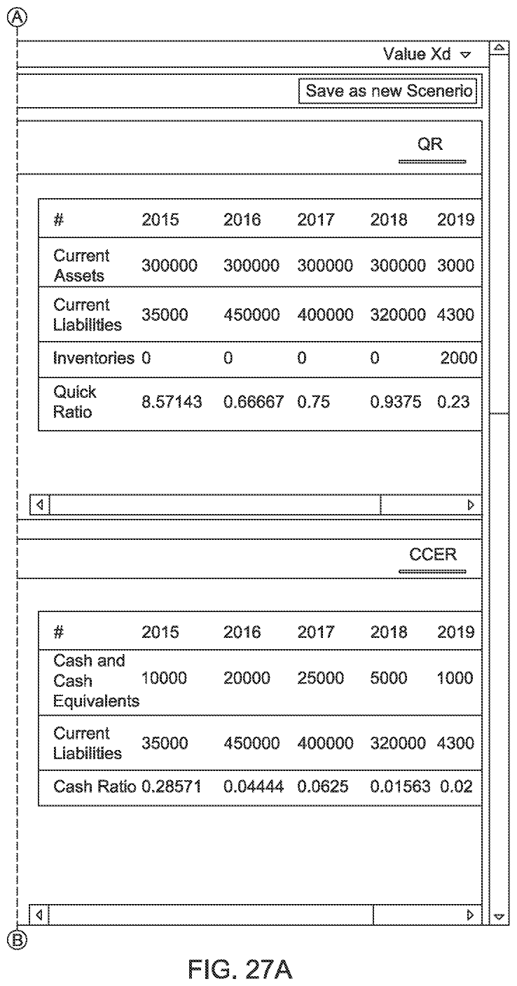

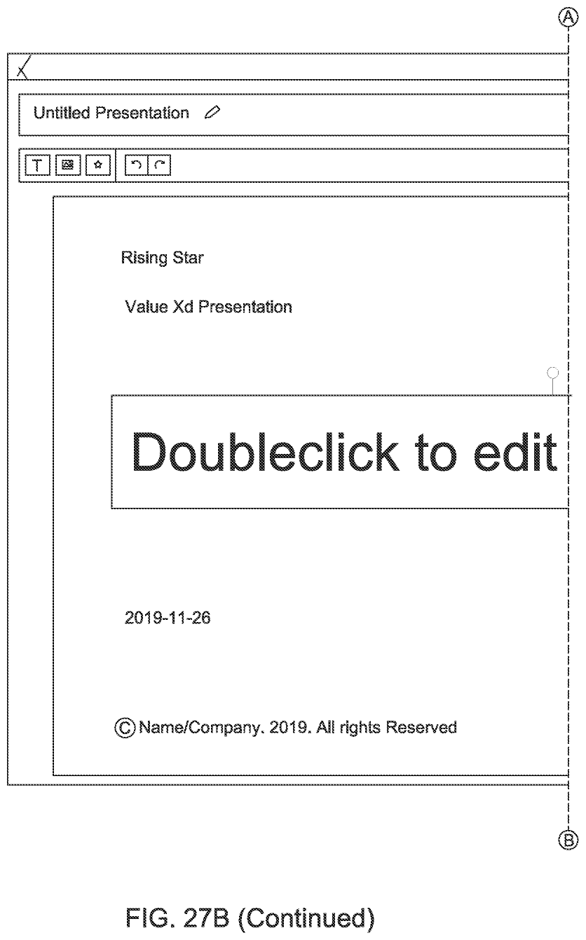

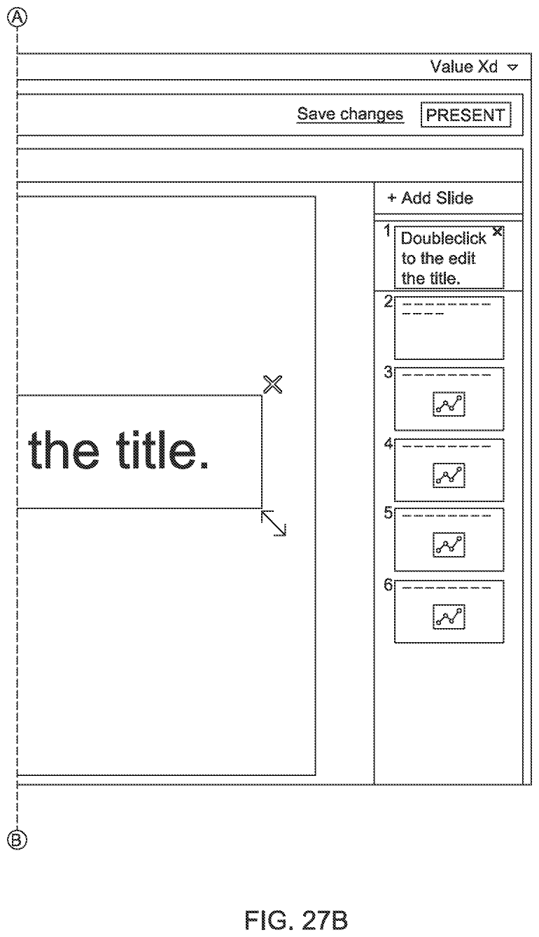

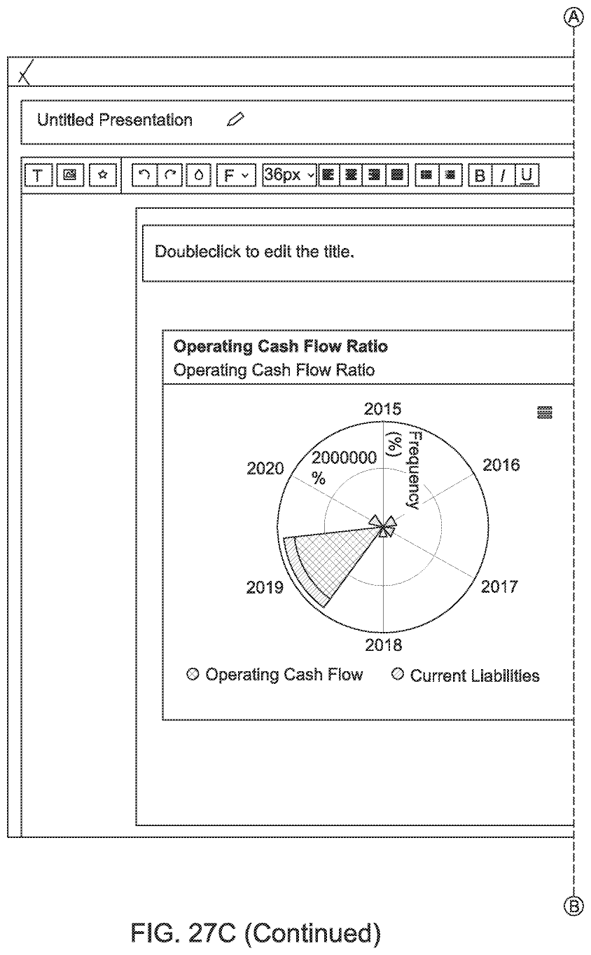

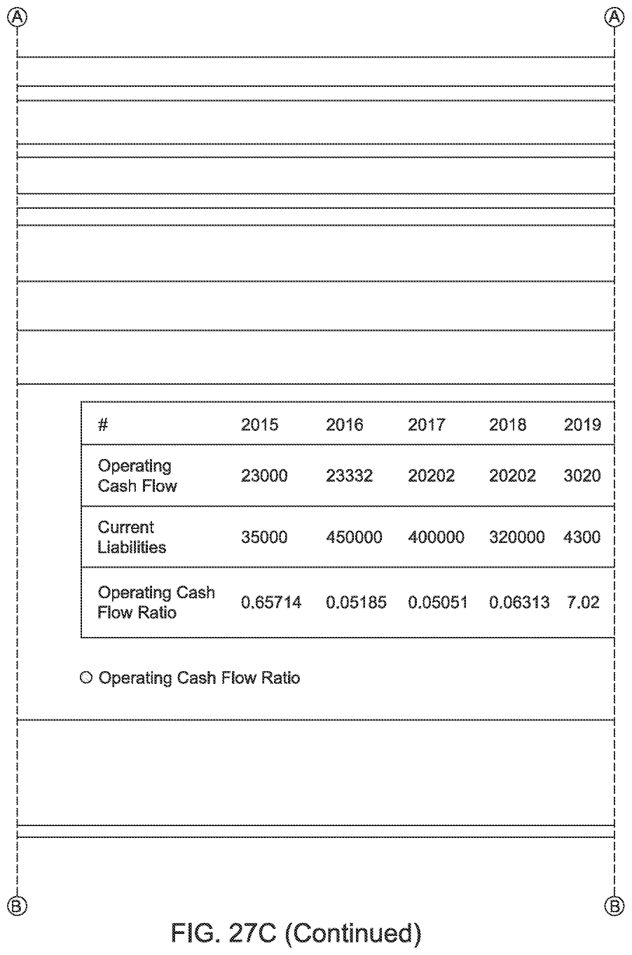

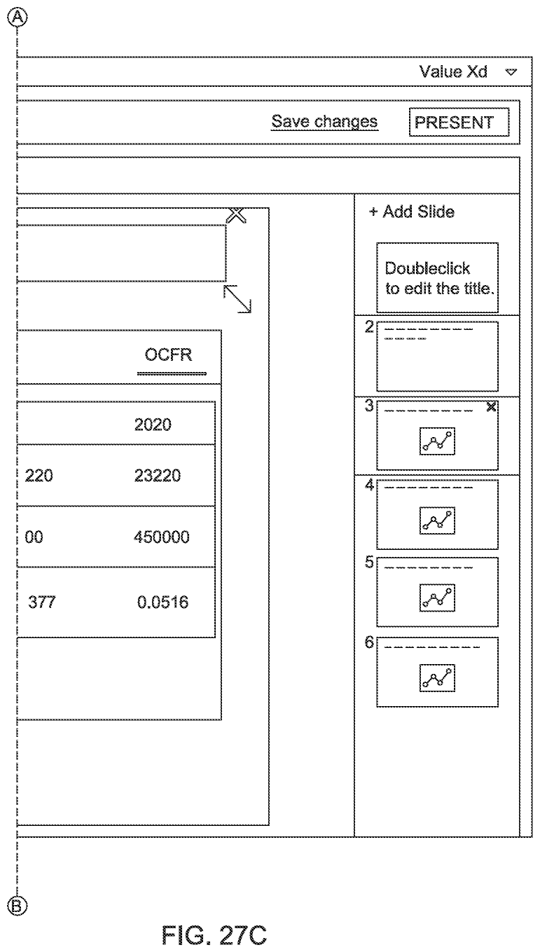

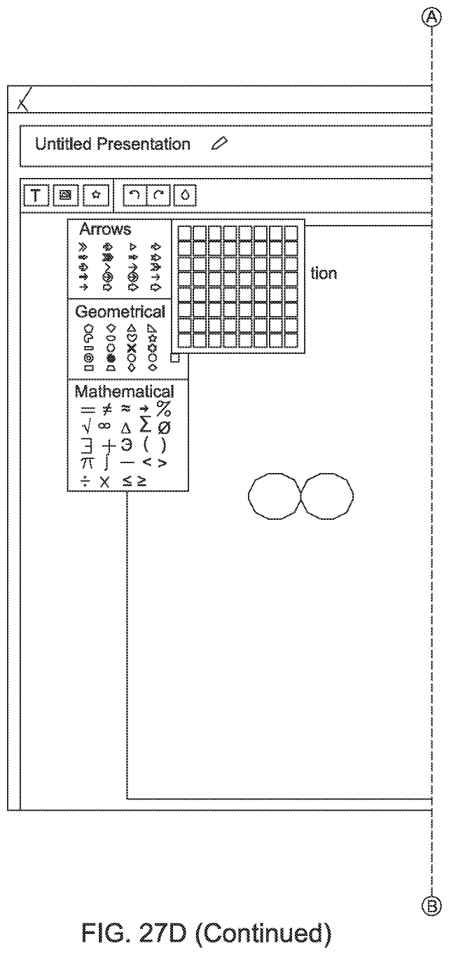

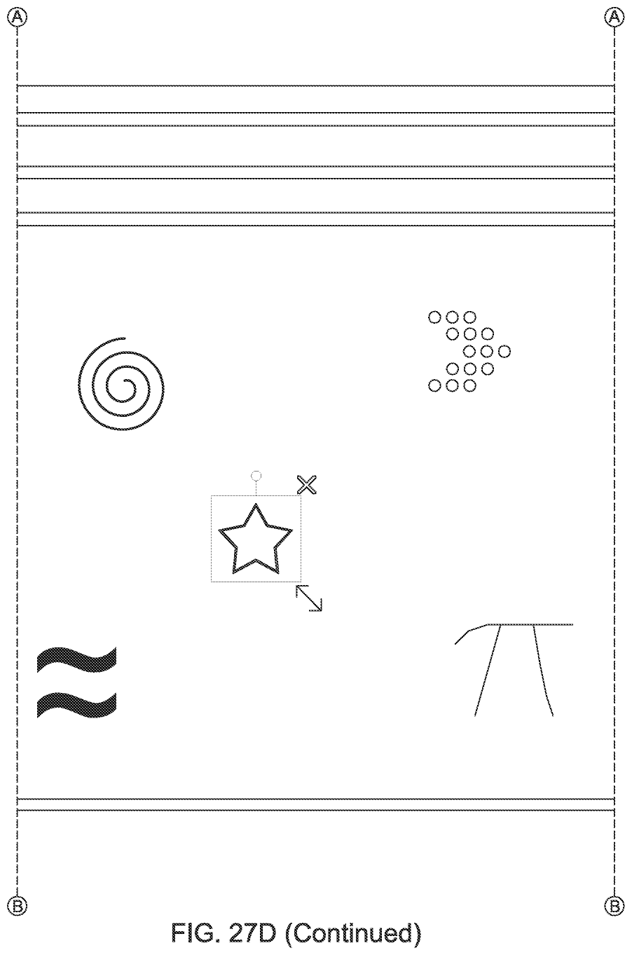

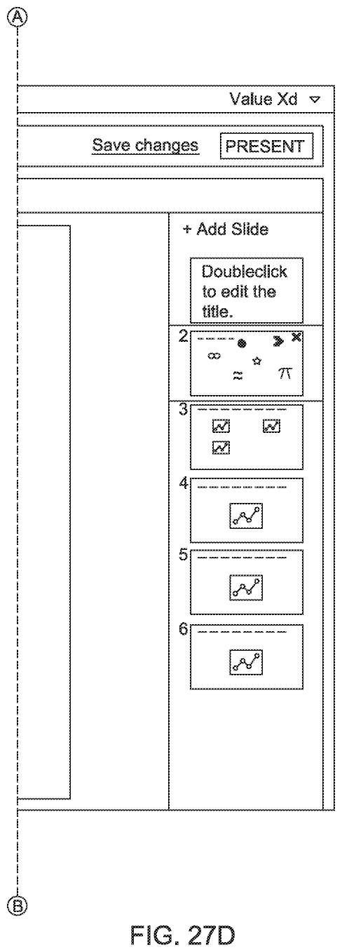

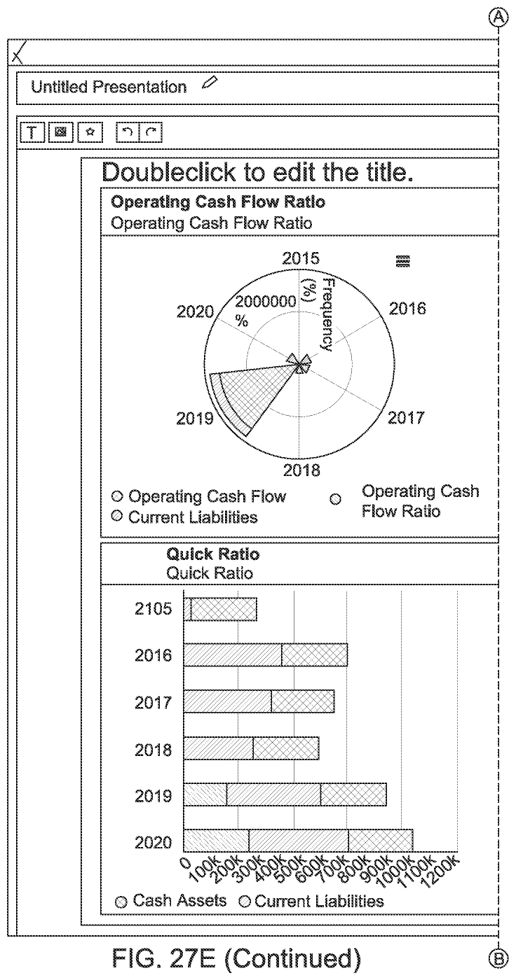

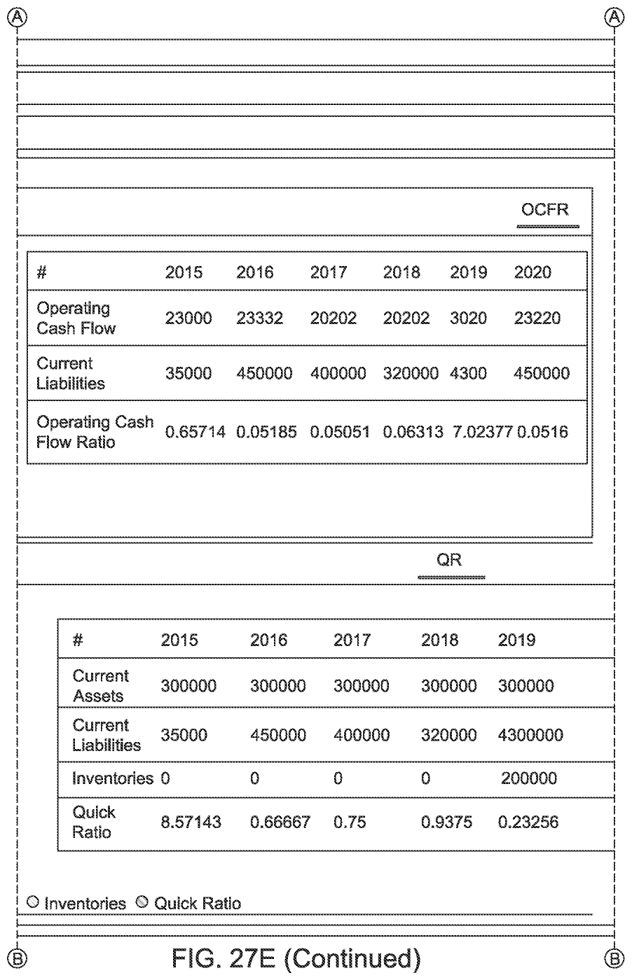

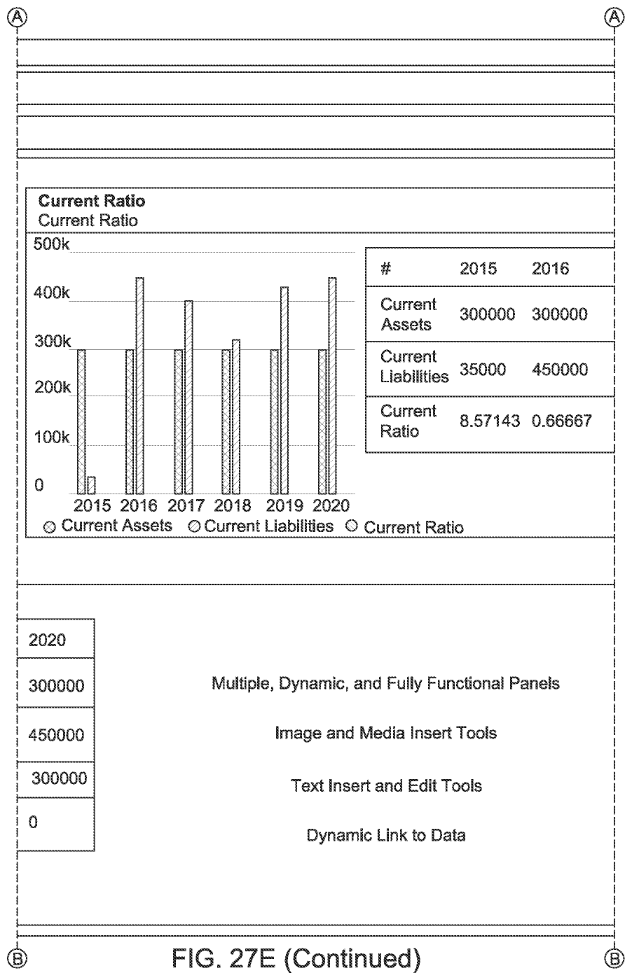

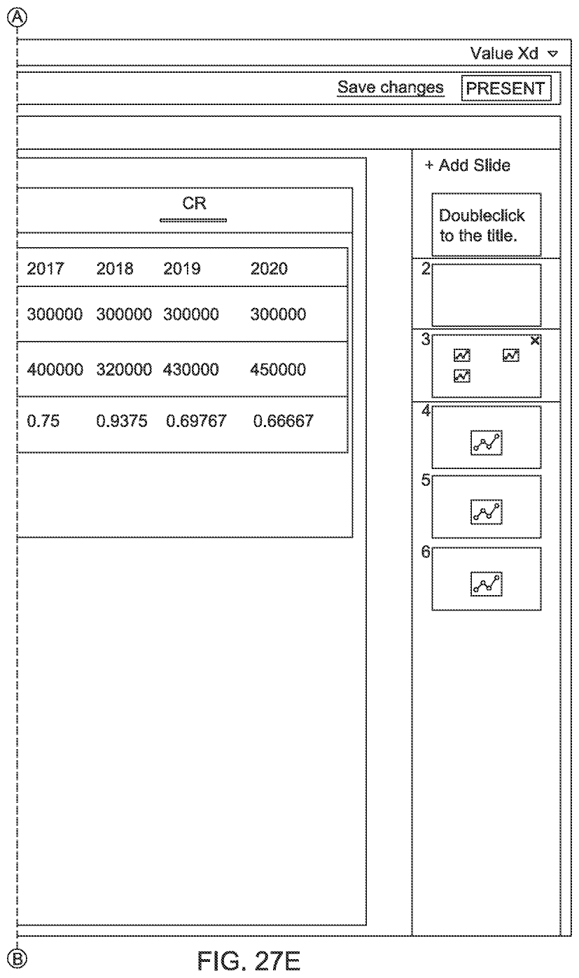

When in the Results page for a case, a user may select to Create Presentation and is directed to a presentation page (FIG. 27A). The first page of the presentation may contain the name of the dashboard followed by profile name, date and copyright section at the bottom (FIG. 27B, 27C). Everything and all elements in the presentation are editable in its text box. These are automatically fed into the presentation editor through the user profile and Case analysis content, and the dashboards which have been applied to the case.

The user can insert pictures, media, and shapes, edit colours, and adjust the size (FIG. 27C, 27D). The user can also move panels into different slides, or put them together in one panel as in FIG. 27E. Slides may be rearranged, previewed and manipulated by the user as desired. Similarly to textbox tools, panel tools inside the presentation are interactive so that the user can manipulate their size and location, where the content is adjusted in sync with the size.

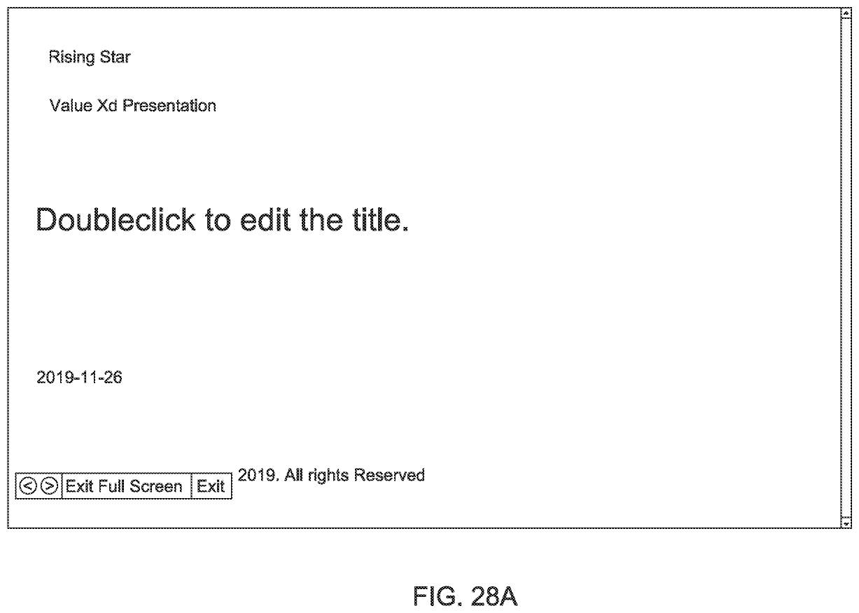

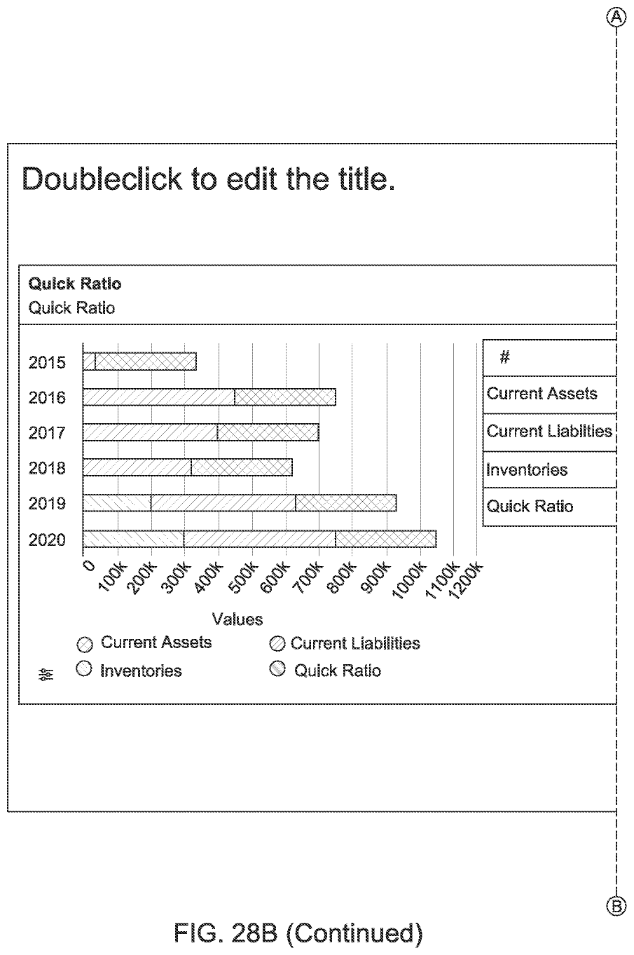

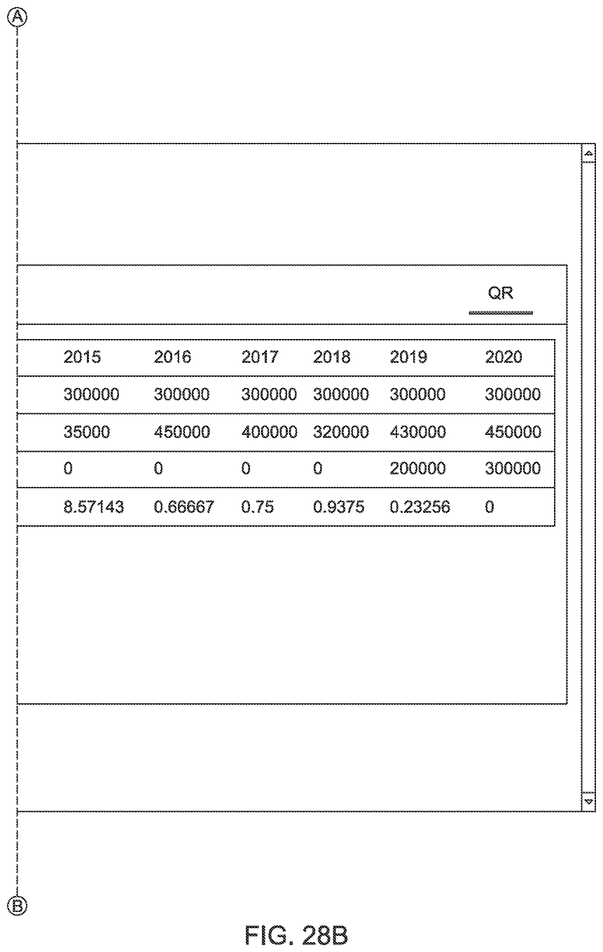

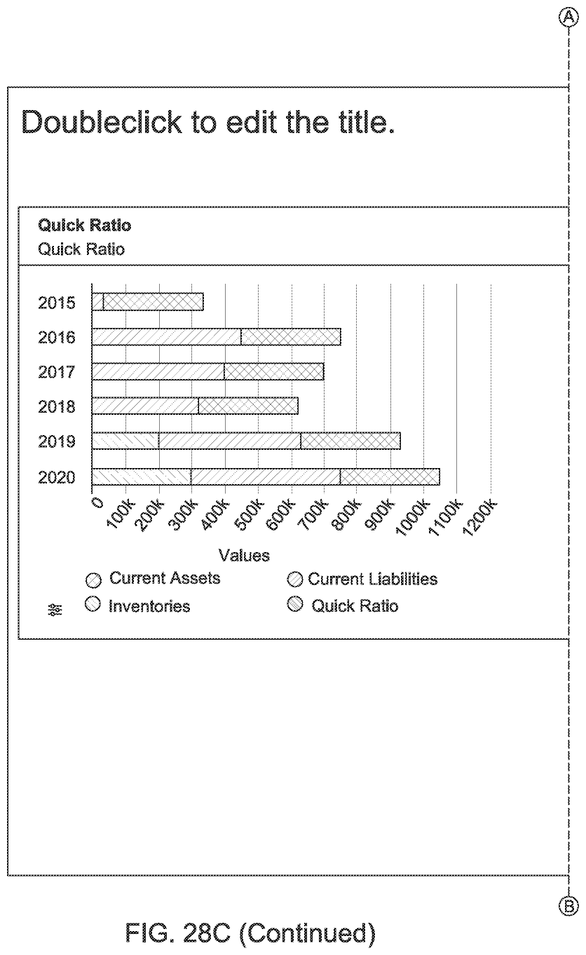

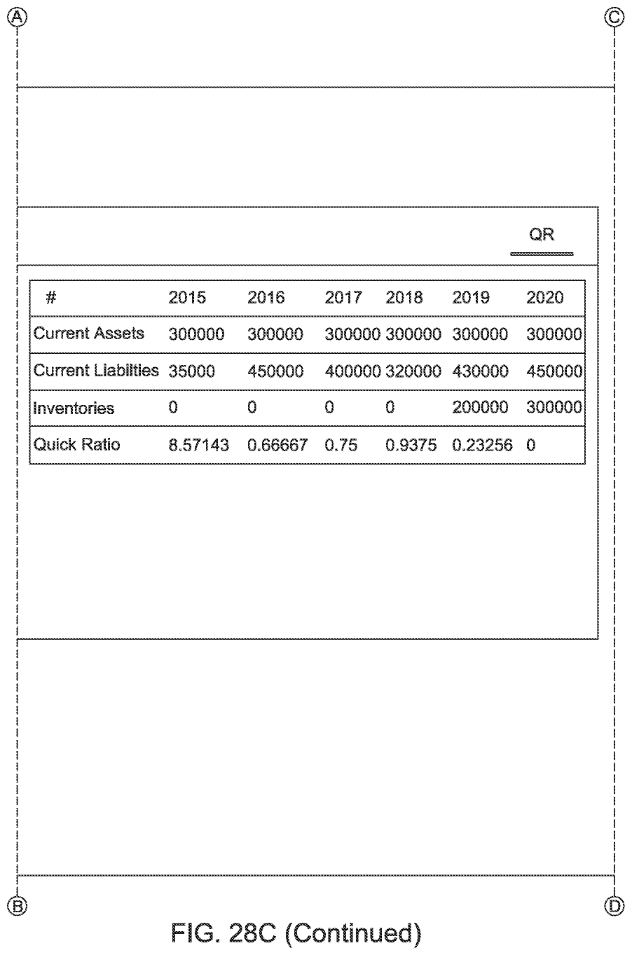

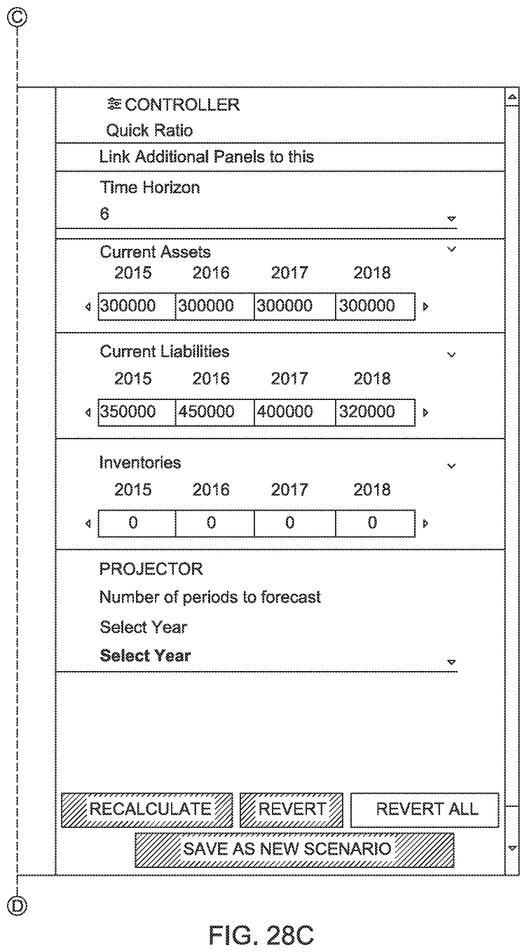

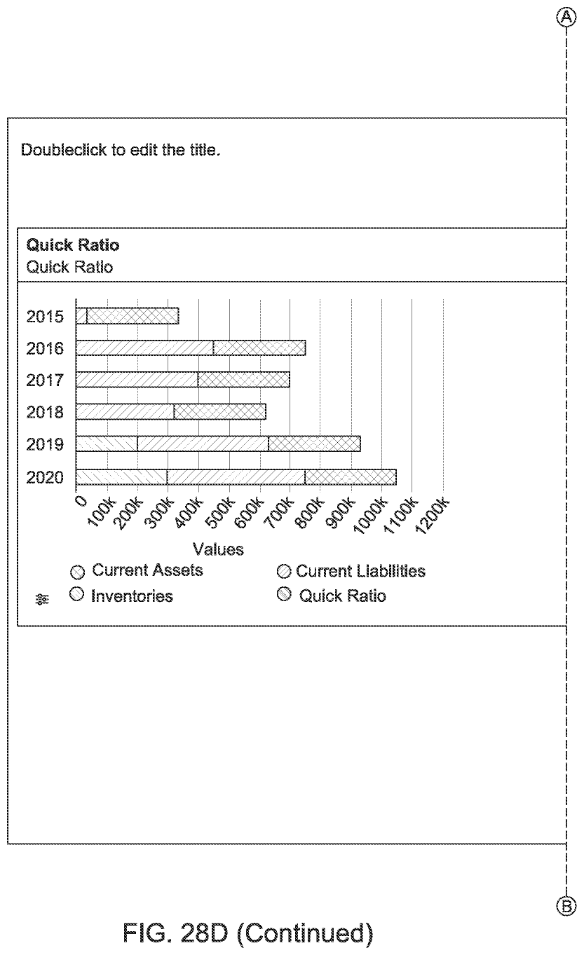

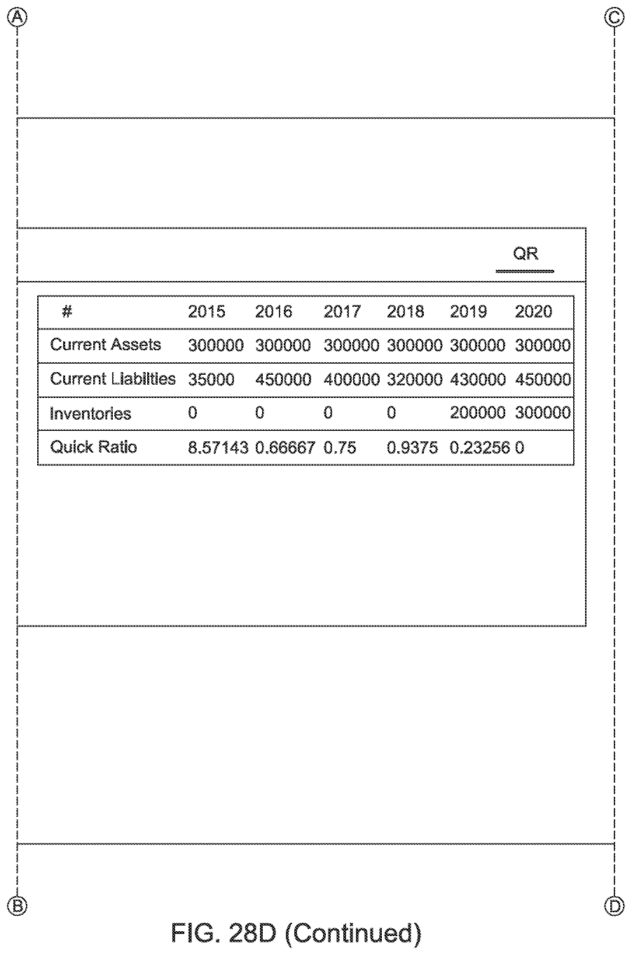

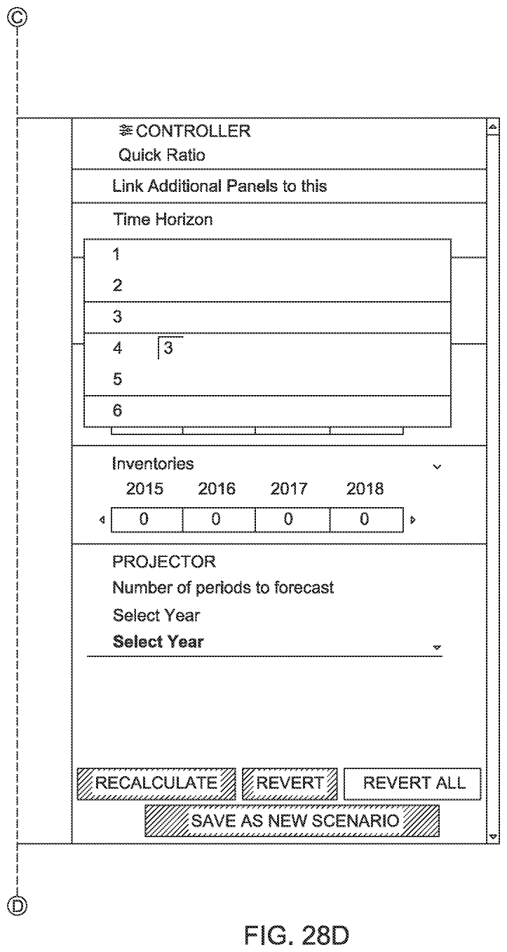

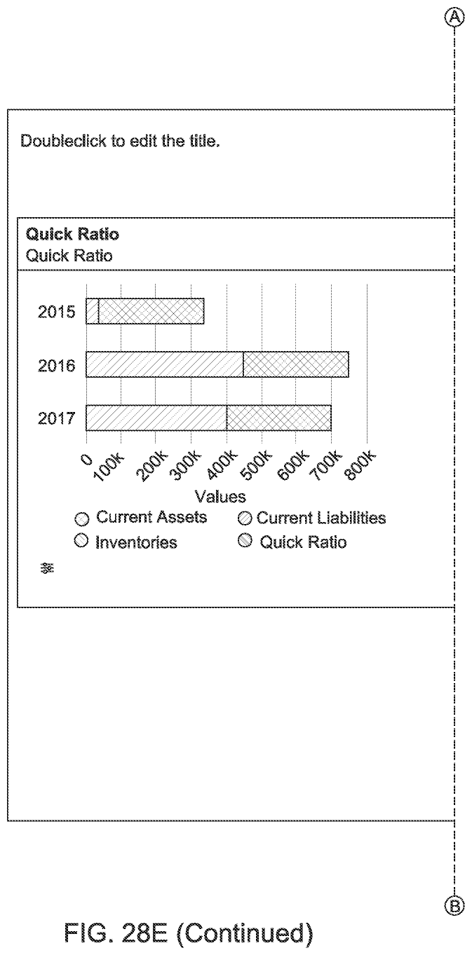

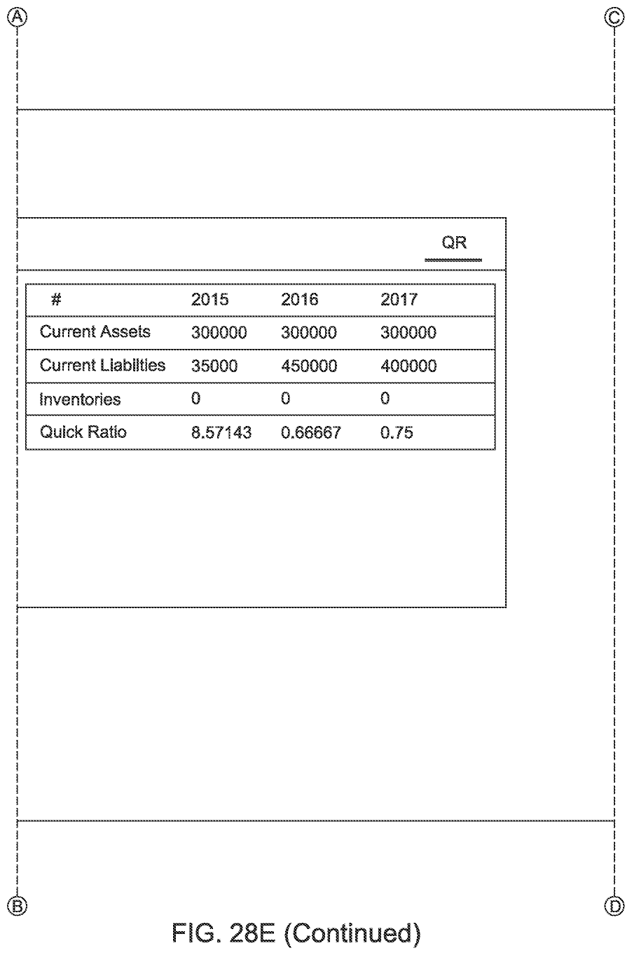

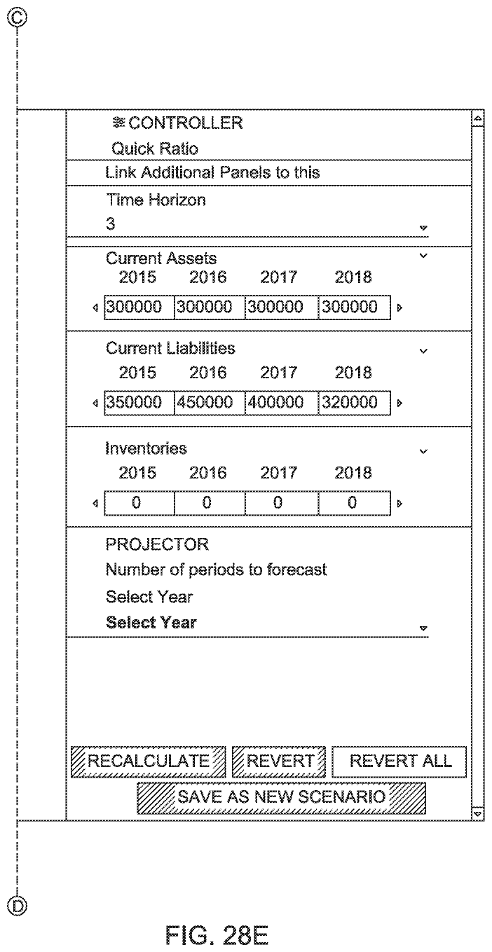

After a user has made all the changes desired to the slides a user may select to Present, by clicking on a Present button, to enter presentation mode (FIGS. 28A and 28B).

In presentation mode, navigation elements such as arrows (Next/Previous), Full Screen and the Exit buttons are included to allow navigation through the presentation, see FIG. 28A.

Importantly, during live presentation, just like in edit mode, if a slide contains a panel (whether a model, a chart, a table, or a map), the slide is fully interactive and provides the full functionality of the user's panel's interaction (FIG. 28B). Most importantly, the controller of the panel, be it a model, a table, a chart or a map, is available to the user/presenter during live presentation. Advantageously, this can make user presentations stand out, and discussions more informed, allowing the simulation of different scenarios while in live presentation mode.

The controller described above is available for use in live presentation mode. When a user selects it, FIG. 28C, the controller sidebar appears, in this example to the right of the presentation screen. Users when presenting their analytical outputs now have a tool that is linked to the underlying data, and allows them to manipulate and simulate alternative outputs through the use of the controller during live presentations. FIGS. 28D and 28E describe how a user can change the timeline of a panel (Model, Chart, Table, Map) during a live presentation and see the output change in front of them during live presentation.

One option in the controller sidebar is to Link Additional Panels (FIG. 28F). This provides the opportunity to link other panels, thus making the controller the front end interface allowing you to fine tune, simulate, and manipulate results as per the user's strategic and tactical needs. When a drop down menu of the select panel is clicked for example, only the panels with matching timeline and at least one matching property and/or constant will be available to select from. One or many panels may be added as desired.

Selected panels may be listed under additional panels selected. A user may select an Unlink option to remove the link with the panel. The controller including the projector operate in the same manner in the sections described above with reference to FIGS. 18A to 18C.

### Sharing

In preferred embodiments, sharing may be configured to occur on more than one level. In a preferred embodiment, sharing may be configured to occur on two levels or more. One of the levels may be internal to the universe defined by the user or operator and provide the option of sharing or unsharing particular content. Another level may be external to allow a user or operator to share or unshare with the public. This latter form may be defined as publishing and unpublishing particular content such as models and/or equations. In preferred embodiments, the option of public sharing may generate a link which allows a user external to the universe to click on and after registration to the platform to become readers in the universe. The system may also allow a presentation to be viewed in a fully dynamic mode with access to the controller and projector.

In the context of sharing, in certain embodiments, presentations have an import panel tool, which allows users to import any applied panel from any other case or dataset, into any other presentation.

The system also facilitates the sharing of dashboards, models etc. within specific predefined groups in addition to any sharing which a user may wish to engage with any third party more generally. These groups may include a company, a department, a team and any other appropriate level of grouping.

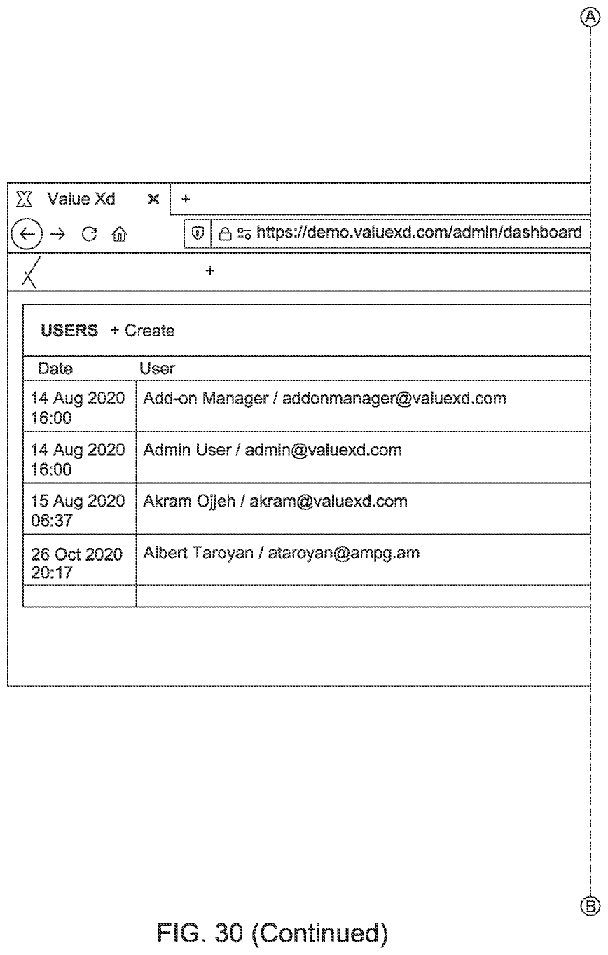

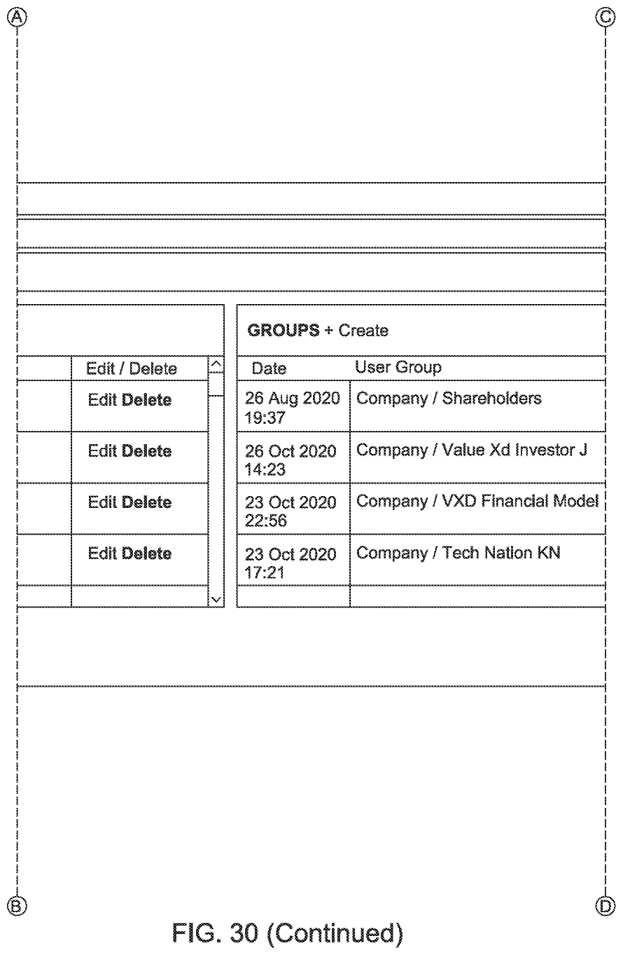

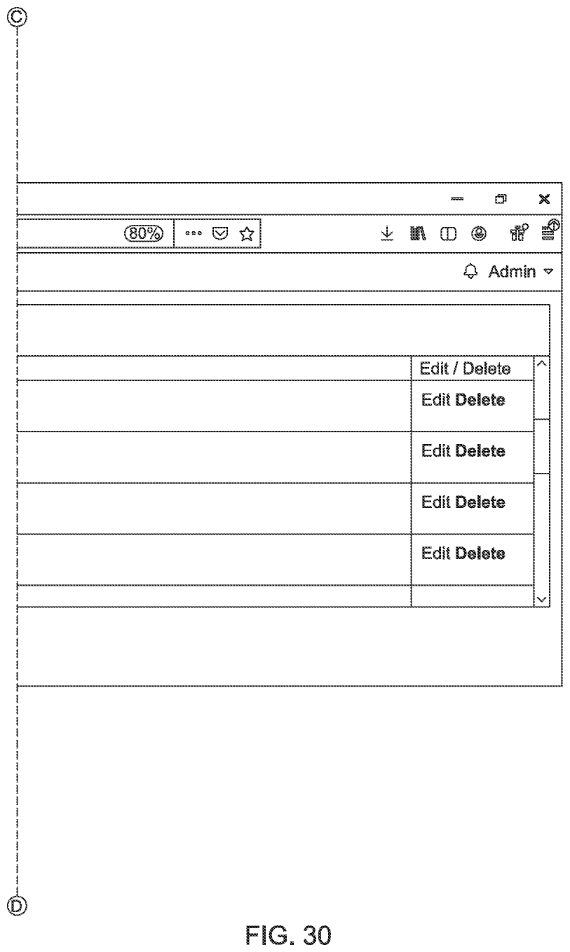

As shown in FIG. 30, the user interface allows users to add guests to particular groups and to assign group owners. The user interface may be configured to request the specific emails for either guest members of a group and for the group owners which are assigned to a particular group. This provides the ability to share cases, datasets, dashboards, elements and presentation both created by a user or downloaded by a user.

A particular team may view a list of shared cases, datasets and dashboards prior to opting either or not to download the item. The item may also be deleted by the user should he/she not be interested in downloading it.

The system is also configured so that downloaded material may be filtered from all user created material. A separate desktop for downloaded material may be provided from a desktop for user created or generated material.

### X-Axis Timeline Creator

The x-axis timeline creator allows, in certain preferred embodiments, the conceptual creation of a functional x-axis timeline in the data sheet, without ever actually entering numbers or dates in the spreadsheet, by simply defining the start/end/number of periods and selecting the elements. In other words, the creation of the timeline occurs without actually getting into the cells of a spreadsheet.

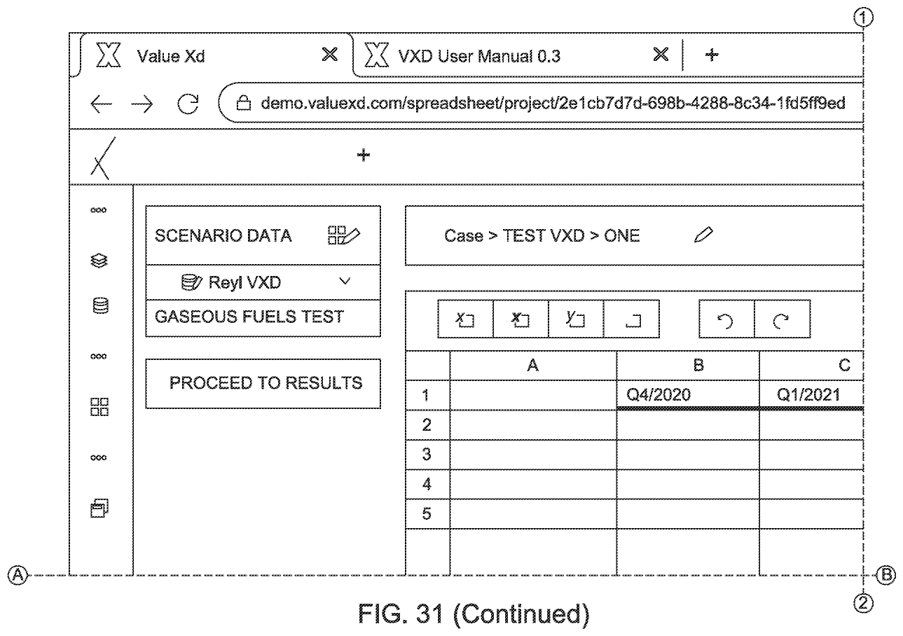

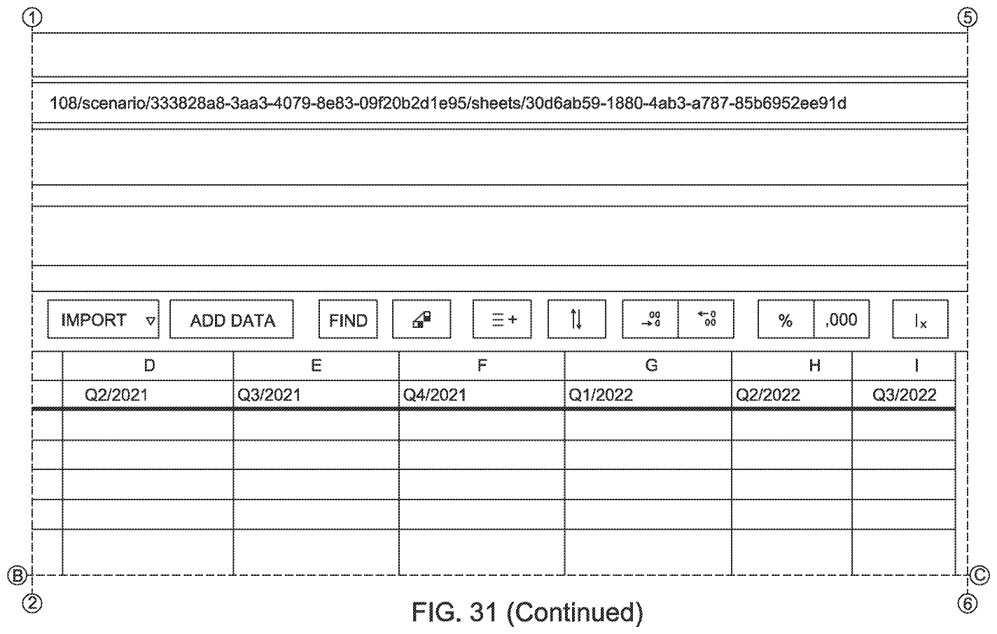

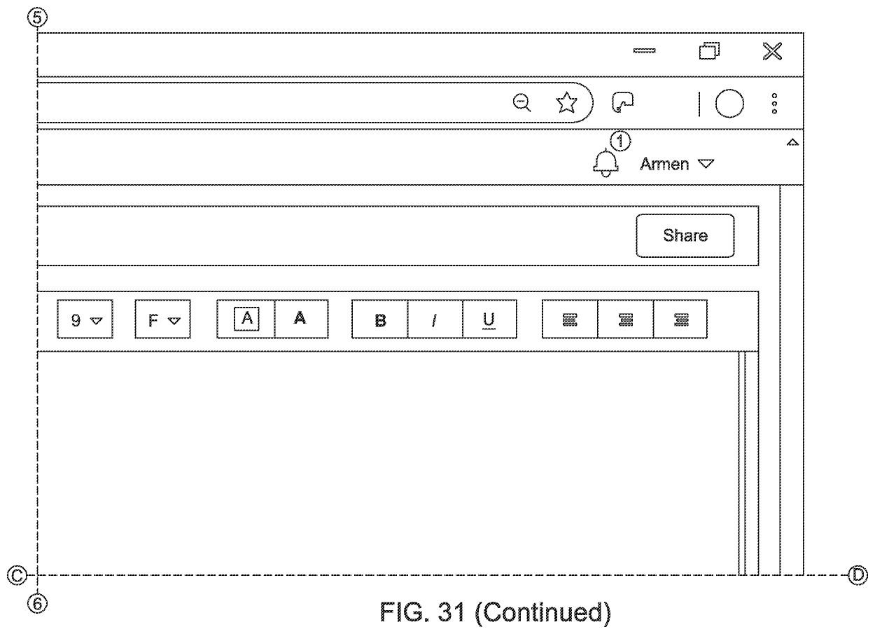

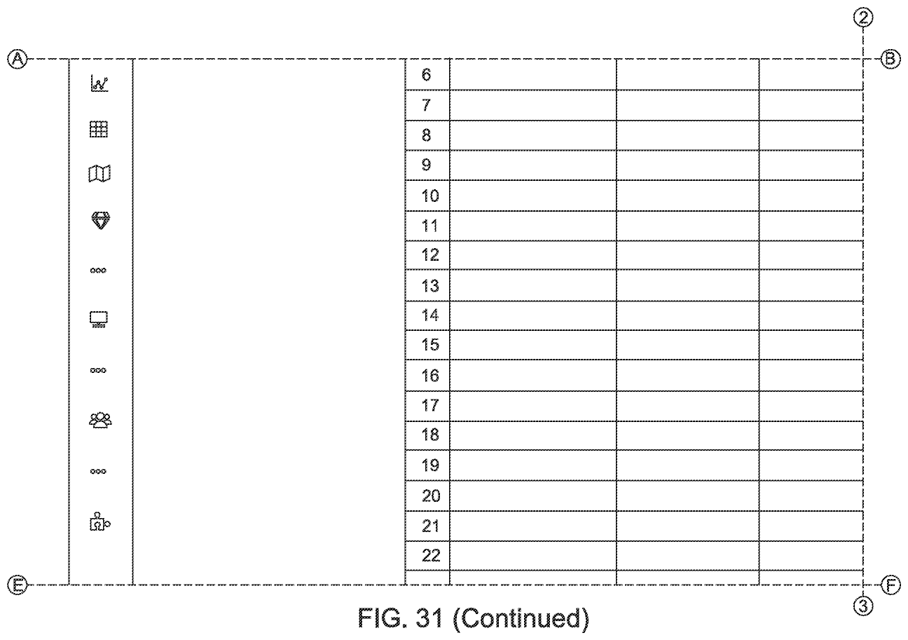

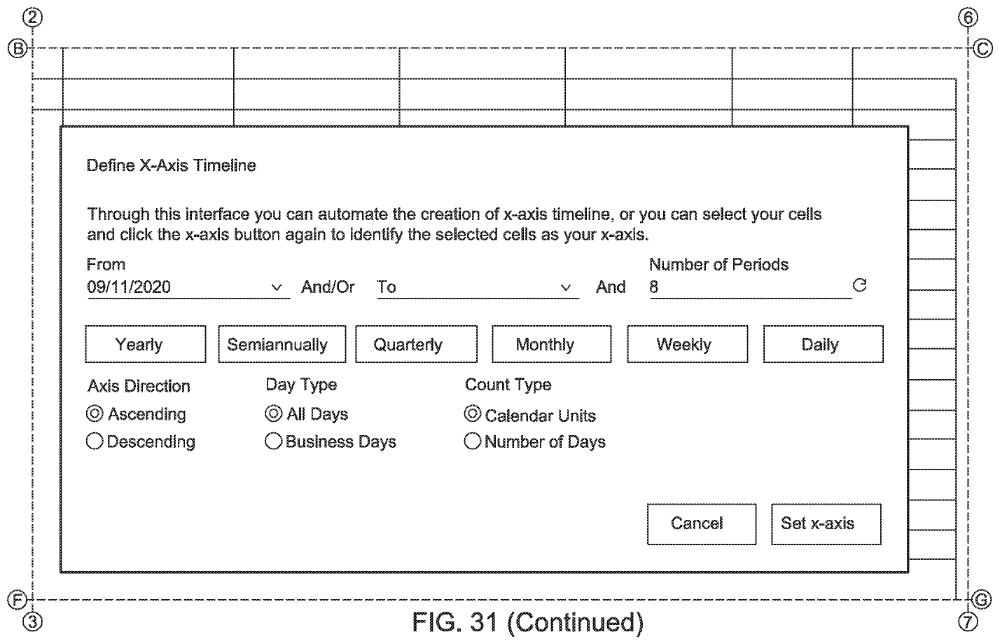

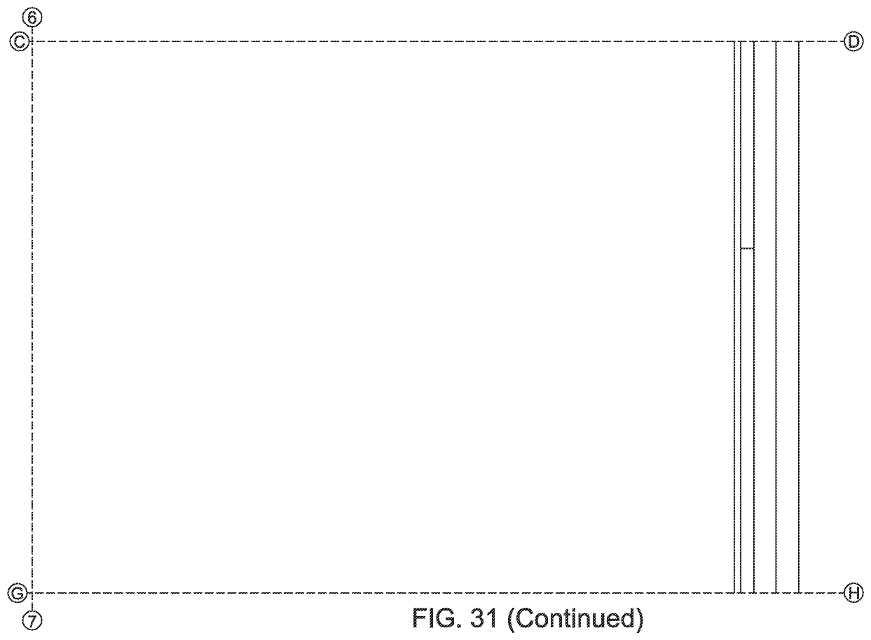

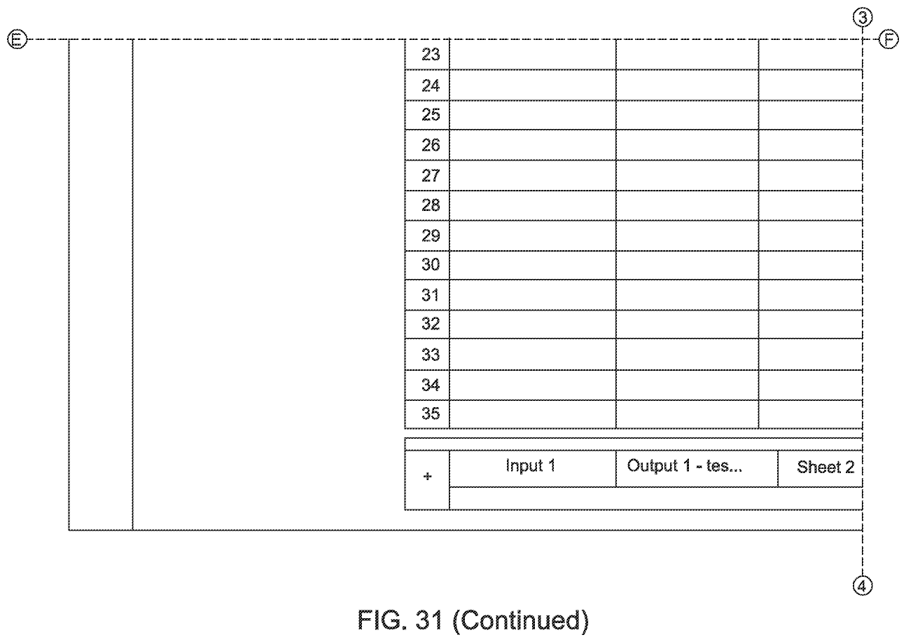

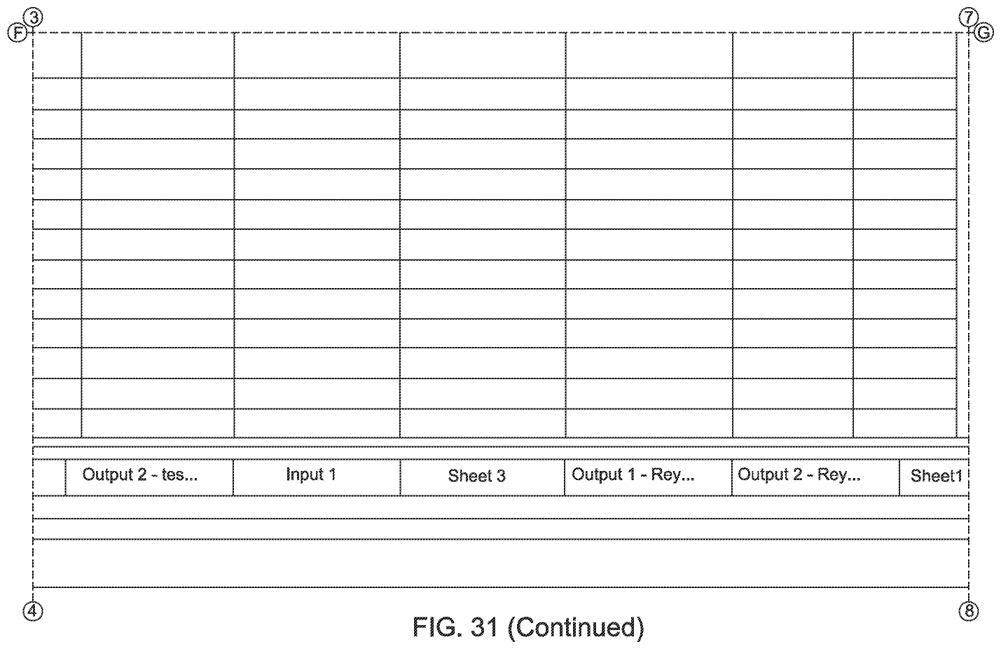

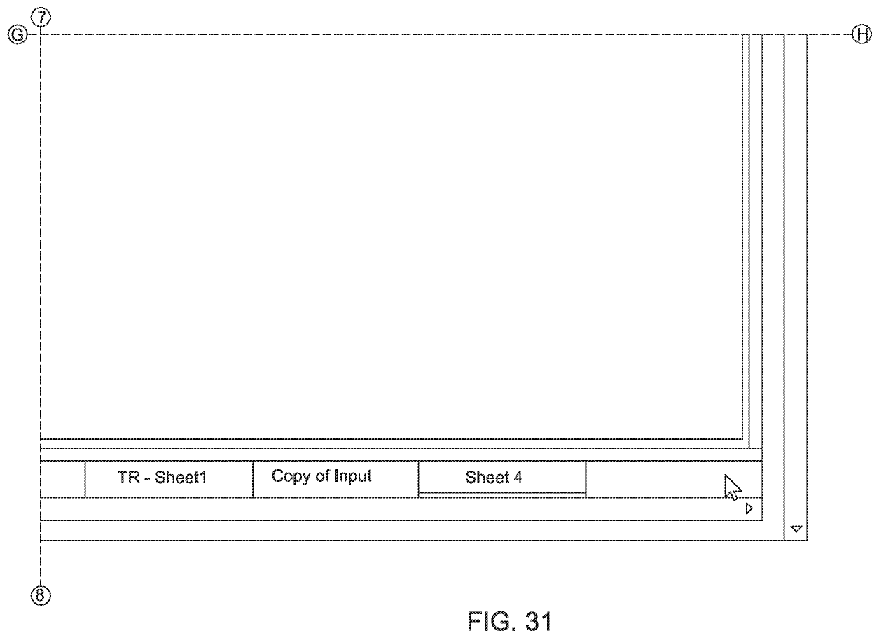

As shown in FIG. 31, the system provides a user interface box which sits above or separate from the spreadsheet and allows a user to automate the creation of the x-axis timeline. It allows the user to provide a starting point in time and optionally an end point in time and simultaneously designate a number of periods. Optionally, the system provides either the axis direction to be ascending or descending. Furthermore, the system provides the option of the days either being all days or only business days. In addition, a count type option is provided as either calendar units or number of days. The time periods are selectable from the following: yearly, semi-annually, quarterly, monthly, weekly, and daily. Once these various options are selected the user may set the x-axis by pressing a user responsive button which sees the spreadsheet populated in a single click across the number of desired periods.

The user may also select cells and click the x-axis button again to identify the selected cells as the desired x-axis.

In the embodiment of FIG. 31, the user has selected a start date of 9 Nov. 2020, a number of 8 periods, the axis direction to be ascending, the day type to include all days, and the count type to be calendar units.

### Add-on Library

In addition the system comprises a database incorporating a library. The library may comprise user downloadable content including living and dynamic models. The term downloaded or downloading, in preferred embodiments, refers to the assignment of models and other such content to a particular user accessible space or resource. This space or resource is in preferred embodiments provided on a remote server rather than any personal computer or other user owned storage facility. In other words, embodiments of the invention envisage the selective storage of a copy from a central server location to an individual user account which may be on the same or on an alternative server giving full functional access to the mathematical models included. Optionally, the user account may be partially located on a personal computer.

The library may form a wikipedia of mathematical equations and models covering a wide variety of topics and subjects where the equations are in their true mathematical form, as opposed to coder invented abbreviations. Embodiments envisage potentially separate libraries for equations, data, and thematic dashboards. These equations, models and dashboards are downloadable and applicable immediately. They are editable and shareable, and produce dynamic outputs which can then be used for simulation through the controller, like all the other models created in the system.

In a further embodiment, the system provides two kinds of dashboards, wherein a first kind is created by the user as detailed above whilst a second kind is also accessible through the interface to facilitate the download of third party originated dashboards.

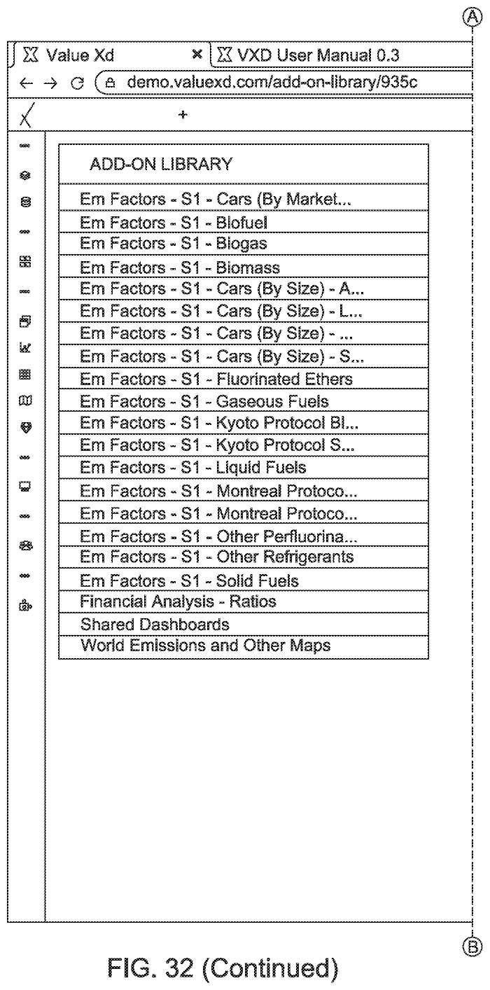

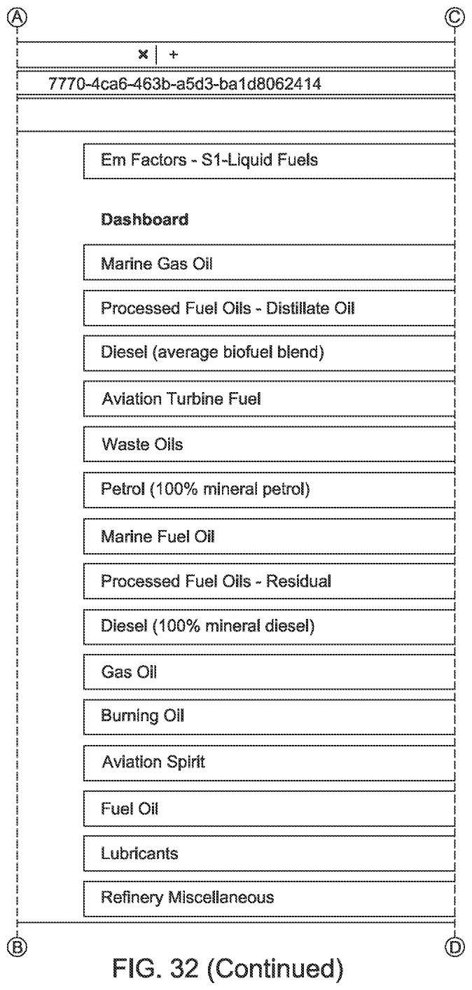

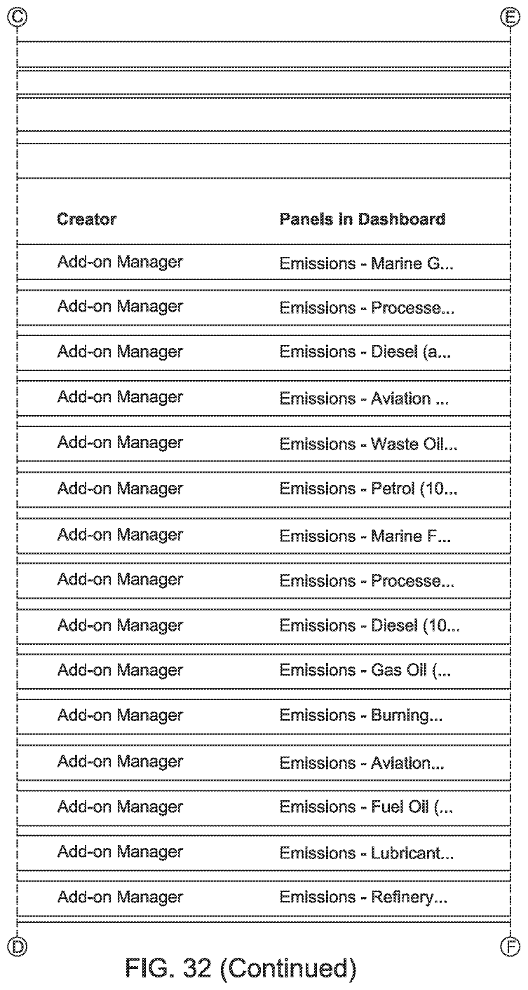

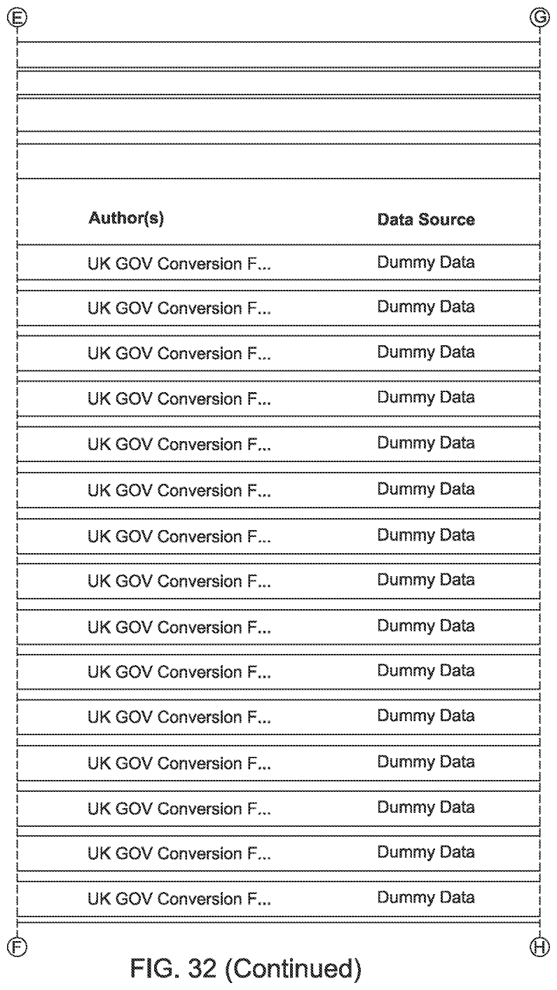

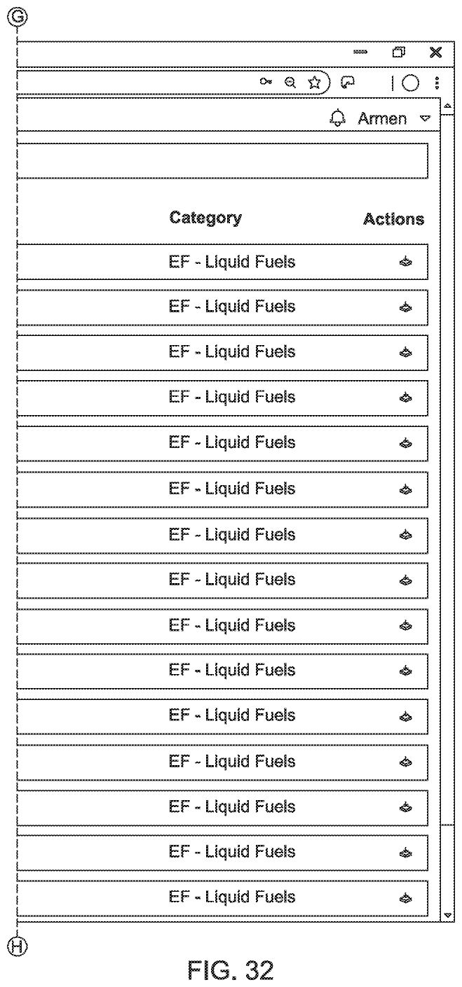

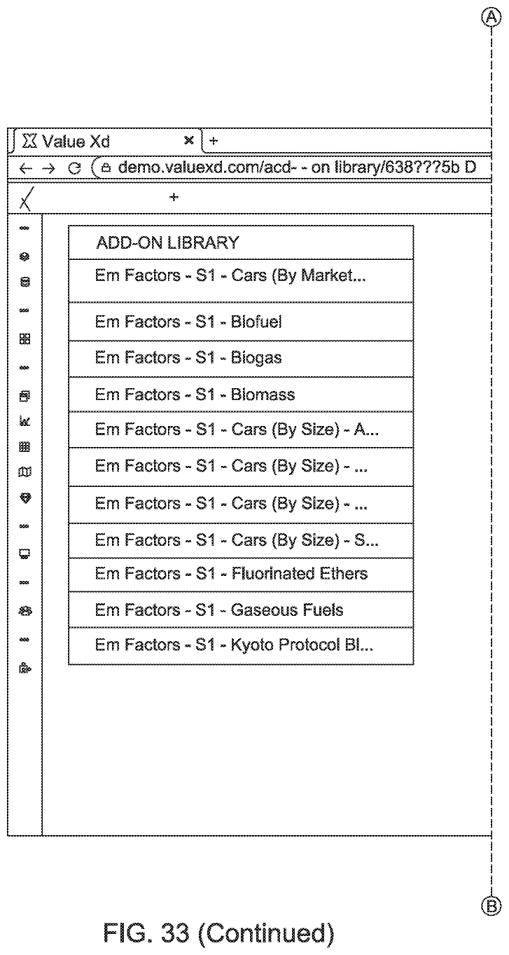

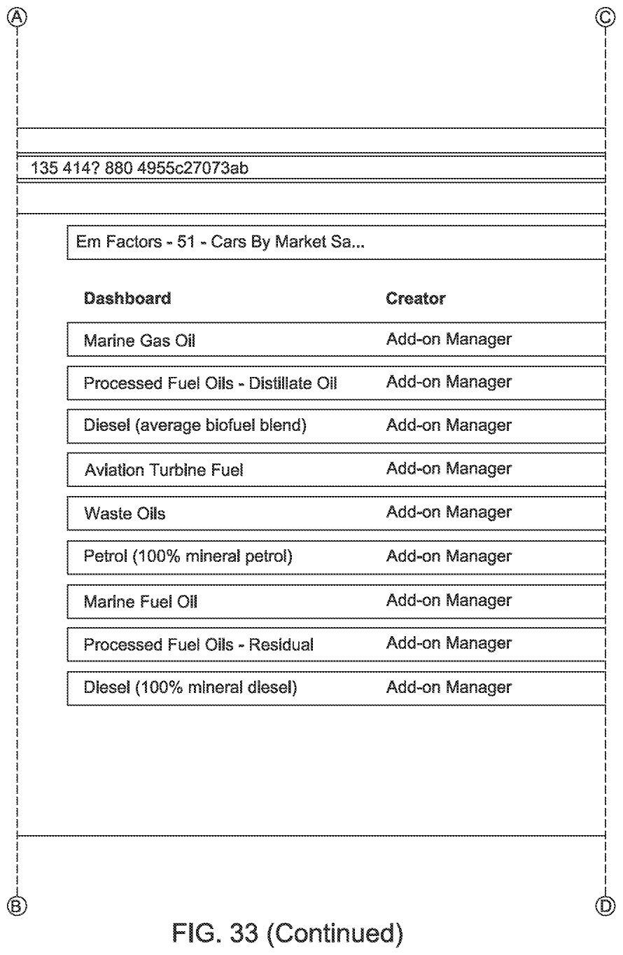

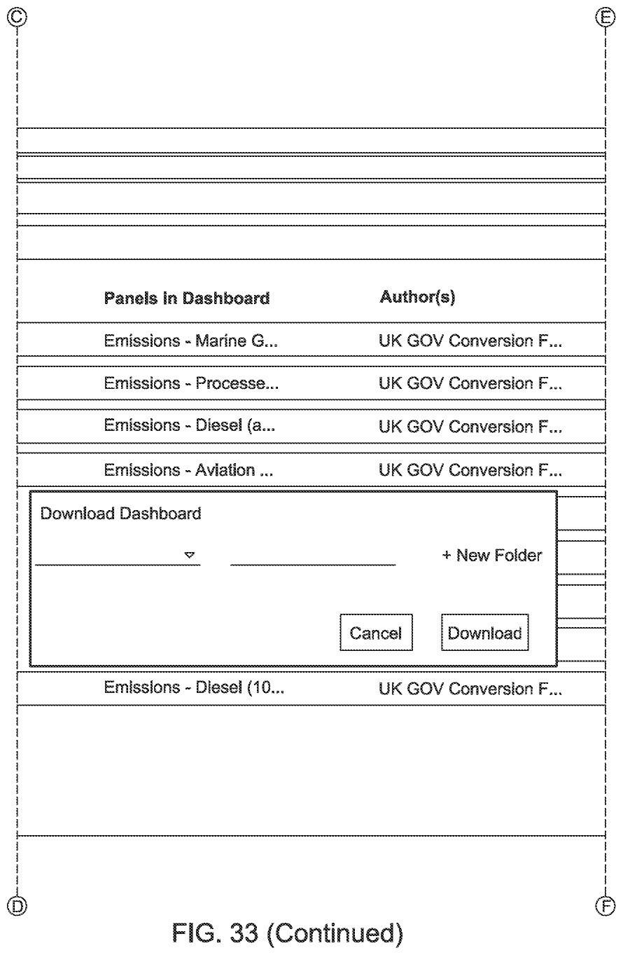

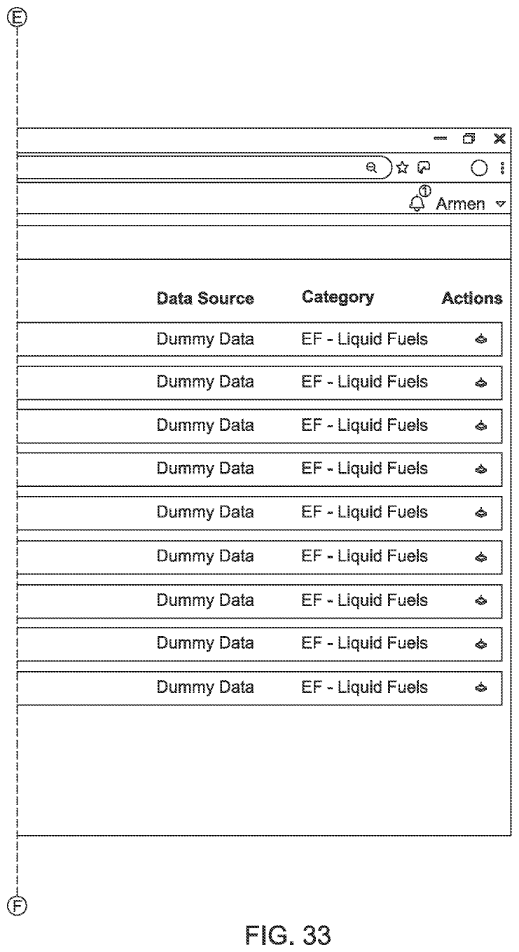

For example, as illustrated in FIG. 32, a user may navigate to an add-on library where the user may find a wide variety of dashboards suitable for download and to thereafter be directly applied to any case or dataset desired. A download button is provided for each one of the downloadable dashboards. The download may be triggered directly by pressing a download icon in the action column of FIG. 32. In response to this action, a further dialogue window, as shown in FIG. 33, may open to allow a user to confirm the specific dashboard to download and the destination of the download.

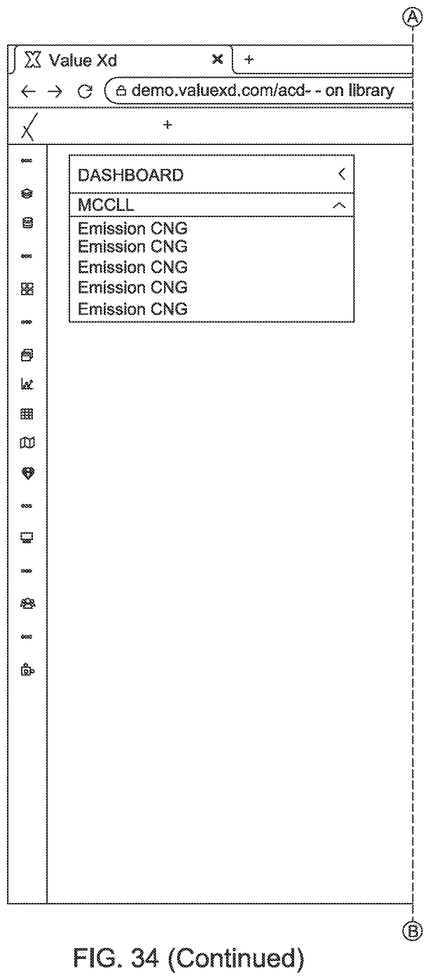

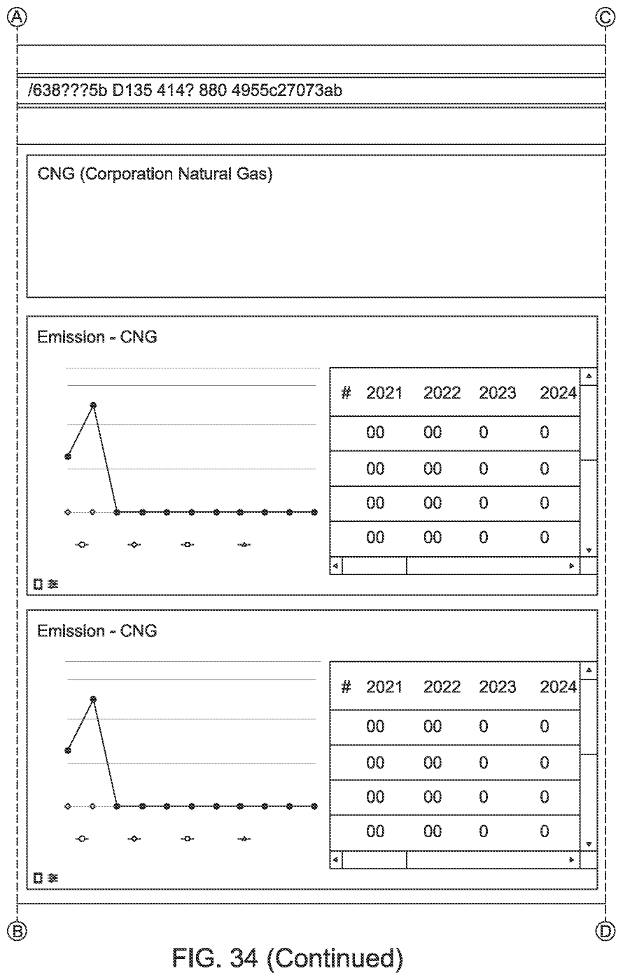

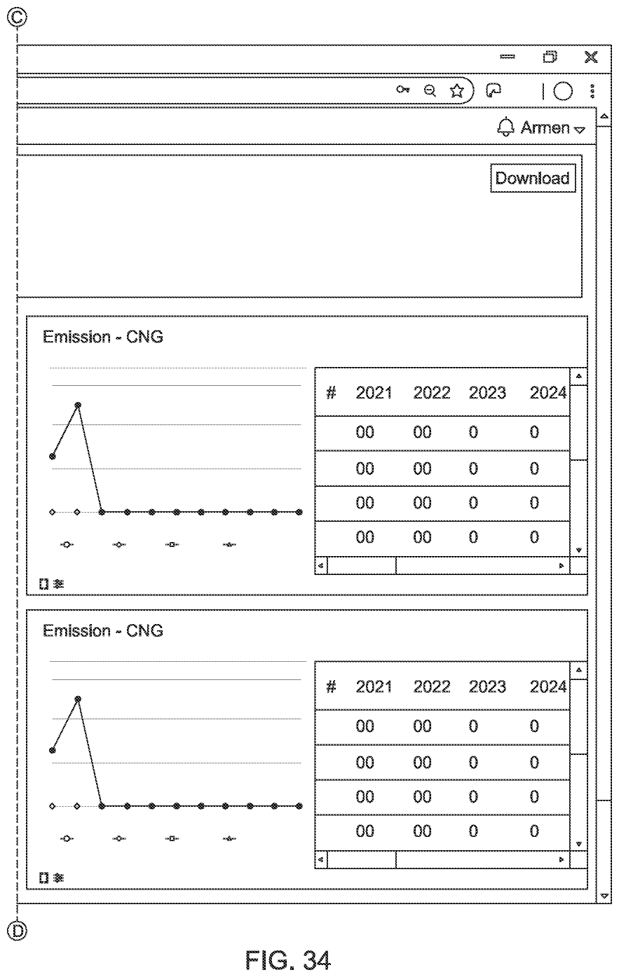

The system is configured to permit a user to check all the details about a specific downloadable dashboard prior to initiating a download. A download button may be provided on top or alongside a detailed preview of a dashboard to proceed with the download of a particular dashboard (see FIG. 34). A user may download a single or a plurality of dashboards which may be available in the Add-On library.

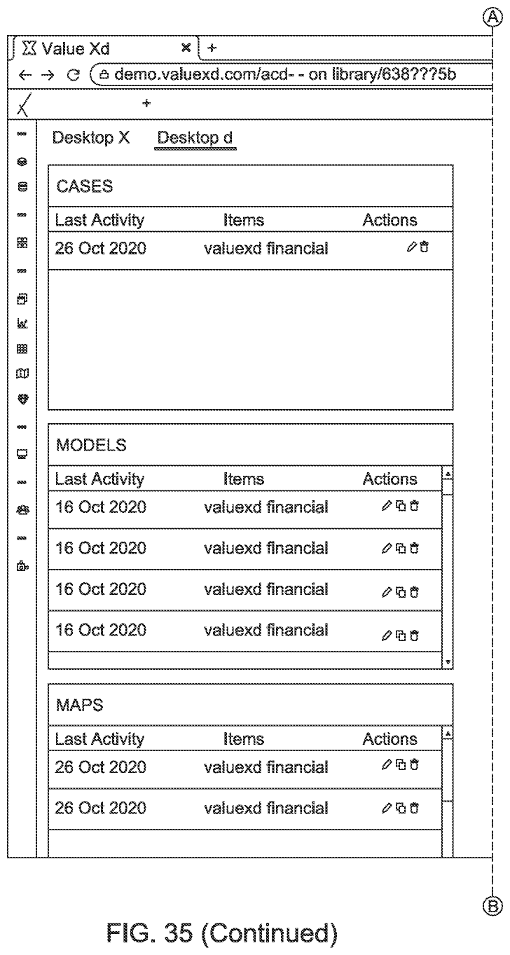

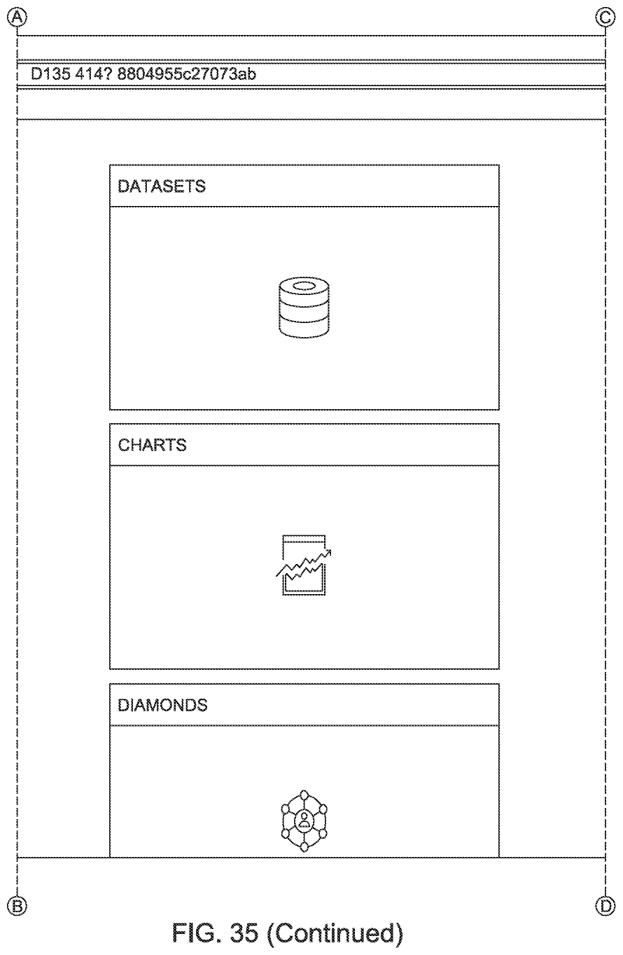

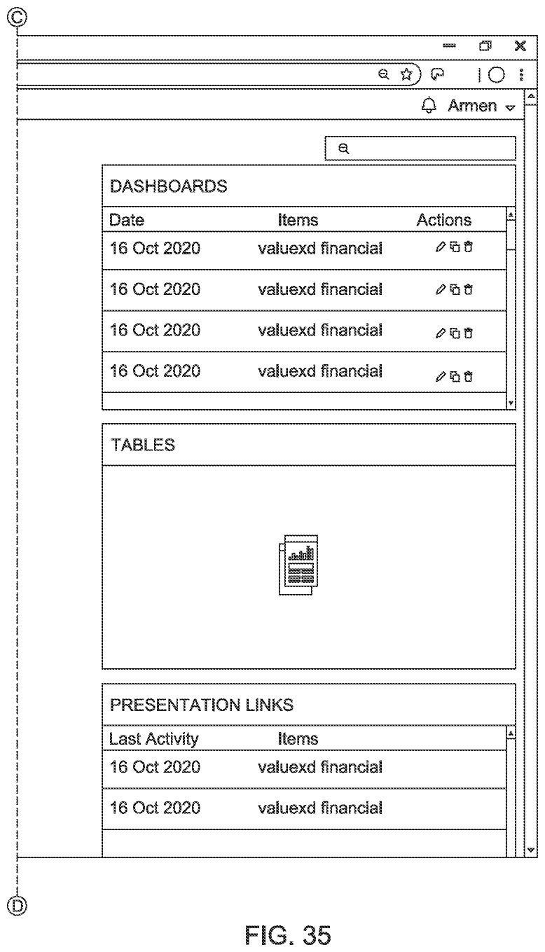

The system in addition to facilitating the download of one or more dashboards and any related model is structured advantageously to strictly segregate downloaded dashboards from user generated or created dashboards. The user interface may provide selective access to either downloaded content or created content. Downloaded content may preferably be accessible inside so called desktop d whereas created content may be accessible via desktop X. This allows a user to safely separate user generated dashboards from downloaded dashboards. The user interface may incorporate a distinct user operable button for toggling between desktop X and desktop d as shown in the top left hand corner of the embodiment of FIG. 35.

The user interface may advantageous categorise not only dashboards as downloaded and created but other items such as cases, datasets, equations, models, charts, tables, maps, diamonds and presentation links may also likewise be categorised as downloaded and created. As shown in FIG. 35, the user is provided with both a desktop X and a desktop d for selecting as appropriate.

### Systems

It will be appreciated that the described methods may be performed on any suitable processing system, including hardware or firmware. In some cases, each step may be performed by a module in a system.

Additionally or alternatively, any of the described methods may be embodied as instructions on a non-transitory computer-readable medium such that, when the instructions are executed by a suitable module within the system (such as a processor), cause the module to perform a described method. In a preferred embodiment, it will be appreciated that any of the described methods may be performed by a computer.

### Interpretation

It will be appreciated that the order of performance of the steps in any of the embodiments in the present description is not essential, unless required by context or otherwise specified. Thus most steps may be performed in any order. In addition, any of the embodiments may include more or fewer steps than those disclosed.

Additionally, it will be appreciated that the term “comprising” and its grammatical variants must be interpreted inclusively, unless the context requires otherwise. That is, “comprising” should be interpreted as meaning “including but not limited to”.

Moreover, the invention has been described in terms of various specific embodiments. However, it will be appreciated that these are only examples which are used to illustrate the invention without limitation to those specific embodiments. Consequently, modifications can be made to the described embodiments without departing from the scope of the invention.

1. A computer-implemented method comprising the steps of:
providing a data set for use in one of a first analytical scenario and an analytical use case;
providing a user interface for applying a model function to the data set and for creating an analytical data representation; said representation being selected from the group comprising a model, a chart, a table, and a map representative of one of said first analytical scenario and said analytical use case, wherein data from the data set represents model function variables;
modifying the data set for use in one of said second analytical scenario and analytical use case;
wherein the model function is accessible to allow a user to reapply the model function, via the user interface, and thereafter generate a modified analytical representation representative of one of said second analytical scenario and analytical use case.

2. The computer-implemented method according to claim 1, wherein the data set is provided for insertion not a data sheet comprising a plurality of data cells.

3. The computer-implemented method according to claim 1, further comprising the steps of inputting one of additional constants and variables for one of said second analytical use case and scenario and applying modifications in order to display a modified analytical representation and optionally applying said modifications as a second analytical scenario.

4. The computer-implemented method according to claim 1, further comprising providing a control unit operable to select at least one of said model function variable and constant, receive an input to modify a data value in the data set associated with at least one of said variable and constant and reapply the model function to the data set to provide a second analytical representation of the applied model function.

5. The computer-implemented method according to claim 1, wherein the second analytical representation is provided without the user taking the step of accessing the data sheet.

6. The computer-implemented method according to claim 3, wherein said data set has a time line and said at least one of said model variable and constant is provided as a panel with a matching time line and at least one of said matching variable and said constant.

7. The computer-implemented method according to claim 1, wherein the method further comprises the step of providing a panel relating to at least one of said additional variables and constants.

8. The computer-implemented method according to claim 1, wherein the method further comprises the steps of presenting a list of a plurality of panels relating to at least one additional variable; said at least one panel having at least one of a selectable matching property and at least one of a selectable matching constant.

9. The computer-implemented method according to claim 1, wherein the user interface enables the user to combine a plurality of said panels in a dashboard.

10. The computer-implemented method according to claim 9, wherein the user interface allows the user to apply the dashboard to the second of said analytical scenario and said analytical use case.

11. The computer-implemented method according to claim 4, wherein said control unit is accessible by interaction with the user interface and said control unit provides the option of selecting an additional variable and associating said variable with a particular data set of a data sheet by clicking to link and selectively unlink said additional variable.

12. The computer-implemented method according to claim 4, wherein said control unit comprises a projector which operates as a simulation tool that allows manipulation of data providing front end access to underlying data variables after analytical representations are created, wherein new outputs are saveable as a new analytical representation.

13. The computer-implemented method according to claim 1, wherein the user interface includes a toolbar display operative to display a plurality of visual components representing respective one of mathematical functions and equations, wherein one of said visual components is displayed in response to a selection of its respective mathematical function, wherein at least one of said mathematical functions is connected to an associated calculation engine of a calculation controller independent from the data set, the calculation engine operable to apply the at least one of said mathematical functions to the data set.

14. The computer-implemented method according to claim 13, wherein the plurality of visual components are preferably suitable for combining into an aggregate mathematical function representing said model function.

15. The computer-implemented method according to claim 4, wherein said controller is configured to be accessible during a presentation of said analytical representations and to allow a user to input at least one of additional constants and variables to said controller and thereafter generate a modified display as an updated analytical representation which takes into account at least one of said inputted additional constants and variables.

16. The computer-implemented method according to claim 1 comprising the steps of:
providing a data set for insertion into a data sheet comprising a plurality of data cells;
providing a user interface operative to display a plurality of visual components representing respective mathematical functions, wherein one of said visual components is displayed in response to a selection of its respective mathematical function,
wherein at least one of said mathematical functions is connected to an associated calculation engine of a calculation controller independent from data inserted in the plurality of data cells, the calculation engine operable to apply the at least one of said mathematical functions to the data set.

17. The computer-implemented method according to claim 1 comprising the steps of:
providing a data set for insertion into a data sheet comprising a plurality of data cells;
applying a model function to the data set, wherein data from the data set represents model function variables;
providing a first visual representation of the applied model function, and providing a control unit operable to select at least one of said model variable and said constant, receive an input to modify a data value in the data set associated with at least one of said variable and constant and reapply the model function to the data set to provide a second visual representation of the applied model function.

18. The computer-implemented method according to claim 1, said method for operating a computer application for displaying data as at least one of a chart, a map and a table, comprising the steps of:
providing a data set for insertion into a data sheet comprising a plurality of data cells;
displaying said data as one of at least a chart, a map, and a table; and
providing a user interface and a controller which is accessible through said user interface;
wherein said controller is configured to be accessible during a presentation of said at least one of said chart and table and to allow a user to input at least one of additional constants and variables to said controller and thereafter generate a modified display as at least one of an updated chart, an updated map, and an updated table which takes into account said at least one of said inputted additional constants and variables.

19. The computer-implemented method according to claim 1 comprising the steps of providing a user interface for accessing a plurality of model functions in a library of model functions; said model functions being downloadable;
wherein the method provides a step of segregating downloadable model functions from user's created model functions.

20. The computer-implemented method according to claim 1 comprising the steps of:
providing a user interface operative to display a window for the selection of a plurality of visual components representing a plurality of options for defining a principal axis time line;
wherein said window sits above or alongside said data sheet.

21. A computer-implemented method comprising the steps of:
providing a data set for insertion into a data sheet comprising a plurality of data cells;
providing a user interface operative to display a plurality of visual components representing respective mathematical functions, wherein one of said visual components is displayed in response to a selection of its respective mathematical function,
wherein at least one of said mathematical functions is connected to an associated calculation engine of a calculation controller independent from data inserted in the plurality of data cells, the calculation engine operable to apply the at least one of said mathematical functions to the data set.

22. A computer-implemented method comprising the steps of:
providing a data set for insertion into a data sheet comprising a plurality of data cells;
applying a model function to the data set, wherein data from the data set represents model function variables;
providing a first visual representation of the applied model function, and providing a control unit operable to select at least one of a model variable and a constant, receive an input to modify a data value in the data set associated with at least one of the variable and constant and reapply the model function to the data set to provide a second visual representation of the applied model function.

23. A computer-implemented method for operating a computer application for displaying data as at least one of a chart, a map and a table, comprising the steps of:
providing a data set for insertion into a data sheet comprising a plurality of data cells;
displaying said data as at least one of a chart, a map and a table; and
providing a user interface and a controller which is accessible through said user interface;
wherein said controller is configured to be accessible during a presentation of at least one of said chart and said table and to allow a user to input at least one of said additional constants and variables to said controller and thereafter generate a modified display as at least one of said updated chart, updated map and said updated table which takes into account said at least one of said inputted additional constants and variables.
